(19) United States
(12) Patent Application Publication
(10) Pub. No.: US 2025/0383544 A1
(43) Pub. Date: Dec. 18, 2025

(54) VIRTUAL DISPLAY SYSTEMS WITH INTERACTIVE MIDAIR AND EXTENDED IMAGES

(71) Applicant: Brelyon, Inc, San Mateo, CA (US)

(72) Inventors: Barmak Heshmat Dehkordi, San Mateo, CA (US); Christopher Barsi, Lee, NH (US); Yushin Kim, San Mateo, CA (US); Ahmed Othman, San Mateo, CA (US)

(73) Assignee: Brelyon, Inc, San Mateo, CA (US)

(21) Appl. No.: 19/315,914

(22) Filed: Sep. 2, 2025

Related U.S. Application Data
(63) Continuation-in-part of application No. 18/755,762, filed on Jun. 27, 2024.
Application No. 18/755,762 is a continuation-in-part of application No. 18/652,891, filed on May 2, 2024, now Pat. No. 12,443,037.
Application No. 18/652,891 is a division of application No. 18/465,396, filed on Sep. 12, 2023, now Pat. No. 12,025,798.
Application No. 18/755,762 is a continuation-in-part of application No. 18/477,684, filed on Sep. 29, 2023, now Pat. No. 12,346,532.

(51) Int. Cl. G02B 27/01; B60K 35/10; B60K 35/23; B60K 35/40

(52) U.S. Cl. CPC G02B 27/0101; B60K 35/10; B60K 35/23; B60K 35/425; B60K 2360/146; B60K 2360/21; B60K 2360/23; B60K 2360/25; B60K 2360/31; G02B 2027/0118

(57) ABSTRACT

Systems and methods of virtual displays to generate virtual images. Some display systems comprise a light source and a plurality of specular reflectors to produce virtual images that have a monocular depth that is closer to a viewer than an exit aperture optic or other optical component of the display system. In some embodiments, sensors or cameras detect a property of a viewer or of an environment to impact the virtual image or to provide sensory feedback to the viewer.

This is continuation-in-part of U.S. patent application Ser. No. 18/755,762, filed on Jun. 27, 2024, which is incorporated by reference herein in its entirety and which is a continuation-in-part of U.S. patent application Ser. No. 18/652,891, filed on May 2, 2024, which is incorporated by reference herein in its entirety and which a divisional of U.S. patent application Ser. No. 18/465,396, filed on Sep. 12, 2023.

This is also a continuation-in-part of U.S. patent application Ser. No. 18/755,762, filed on Jun. 27, 2024, which is incorporated by reference herein in its entirety and which is a continuation-in-part of U.S. patent application Ser. No. 18/477,684, filed on Sep. 29, 2023, which is incorporated by reference herein in its entirety and which is a continuation-in-part of U.S. patent application Ser. No. 18/193,329, filed on Mar. 30, 2023.

### FIELD OF THE INVENTION

The present invention relates generally to display systems and content generation for display systems with a main part and an extended display subsystem, wherein the extended display subsystem uses either its own light source or a portion of the light source from the main part. The extended display subsystem produces virtual images with one or more monocular depths.

### BACKGROUND

Increasing movement towards more immersive lightfield and/or autostereoscopic three-dimensional (3D) displays is due to advancement in electronics and microfabrication. 3D display technologies, such as virtual reality (VR) and augmented reality (AR) headsets, are often interested in presenting to a viewer an image that is perceived at a depth far behind the display device itself. Refractive elements can produce such an image but suffer from of increased bulk and optical aberrations. Further, such displays may cause eye strain, nausea, or other fatigue symptoms.

Virtual display systems are designed and implemented with various specifications. For example, in U.S. Pat. Nos. 11,067,825 B2 and 11,768,442 B1, Dehkordi described a virtual display system providing monocular and binocular depth cues to achieve realistic depth perception effects. In U.S. Pat. No. 11,592,684 B2, Dehkordi disclosed an optical component called a field evolving cavity to make the light source appear farther from the viewer compared to the distance to the physical display system. In U.S. Pat. No. 11,196,976 B2, Dehkordi further disclosed a virtual display system directed to tessellating a light field to extend beyond the pupil size of a display system. In U.S. Pat. No. 11,662,591 B1, Dehkordi et al disclosed an apparatus for modifying the monocular depth of virtual images dynamically and for producing a multifocal virtual image. Last, in U.S. Pat. No. 11,320,668 B2, Dehkordi et al disclosed a method of modifying the optical quality or the properties of a display system using optical fusion, which combines computational methods with optical architectures to remove visual artifacts from the images produced by the display system.

### SUMMARY

Some aspects relate to an extended display subsystem operable coupled to a main display. In some embodiments, the main display is an existing display device, and the extended display subsystem is an add-on device. Extended display systems allow a viewer to engage with visual information in new ways. The extended display subsystem integrated to a main display allows modification, enhancement, and optimization of the main display content, and production of virtual images. In some embodiments, the extended display subsystem has its own light source, such as a display, to produce a virtual image. In some embodiments, the light source is a part of the main display content, i.e., a subsection or subregion of the primary display.

In an embodiment, the interactive display system comprises a housing having an aperture and, within the housing, a light source to emit light, a plurality of specular reflectors to direct the light along an optical path forming a virtual image having a monocular depth and an exit aperture optic in the aperture to prevent stray light from impacting the virtual image, wherein the monocular depth differs from a distance between the exit aperture optic and a viewer by a magnitude of at least 1 cm.

In some embodiments, the monocular depth is closer to the viewer than the distance between the exit aperture optic and the viewer.

In some embodiments, the monocular depth is at least 10 cm.

In some embodiments, the virtual image is visible in a headbox that spans a lateral dimension of at least 7 cm.

In some embodiments, the viewer is a first viewer, the headbox is a first headbox, and wherein the virtual image is simultaneously visible by a second viewer located within a second headbox.

In some embodiments, the monocular depth is a first monocular depth, and the virtual image further comprises a second monocular depth, the first monocular depth and the second monocular depth forming a multifocal image.

In some embodiments, the virtual image is a first virtual image, the optical path is a first optical path, the monocular depth is a first monocular depth, and wherein the plurality of specular reflectors directs a portion of the light along a second optical path to create a second virtual image with a second monocular depth, the second monocular depth farther from the viewer than the distance between the exit aperture optic and the viewer.

In some embodiments, at least one of the plurality of specular reflectors is a curved specular reflector.

In some embodiments, at least one of the plurality of specular reflectors is polarization dependent.

In some embodiments, the interactive display system further comprises a sensor to detect a property of the viewer, the property impacting the virtual image.

In some embodiments, the interactive display system further comprises a feedback module to direct a physical response to the viewer when the viewer interacts with the virtual image.

In some embodiments, the interactive display is integrated into a vehicle.

In some embodiments, the interactive display is integrated into a device selected from a group consisting of a phone, a watch, a tablet, and a laptop.

In another embodiment, an interactive display system comprises a housing having an aperture and, within the housing, a light source to emit light, a plurality of specular reflectors to direct the light along an optical path forming a virtual image possessing a monocular depth, and an entrance aperture optic in the aperture, wherein at least one of the plurality of specular reflectors is a curved specular reflector, and the monocular depth is closer to a viewer than a distance between the exit aperture optic and the viewer.

In some embodiments, the interactive display system further comprises a sensor to detect a property of the viewer, the detected property impacting the virtual image.

In some embodiments, the virtual image is visible in at least one headbox that spans a lateral dimension of at least 7 cm.

In some embodiments, the interactive display system further comprises an electro-optic element to temporally modulate the monocular depth.

In another embodiment, an interactive display system comprises a housing having an aperture, a light-guiding subsystem secured within the housing and having a plurality of specular reflectors oriented to direct light from a light source forming a virtual image possessing a monocular depth, and an exit aperture optic in aperture to transmit the light away from the housing, wherein the virtual image is visible in a headbox that spans at least 10 cm laterally, and the monocular depth is shorter than a distance between the exit aperture optic and a viewer in the headbox.

In some embodiments, the interactive display system further comprises the light source.

In some embodiments, at least one of the plurality of specular reflectors is retroreflective

In some embodiments, the interactive display system further comprises a sensor to detect a property of the viewer, and a feedback module to direct a physical response to the viewer, the physical response based on the property of the viewer.

### BRIEF DESCRIPTION OF THE DRAWINGS

FIG. 1 illustrates elements that are common features in the embodiments in this disclosure.

FIGS. 2A through 2D describe a set of software applications that use extended, virtual, or multilayer display systems with or without remote computing sources.

FIGS. 3A and 3B depict flow charts of a software-generating mechanism for virtual or multilayer displays.

FIGS. 4A and 4B depict detailed drop-down menus of the software-generating mechanism for extended, virtual, or multilayer display systems.

FIGS. 5A through 5J illustrate a set of example functional blocks that may be used in the software-generating mechanism to produce various software experiences. These blocks may be chosen by the user or be decided based on prompts or inputs in the system at a given time.

FIGS. 6A through 6J illustrate a set of flowcharts or block diagrams corresponding to the example embodiments described in FIGS. 5A through 5J.

FIGS. 7A through 7G show a set of embodiments of generated software experiences, configured to display alternative actions that may be executed with the display system and that are correlated with the current usage.

FIGS. 8A through 8G illustrate a set of flow charts demonstrating example mechanisms for displaying alternative actions for some of the embodiments in FIGS. 7A through 7G.

FIGS. 9A and 9B depict neural network block diagrams that can be used to implement predictive features of the software described in this disclosure.

FIGS. 10A and 10B depict block diagrams depicting self-attention mechanisms for use in predicting alternative actions within extended, virtual, or multilayer display systems.

FIGS. 11A through 11G depict a set of embodiments of software applications for extended, virtual, or multilayer display systems.

FIG. 12 is a flow chart describing content from simultaneous remote and local sources.

FIGS. 13A through 13I depict embodiments of generative software applications for extended, virtual, or multilayer display systems for which the content is derived from local or remote sources.

FIGS. 14A through 14E depict a set of embodiments of generative software applications for extended, virtual, or multilayer display systems for multi-user applications.

FIGS. 15A and 15B depict a set of flow charts for some of the generative software applications described in this disclosure.

FIGS. 16A through 16C depict a set of flow charts that describe the partitioning of extended display systems into remotely sourced and locally sourced subsections.

FIGS. 17A through 17D depict auxiliary embodiments showing methods of graphically displaying information and events that follow a sequence and that can branch out from a central event that occurs in a generative software application.

FIGS. 18A through 18C depict embodiments involving using generative functions to produce modified display content based on graphical display input stream.

FIG. 18D depicts a graph of power savings based on generative functions dynamically changing the brightness of the display content.

FIG. 19A depicts an embodiment that uses a delayed real-time video and a generative AI module to produce a simulation training experience.

FIGS. 19B and 19C depict embodiments in which an AI module operates on a display content to provide an analysis or modifications of said display content.

FIGS. 20A through 20E depict a set of embodiments in which generative AI modules are used for communication and collaboration experiences.

FIG. 21 shows a list of commonly used elements throughout this disclosure.

FIGS. 22A through 22C describe a set of basic configurations and simple architectures using the elements of FIG. 21, some of these configurations corresponding to field evolving cavities.

FIGS. 23A through 23I depict a set of embodiments for integrated visualization systems and virtual displays, including multipurpose HUDs, ambient-light-driven displays, and hovering real images with which a viewer can interact through a sensor such as a gesture camera.

FIGS. 24A through 24M depict embodiments of multipurpose display systems that combine HUDs with integrated visualization display systems, including for instrument clusters in a vehicle.

FIGS. 25A through 25K depict virtual display embodiments using ambient light as a source.

FIG. 26 depicts a flowchart for identifying the conditions under which the virtual display system uses the ambient light sources of FIGS. 25A through 25I.

FIGS. 27A through 27M depict a set of embodiments that use display systems to produce hovering real images that a viewer can interact with using a gesture camera.

FIGS. 28A through 28D depict various configurations of hovering-real-image display systems integrated in various parts of a vehicle.

FIGS. 29A through 29C illustrate certain embodiments in which a portion of the optical system is itself integrated into a windshield of a vehicle.

FIGS. 30A through 30C show a set of figures of extended display subsystems operably coupled to a main display to produce an extended display system where the extended display subsystem produces secondary content using its own light source or a portion of the main display.

FIGS. 31A through 31F show further embodiments like those in FIGS. 30A and 30B.

FIGS. 32A through 32K show a set of embodiments like that in FIG. 30B, wherein the extended display subsystem uses a portion of the main display as the light source.

FIGS. 33A through 33G show a set of applications of the disclosed extended display systems involving productivity, including eye health and workflow management systems.

FIGS. 34A through 34F show embodiments of portable or in-vehicle main displays.

FIGS. 35A through 35D show applications of the extended displays disclosed herein.

FIGS. 36A through 36D outline a representative process for calibrating the extended display systems when the light source of the edge display is a portion of the main display.

FIGS. 37A through 37D show a set of electrical block diagrams disclosing examples of how the extended display subsystem and the main display are operably coupled.

FIGS. 38A through 38C show a set of embodiments that have mechanical components to move at least a portion of the extended display subsystem relative to the main display.

FIGS. 39A through 39D show a set of embodiments in which the light source is different from a display or in which the light-guiding system is different from a field-evolving cavity (FEC).

FIG. 40 depicts a hovering image in a large scale at a monocular depth in front of its aperture.

FIG. 41 shows an embodiment of a hovering image that a viewer can interact with.

FIGS. 42A and 42B show an embodiment of a free-standing display system that produces a hovering image with has multifocal content.

FIGS. 43A through 43O show embodiments of display systems that produce hovering images for at least one user.

FIGS. 43P through 43S show embodiments of display systems that produce hovering images where a plurality of viewer may view and interact with the images.

FIGS. 44A through 44C present some theoretical analyses about the optical properties of a hovering image.

FIGS. 45A through 45E show extended display subsystems that can produce hovering images or real images.

FIGS. 46A through 46J show methods of interactivity or feedback between a viewer and a hovering image.

FIG. 47 shows some examples of the content within a hovering image.

FIGS. 48A through 48F show examples of extended display subsystems of hovering images integrated with vehicles, portable devices, and wearable devices.

### DETAILED DESCRIPTION

Modern display devices offer new channels of bandwidth sharing, content creation, and user interaction. Immersive content and hardware, such as augmented reality (AR), virtual reality (VR), extended reality (XR), mixed reality (MR), headsets, and free-standing virtual display systems, are all modalities that offer unexplored methods and software applications to enhance human productivity and entertainment. Coupled with machine learning (ML), artificial intelligence (AI) algorithms, and other software architectures and algorithms, predictive and generative visual content can be displayed in new and unique ways to amplify or enrich the user experience. The inventors have recognized and appreciated that the visual experience of the user may be enriched by leveraging computer power that is running in tandem to extend and expand the set of possibilities that are offered to the user's field of view (FoV). For example, software mechanisms that incorporate such content into varieties of display systems that include, but are not limited to, three-dimensional displays, virtual and multilayer displays, or even multi-monitor setups. In some embodiments, the display images are just 2D images extended to side panels and monitors. In some other embodiments, the display provides images with monocular depth, wherein a viewer experiences accommodation depth cues to at least one image plane. In some embodiments, the display images are stereoscopic images. In some embodiments, both stereoscopic and monocular depth cues are provided. A user of the disclosed technology may experience enhanced productivity, entertainment value, or generative suggestions for an arbitrary application.

Herein disclosed are new apparatus and software methods/applications. Some embodiments described herein disclose such methods and applications configured for use in extended display systems, and they include methods for generating software applications, integration of predictive visual software, collaborative and single-user applications, and software applications and displays that involve a plurality of sources, including remote sources. New ways are described for generating visual bandwidth for productivity, training, video conferencing, telepresence, or entertainment.

In many cases, the format of the content intended to be displayed on one of these platforms is different, or even incompatible, with the format intended for display on a different platform. As such, new tools, methods, and systems are necessary for converting one format into another. In some embodiments, the conversion is automatic, semi-automatic or manual; or the information that is required is underdetermined or unknown. In some of these embodiments, machine learning (ML), artificial intelligence (AI) algorithms, and other software architectures and algorithms are used to perform the content conversion. Some of these tools may also add predictive and generative visual content to enrich the content in new and unique ways to amplify or enrich the user experience.

In some embodiments, the extended display system has two parts, a main display part and an extended display subsystem, where the main display part is an existing display, and the extended display subsystem is an added feature that is operably coupled to the main display part. The extended display subsystem may use its own light source, or it may use light from the main display part to generate an image. In some embodiments, the extended display subsystem generates imagery that is dependent on or related to the main display content. In some embodiments, the extended display subsystem generates imagery that is a virtual image, such as a multifocal image.

### Nomenclature

In this description, references to an “embodiment,” “one embodiment,” or similar words or phrases mean that the feature, function, structure, or characteristic being described is an example of the technique or invention introduced here. Occurrences of such phrases in this specification do not necessarily all refer to the same embodiment. On the other hand, the embodiments referred to herein also are not necessarily mutually exclusive. The invention here is explained relative to preferred embodiments, but it is to be understood that modifications/variations can be made without departing from the scope of the claimed invention.

All references to “user,” “users,” “observer,” or “viewer,” pertain to either individual or individuals who would use the apparatus, methods, and techniques introduced here. A user interacts with a system using a sense, which could be visual, auditory, tactile, or olfactory. In some embodiments, the system is a display system or an extended display system. A user may be a future user, who will use a system at a different time, to allow for asynchronous applications.

Additionally, the term “arbitrarily engineered” means being of any shape, size, material, feature, type or kind, orientation, location, quantity, components, and arrangements of single components or arrays of components that enables the present invention, or that specific component or array of components. The term “optically coupled” refers to two elements, the first element being adapted to impart, transfer, feed, or direct light to the second element directly or indirectly. In this disclosure, the “lightfield” at a plane refers to a vector field that describes the amount of light flowing in every or several selected directions through every point in that plane. The lightfield is the description of the angles and intensities of light rays traveling through or emitted from that plane. Further, a “fractional lightfield” refers to a subsampled version of the lightfield such that full lightfield vector field is represented by a finite number of samples in different focal planes and/or angles. Some lightfield models incorporate wave-based effects like diffraction. A lightfield display is a three-dimensional display that is designed to produce 3D effects for a user using lightfield modeling. The terms “concentric light field” or “curving light field” as used herein mean a lightfield for which for any two pixels of the display at a fixed radius from the viewer (called “first pixel” and “second pixel”), the chief ray of the light cone emitted from the first pixel in a direction perpendicular to the surface of the display at the first pixel intersects with the chief ray of the light cone emitted from the second pixel in a direction perpendicular to the surface of the display at the second pixel. A concentric lightfield produces an image that is focusable to the eye at all points, including pixels that are far from the optical axis of the system (the center of curvature), where the image is curved rather than flat, and the image is viewable within a specific viewing space (headbox) in front of the lightfield. As used herein, the term “chief ray” refers to the central axis of a light cone that is emitted by a pixel source or a point-like source, or that is reflected by a point on an object.

“Monocular optical depth” or “monocular depth” is the perceived distance, or apparent depth, between the observer and the apparent position of an image. It equals the distance to which an eye accommodates (focuses) to see a clear image. Thus, the monocular depth is the accommodation depth corresponding to the accommodation depth cue. Each eye separately experiences this depth cue. A “3D image” is an image that triggers any depth cue in a viewer, who consequently perceives display content at variable depths, or different parts of the display content at various depths relative to each other or display content that appears at a different depth than the physical display system. In some embodiments, parallax effects are produced. In some embodiments, 3D effects are triggered stereoscopically by sending different images to each eye. In some embodiments, 3D effects are triggered using monocular depth cues, wherein each eye focuses or accommodate to the appropriate focal plane. A virtual image is an image displayed on a virtual display system. Virtual images may be multifocal, varifocal, lightfield images, holographic, stereoscopic, autostereoscopic, or (auto) multi-scopic. The virtual depth of a virtual image may be dynamically adjustable via a control in the display system, a user or sensor input, or a pre-programmed routine.

For example, a point source of light emits light rays equally in all directions, and the tips of these light rays can be visualized as all lying on a spherical surface, called a wavefront, of expanding radius. (In geometric optics in, for example, free space or isotropic media, the wavefront is identical the surface that is everywhere perpendicular to the light rays.) When the point source is moved farther from an observer, emitted light rays travel a longer distance to reach the observer and therefore their tips lie on a spherical wavefront of larger radius and correspondingly smaller curvature, i.e., the wavefront is flatter. This flatter wavefront is focused by an eye differently than a less flat one. Thus, the point source is perceived by an eye or camera as a farther distance, or deeper depth, to the object. Monocular depth does not require both eyes, or stereopsis, to be perceived. An extended object can be considered as a collection of ideal point sources at varying positions and as consequently emitting a wavefront corresponding to the sum of the point-source wavefronts, so the same principles apply to, e.g., an illuminated object or emissive display panel. Wavefront evolution refers to changes in wavefront curvature due to optical propagation. Here “depth modulation” refers to the change, programming, or variation of monocular optical depth of the display or image.

In this disclosure, the term “display” can be based on any technology, including, but not limited to, display panels likes liquid crystal displays (LCD), thin-film transistor (TFT), light emitting diode (LED), organic light emitting diode arrays (OLED), active matrix organic light emitting diode (AMOLED), plastic organic light emitting diode (POLED), micro organic light emitting diode (MOLED), or projection or angular-projection arrays on flat screens or angle-dependent diffusive screens or any other display technology and/or mirrors and/or half-mirrors and/or switchable mirrors or liquid crystal sheets arranged and assembled in such a way as to exit bundles of light with a divergence apex at different depths or one depth from the core plane or waveguide-based displays. The display may be an autostereoscopic display that provides stereoscopic depth with or without glasses. It might be curved, flat, or bent; or comprise an array of smaller displays tiled together in an arbitrary configuration. The display may be a near-eye display for a headset, a near-head display, or far-standing display.

A “segmented display” is a display in which different portions of the display show different display contents, i.e., a first portion of light from the segmented display corresponds to an independent display content compared to a second portion of light from the segmented display. In some embodiments, the light corresponding to each display content travels a different path through an optical system to produce correspondingly different virtual images. The virtual images may be at different monocular depths. Each display content is called a “segment.” In some embodiments, the different segments show identical content that are made to overlap to enhance brightness or another property of the image quality.

A “display system” is any device that produces images. Physical sources of display images can be standard 2D images or video, as produced by a display panel or a plurality of display panels. Such display technologies, or a plurality of them, may also be incorporated into other display systems. In some embodiments, spatial light modulators (SLMs) are used. In some display systems, light sources may be coupled with masks or patterned elements to make the light source segmented and addressable. Other sources may be generic light sources, such as one or several LEDs, backlights, or laser beams, configured for use, for example, in projection-based display systems. A display system may be a headset, a handheld device, or a free-standing system, where the term “free-standing” means that the device housing can rest on a structure, such as a table. In some embodiments, the display system is configured to be attached to a structure by a mechanical arm.

In this disclosure, an “extended display” or “extended display system” is any display system that has part of an image or visualization allocated, extended, or dedicated to extended content, which is not the main content fed to the display. This includes a multi-monitor setup; a monitor-projection system hybrid setup; virtual display systems; AR, VR, and XR headsets with extended headtracking views; multi-projection systems; lightfield display systems; multi-focal display systems; volumetric displays systems; tiled video walls; or any display systems that are connected portions of the same environments. In some embodiments, the extended display system has one part on a monitor and another part on a cellphone, tablet, laptop screen, touch screen, advertisement screen, or AR/VR/XR/MR device. An extended display system can be divided into any collection of displays on any screen devices in any application. An extended display system may be considered as a collection of displays or pixels on one or a plurality of devices, such that there are a main input set of pixels and an extended set of pixels. The extended set of pixels may also be called an “extended portion” or “extended part” of the display content. An extended display system may be described as having a main part, for which the content is generated by a primary computer system (a “local source”), and it may have a secondary part (i.e., an extended part) that may be generated by auxiliary or indirect computer systems or sources (a “remote source”).

Sources of display content may be local or remote. Sources include local workstations, laptops, computers, edge devices, distributed sensors, the internet, cloud sources, servers or server farms, or any electronic device that can communicate data. Sources can include microcontrollers, field programmable gate arrays (FPGAs), cloud computers or servers, edge devices, distributed networks, the internet of things (IoT). Sources may operate on the data before transmitting it to the display system, and sources may receive data from the display system to operate on.

Remote sources include, but are not limited to, cloud servers, the internet, distributed networks or sensors, edge devices, systems connected over wireless networks, or the IoT. Remote sources are not necessarily located far away and may include processing units (CPUs, GPUs, or neural processing units (NPUs)) that are operating on a station other than a local source. The local source is hardwired to the user interface system and acts as the main workstation for the main display portion of an extended display.

A “virtual display system” produces images at two or more perceived depths, or a perceived depth that is different from the depth of the display panel that generates the image. A display system that produces a virtual image may be called a virtual display system. Such images may rely on monocular depth; they may be stereoscopic, autostereoscopic, or (auto) multi-scopic. A virtual display system may be a free-standing system, like a computer monitor or television set. It may be part of a cellphone, tablet, headset, smart watch, or any portable device. It may be for a single user or multiple users in any application. Virtual display systems may be volumetric or lightfield displays. In some embodiments, the virtual display system is a holographic display, which relies on the wave nature of light to produce images based on manipulating the interference of the light. A virtual display system may be, or form part of, an extended display system.

A virtual image is meant to be viewed by an observer, rather than be projected directly onto a screen. The light forming the image has traveled an optical distance corresponding to the monocular depth at which a viewer perceives the image. The geometric plane in space in which the virtual image is located is called the “focal plane.” A virtual image comprising a set of virtual images at different focal planes is called a multifocal image. A virtual image whose focal plane can be adjusted dynamically, e.g., by varying an optical or electrical property of the display system, is also called a multifocal image. A virtual display system that produces multifocal images may be called a “multifocal display system.” The depth at which content is located is also called a “virtual depth,” or “focal plane.” A display that produces display content viewable at different virtual depths is called a “multilayer display system” or “multilayer display.” E.g., a multilayer display system is one in which display content is shown in such a way that a viewer must accommodate his eyes to different depths to see different display content. Multilayer displays comprise transparent displays in some embodiments. Content at a given virtual depth is called a “layer,” “depth layer,” or “virtual layer.”

The display system may produce a real image in the space outside the display system. (A real image forms where the light rays physically intersect, such that a film placed at that location will record a (collection of) bright spot(s), corresponding to an image.) The light rays diverge beyond that intersection point, such that a viewer sees a virtual image. That virtual image is first formed as a real image and will appear to the viewer as floating, or hovering, in front of the display panel, at the location of the real image location. This image is called a “hovering real image.”

The term “display content” is used to describe the source information or the final image information that is perceived by a viewer. In some embodiments, the virtual display system produces an eyebox whose volume is big enough to encompass both eyes of a viewer simultaneously. In another embodiment, the virtual display system produces a left eyebox and a right eyebox, configured for simultaneous viewing by the left and the right eye, respectively. The size and number of eyeboxes depends on the specific nature and design of the display.

Extended display systems and virtual display systems may incorporate any hardware, including liquid crystals or other polarization-dependent elements to impact properties of the display; any type of mirror or lens to redirect the light path, influence the size in any dimension, modify the focal depth, or correct for aberrations and distortions; any surface coatings, active elements; spectral or spatial filters to assist in image quality; optical cavities; or any type of element or coating to serve as a shield layer or antireflection layer to reduce unwanted, stray, or ambient light from reaching a viewer. In some embodiments, display systems comprise metamaterials and metasurfaces, nonlinear optical elements, photonic crystals, graded-index materials, anisotropic or bi-anisotropic elements, or electro-optic elements. In some embodiments, extended display systems are optical virtual display systems. But extended display systems can be of any modality, including radiofrequency or acoustic display systems, configured for consumption by a person's human auditory system. The displays, or elements of the display may be curved in some embodiments.

A display system can produce images, overlay annotations on existing images, feed one set of display content back into another set for an interactive environment, or adjust to environmental surroundings. Users may have VR, AR, or XR experiences; video-see through effects; monitor remote systems and receive simultaneous predictive suggestions; provide an avatar with permissions to make imprints on digital content or online resources; or use AI for generative content creation. A subsection of the display content may be input into an algorithm to impact another subsection. A “subsection” of display content is a partitioning of the display content produced by the display system. In some embodiments, a subsection is a pixel or set of pixels. The set of pixels may be disjoint or contiguous. In some embodiments, a subsection corresponds to a feature type of the display content. For example, a subsection of an image of a person may be a head or an arm, and another subsection may be a hand or an eye. In some embodiments, a subsection may be an entire layer or part of a layer or focal plane of a display that produces multiple focal planes. In some embodiments, a subsection is a part of the spectral content of an image or a portion of the image in an arbitrary mathematical basis. Subsections may also be partitioned differently at various times.

In some embodiments, a subsection is one of the segments of a segmented display.

Display content may be manipulated by a user or interactive with a user through various input devices. Input devices are types of sensors that take in a user input, usually deliberately rather than automatically. Input devices, such as cameras, keyboard and mouse input, touch screens, gesture sensors, head tracking, eye tracking, VR paddles, sound input, speech detection, allow for user feedback in multiple modalities. In some embodiments, various biological or health sensors capture information—such as heart rate, posture, seating or standing orientation, blood pressure, eye gaze or focus—and use that information in an algorithm to influence or impact the displayed content.

Eye gaze may be detected, and the locations of the eye gaze may be tracked. Eye gaze detection may measure a person's focus, i.e., where that person is looking, what that person is looking at, how that person is blinking or winking, or how that person's pupils react (e.g., changes in pupil size) to any stimuli, visual or otherwise. A sensor, like an infrared sensor, may shine infrared light onto the eyes to detect changes in reflectivity based on eye motion. In some embodiments, a camera captures images of the eyes, and a convolutional neural network (CNN) is used to estimate the eye gaze. Once the eye gaze is detected or known by the display system, the display content may change based on the eye gaze. For example, the eye gaze might be such that a user is looking at a particular display content that corresponds to an action that the user may take, such as displaying a menu. In another example, a first layer may display a wide-field image of a scene or a user's location on a map, and eye tracking feedback zooms into a particular region or displays annotations about the region that is the focus of the eye gaze. This example may be called telescoping functionality.

An “instrument cluster” is a display for a vehicle that provides visual information about the status of the vehicle. In an automobile, an instrument cluster may show a speedometer, odometer, tachometer, fuel gauge, temperature gauge, battery charge level, warning signals, other alerts. In some embodiments it includes GPS or map information for navigation. A HUD image is an image that forms overlaid with a transparent window of a vehicle. A “HUD image” is an example of an AR image, in which the image is overlaid with environmental scenery.

“Headbox” is the volume of space where a viewer's eyes may be positioned for an image to be visible. In some embodiments, the headbox is larger than the average interpupillary distance for a person, such that both eyes can be located within the headbox simultaneously. The virtual images disclosed herein are simultaneously visible by both eyes of a view. In some embodiments the headbox is large enough for a plurality of viewers to see a virtual image. In some embodiments, headbox and eyebox are used interchangeably.

An “addressable matrix” or “pixel matrix” is a transmissive element divided into pixels that can be individually (e.g., electrically) controlled as being “ON,” to transmit light, or “OFF,” to prevent light from passing, such that a light source passing through can modulated to create an image. The examples of displays above include such matrix elements. Generally, a “modulation matrix” is an element that is segmented such that light traveling incident on different portions of the modulation matrix experience different optical properties of the modulation matrix, the different optical properties being controllable. Such a layer is used to imprint spatial information, such as an image, onto the light. A modulation matrix may be absorptive, reflective, transmissive, or emissive; and it may comprise electrophoretic, absorptive, fluorescent or phosphorescent, mechanical, birefringent, electrooptic materials. An addressable matrix is an example of a modulation matrix layer. In some embodiments the optical properties of each portion of a modulation matrix depend also on the incident light (e.g., for a photochromic-based modulation matrix).

As used herein, the “display aperture” is the surface where the light exits the display system toward the exit pupil of the display system. The aperture is a physical surface, whereas the exit pupil is an imaginary surface that may or may not be superimposed on the aperture. After the exit pupil, the light enters the outside world.

As used herein, the “imaging aperture” is the area or surface where the light enters an imaging system after the entrance pupil of the imaging system and propagates toward the sensor. The entrance pupil is an imaginary surface or plane where the light first enters the imaging system.

“Image aperture,” “exit aperture optics” or “exit aperture” all correspond interchangeably to a set of optical elements located at the aperture surface. In some embodiments, the set contains only one element, such as a transparent window. Exit aperture optics protect the inside of the display system from external contaminants. Exit aperture optics are also used to prevent unwanted light from entering the display system. In a display system, “stray light” is unwanted light that interacts with the display system and travels along a substantially similar path as the desired image into a viewer's eyes. E.g., stray light includes ambient light that enters the system through an undesired entrance and finally exits through the display aperture to be visible by an observer, thus degrading the viewing experience. With exit aperture optics, such stray light prevents or mitigates this degradation by removing stray light or its effects. In some embodiments, exit aperture optics includes a wave plate and a polarizer. In some embodiments, it includes an anti-reflection coating. In the context of stray light mitigation, an exit aperture may also be called an “ambient light suppressor.”

In display systems that use ambient or environmental light as the light source, the ambient light enters the display system through a set of optics called an “entrance aperture” or, equivalently, “entrance aperture optics.” In some embodiments, this set contains only one element, which may be a single transparent element to transmit the ambient light into the display system. Entrance aperture optics is located at the surface where the ambient light enters the display system. In some embodiments, the entrance aperture optics is configured to collect as much light as possible and may include diffractive optic elements, Fresnel lens or surfaces, nanocone or nanopillar arrays, antireflection layers, and the like.

The terms “field evolving cavity” or “FEC” refer to a non-resonant (e.g., unstable) cavity, comprising reflectors or semi-reflectors, that allows light to travel back and forth between those reflectors or semi-reflectors to evolve the shape of the wavefront, therefore the monocular depth, associated with the light in a physical space. One example of an FEC may comprise two or more half-mirrors or semi-transparent mirrors facing each other and separated by a distance d. The light that travels from the first half-mirror, reflected by the second half-mirror, reflected by the first half-mirror, and finally transmitted by the second half-mirror will have traveled a total distance of 2d, which is the monocular depth. Thus, the monocular depth is larger than the length of the FEC.

In some embodiments, an FEC may be parallel to or optically coupled to a display or entrance aperture optics (in the case of display systems that use ambient light as the light source) or to an imaging aperture or imaging aperture (in the case of imaging systems). In some embodiments, an FEC changes the apparent depth of a display or of a section of the display. In an FEC, the light is reflected back and forth, or is circulated, between the elements of the cavity. Each of these propagations is a pass. E.g., suppose there are two reflectors comprising an FEC, one at the light source side and another one at the exit side. The first instance of light propagating from the entrance reflector to the exit reflector is called a forward pass. When the light, or part of light, is reflected from the exit facet back to the entrance facet, that propagation is called a backward pass, as the light is propagating backward toward the light source. In a cavity, a round trip occurs once the light completes one cycle and comes back to the entrance facet. In some embodiments, a round trip occurs when light substantially reverses direction to interact with an element of an optical system more than once. The term “round trips” denotes the number of times that light circulates or bounces back and forth between two cavity elements, or the number of times light interacts with a single element.

FECs can have infinitely many different architectures, but the principle is always the same. An FEC is an optical architecture that creates multiple paths for the light to travel, either by forcing the light to make multiple round trips or by forcing the light from different sections of the same display (e.g., a segmented display) to travel different distances before the light exits the cavity. If the light exits the cavity perpendicular to the angle it has entered the cavity, the FEC is referred to as an off-axis FEC or a “FEC with perpendicular emission.”

An FEC assists in providing depth cues for three-dimensional perception for a user. In some embodiments, a depth cue is a monocular depth cue. Another example of an FEC comprises a first semi-reflective element, a gap of air or dielectric material, and a second semi-reflective element. Light travels through the first semi-reflective element, through the gap, is reflected by the second semi-reflective element, travels back through the gap, is reflected by the first semi-reflective element, travels forward through the gap again, and then is transmitted by the semi-reflective element to a viewer. The result is that the effective distance traveled by the light in this case is three times bigger than the gap distance itself. The number of round trips is arbitrary. For example, there may be 0, 1, 2, or 3 round trips. In some embodiments, polarization-dependent and polarization impact elements—such as polarizers, wave plates, and polarizing beam splitters—may be used to increase the light efficiency or modify the number of round trips. If, for example, the source of light is a pixel, which is approximately a point source, the FEC causes the spherical wavefront of the pixel to be flatter than it would be if the light traveled once through the gap.

In an FEC, the number of round trips determines the focal plane of the image and, therefore, the monocular depth cue for a viewer. In some embodiments, different light rays travel different total distances to produce multiple focal planes, or a multi-focal image, which has a plurality of image depths. In some embodiments, an image depth is dynamic or tunable via, e.g., electro-optic structures that modify the number of round trips.

The “light efficiency” or “optical efficiency” is the ratio of the light energy that reaches the viewer to the light energy emitted by an initial display.

Throughout this disclosure, “angular profiling” is the engineering of light rays to travel in specified directions. Angular profiling may be achieved by directional films, holographic optical elements (HOEs), diffractive optical elements (DOEs), lenses, lenslet arrays, microlens arrays, aperture arrays, optical phase masks or amplitude masks, digital mirror devices (DMDs), spatial light modulators (SLMs), metasurfaces, diffraction gratings, interferometric films, privacy films, or other methods. “Intensity profiling” is the engineering of light rays to have specified values of brightness. It may be achieved by absorptive or reflective polarizers, absorptive coatings, gradient coatings, or other methods. The color or “wavelength profiling” is the engineering of light rays to have specified colors, or wavelengths. It may be achieved by color filters, absorptive notch filters, interference thin films, or other methods. “Polarization profiling” is the engineering of light rays to have specified polarizations. It might be achieved by metasurfaces with metallic or dielectric materials, micro- or nanostructures, wire grids or other reflective polarizers, absorptive polarizers, quarter-wave plates, half-wave plates, 1/x waveplates, or other nonlinear crystals with an anisotropy, or spatially profiled waveplates. All such components can be arbitrarily engineered to deliver the desired profile.

“Distortion compensation” is a technique for compensating errors in an optical system that would otherwise degrade image quality. In some embodiments, the distortion compensation is computational. The desired image content is pre-distorted such that when it experiences a physical distortion, the effect is negated, and the result is a clear image. Distortions to compensate include aberrations, angular variations of reflections. For example, a birefringent or anisotropic element may be added to account for an angle-dependent response of a wave plate. Such elements are called compensators or C-plates.

All such components and software can be arbitrarily engineered to deliver the desired profile. As used herein, “arbitrary optical parameter variation” refers to variations, changes, modulations, programing, and/or control of parameters, which can be one or a collection of the following variations: bandwidth, channel capacity, brightness, focal plane depth, parallax, permission level, sensor or camera sensitivity, frequency range, polarization, data rate, geometry or orientation, sequence or timing arrangement, runtime, or other physical or computational properties. Further parameters include optical zoom change, aperture size or brightness variation, focus variation, aberration variation, focal length variation, time-of-flight or phase variation (in the case of an imaging system with a time-sensitive or phase-sensitive imaging sensor), color or spectral variation (in the case of a spectrum-sensitive sensor), angular variation of the captured image, variation in depth of field, variation of depth of focus, variation of coma, or variation of stereopsis baseline (in the case of stereoscopic acquisition).

Throughout this disclosure, the terms “active design,” “active components,” or “active” refer to a design or a component that has variable optical properties that can be changed with an optical, electrical, magnetic, or acoustic signal. Electro-optical (EO) materials include liquid crystals (LC); liquid crystal as variable retarder (LCVR); or piezoelectric materials/layers exhibiting Pockel's effects (also known as electro-optical refractive index variation), such as lithium niobate (LiNbO₃), lithium tantalate (LiTaO₃), potassium titanyl phosphate (KTP), strontium barium niobate (SBN), and β-barium borate (BBO), with transparent electrodes on both sides to introduce electric fields to change the refractive index. The EO material can be arbitrarily engineered. Conversely, “passive designs” or “passive components” refer to designs that do not have any active component other than the display.

Throughout this disclosure, the term “GRIN material,” or “GRIN slab,” refers to a material that possesses a graded refractive index, which is an arbitrarily engineered material that shows a variable index of refraction along a desired direction. The variation of the refractive index, direction of its variation, and its dependency with respect to the polarization or wavelength of the light can be arbitrarily engineered.

Throughout this disclosure, the term “quantum dot” (QD), or “quantum-dot layer,” refers to a light source, or an element containing a plurality of such light sources, which are based on the absorption and emission of light from nanoparticles in which the emission process is dominated by quantum mechanical effects. These particles are a few nanometers in size, and they are often made of II-IV semiconductor materials, such as cadmium sulfide (CdS), cadmium telluride (CdTe), indium arsenide (InAs), or indium phosphide (InP). When excited by ultraviolet light, an electron in the quantum dot is excited from its valence band to its conduction band and then re-emits light as it falls to the lower energy level.

The “optic axis” or “optical axis” of a display (imaging) system is an imaginary line between the light source and the viewer (sensor) that is perpendicular to the surface of the aperture or image plane. It corresponds to the path of least geometric deviation of a light ray.

Throughout this disclosure, “transverse invariance” or “transversely invariant” are terms that refer to a property that does not vary macroscopically along a dimension that is perpendicular to the optic axis of that element. A transversely invariant structure or surface does not have any axis of symmetry in its optical properties in macro scale.

As used herein, “imaging system” refers to any apparatus that captures an image, which is a matrix of information about light intensity, phase, temporal character, spectral character, polarization, entanglement, or other properties used in any application or framework. Imaging systems include cellphone cameras, industrial cameras, photography or videography cameras, microscopes, telescopes, spectrometers, time-of-flight cameras, ultrafast cameras, thermal cameras, or any other type of imaging system. In some embodiments, the gesture that is output can be used to execute a command in a computer system connected, wireless or by hardwire, to the gesture camera.

A “gesture” is a motion, facial expression, or posture orientation of a user, which are normally interpreted by a person or by a computer to indicate a certain desired change, emotion, or physical state. They are typically on a time scale observable by a human being. Micro-gestures are motions, expressions, or orientations that occur within a fraction of a second. They are usually involuntary and indicate similar features as gestures. They can include brief shifts in eye gaze, finger tapping, or other involuntary actions. Gestures may be captured by a camera and identified or classified by a deep learning algorithm or convolutional neural network.

Generally, the “geometry” of a person, user, object, display image, or other virtual or physical object is a term that includes both the position and the orientation of the item. In some embodiments, the geometry of an object may correspond to the shape, i.e., by how much an object is distorted, stretched, skewed, or generally deformed. For example, a camera and algorithm together may be used to identify the location of a physical object in space.

A “communication channel” refers to a link between at least two systems or users that allows the transmission of information and data, for example, between a source and a display. It may be hardwired or wireless. Communication channels include ethernet, USB, wireless networks, any short-range wireless technology (such as Bluetooth), fiber optic systems, digital subscriber line (DSL), radiofrequency (RF) channels, such as coaxial cable.

An “input stream” refers to data or information from an either local or remote data storage system or source from which data can be retrieved. The data can be transmitted in real-time. It can include metadata about the physical source itself or about other content. An input stream may be graphical data meant directly for display on a display system. In some embodiments, an input stream may refer to one or more input streams directed to a subsection of a display system. In some embodiments an input stream is generated by a user action in one subsection of a display and shown on another subsection.

Latency is the delay between the instant information begins transmission along a communication channel and the instant it is received at the end of the channel. Typically, there is a tradeoff between latency and content bandwidth. For remote sources, latency of data communication is a parameter that can be integrated into designing software applications. Latency in remotely generated content can be incorporated into ML weights and linear layers of various neural networks.

In some embodiments, various AI and ML algorithms can be incorporated into visual predictive services. Existing learning algorithms such as generative pre-trained transformers and bidirectional encoder representations from transformers may be generalized, as described herein, for user actions and incorporated into the extended display system to command part or the entire extended display. Applications include, but are not limited to, graphical predictive assistants and virtual assistants, quality control, teleoperations, flight simulations and defense, medical and diagnostic imaging, e-sports and gaming, financial trading. In these use cases, multidimensional datasets must be displayed in intuitive ways, so that a user may make an informed decision. In some embodiments, predictive analyses can be computed. In some embodiments, virtual avatars, or AI systems with user-granted permissions act on these predictive analyses. Examples of AI generative content include text-to-image, image-to-text, image- or text-to-task, text-to-code, text-to-reasoning, image- or text-to-recommendation, or any other combination An AI function or module may be assisted in content generation by probabilistic analysis to combine different models or training data.

A “user interface,” or “UI,” corresponds to the set of interactive tools (such as toggle buttons, radio buttons, scroll bars, or drop-down menus) and screens that a user can interact with. Similarly, a “user experience,” or “UX,” defines a summative experience of a user as determined by a UI.

An “annotation layer” is display content that provides context, more information, or descriptions of other content in the display system. For example, an annotation layer might be a layer or focal plane in a multilayer display. An annotation layer provides graphics or text annotations about the content in the other layers. Other formats of extended displays may also include annotations. An annotation may be displayed on hovering graphics, on extended FoV displays, or overlaid on top of the associated display content in a single image.

In some embodiments, other properties of interest of the display content include, but are not limited to, resolution, refresh rate, brightness, FoV, viewable zone, monocular depth, or accommodation, vergence, eye box or headbox.

A “visual template” refers to a predetermined way to computationally organize and display data and information in a virtual display system. A visual template example is a set of layers produced by a multilayer display.

Generally, a “visual environment” is a collection of display content or virtual images, which may be able to interact with each other. The display content may have as its source camera images or computationally rendered images, such as computer graphics. The visual environment can be a virtual reality environment, in which all the content is virtual display content; it can be an augmented or mixed reality environment, in which virtual images are super-imposed a physical environment; or it can be a conventional image content from a display panel like an LCD panel. In some embodiments, the visual environment comprises only one virtual image. Visual environments may be used by a single user in the kinematic rig, or they may be shared or displayed by a plurality of display systems that are in communication with each other through, for example, the internet, or any type of wired or wireless network. A “shared visual environment” is a visual environment that may be used for any collaborative activity, including telework applications, teleconferencing, web conferencing, online teaching, or collaborative or multi-player gaming. In a visual environment or a shared visual environment, different users may view the display content from different perspectives, and in some embodiments the shared visual environment is immersive, such that two users each using a display in a separate location but in the same shared visual environment perceive that they are physically next to each other, or such that a user perceives being in a location other than the physical location of the display system, for example, by navigating in visual environment, or having collaborative users in the peripheral area of a virtual panorama.

Extended display systems and virtual display systems are useful for varied applications, including video games, game engines, teleoperations, simulation training, teleconferencing, and computer simulations.

A video game is an electronic game involving interaction with one or more players through a user interface and utilizes audio and visual feedback to create an immersive and interactive gaming experience. Video games may be designed for a variety of platforms, including consoles, personal computers, mobile devices, and virtual reality systems, and may incorporate various game genres, such as action, adventure, role-playing, simulation, sports, puzzle, and strategy games. The game mechanics and rules may vary depending on the game, but they usually involve an objective that the player(s) must achieve within the game's environment. A game engine is a platform for generating video games.

Teleoperations is a method of controlling a remote device or system that enables a human operator to perform tasks on the remote device or system in real-time. The teleoperation system typically includes sensors and actuators for the operator to perceive and manipulate the remote environment, as well as a user interface that provides feedback and controls for the operator. The remote device or system may be located in a hazardous or difficult-to-reach location, or it may require specialized skills or expertise to operate, making teleoperations a useful tool in a variety of industries, including manufacturing, construction, exploration, and remote-controlled vehicle use. The teleoperation system may also incorporate artificial intelligence and machine learning algorithms to enhance the operator's abilities and automate certain aspects of the remote operation

Teleconferencing is a technology that enables remote participants to communicate and collaborate in real-time conferences over a communication channel, such as the internet. The teleconferencing system usually includes both hardware and software components that allow participants to connect to the conference and interact with each other, such as a camera, microphone, speaker, display screen, and user interface. The system may also incorporate features such as screen sharing, file sharing, virtual whiteboards, and chat messaging to enhance the collaboration experience. Teleconferencing is commonly used to facilitate remote meetings, presentations, training sessions, and consultations, allowing participants to communicate and work together without the need for physical travel.

Simulation training is a technology that replicates the experience of a task in a simulated environment, typically using computer software and specialized hardware. An example is a flight simulation technology, which simulates the task of flying an aircraft. The flight simulation system typically includes a cockpit simulator or control interface that mimics the controls and instruments of a real aircraft, as well as a visual display system that provides a realistic representation of the simulated environment. The simulator may also incorporate motion and sound effects to enhance the immersive experience. Flight simulations can be used for a variety of purposes, such as pilot training, aircraft design and testing, and entertainment. The simulation may be based on real-world data and physics models to accurately replicate the behavior of the aircraft and its environment, and it may also incorporate scenarios and events to simulate various flight conditions and emergencies. User inputs to a flight simulation training application include a yoke and throttle, physical panels, or touch screens.

A computer simulation is a digital model of a real-world system or process that is designed to mimic the behavior and interactions of the system or process under different conditions. Computer simulations usually use mathematical algorithms, computer programs, and data inputs to create a visual environment in which the behavior of the system can be explored and analyzed. The simulated system may be a physical object or phenomenon, such as a weather system, a chemical reaction, an electromagnetic phenomenon, or a mechanical device, or it may be an abstract concept, such as a market or a social network. Computer simulations can be used for a variety of purposes, such as scientific research, engineering design and testing, and training and education. The accuracy and complexity of computer simulations can vary widely, depending on the level of detail and fidelity required for the application. Often the computer simulation allows a user to interact with the details of the simulated system by changing the modeling parameters or computational parameters.

A “processing device” may be implemented as a single processor that performs processing operations or a combination of specialized and/or general-purpose processors that perform processing operations. A processing device may include a central processing unit (CPU), graphics processor unit (GPU), accelerated processing unit (APU), digital signal processor (DSP), field programmable gate array (FPGA), application specific integrated circuit (ASIC), system on a chip (SOC), and/or other processing circuitry.

AI is any intelligent operation produced by a machine. Intelligent operations include perception, detection, scene understanding, generating, or perceiving information, or making inferences. The terms “neural network,” “artificial neural network,” or “neural net” refer to a computational software architecture that are example implementations of AI and that is capable of learning patterns from several data sources and types and making predictions on data that it has not seen before. The types, algorithms, or architectures, of neural networks include feedforward neural networks, recurrent neural networks (RNN), residual neural networks, generative adversarial networks (GANs), modular neural networks, or convolutional neural networks (CNN) (used for object detection and recognition). Neural networks can comprise combinations of different types of neural network architectures. The parameters of a neural network may be determined or trained using training data. Neural networks can be supervised or unsupervised. The learning can be completed through optimization of a cost function. The neural network architecture may be a radial basis network, multi-layer perceptron architecture, long-short term memory (LSTM), Hopfield network, or a Boltzmann machine. Neural network architectures can be one-to-one, one-to-many, many-to-one, many-to-many. Any of the AI algorithms can be used in the AI-based embodiments in this disclosure. For example, a GAN may use an optimization by stochastic gradient descent to minimize a loss function. An LSTM or RNN may use a gradient descent algorithm with backpropagation.

A “transformer” is a machine learning model in deep learning that relies on self-attention to weigh input data in diverse ways. Transformers are often used in computer vision and natural language processing (NLP). They differ from RNNs in that the input data is processed at once, rather than sequentially. Generative pre-trained transformers and bidirectional encoder representations from transformers are examples of transformer systems. Applications include video or image understanding, document summarization or generation, language translation, and the like.

Learning algorithms may be supervised or unsurprised. Some supervised learning algorithms used to implement the embodiments disclosed herein include decision trees or random forest, support vector machines, Bayesian algorithms, and logistic or linear regression. Unsupervised learning gains information by understanding patterns and trends in untagged data. Some algorithms include clustering, K-means clustering, and Gaussian mixture models. Non-neural network computational methods may be used to generate display content. Neural networks may be combined with other computational methods or algorithms. Other computational methods include optimization algorithms, brute force algorithms, randomized algorithms, and recursive algorithms. Algorithms can implement any mathematical operation or physical phenomena.

An “avatar” is a computer program or program interface that may include a character or a representation of a user in a digital or a visual environment. The avatar may be a visual likeness of a person, but it may also take on a default form. In some embodiments, the avatar does not have a visual likeness at all or uses text or audio modes to communicate with a user; the avatar serves as a user interface for making suggestions to a user, making predictions, or assisting in executing tasks; or the avatar has permissions to execute tasks without direct influence from a user. The avatar may be AI-based. An avatar may use a neural network or other deep learning mechanism.

“Tandem computing” is a method by which a display system shows display content from a plurality of sources, at least one being a remote source that displays content on an extended part of an extended display system. The display content is of any variety and may interact with each other.

To “interact,” in the context of two display contents interacting with each other, means that the display content of one portion of the display system is input into a function whose output dynamically impacts the display content of a second portion, and vice versa, i.e., that the display content of the second portion is input into a function (which may be the same function) whose output dynamically impacts the display content on the first portion.

“Render parallelization” refers to the capability of breaking up renderings tasks so that they can be distributed among different local and non-local computational resources. Graphics may be rendered in a variety of ways, including computer graphical techniques and radiance equations, leveraging content from volumetric video, neural rendering, or neural radiance fields.

A “graphical user interface,” or “GUI,” refers to any interface displayed on a display system that allows a user to interact with the system and information in a graphical and visual manner. A GUI may include different ways for a user to input information, such as radio buttons, toggle switches, drop down menus, or scroll bars. The GUI allows the user to interact with or generate software, or to interact with electronic devices.

A “function” is a mapping that takes in a piece of content to produce a different piece of content, or to annotate or modify the original content. A Function may be an algorithm to implement a mapping or operation. A function may take in multiple pieces of content and output multiple pieces of content. The functions may be low-level, for example, mathematical operations or image processing functions. The functions can be mid-level, for example, take in an image and detect a feature, such as an edge, within a scene. A function may be a computer-vision-assisted function. Or the function can enhance the property of the content. The function can be high-level, for example, and generate content, detect a class of objects, or make predictions about future possible actions taken by a viewer observing the input content. In some embodiments, functions are predefined. In some embodiments, functions are user-defined. Functions may be enacted through AI, including neural networks, encoder/decoder systems, transformers, or combinations of these examples. Functions may also include various methods to optimize, sort, or order various data or images. Functions may be deterministic or stochastic. They may take multiple inputs and produce multiple outputs, which may depend on time.

An example of a computational function is a simultaneous localization and mapping (SLAM) function, which constructs or updates a map of an environment and tracks users or objects in it. SLAM algorithms may involve taking as input sensory data, such as a camera, and calculating the most probable location of an object based on the sensory data. The solution may involve an expectation-maximalization algorithm. Particle or Kalman filters may be used.

Another function may be used for tracking an object or a user's body part, such as in a headtracking use case. Tracking may be implemented with a constant velocity model.

The terms “graphics intelligence,” “Intelligent generative content” or “generative content” refer to functions that output content whose input is at least one input stream. The input streams may include content that is configured for a display system. An example of graphics intelligence is an AI module or function that takes as input a set of display images and outputs a second display image that has various annotations to describe the input and to suggest methods for the user to interact with those inputs. The output content may be visual data. The output content may be used as input for other functions. The graphics intelligence may also take as input sensory data of the user, the user's environment, or another environment, such as a manufacturing warehouse, automobile surroundings, or other industrial setting. A “generative function” is a function that takes as input one or more input streams and outputs new content. In some embodiments the generative function is also influenced, impacted, or parametrized by a user's input, profile, history. The user profile contains information about the user, for example, interests, goals, desired viewing content, or demographics. The user history is the historical usage made by a user of a particular application or set of applications. It may be, for example, a search history, a list of email correspondents, a list of media that the user viewed in a given time period, and the like.

A “collaborative software application” is one in which a plurality of users interacts with each other through it. The interaction can be simultaneous or asynchronous. Examples include teleconferencing or web conferencing, online courses, multi-person gaming, various applications in control centers or teleoperations situations, webinars, or other remote learning environments. Collaborative software applications may be used in a shared visual environment.

Some capabilities described herein such as functions, visual templates, graphical user interfaces, input stream reception, and input stream generation, may be implemented in one or more modules. A module comprises the hardware and/or software, to implement the capability. For example, such a capability may be implemented through a module having one or more processors executing computer code stored on one or more non-transitory computer-readable storage medium.

In some embodiments, a capability is implemented at least in part through a module having dedicated hardware (e.g., an ASIC, an FPGA). In some embodiments modules may share components. For example, a first function module and a second function module may both utilize a common processor (e.g., through time-share or multithreading) or have computer executable code stored on a common computer storage medium (e.g., at different memory locations).

In some instances, a module may be identified as a hardware module or a software module. A hardware module includes or shares the hardware for implementing the capability of the module. A hardware module may include software, that is, it may include a software module. A software module comprises information that may be stored, for example, on a non-transitory computer-readable storage medium. In some embodiments, the information may comprise instructions executable by one or more processors. In some embodiments, the information may be used at least in part to configure a hardware such as an FPGA. In some embodiments, the information for implementing capabilities such as functions, visual templates, graphical user interfaces, input stream reception, and input stream generation may be recorded as a software module. The capability may be implemented, for example, by reading the software module from a storage medium and executing it with one or more processors, or by reading the software module from a storage medium and using the information to configure hardware.

Each of the processes, methods, and algorithms described in the preceding sections may be embodied in, and fully or partially automated by, code components executed by one or more computer systems or computer processors comprising computer hardware. The processes and algorithms may be implemented partially or wholly in application-specific circuitry. The various features and processes described above may be used independently of one another or may be combined in numerous ways. Different combinations and sub-combinations are intended to fall within the scope of this disclosure, and certain method or process blocks may be omitted in some implementations. Additionally, unless the context dictates otherwise, the methods and processes described herein are also not limited to any sequence, and the blocks or states relating thereto can be performed in other sequences that are appropriate, or may be performed in parallel, or in some other manner. Blocks or states may be added to or removed from the disclosed example embodiments. The performance of certain operations or processes may be distributed among computer systems or computers processors, not only residing within a single machine but deployed across several machines.

This disclosure extends previous methods display systems which produce a single, continuous lightfield that enables simultaneous detection of monocular depth by each eye of a viewer who is positioned within the intended viewing region, where both the monocular depth can be greater than the physical distance between the display and the viewer, and where the apparent size of the display (as perceived by the viewer) is larger or smaller than the physical size of the display. The methods in this disclosure can be used in arbitrarily engineered displays. These include, but are not limited to, large-scale lightfield displays that doesn't require glasses, systems that do require glasses, display systems that curve in front of the face and are closer to the user, lightfield displays with fractional lightfield, any type of head-mounted displays such as AR displays, mixed reality (MR) displays, VR displays, and both monocular and multifocal displays.

Further, the methods in this disclosure can be used in arbitrarily engineered imaging systems, including, but not limited to, microscopes, endoscopes, hyperspectral imaging systems, time-of-flight imaging systems, telescopes, remote imaging systems, scientific imaging systems, spectrometers, and satellite imagery cameras.

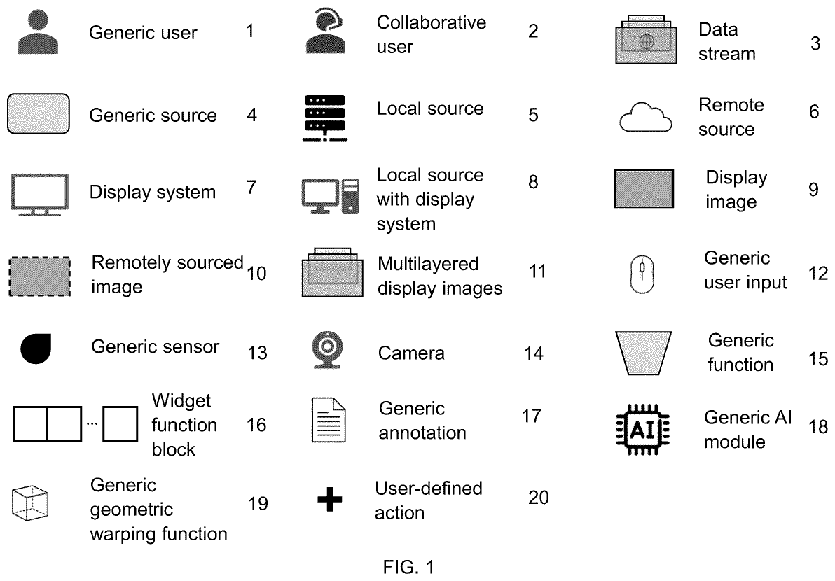

FIG. 1 depicts icons representing elements that are used throughout all the disclosure figures and serve as dictionary elements or glossary elements. In FIG. 1, Icon 1 depicts a generic user of the display systems described in this disclosure. The term “user” is defined above. Icon 2 depicts a user that is engaged in a collaborative with other users. Collaborative software applications include teleconferencing, online education platforms, multi-user gaming or entertainment, simultaneous streaming. Collaborative users may interact with each other in a shared visual environment. They may also interact in visual environments asynchronously, at various times.

Icon 3 depicts input streams pulled a source. Input streams may be any content, such as visual content, metadata, programming code, text data, database information, mathematical quantities, audio data, or numerical data. Further, the format of a data stream is arbitrary and can include, e.g., compressed, or compressed formats, vector, or bitmap formats.

Icon 4 depicts a generic source, which can be remote or local. A source can provide data to display or metadata. A source also can operate on data or metadata. A generic source, local source, or remote source may also operate on data before transmitting data to a display system. Icon 5 depicts a local source. Local sources include workstations, laptops, and desktop computers; and microcontrollers and microcontroller arrays that are physically connected to and generate content for the main part of an extended display. Icon 6 depicts a remote source. Remote sources include the internet, the IoT, remote servers, other computers on extended networks, distributed networks, or edge devices. Remote sources may also be called “indirect sources,” i.e., remote sources provide tangential or extended information or display content on extended portions on an extended display. A remote source also includes computational modules, not directly connected to a local source, that take as input the display content on the main part of an extended display system, operate on that display content with a function, and output the results of the function, such that the output impacts or is part of the display content of the extended part of the extended display system. That is, a remote source may use the display content of the main part of an extended display to impact the display content on the extended part without having information about how the display content of the main part is produced by the local source.

Icon 7 depicts a generic display system. In the embodiments described herein, display systems are extended display systems, but those skilled in the art can adapt and execute this description for use in any display system. In some embodiments, the display system purely receives data for display as content. In some embodiments, it may also process the data. A display system may include audio systems, such as microphones or speakers, that are synchronized to impact the display content. They may be integrated into the display system. Icon 8 depicts a local source paired with a display system. An example is a workstation with a computer monitor.

Icon 9 depicts a generic image or display content being displayed. Icon 10 depicts a generic image or display content that has been generated from a remote source. The image could be an independent display content, or it can be a subsection of a larger display content, the rest of which is pulled from another source. Icon 11 depicts a set of layers or multi-layered graphical information in which at least a portion of one display content overlaps with at least a portion of second display content. The number of layers can be arbitrary, for example, 2 layers, 3 layers, 6 layers, 8 layers, and the like. In some embodiments, the layer properties, such as the focal depth, are tunable.

Icon 12 depicts a generic input device. Icon 13 depicts a generic sensor that captures information about a person, a user, or an environment and communicates that information. The generic sensor may include a camera. Icon 14 depicts a generic camera or camera system.

Icon 15 depicts a block diagram icon describing a function acting on at least one data stream. Icon 16 depicts a series of connected function or widget blocks that will produce desired outputs based on specified inputs. Icon 17 depicts a generic annotation. This includes, for example, text or graphics that appear in a multilayer display, or it may be used as a specific function that produces an annotation. Icon 18 depicts a generic AI module. Example AI modules may include a neural network, a transformer, or other deep learning or ML algorithms. An AI module may comprise several AI modules that interact with each other, for example, by each feeding its own output content into the input of the others. In some embodiments, an AI module comprises several AI modules performing interrelated tasks, for example, composing a movie, such that one module produces audio content and another visual content, with the audio content affecting the video content and vice versa. In some embodiments, multiple AI modules are configured to individual tasks in parallel. Generally, a “computational module” is a device configured to process an input in a specified way. Computational modules tend to have specific functions and are usually different from generic processors in, e.g., a computer.

Icon 19 depicts a generic geometric transformation function. An example of a geometric transformation algorithm is a pose warping algorithm. Pose or motion warping may involve comparing the time series of the positions of points on an object and using a dynamic time series (which may also be used for, e.g., speech recognition) algorithm to optimize those distances. Transformation functions may also be spline-based to transform various parameter curves. Such transformation functions or algorithms may also be used for stride warping, perspective warping, orientation warping, deformation warping, or motion warping. The geometric transformation function may act on synthetic data, such as data about characters in a video game, or it may act on real data, such as an image of a user captured by a camera and segmented from the environment based on a machine learning algorithm.

In this disclosure, geometric transformation is any kind of geometric transformation, including shifts, rotations, affine transformations, homograph transformations. Geometric transformation also includes computational remapping. For example, depth remapping is an example in which a user's distance to a camera is processed to render a virtual image that maintains the correct physical or geometric proportions. Depth remapping may use isomorphism or homography to assess the remapping. Geometric transformation also includes dewarping, which is used to remove distortions that may be caused by an optical system, including fisheye distortion or barrel/pincushion distortion.

Icon 20 depicts a user-defined action or user-defined model/template. Any component of the software techniques here may be user-defined.

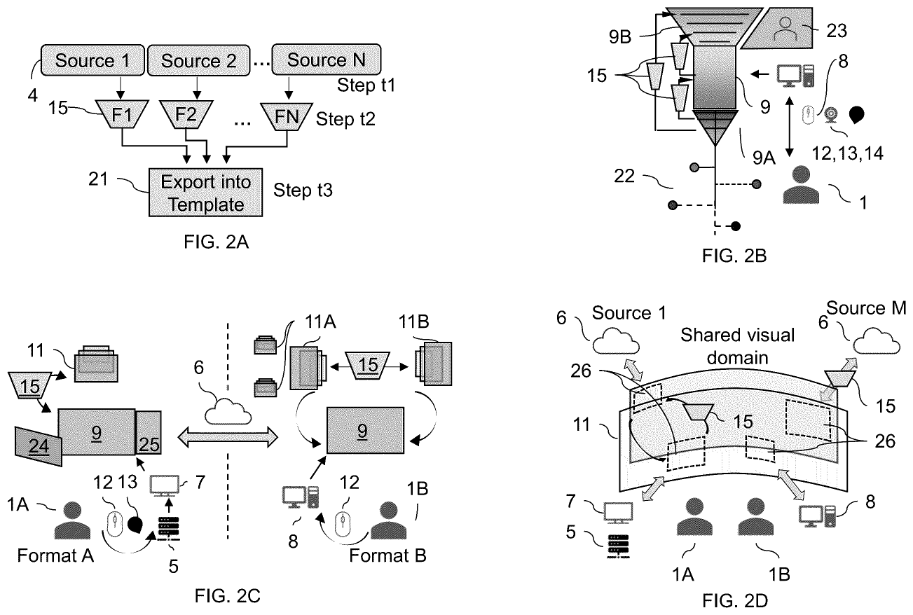

FIGS. 2A through 2D illustrate embodiments of software applications that include software generation, predictive applications, single-user and collaborative applications, and software applications that incorporate both local and remote sources, configured for use in a virtual display system.

FIG. 2A depicts a software generation application, referred herein as a “stream weaver,” (STW) for generating visual content configured for use in an extended display system. It includes a sequence of steps involved in collecting and compiling data from various sources 4, operating on said data using functions 15, and displaying said data to users according to template 21. Step t1 describes a set of N sources 4 from which data is pulled. The sources 4 may be remote, local, or any suitable combination of the two types. A source may be a video input stream, a camera input stream, a game input stream, an application, or any code or device connection. Step t2 describes a set of functions 15 that process the data pulled from the sources. The functions can act on the input streams from sources, including the metadata of the sources. Step t3 describes the process that shows the display content generated by the functions in step t2, configured for a chosen visual template 21. The exported visual template 21 may be a built-in choice or be user-defined. Various visual template options and features include display type or graphics specifications, arrangement of focal planes or virtual images, resolution, brightness, and depth resolution. In some embodiments, functions 15 are chosen after choosing the visual template or simultaneously. Error correction blocks may be added to correct, modify, or improve the information created in step t2.

Functions and sources do not need to be configured in sequence, and the number of sources does not need to be equal to the number of functions used. In some embodiments, functions take multiple sources as input. For example, a function “F4” may take as inputs input streams from “Source 1,” “Source 2,” and “Source 3.” Functions may also act compositely. For example, function “F8” may take as input the output of function “F7.” Some input streams may be integrated into the export template without any function operating on it at all. In some embodiments, there are no functions, and all the sources are directly integrated into the visual template. In some embodiments, a function has a feedback loop, for which the output of the function may be fed into the function as an input. This may be the case, for example, if feedback is desired for stability, recurrence functions, oscillation, or nonlinear dynamics.

Functions themselves include basic or extended mathematical operations and computational or graphic operations. Other functions include ML architectures, such as self-attention transformers or neural networks. In some embodiments, neural networks include a dictionary and training data. Functions are also generally time-dependent and depend on user input at the time of operation or on the history of user actions on the display system.

In some embodiments, the full set of functions may be decided by a generative neural network based on prompts that are input into the system. This allows a computer to choose how things can be reformed and shown to the user visually, based on those prompts. For example, one prompt may be “Give me a bird's eye view of one thousand video results that relate to my search and highlight the most popular ones.” In such a prompt, the computer defines N=1000 and collectively and cohesively sends it through all the functions and starts showing annotations in different depth layers.

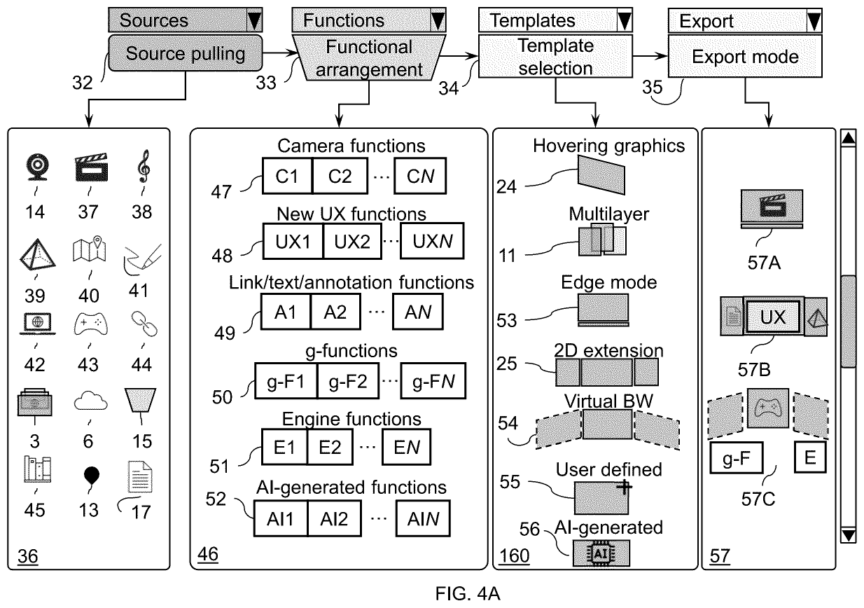

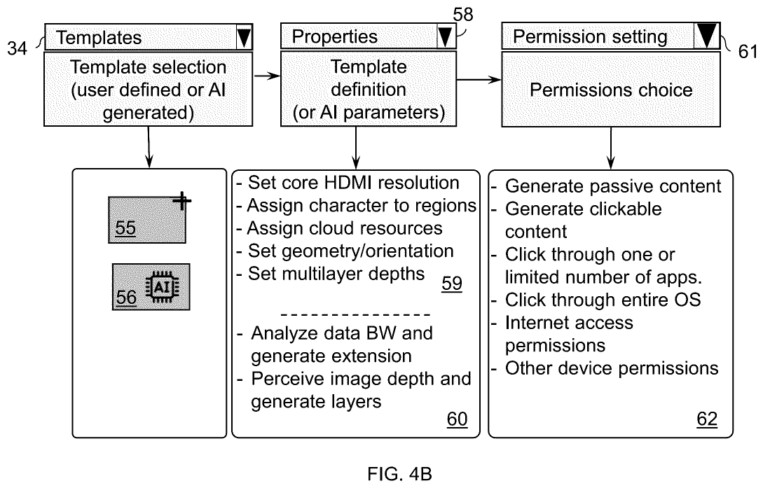

In another, much simpler example, a user may have only a main content source, say, a game stream, and the user navigates through a UI and chooses how she would like to choose other streams (or generate other streams) to interact with this one. For example, she can choose that for each frame of the main, center monitor, two side monitors show an out-painting frame of the center image, a median color, average color, a replica with a two-second time delay or inverted or geometrically transformed versions of the main game stream. As noted in this case, the two other monitors are dependent on the content shown in the center monitor. The streams are not necessarily video streams but may be interactive interfaces. This is a notable difference between video mixing done in video editing software and multiple interactive streams mixed together here. More categories and family trees of these functions will be described in FIGS. 4A through 4B, 5A through 5J, and 6A through 6J.

It should be appreciated that functions, visual templates, graphical user interfaces, AI, and other algorithms described throughout this specification and referenced in the drawings may be implemented in software, hardware, or any suitable combination thereof. Software may consist of machine-readable code stored in a memory (e.g., a non-transitory computer readable storage medium) that when executed by a processing device yield the described results either in the processing device itself or in hardware operably connected to the processing device (e.g., memory, extended display system).

FIG. 2B depicts a predictive software application “funnel expander,” or “event,” in which a local source with display system 8 functions by inputting past and present events or actions by a user 1, who is viewing a central display 9, into functions 15 to show content to the user corresponding to potential actions that the user may take. In some embodiments, multiple remote or local sources are used. The past actions may be shown in a narrowing or less obtrusive display 9A, and the potential actions shown as a more expansive display 9B, such that the past and present actions assist in displaying an expansion or funnel of future possibilities.

Current inputs and feedback by the user captured by generic input devices 12, a camera 13, or sensors 14, and are processed. The display content may also include some infographic 22 that indicates user history in a meaningful way. User history includes what applications were used, what features of applications were used, how long applications were used for, which applications were used in sequence, the actions that were taken, the display content viewed, their duration and time stamps, and their importance when measured against some metric, such as productivity. Functions 15 may produce as output a set of predicted actions that the user is most probably to engage in. In some embodiments, the suggested content is formulated by a different method than a probabilistic analysis. The method may be event-based, priority-based, based on time of day, based on settings pre-selected by a user, or any other suitable method.

In some embodiments, a user interacts with an avatar 23, which can assist in user input or be given permissions to be able to execute predicted actions. In this way, the user can multi-task in multiple parallel processes. The avatar may be a visualization, a set of text instructions, or a subroutine that is not visible to a user.

In some embodiments, the functions are probabilistic, such that actions that happen most frequently or are most correlated with the current action or display content are weighed more heavily than others. In some embodiments, the functions are based on a time factor, such that actions from the recent past are weighed more heavily than those in the distant past. In some embodiments, neural networks or transformers are used to help determine or refine the predictive behavior of the software.

The predictive features in some embodiments include estimates on the success of the user's current action, or how long it will take a user to complete the current action and how the user's schedule or calendar might be affected. Using a calendar as an input, the predictive feature may suggest alternative times to complete various tasks.

This embodiment allows for four-dimensional scrolling, in both time and space, using the extended display screens as infinite scroll with cursor or user inputs. In some embodiments, the user may be able to see parallel possibilities at multiple parts or depths of the extended display system and simply choose the desired option with a gamified mechanics. Which parallel possibilities are shown depend on the current user action and therefore can change dynamically in real time. This embodiment helps the user see as vast a set of possibilities generated by the computer as possible while getting to almost real-time interactions (back-and-forth “ping-pong-like” feedback) with computer as it crafts the data stream. For example, today, to write a word document, one must write it line by line or, if text is generated by a computer, the user must read a single variation at a time, edit it line by line, or ask for a different variation. In an embodiment described here, an expanded set of variations are shown in different parts of extended display, such that while reading, the user is also choosing in real-time what variations are being woven into the text.

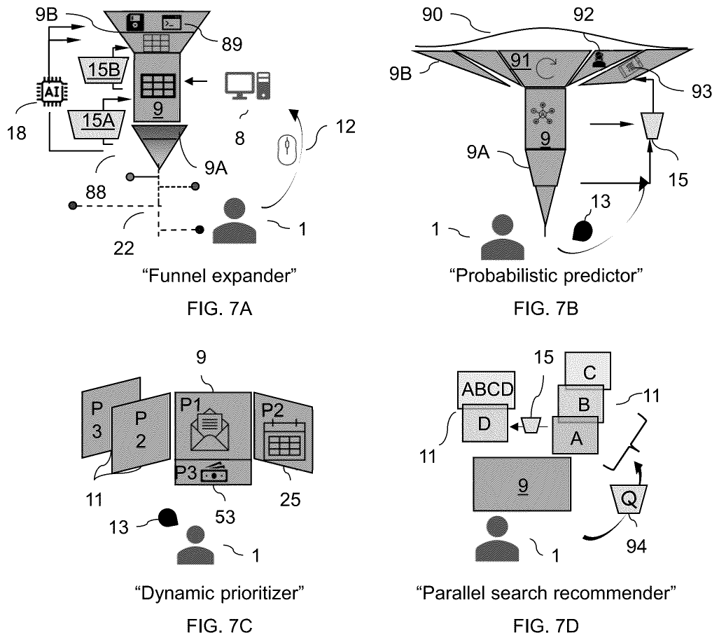

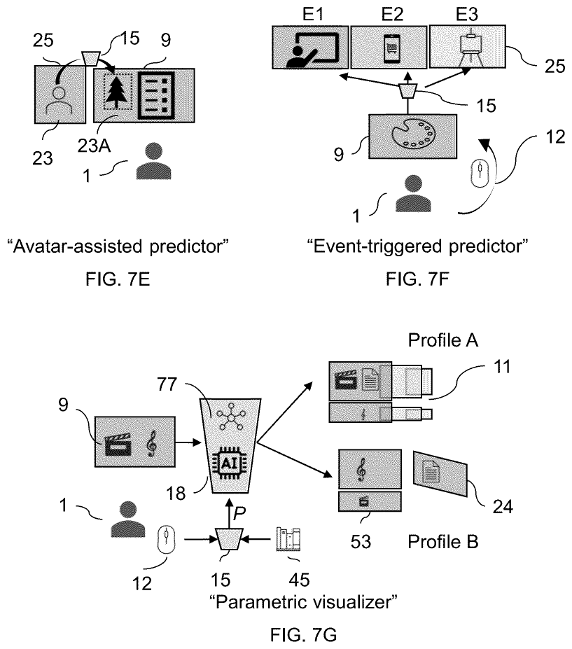

Another example is a rolling screen embodiment. Today, a user is limited by vertical resolution of a screen when scrolling on a website, computer code, or vertically long data. In the case of a three-monitor setup, this arrangement does not help in seeing more of that vertical data. With a funnel expander, a user has side monitors or front depth layers as the continuation of those vertical data. Funnel expanders may also suggest varieties of possibilities or parallel possibilities inside monitors, other depth layers, or in a peripheral FoV. For example, in a VR headset, when reading a vertical article, a user may see several other parallel articles appearing next to the main article that can be seen in the periphery. More details of funnel expanders will be given in FIGS. 7A through 7G.

FIG. 2C depicts the use of a software application in an environment in which one or more users interact with the software generated by the embodiments in FIG. 2A or 2B. The users may interact with the same content in different ways, i.e., the content may show up on a first user 1A in a different format, Format A, or visualization compared to that for a second user 1B, Format B.

First user 1A uses a display system that produces multilayer display images 11, hovering graphics 24, and a 2D extension 25, in addition to a central display 9. The user inputs information through any means, such as generic input 12 or sensor 13. Based on the user input, or on the functions that determine the display content, the display content in each of the multilayer display images 11 may be pushed forward or backward to the forefront of the user's viewable region via a function 15. Display 7 may be connected to a local source 5.

In some embodiments, multiple display systems are connected through a remote source 6, for example, the internet. A second user 1B interacts with a local source and display system 8 that shows similar content to the first user 1A. The display content for Format B may be presented using a different template than is a different user. For example, in some embodiments the visual template may consist of a first image 9 and a plurality of sets of multilayer images 11A and 11B, configured to interact with each through various functions.

For example, a user 1B may use a generic input 12 such as a mouse to scroll through a video game environment, and as the video game character moves about in the environment, different layers, each corresponding to a different depth in the environment, come closer or move farther from the user 1B. The first user 1A may be a teammate in the game and use the hovering graphic 24 as annotations about his teammates' health.

In another example, a teleconferencing call application depicts a user on one layer and various call features, whiteboarding, shared environments, or notes on other layers. The various display content and display layers interact with each other through functions. For example, a hovering graphic 24 of a user 1A may present information based on a set of images, including a video of another user 1B, in a multilayer display configuration.

FIG. 2D highlights an embodiment in which multiple users interact with display content through remote sources and local sources. In some embodiments, there is only one user, but there may be multiple users. In FIG. 2D, a first user 1A views a pair of display images in a set of multilayer images 11. A back layer of the set of multilayer images 11 might be generated by remote sources 6 and correspond to a shared visual domain, for which multiple users have access to the same display content. The input stream from a remote source might be operated on by function 15 before being displayed. A front layer may be generated by a local source 5 connected to a display system 7 or by a local source with display system 8. In some embodiments subsections 26 of a given layer or image are generated based on a user's input, history, or settings. In some embodiments, the sections are not contiguous. In some embodiments the subsections are individual pixels or sets of pixels. These shared visual domains could be, for example, a shared visual environment, corresponding to a common space on a back layer, and perspectives or windows into that common space generated on the front layer.

In some embodiments, the input from the users is motion tracking, SLAM input, or orientational input to dynamically change the scenes based on the users' position or orientation relative to the display system. In some embodiments, a subsection of a display image is input into function 15 that influences the back layer. In some embodiments, the division of data sourcing depends on content-dependent bandwidth, image mode analysis. The users can be active users and manipulate windows, or they can be passive users and just experience content that is decided, as might be the case in advertising use cases, wherein display content is intended to showcase a product or service.

In some embodiments of FIG. 2D, for example, multiple users can be in different environments looking at an upscaled virtual “cloud” image from different workstations and local workstations provide different windows in their display content to the cloud image as sharable viewable zones. In some embodiments, a single user can be viewing content from multiple input sources. In some embodiments, the display system comprises a main workstation that is influenced by a mobile device, tablet, or distributed network.

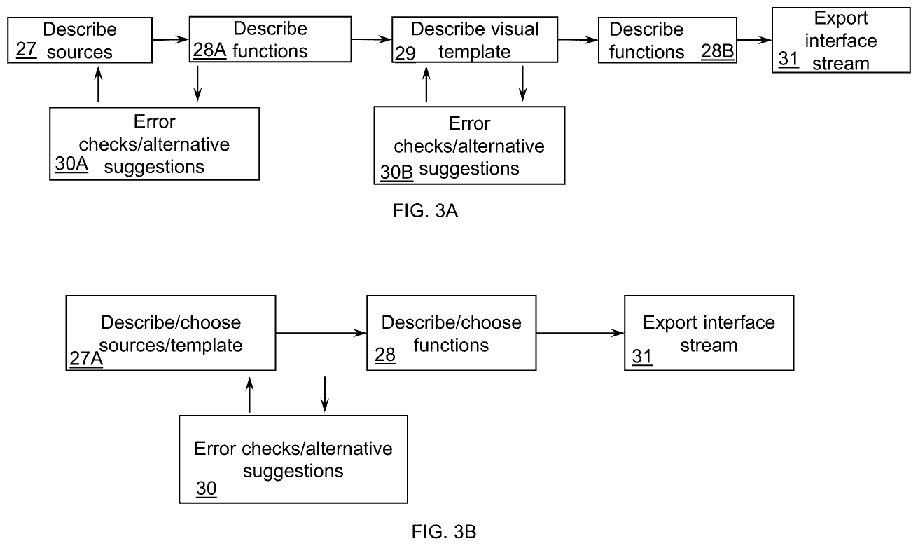

FIGS. 3A and 3B depict flowcharts for the software generation program of FIG. 2A.

The flowchart in FIG. 3A indicates at step 27 that the set of source information is first chosen or described. Then, at step 28A, the functions that act on those sources are described or chosen. In some embodiments, a function takes one or more sources as an input and produces another source as an output. Then, at step 29, the visual template is described or chosen. In some embodiments, the choice of visual template allows for further function choices at step 28B, such as the orientation of the visual template, which sources appear on which templates, and the like. In some embodiments, an error-feedback action step 30A and step 30B between the descriptions or choices checks for errors, inconsistencies, or incompatibility of choices. In some embodiments, the software generation program makes suggestions to optimize, alter, or improve the resulting software by comparing the choices of sources, functions, or template in these feedback loops. This may happen because of a prompt that is given to the software, or it may happen dynamically based on users or other sensory inputs. Finally, an export interface stream 31 is chosen by the user or the algorithm to define the form of the final interface or stream. This could be, for example, a given formatting type, compression ratio, or filename.

The flowchart in FIG. 3B represents an alternative flowchart, in which the source description and template description occur simultaneously at a step 27A, and then all the potential functions are selected in a separate function-description block at a step 28. The stream is then exported into a final export stream for an end user at step 31. Like the flowchart in FIG. 3A, in some embodiments, a feedback step 30 utilizes error-check modules to, between the choices, checks for errors, inconsistencies, or incompatibility of choices. In some embodiments, the software generation program makes suggestions to optimize, alter, or improve the resulting software by comparing the choices of sources, functions, or template.

FIGS. 4A and 4B depict a pipeline at the core of the stream weaver (STW) process. This pipeline may be a series of drop-down menus in a GUI for a user to generate software applications. The GUI may be of any configuration, however, and may be configured to clearly depict information about input streams, functions, sources, and visual templates. Shown in FIG. 4A, the STW process starts with a source pulling step 32 to decide the sources from which data or input streams are retrieved. The process continues with a functional arrangement step 33, in which data and information pulled in the previous step is processed with a variety of functions. That is, in this step, functions are chosen, the inputs to the functions are chosen, and the output are chosen. The outputs may be automatically determined by the choice of function and source. The next step is template selection step 34, in which the visual template for assembling the information processed in the previous step is chosen. The last step is an export step 35 to export the information to the user or other applications.

FIG. 4A also shows example input streams, functions, visual templates, and export modes. The source set 36 includes, but is not limited to, cameras 14, videos or clips 37—the video or camera sources may be arbitrary and are not limited to, e.g., cameras capturing video of a user—music or sound recordings 38, UX environments 39, GPS or other mapping data 41 text documents 41 with or without annotations 17, websites 42, gaming applications 43, metadata or hyperlinks 44, generic data streams 3, remote sources 6 (such as cloud-based data), the output of a function 15, or a library 45, or generic sensor data 13. Functions may be individual functions, or they may be grouped into functional blocks.

The functional block set 46 includes, but is not limited to, camera-source function blocks 47, UX- or UI-source function blocks 48, Text-/annotation-source function blocks 49, generic-source function blocks 50—in which the functions may be arbitrary, or user defined—engine-source function blocks 51, and AI-generated function blocks 52. In these function blocks, the functions themselves are AI-generated based, for example, on an understanding or classification of the input stream. For example, an input stream may be a video, and an AI function first classifies the type of video as a training video or an entertainment video. Another AI function may then generate an operation based on an anticipated user's desired application.

The visual template set 160 includes, but is not limited to, templates to display information such as hovering graphics 24, multi-layer screens 11, edge mode expander mode 53, lateral 2D desktop extension 25, tandem-extended or virtual bandwidth displays 54—displays in which at least a part of the image is generated by a remote source—a user-defined template 55, and an AI-generated template 56. This template might be automatically generated based on an output of the functions in the previous step. For example, the output of a clickable training video that includes annotations may be a display with multiple hovering graphics that contain annotations and automatically shift based on the motion of the objects being annotated.

Hovering graphics 24 can show display content such that the viewer's eye accommodates to a distance closer than a distance of the physical display system. In this way, the hovering graphics appear closer to a user than the display system itself. This can be produced, for example, using phase conjugating, retroreflective, or retro-refractive (retroreflective in transmission) elements, which cause a point source of light from the display system to be focused between the user and the display system.

A multilayer image 11 shows multiple layers of display content, such that the viewer's eyes accommodate to different depths and the viewer consequently sees different display content coming into focus. This can be produced, for example, by using a field evolving cavity to circulate the light one or multiple round trips depending on the polarization of the light, including multiple display panels, or switchable elements that can modify the path length traveled.

The edge mode expander 53 and 2D extension template 25 produce virtual images that extend the FoV of the viewer. This can be achieved by starting with a plurality of display images and directing the light along paths that travel different directions before exiting the system. To form a cohesive image across the entire depth plane, the plurality of images is tiled together such the separation is less than what is visible by the human eye, for example, a separation that is smaller than what can be seen by a person with 20/20 vision, or 20/40 vision, when viewing the display content. In some embodiments, gaps may be desirable. In some embodiments, the tiling happens in multiple directions, for example, vertically and horizontally. In some embodiments, images or the data are spatially separated in an extended FoV with an arbitrary template. The tiles or spatially separated images may change their positions dynamically according to a user or sensor input or on various computational routines.

In some embodiments, the edge expander or extended FoV templates use multiple physical monitors in an extended display system. In some embodiments, they may be virtual images produced by a virtual display system.

A tandem-extended or virtual bandwidth display template 54 is a display when information about a portion of the display content is received by a remote source. The information can be the display content itself (e.g., remotely rendered display content), metadata about the display content, information about graphics settings, or data about an environment. The information can be specific to a certain application, or it can influence a plurality of applications. In some embodiments, the partition of the display content that is influenced by the remote source changes dynamically, dependent on user settings, application features, or bandwidth constraints.

The results of the export step 35 are a software application set 57 that includes, but is not limited to, new applications, which can be a predictive application, an interactive video 57A (which can be clickable), metadata, a database, a new UX 57B, a new game 57C with interactive features or dynamic game engine, and/or interactive media.

The resulting applications that are generated by the STW may be displayed on an extended display system. They may be displayed on a virtual display system.

FIG. 4B depicts a detail of the user-defined or AI-generated template options in FIG. 4A. In this process, the template dropdown menu 34 focuses on only the user-defined template 55 or the AI-generated template 56. If either of these is chosen, a new properties dropdown menu 58 appears. The user defines a new template by choosing among properties set 59.

Properties include the shape, orientation, and position of the display content; core resolution; and assignment of different sections to different sources or research. For example, in some embodiments, the user chooses the shape of the display images, and the shapes could be squares, rectangle, arbitrary quadrilaterals, triangles, circles or bubbles, or any combination. The resolution can be of any setting, such as high definition, full high definition, wide ultra-extended graphics array, quad high definition, wide quad high definition, or ultra-high definition. User defined visual templates may be combinations of the visual templates shown in FIG. 4A.

The properties dropdown menu 58 may include an AI-parameter set 60 for AI-generated templates. For example, a user may choose various AI analyses to perform on the output of the functions. A user may wish the AI-generated template first to analyze the bandwidth of the output and then generate a 2D extension whose size can display all the information. Or a user may set the AI-generated template to first perceive or estimate image depth ranges and then generate a multilayer image with depth layers that will optimize depth perception for a viewer by, for example, matching the depth layers to horopters of the human visual system.

A user-defined template may also include a permissions dropdown menu 61 to choose various permissions settings that include whether the resulting software can integrate one app, several apps, span the entire operating system of a computer, include internet access, or generate active or passive media through user interaction.

In some embodiments, the template might be a generic, dynamic 2D geometrical shape or arbitrary mask and shown in the same 2D display. For example, a display may be partitioned into a triangle to show a video, while another triangle is a camera video stream for gaming in a more attractive format. In some embodiments, when a user is reading a text file on the screen, the input from an eye tracking device may see where the user is looking and automatically may consequently dim the rest of the display content except for a highlighted area based on the location of the user's gaze. In some embodiments, the area of the gaze may be rendered in any other different way or with different properties. For example, the area of the gaze may be rendered with higher graphic fidelity, or it may track a set of tool options as the user looks around, so the toolset is more accessible to wherever the user looks in the FoV of the screen.

In some embodiments, the mask can dynamically change based on an internal algorithm or AI algorithm that has a suggestive approach and generates shapes or masks based on an analysis of the display content.

In some embodiments where there are multiple depth layers, there may be a set of tools shown on the first layer that follows a user's head and gaze location and shows to the user the most probable choice to make based on the rest of the information shown on your screen. In this case, however, the user does not need to move the mouse to click the button in the inherent underlying app. Instead, with the shown suggestions, an arrow key or other auxiliary key may simply be clicked to proceed; this helps reduce maneuvering a mouse-over many times.

In some embodiments, the template can be defined in a 3D environment such that the display content goes through affine translational transforms to be shown as if they are mapped or skinned to different facets of a 3D environment. For example, an advertisement is transformed into a perspective view for display in a 3D environment.

In some embodiments, the geometrical templates that are applied may change dynamically based on events or action items taken in the mainstream or auxiliary streams. For example, in a game when an event happens, such as shooting or jumping of the character, side display content may flash a certain color or show a certain image, or it may become magnified or minified.

In some embodiments, the templates include templates configured for display on multiple concurrent devices. For example, a cellphone screen or tablet screen may share a visual template with a laptop. Here, as a non-limiting example, if a game character is jumping up and down in the game, on a laptop a certain display content is shown, a second on a cell phone, and still a third on a tablet.

In another example, a user is executing financial trading transactions with a desktop screen and has chosen a cellphone or tablet screen as part of the STW-generated application. When a certain news item comes or a certain stock is updated, the related content of that stream is sent to the cellphone or tablet.

In some embodiments, the STW is used to create simulation, training, or educational applications. A user who serves as the trainer or educator may share depth layers, an auxiliary display, or part of an extended FoV to a trainee to provide training instructions that appear geometrically relevant to the training medium and material. In some embodiments, the trainer may be a chat bot or AI-based algorithm that is generating instructions by predicting user intent. In some embodiments, the AI may have permission to access the primary input stream, as opposed to only showing what the user may do. In some embodiments, the training content may be played as a video stream, step by step, in front of the user.

Training and simulation experiences may involve multiple users. For example, an instructor or trainer may be observing a user who is training on the display system. The instructor may be using his own display system, or the instructor's image may be captured by a camera and shown to the user on an extended part of the user's extended display system. The instructor may provide live feedback—based on voice, keyboard or mouse input, or sensory input—to the user, and the feedback may be presented as visual or text content as an annotation, or as changes to existing annotations, in the user's display system.

In some embodiments, multiple users may each be using a display system, but the image of a first user, captured by a camera, is shown in an extended part of a second user's display system, and vice versa, to mimic the experience of being next to each other. The respective images may be warped or unwarped to provide realistic peripheral images.

In some embodiments, the display system includes multiple display devices, such as a free-standing monitor and a headset that are communicatively coupled. For example, the free-standing monitor may display a wide-field image of a simulation or training exercise, and the user is wearing a headset that shows annotations based on the monitor's displayed content or the user's geometry or eye gaze. The communication between headset and monitor may be hard-wired, e.g., through connecting cables, or wireless, e.g., through a wi-fi network or remote central source.

In some embodiments, the STW application is configured to help edit a video, depending on permission settings and output templates. An AI program may show a user how a task is performed in a video stream that appears as part of an extended display, or the AI or the trainer takes control of the program and performs, step by step, the task at hand. At any of the steps, the trainee may interject and/or collaboratively change what the trainer is doing based on user or sensory input.

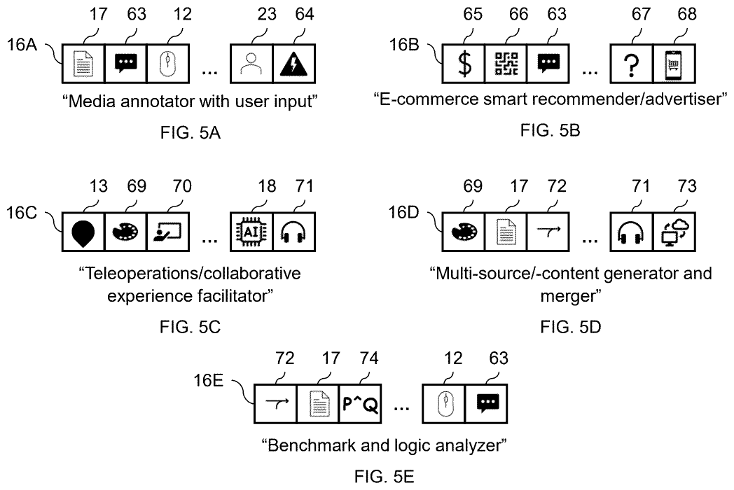

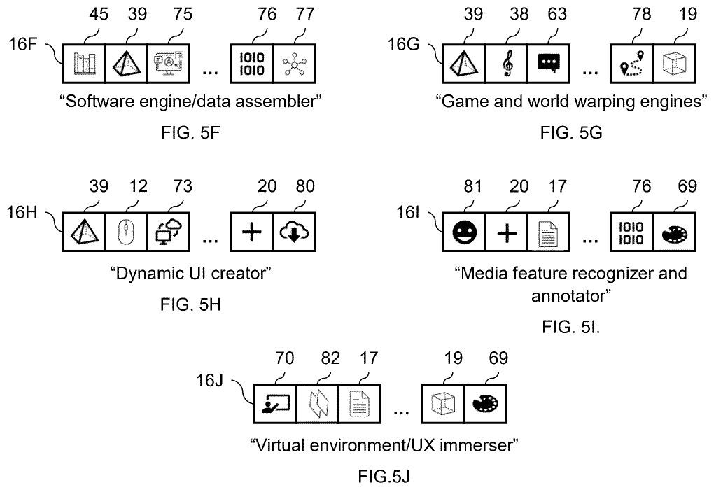

FIGS. 5A through 5J depict examples of function blocks for various sources. These various functions are chosen by a user of the STW to operate on chosen input streams for eventual display organized into a visual template. The function blocks may be how the STW organizes the available functions to choose from. The final software product-which is the software-based display content that is generated by a user who is using the STW-includes general apps, videos, clickable videos, metadata, predictive apps, databases, games, and interactive media. The following embodiments describe both the function blocks of the STW and some of the resulting software applications.

In some embodiments, such as the “Media annotator with user input” in FIG. 5A, a source includes a camera source, which could be used for VR or AR applications, video see-through, teleoperations, remote controlling other devices, teleconferencing, or video content creation, and some of the possible functions appear in a camera-source function block 16A. The resulting software is used for interactive video applications. For example, the camera-source function block may comprise an annotator function 17, such that the display system produces digital content to overlay over the camera source content to highlight aspects of the video. The digital content may be positioned in the same focal plane as the camera content, or it may be located in another focal plane, as in a hovering graphic or hovering text or another layer of a multilayer template. The annotations may be pre-programmed, depending on a user profile or action, or they may be generated dynamically through an AI module. The camera-source function block may also include a comment function 63, such that the user is able to provide feedback or ask questions about the content. The user feedback may be a text-based feedback mechanism integrated with an AI module, such as a chat bot that can respond to the feedback. More generally, there may be a user-input function 12, which allows the user to provide input to the software in an arbitrary modality, including a keyboard stroke, mouse click, gesture or facial expression, or voice command. In some embodiments, the user-input function is configured to request input for specified frames of the camera source information, for use, for example, in an online quiz or training video. Another function is an avatar assistance function 23, such that the user can interact with a virtual avatar or assistant. The avatar may provide suggestions based on user content or the camera source information to guide the user during the experience. Last in this function block is a graphic function 64. The graphics include warning labels, congratulatory images for a user, or graphics to highlight features of the camera content. The graphics function may be implemented as a standard graphics function, which, for example, processes the video frames, or it may be based on the sensor input or the user input of the user. For example, the graphics function may take in the user's eye gaze and brighten the region of the display where the user is focusing.

Although specific functions in the embodiments in FIGS. 5A through 5B are associated with specific sources, those functions may be used in other embodiments. The avatar assistant 23, for example, can be used in any embodiment to assist or impact functionality of the resulting software.

In an embodiment, the avatar assistant is programmed to output information based on the relative importance of objects in a training video and can take in user input, such as voiced questions, and answer them based on the video content. The function may be connected to a dictionary, training data, or search engine related to the video content to provide extra information upon request or to provide cues to connect concepts from one part of the video to another.

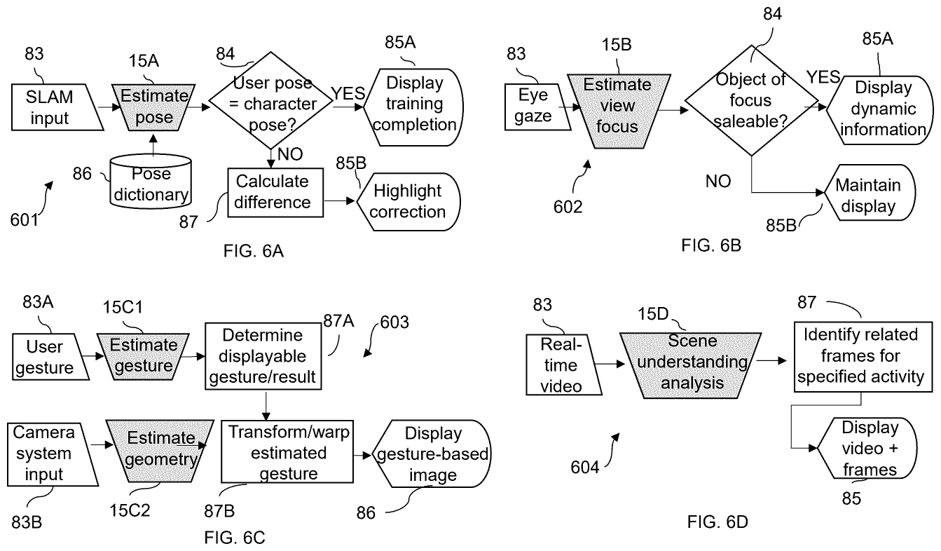

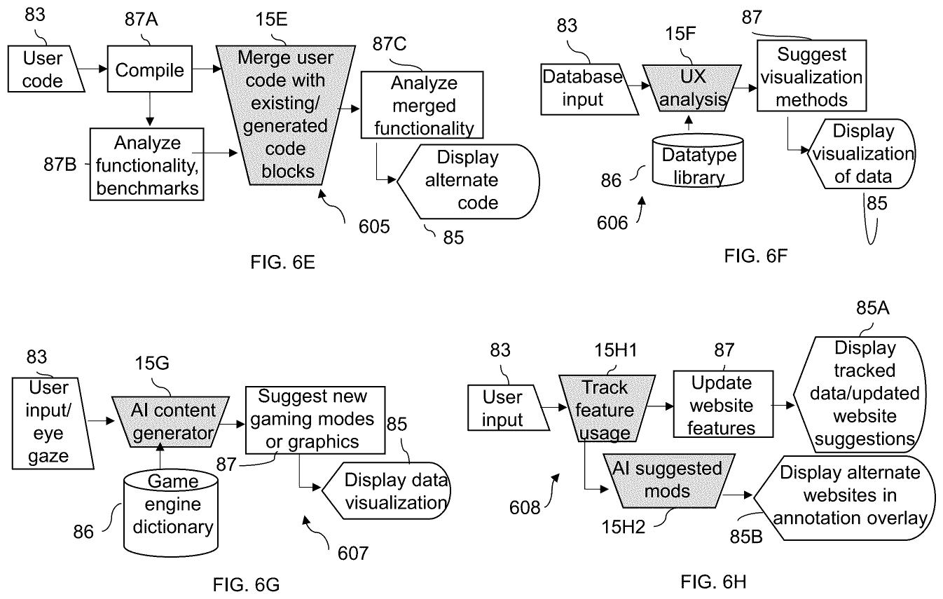

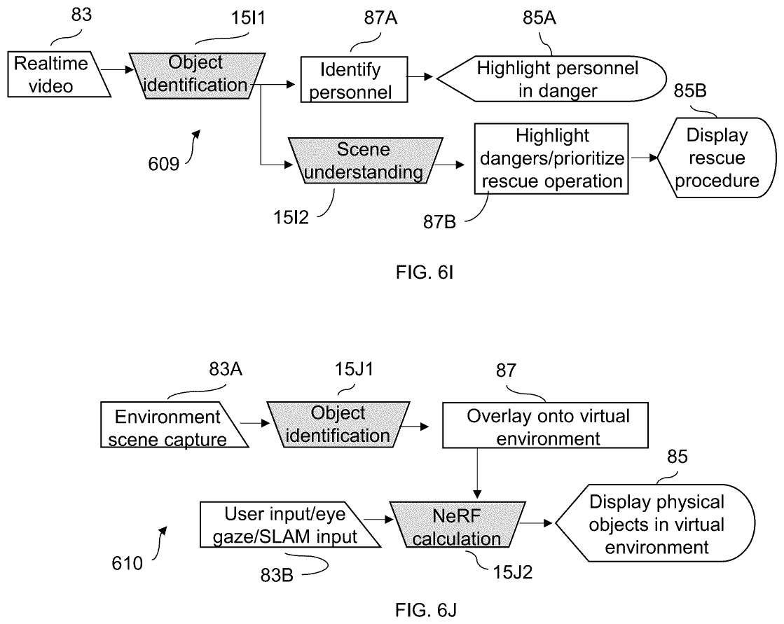

In an embodiment, the graphics function may highlight an aspect on the video based on the user's progress through the video, the user's eye gaze captured from a sensor, or the user's SLAM input. For example, the video may be a training video for proper posture when performing a physical task, and the indicator function takes in as input the pose of the user and compares it with the pose of the character. The function outputs highlight in the video to show how the viewer should change his posture relative to a character in the video, by, for example, highlighting the video character's back posture or shoulder posture, in comparison with the user. A related flowchart is shown in FIG. 6A.

FIG. 5B shows an embodiment, an “E-commerce smart recommender/advertiser,” in which the camera-source function block 16B is configured for use as a source for an online shopping platform or advertisement. For example, a multilayer display content may include a video layer that is a commercial ad, and a second layer that comprises annotations of items based on the user's eye gaze captured by a camera. The annotations may highlight purchasable items or display further information in extended display images.

This function block may use a live video or a video recording. One of the functions includes purchase function 65, configured such that purchasable items in the video content are highlighted and may include a link to an online shopping platform. The purchasable content may be identified through an object detection algorithm and a search engine that determines salability, and the software may determine which objects to highlight based on a user input or a user profile. A flowchart of this example is shown in FIG. 6B. For example, a user who has browsed and purchased scientific equipment would see different objects highlighted than a user whose browsing history centers on home decor. The function inputs are the video frame and the user input/profile, and the output may be annotation layers with salable information, purchase options, and various alternatives.

In some embodiments the details are impacted by the user's history with the display system, previous purchases, search history, or other user-unique details. Sharing function 66 allows a user to share content from the camera source with other users or potential users in a network. This function may create, for example, a quick response (QR) code for a detected object in the video, where the QR code is shared with other users, such that the QR code appears in hovering graphics for other users who watch the video. In this example, the QR code is generated based on where a user clicks with a mouse input. Another function is the comment function 63, configured such that users click on objects in the video and provide feedback-which can be user-generated text or a chosen graphic—to the creator of the video or the various vendors. The input to this function includes the annotation layers that are generated from the purchase function 65. In some embodiments, the purchase function or the feedback function takes as an input the user's body type based on a camera system connected to the display, configured, for example, to determine if a wearable item will fit properly. In these embodiments, a geometrical transform subfunction must be used to align the user's geometry with that of the salable item on the screen to create a virtual-reality image of the user wearing the item.

Similarly, inquiry function 67 allows users to gain more information about the objects in the video by viewing testimonials of previous purchases or be connected to online forums that review the product. For example, in some embodiments, the user hovers a cursor over a given object and a list about user experiences with that product is displayed in a hovering graphic or an edge-extended display.

Another function in this block is a synchronization function 68, configured such that the information about the user's navigation through the software experience in the current instance is automatically input into, for example, multiple users, the individual user's separate software accounts on various shopping platforms, or a memory bank for future user of the inquiry function 67. For example, a user may synchronize a shopping platform application that is stored on a mobile device, and the shopping cart or browsing history is input into a multilayer displayer, such that various annotations and QR codes are emphasized or de-emphasized.

In another embodiment, “Teleoperations/collaborative experience facilitator,” shown in FIG. 5C, a camera-source function block 16C includes functions for various collaborative visual environments or monitoring environments, for use, for example, in online classrooms, webinars, quality control monitoring, control centers, or teleoperations. In some embodiments, the camera-source function block includes a generic sensor-integration function 13. This function allows for integration of any sensor connected on a network or other cameras—from, e.g., other users, a remote or autonomous vehicle, a security camera, or a camera observing a robotic or machining part. These inputs may be synchronized such that their content is overlayed in a multilayer display in real time. In other embodiments, the images are tiled in an extended FoV, as would be used for example, in a multi-camera vehicle navigation system, to produce a panoramic view of the vehicle's environment. Another function is an image processing function 69. This function may have separate sub-functions that manipulate the camera source, or any sensor source configured to produce visual content. For example, the inputs to this function may be the video itself and the sensory input, and the image process function is programmed to output brighter pixel regions or display content where the viewer needs to focus attention, based on a user-defined monitoring task.

Further, a whiteboarding function 70 allows a user to share a separate application or merge a separate application with the camera source, as in, for example, an online lesson for an online course. The shared content may be a conventional sharing mechanism, or it may be a dynamic mechanism, where the content is translated dynamically to adjust to the viewer's needs. For example, the input to the whiteboarding function may be a dataset of flight trajectories, and the function is configured to plot those data into visual trajectories that are overlaid on a multi-layer flight simulator.

For example, an extended display system may include one region where multiple users can interact with each other through virtual images of themselves captured by cameras. The region is produced by the whiteboarding function 70. A second region, which may be a second layer in a multilayer display or an extended field of view, may be a virtual whiteboard space, which is manipulated by users through eye gaze or gesture sensing. For example, the sensor integration function 13 may take as input a gesture captured a gesture sensor or camera system and then determine an action to display on the virtual whiteboard space, such as a handwriting text. This example is further described in FIG. 6C.

For displays in which the content includes an image of the user or the user's body part, a projection mapping or geometric transformation may be a type of image processing function to be used to impact the display image. The geometric distortion may include removing distortion of the optical system. Generally, geometric distortion may be removed or compensated in an arbitrary way. For example, polynomial distortion algorithms may be used to remove lens or fisheye distortion. Camera calibration may also be used to remove distortion from a camera.

Image processing functions 69 also include brightness adjustment, foveated viewing, edge enhancement, blurring features, video or image filters, background blurring, computational remapping, and the like. This function may operate on an entire source, or it may operate on a partition of the source, determined by a user, or based on sensor inputs. The function may require other routines to assist in the image processing. In an autonomous or teleoperated vehicle, a panoramic view is displayed, and one of these image processing functions is configured to identify an object, estimate its speed, and then highlight it if its speed crosses a threshold value. Another function is an AI module 18, which is configured to analyze all the visual content together and suggest generative ways to act on those contents.

An audio function 71 for modifying sounds, music, and other audio effects. The audio source can be a microphone connected to the display system, or it can be a remote source. The function can also be configured to output audio through any speaker or other audio transducer. For example, an audio signal may be configured, through holographic or beamforming methods, to sound as if it comes from a first layer or a second layer in a multilayer display, such that when a user hears a sound, the user recognizes a distance associated with the source. This could be, for instance, audio effects related to a whiteboard space or speech sounds made by multiple users in a virtual classroom. The beamforming is produced by using an array of speakers, each emitting individual sound waves, such that the sum sound waves produce a wavefront that approximates a sound source from a desired depth. The individual sound waves are determined by an optimization algorithm that outputs the relative phases of the individual sound waves based on how accurate the approximation is.

FIG. 5D shows an embodiment, “Multi-source/-content generator and merger,” of a camera-source function block 16D, wherein the camera source is a generic image source. The functional blocks include image processing functions 69 and an annotation layer function 17, such that various descriptions or visualizations of the camera content can be overlayed or displayed near the camera content. The embodiments also have a merge function 72, which allows a user to combine other video or camera sources with the original content. For example, this function block may be used in an embodiment involving teleoperations or research methods, wherein a camera or photodetector is recording optical information about a setup, and other sensors are monitoring the equipment used, such that the merge function combines the sensor data overlayed with the camera. The merge function may first be analyzed automatically through a user-selected or user-defined function, and side windows of an extended display show alternative results that might have occurred with the equipment settings shifted by incremental amounts. The alternative results may be calculated through numerical simulation of the underlying physical laws, or through a deep learning algorithm.

In some embodiments, the merging function might be based on an AI neural network that compares data for various correlations and trends. In this example, the original images may be merged with AI-generated image content based on user specifications that may include touch-up features, automatic encryption of visual data, or content generation for video media.

In an embodiment, the video may be a live feed of a workplace, such as a construction site or warehouse, for monitoring personnel. In this example, a central display may show the live feed, and extended display images may show snapshots or frames of the live feed. In this case, the merge function 72 is programmed to merge the historical frames of the video with the live frame in an extended display. A subroutine in the merge function may first analyze the frames to identify important or correlated personnel actions, such as incorrect procedural actions, productivity levels, or interaction with coworkers. This subroutine may use a CNN to detect similar objects or poses. Another subroutine may add annotations for the user to focus on when these frames are displayed. For example, the output of the CNN detects and displays all the frames in which personnel in a warehouse are lifting a heavy box and identifies the frames in which too few people are present, adding an annotation warning to the user to intervene. This embodiment is described further in FIG. 6D.

In some embodiments, the video source is used in a video editing environment. In some embodiments, the merged content is not visual content but some other type of information to generally impact or enhance the camera content. The merging function may depend on the specific layer in a multilayer display or a subsection of a layer of interest. An audio function 71 allows a user to edit, add, or emit audio signals. Finally, upload function 73 allows the user to send the content or a portion of the content to another device or network. The upload function may also include its own merge or synchronize subroutine that collects the content from multiple users or adds the content in a database or a training library for machine-learning algorithms.

Another embodiment is shown in FIG. 5E, “Benchmark and logic analyzer,” where the source is a text-based source, and the set of functions is a text-source function block 16E. The text source may be a document, a spreadsheet, an online address book, a journal or publication, an e-book, computer code, or a presentation. The function block includes a merging function 72, such that multiple text sources can be merged. For example, a user may wish to combine two versions of computer code. This function may be configured with several options. The first option is to update an existing line of code with updated code written in a separate file. A second option is to compare two versions of a computer code and produce an updated version that is optimized based on the two inputs. In some embodiments, the user's original code may be automatically compiled, executed, and benchmarked, and a set of adjustments or alternative algorithms are proposed in different display content, arranged in such a way that a user can compare the various performances. This example is discussed further in FIG. 6E. An annotation function 17 can add descriptive, graphical, or other visualizations on the original text in a hovering graphic or multilayer display. In some embodiments, the text or annotations can be made to depend on events or to be anchored by an object, for example, through clicking a QR code. In some embodiments, SLAM input or eye gaze input influence annotations. In some embodiments, the annotate function might involve a subroutine that is configured to read the text for tone, consistency, logical soundness, or emotion, annotate locations in the text that need revising, or to suggest alternative paragraphs or images in extended display images.

Another function in this block is a logical analyzer function 74, which is produced by logical programming, for example by mapping axiomatic statements to programming commands. The user may specify the method of proof and set the function to prove by induction, prove by contradiction, or another suitable method of proof. Alternately, the function may use an AI generative approach and collect various proofs and theorems available online to generate new proofs. This function parses the text or code into statements whose truth value is analyzed based on the structure of the document. The output of the logical analyzer function 74 may be a classifier that ranks the strength of a verbal argument, or it may point out logical flaws. In some embodiments, the output may include suggestions to correct any logical errors. The logic may be formal verbal logic, based on Aristotelian logic rules, or it may be formalized as mathematical logic, as would be used, for example, in axiomatic set theory or geometric proofs.

User-input function 12 allows the user to interact with the text using, for example, gestures. In some embodiments, the input is the same as in the source, for example, typing new next in an existing document. The user input could also be new methods or modes of input, such as a speech-to-text function, or a speech-to-computation function. Last in this embodiment is a comment function 63, which allows users to annotate or view the document's metadata or other properties without directly editing or modifying the text.

FIG. 5F shows an embodiment of a user-defined source function block 16F, configured as a method of designing a software engine, i.e., this embodiment is a “Software engine/data assembler.” The source that this function block acts on may be an arbitrary data type. For example, it may be a database, a point cloud, a look-up table or dictionary, online repositories, the internet, or libraries of code blocks. The type of engine that is generated is arbitrary. In may be a database engine, graphics engine, physics engine, search engine, plotting engine, web browsing engine, or game engine. The STW may have multiple functional blocks to create multiple engines. The engines can assist in content processing, scene understanding, or image processing. In some embodiments, the engine is a recommendation engine, configured as a real-time engine, or an app-specific recommendation engine.

In this function block, a library function 45 may be used to sort through various engine libraries or to design or implement new libraries. In some embodiments, the library may have at its input a user query or desired task, and the library is generated based on an AI-module. For example, a user may input the library function, “Provide all subroutines for graphing three-dimensional data,” and the library function either searches the source data or generates data itself to output methods of graphical display of data. Or the library function may take in the input data and identify libraries based on the structure or size of the input data. For example, the input data may correspond to a genome sequence or a set of proteins, and the library function is an AI-based function that first identifies the data as a genome sequence or set of proteins, searches the internet for all such similar datasets, and builds a library of the datasets in the same format as the input data.

A graphics function 39 may allow customized graphics settings, such as resolution, frame rate, or intensity variation, for use in visual applications, physics-based graphics renderings, or engines. In some embodiments the graphics function may have subfunctions that implement various physical or dynamical laws to render graphics. The input data for this function may be a point cloud used for a video game or scientific images for research purposes. This function may also be a subroutine for a more specific game-engine function block.

UI/UX function 75 acts on the sources and displays them in a way that is useful or appealing. For example, the UI/UX function 75 may include subfunctions that (1) take in numerical data and classifies the data set based on an AI-module, (2) optimize a best mode of presentation based on the classification and the data size, and (3) arrange in graphically and generate annotations/labels for user interaction. This embodiment is further described in FIG. 6F. Another subfunction includes a predictive function—which can be a probabilistic function, a time-dependent function, or a neural network or other deep learning function—wherein the function takes as input both the sources as well as the history of user inputs and produces new graphics that suggest possible future actions of the user. For example, an AI-based UI/UX function may classify the data as weather data in a region over a certain period, and a toolbar is generated that allows a user to average the data, extrapolate the data into the future, or search the internet for data from different time intervals.

In some embodiments, for example, the desired engine is a database engine, and the display panel is configured as a multilayer display, where the depth layers correspond to another dimension of the data to produce, e.g., a three-dimensional database, which can be used to manipulate volumetric information, such as a point cloud of an image. The UX function takes in the data from the database and analyzes the structure of the data, possibly comparing it against a library of datatypes, to present it in a visually appealing manner, such as an infographic or multi-dimensional graph.

Code-block 76 allows users of the generated engine to produce new code to modify or enhance the engine. Neural network function 77 allows the engine to incorporate a neural network for any application. For example, in a game engine, a CNN may be used to detect objects in a scene captured by a video camera and incorporate them into the video game environment. In some embodiments, an API function additionally allows a user to configure the source information to interact with local hardware or hardware distributed on a network. For example, the data may be pulled in real time from a set of camera images or from usage details of an appliance or machine.

In the embodiment shown in FIG. 5G, “Game and world warping engines,” the source is an existing game or game engine, and the function block is a game-function block 16G. The functional block includes graphics functions (such as resolution effects or enhancement) 39, audio functions 38, a comment function 63 to add comments (e.g., in a multiplayer game), a computational remapping function 78 for 3D remapping effects and mesh creation, and a geometric transformation function 19 for various warping effects of game characters or graphics within a game. In some embodiments, an annotation function is included.

In some embodiments, the existing game is a first-person perspective game, and different items in the scene are shown at different depths on a multilayer display. In some embodiments, one of the layers may be an annotation layer to provide hints based on the user's eye gaze or character motions. In another embodiment, a user may be playing a game where the character is an image of the user captured by a camera system, and a geometrical transformation is used with the geometric transformation function 19 to dynamically optimize the character's shape and size in the game. In some embodiments, the game is a beta version of a game, and an AI component suggests different viewpoints or interactions inside windows of an extended delay as the user evaluates the game. This example is described further in FIG. 6G.

In some embodiments, as shown in FIG. 5H, “Dynamic UI creator,” a UI function block 16H has for its source an arbitrary UI. A UI can be a website landing page with certain features, buttons, links, icons, visual elements, or audio elements. The UI-functional block includes graphics functions 39 and the ability to set various graphics qualities, to accept user input through an input function 12, to detect or upload information local or remote sources through an upload function 73, or to receive instructions through a download function 80. In some embodiments a user-defined function 20 allows a user to manipulate the input source(s) arbitrarily. The user-defined function can be an image processing subfunction block; a terminal window for writing, compiling, and executing code; or any function described in this disclosure. For example, in some embodiments this function block is used for website testing, and the user is testing a website with various input requests, such as checkboxes or radio buttons. As the user navigates the website, the eye gaze and interactions are recorded and then by an annotation overlay, and parts that are not used are highlighted or made brighter, such that the designer can have graphical feedback about the website. Or the website features may dynamically adjust based on the historical usage of the tester. This example embodiment is described in FIG. 6H.

In FIG. 5I, the embodiment “Media feature recognizer and annotator” shown has display content as its source; this may include generic display content that is output from a previous functional block. For example, the input here may be a clickable training video after it is operated on by the functions in FIG. 5A. The composite function block 16I includes a detection function 81 to detect features in a source image. The feature detection may be low-level (e.g., edge detection), mid-level (e.g., gaze or face tracking), or high-level (emotional detection of display content involving people). In some embodiments, the detection is object detection, or it may be feature detection that is related to environment and not the user. Another function is a user-defined function 94, which is an arbitrary function determined by a user. In some embodiments, a user-defined function 20 is included and may be a mathematical operator. In some embodiments, this function inputs the source to other pre-selected functions or machine learning pipelines (as either training data or input data or encoding data). Further functions include an annotation function 17 for adding annotations and annotation layers to the source, a code-block function 76 for generating and compiling custom code to act on the source, and an image processing function 69 for processing source images or video with existing image processing functions.

The code-block function 76 may be assisted by generative AI, such that code blocks are automatically generated and merged with the source data based on training data. In some embodiments, the code block function may display a terminal in a side window or side display, and the user can modify or impact the AI-generated code in real time through feedback.

For example, in a remote exploration of an environment or a search-and-rescue operation, a camera may capture an image for display for the user to investigate a scene. A primary display layer shows the scene, and a second layer in a multilayer display highlight is programmed by a user-defined function to detect people or faces. Further, a subroutine of the user-defined function or parallel function allows for higher-level scene understands quantifies the level of danger that a person is in for a rescue team to prioritize rescue. In some embodiments, the video is a training video based on a simulation, and the user is asked to decide danger levels and rescue tactics. This example is discussed further in FIG. 6I.

In some embodiments, various ML/AI engines are separate functions to operate on the input. For example, in a clickable training video, a user may be asked to select a component of an image based on various other data within the display content. The AI engine predicts possible outcomes based on the possible selections or based on the eye gaze of a user. The difficulty, time response, and future unfolding of the training can adjust dynamically based on the user actions and the AI training.

In FIG. 5J, “Visual environment/UX immerser,” the input source can be a source configured for generation of visual environments. Such visual environments may be for immersive teleconferencing, or online classroom, such that a virtual immersion function block 16J is used. Teleconferencing is an example of a collaborative software application. This function block may also be used for some of the embodiments described in FIG. 5C. The function block here includes a whiteboard function 70 to share a virtual whiteboard space, which can be overlaid onto other video sources using a multilayer function 82, configured, for example, to make see-through modifications in multilayer applications or to optimize 2D or 3D content for display on a multilayer display. This function may take in visual content and optimize the virtual depths to present the data. The optimization minimizes the focal depth information compared to the depth perception of a human viewer.

Further, an annotation function 17 overlays annotations, a geometric transformation function 19 adjusts various captured images and map them into a visual environment, and an image processing function 69 performs image processing on the various layers of the display content. For example, one of the image processing functions may be a distortion-compensation function, programmed for executing geometric transformation on the images of a user to compensation for barrel or pincushion distortion, for depth remapping, or for automatic scene blurring/deblurring. In another example, a shared whiteboard space may be projected onto a first focal plane, and users projected onto a second focal plane to create a realistic virtual classroom. The geometric transformation function 19 automatically resizes objects based on which focal plane the content is in and based on the physical position of users relative to a webcam.

In some embodiments, the webcam may be part of a camera system video that captures the environment, such that the captured content is displayed on the display system as part of a visual environment, such as a virtual classroom or workspace. An object detection function may recognize and segment important objects in the scene, such as a physical object or a physical whiteboard, which are merged into the visual environment. The image processing function 69 and geometric transformation function 19 may act on the environment scene and geometrically warp objects in the scene to overlay into the visual environment. Based on an eye gaze detected by another camera pointing at a user, the display system may use a neural radiance field (NeRF) to adjust the viewpoint of the see-through components in the visual environment. This example is described further in FIG. 6J.

As another example, a whiteboarding function 70 allows a user to share a separate application or merge a separate application with a camera source, as in, for example, an online lesson for an online course. The shared content may be a conventional sharing mechanism, or it may be a dynamic mechanism, where the content is translated dynamically to adjust to the viewer's needs. For example, the input to the whiteboarding function may be a dataset of flight trajectories, and the function is configured to plot those data into visual trajectories that are overlaid on a multi-layer flight simulator.

Although certain input sources were described in these embodiments, any digital content could be input as a source. In some embodiments, sources include other existing apps, existing websites, groups of websites. For example, an input to the Virtual environment/UX immerser function block 16J may be a teleconferencing call from an existing commercial software. Another example is that the Game and world warping engine's function block 16G, or the Software engine/data assembler function block 16F may take as input an existing game engine environment.

FIGS. 6A through 6J each depict a flowchart for the example embodiments of FIGS. 5A through 5J.

FIG. 6A depicts a flowchart 601 corresponding to the function block of FIG. 5A, configured to produce an interactive training video. The user's SLAM data are input at step 83 into a pose estimation function 15A, which may have a dictionary 86 of poses also as an input. The output is a classification of the user's pose. The software determines at step 84 whether the user pose sufficiently matches the character pose. If it does, then at step 85A the system outputs a first display content that shows the training video as complete, or letting it continue. If not, at step 87 the difference is calculated in a calculation block, and at step 85B a second display content is output showing a highlighted portion of the video for the user to correct himself. The pose estimator may be produced by a feedforward neural network, and the difference between user and character may be calculated by using an encoder to classify the poses in a vector space and calculating the difference between them.

FIG. 6B depicts a flowchart 602 for an interactive video, as described in FIG. 5B. In this flowchart, the user's eye gaze is an input 83 into an estimate view focus function 15B to estimate view focus. The output is the gaze location on the display system. The software then decides at step 84. If the object of focus is salable, then extra information about the object as a first display content 85A. If not, then the display shows a second display content 85B, which maintains the same video until the gaze changes.

FIG. 6C depicts a flowchart 603 highlighting the application from FIG. 5C. User gestures are a first input 83A into a gesture estimation function 15C1, which outputs the identified gestures to a first calculation block 87A that that may show displayable gestures. In parallel, a camera system inputs captured images as a second input 83B into a geometry estimation function 15C2, which outputs the information to a second calculation block 87B that may combine the outputs of the two functions into a display content 86 comprising displayable gestures. The estimated geometry and displayable gestures are combined to transform or warp the gesture before being displayed.

FIG. 6D depicts a flowchart 604 the scene analysis example or action reporter of FIG. 5D. A real-time video is an input 83 into the scene understanding analysis function 15D. The function compares frames of the video and correlates them. The correlation may be feature-based. The output identifies in a calculation block 87 which frames are related to a specified activity that the user may determine beforehand. The output is displayed as a display content 85 consisting of a set of frames along with the original real-time video. The scene understanding analysis may be complete through a CNN or region-based CNN (R-CNN), or through a tree search.

FIG. 6E depicts a flowchart 605 for the example embodiments discussed in FIG. 5E. User code is an input 83 to a first calculation block 87A that compiles the code and inputs the result a merge function 15E. The compiled code is also analyzed independently for functionality or benchmark test in a second calculate block 87B, the results of which are also input into the merge function 15E. The merge function compares the user code and benchmarks with existing code blocks, which may be saved in a library, or it may use an AI module to generate new code using generative pre-trained transformers. One more new code is then output as a merged code, which is then analyzed for functionality in a third calculation block 87C. The resulting merged code and analysis is displayed as display content 85 along with the original code, for a user to compare.

FIG. 6F depicts a flowchart 606 describing the functionality of the embodiment from FIG. 5F. A database is input 83 into a UX analysis function 15F, which may have a dictionary 86 that is a datatype library. The datatype library may contain information about various forms of data, file formats, and applications, as well as a best mode of presentation. The UX analysis outputs to a calculation block 87 a suggested visualization of the database data, which is then displayed as display content 85 on the display system.

FIG. 6G depicts a flowchart 607 related to the embodiment described in FIG. 5G, configured for a game engine or testing. The user inputs information or the user's eye gaze as input 83 into an AI content generator function 15G. The AI content generator may have a game engine dictionary 86 that includes information about game styles, genres, characters, or game environments. The AI content generator outputs new gaming modes or graphics to a calculate block 87, which is then displayed visually on the display system as display content 85.

FIG. 6H depicts a flowchart 608 for the embodiment in FIG. 5H, configured for use as a website testing software. A user input 83 is input into a track feature usage function 15H1, which automatically updates the website features based on the historical usage and displays the result of its calculation block 87 in an extended display as a first display content 85A. For example, this function may simply track the location of the cursor coordinates as a time sequence and then identify the locations where the cursor spends the most time. The updated feature website may be a feature from a set of features which is then placed at the most probable cursor locations. The extended display content of the modified website may be next to the original website for a user to compare the changes. The output of the tracking function may also be input into an AI function 15H2 that suggests modifications, which are displayed as a second display content 85B as an annotation layer over the original website display.

FIG. 6I depicts a flowchart 609 for the example embodiment of FIG. 5I for search and rescue operations. Realtime video is input 83 into an object identification function 1511. This function may be a CNN or R-CNN. The output of the function identifies personnel in danger in a first calculation block 87A and displays that information on the display system as a first display content 85A. The method of display could be, for example, brightening the images of the personnel or annotating their positions. The output of the object identification function is input into a scene understanding function 1512, which analyzes the scene for specific dangers, for example, where a fire or electrical hazard may be most dangerous. The output is the identification of those hazards in a second calculation block 87B, which is then displayed on the display system as a second display content 85B. The output could include a procedure or ordering of which personnel to rescue.

FIG. 6J depicts a flowchart 610 for the example embodiment of FIG. 5J of teleconferencing or ARVR applications. A camera system captures the environment, which may include the user. That information is input as a first input 83A into the object identification function 15J1, which identifies important or relevant objects in the environment. (It may be a different object identification function compared to that in FIG. 6I in that it uses a CNN with a different set of weights.) The identification may be related to a dictionary or look-up table, or the important objects may be specified ahead of time. The output is an overlay of the images of the environment into a visual environment, as shown in a calculation block 87. A user's input, eye gaze, or SLAM data may be input as second input with the virtual environment input 83B into a NeRF function 15J2, which may be implemented as a fully connected deep neural network, and which computes different perspectives of the visual environment. The result is then displayed as display content 85 on the display system.

FIGS. 7A through 7G describe different embodiments of FIG. 2B, which depict various software applications that use predictive features to assist or influence the user experience. In some embodiments, the software applications described presently are created using the methods of FIG. 2A and FIGS. 5A through 5J, as well as the STW interface discussed in FIGS. 4A and 4B.

FIG. 7A describes an embodiment, a generic “Funnel expander,” in which past actions and events are processed along with user inputs to generate predictions of different future actions and possibilities. In this embodiment, a user 1 is viewing a central display image 9, which further comprises a past-content display image 9A, which depicts content or information about past usage, and a future-content display image 9B, which depicts content or information about future usage. The user may be viewing content through a local source paired with a display system 8. Generic functions 15A, 15B, as well as an AI module 18 may take past and present content as input, as well as user input 12, to generate an expanded visualization of future action possibilities 89. An infographic 22 may display the past content in a useful way.

The inputs to the functions can be present uses and past uses of any duration. In some embodiments, the functions are recommendation engines, wherein a user or a user's history or profile determine the settings actions. Other functions are probabilistic or time dependent. Functions that include neural networks take as input user input into the system or sensor input. The history of past actions is shown as an infographic in some embodiments. In some embodiments the infographic is an expandable tree graph where each branch is an aggregate of a set of common actions taken by the user. The trunk of the tree graph indicates the time stamps of those sets of actions, and the extent of each branch may correlate with the amount of time that is spent on each action type.

In an embodiment that uses time delays as functions, a user is using a database, performing data entry, or analyzing numerical results of a simulation. The primary display content is a spreadsheet into which the user is entering data. The most recent activity is the most recent data entered, so the primary predicted activity, shown in a second layer or extended FoV adjacent to the primary image, is continued data entry. The software may predict what data to enter, or it may show extended regions of the database or spreadsheet. The second most recent activity was opening a document, so software predicts on a secondary display layer an indication to save the database or spreadsheet, anticipating opening a new document or closing the current one. The oldest action was using a different application for generating the data, for example a simulation. The third predicted action would be to re-run the simulation to modify the parameters.

A time delay is an example of a time factor that is used to make such predictions and suggestions. Generally, a time-factor based predictive feature incorporates a usage history of the system. For example, in a social media application, if a user has been frequently clicking external links within the last week but was instead frequently scrolling a month prior to current use, predictions and suggestions will be weighted approximately four times more heavily (4 weeks per month) in favor of displaying external links compared to displaying extended scroll features. In this example, the time factor is the ratio of when a user was using a first feature of an application relative to a second feature.

In some embodiments, the time factor is the usage duration of a particular application. For example, a user is viewing media content, e.g., an online video. Based on the prior average time durations the user has viewed the media content in the recent past, after time factor equal to that average, the secondary display will show alternative applications to use or make other suggestions.

FIG. 7B describes a “Probabilistic predictor” embodiment in which the predictions on different actions and possibilities are displayed according to a weighted time decay or probabilistic factor. In the embodiment, a user is viewing a display image 9, which further comprises past-content display content 9A and future-content display content 9B. The past and present usage is input into a function 15 that uses, e.g., a probability distribution 93 for calculating most likely next actions and displays them accordingly. The most probable future action 91 is displayed centrally and most prominently in the most prominent extended part of the display content. A medium-likely future action 92 is displayed with less prominence in the extended part of the display content of medium prominence, and a least likely future action 93 is displayed least prominently most remotely. In some embodiments, the display content is shown as a multilayer display or hovering graphics, in which the most probable content is brightest or closes to the user.

A user can input information directly through input devices or sensors 13, the data from which might rearrange the actions or change the actions dynamically. In some embodiments, sensors capture information about a user or an environment and relay that information into the display system to assist in predictive capabilities.

The probabilistic method may be formulated as follows. Encode all user actions into a vector space x. This can be for a specific application, or it can be for a set of applications. In some embodiments the non-zero vectors are sparse in the basis, so that new actions can be added. Next, define a probability density function. In some embodiments, it would be a bell curve (Gaussian function), a Lorentzian, or a Cauchy function. These functions can be discretized for discrete sets of actions. In some embodiments, the probability density function is defined by certain constraints, such as maintaining a certain standard deviation, skew, kurtosis, or a set of moments or central moments. Or, instead, a characteristic function, moment generative function, cumulative function is given. In some embodiments, the probability characteristics are defined by the correlations of the various actions xᵢ belonging to the vector space x or by the relative frequencies of the user actions during a period when the system is being calibrated.

In some embodiments, the sequence of actions be stationary in some sense, for example wide sense stationary, strictly stationary, or stationary in increments. In some embodiments, the system is not stationary and depends, for example, on the time of day or other external factors.

A second set of actions is encoded into a second vector space y. In some embodiments, there are more than two sets of actions, for example, 3 or 4 or 9. If a user is using the display system for a particular action xᵢ, the software calculates all the conditional probabilities

$${p}_{ij} = P ( {y}_{j} \vert {x}_{i} ) ,$$

for each potential action yⱼ. The conditional probability P (A|B) for two events A and B is the probability that A will occur with the condition or constraint that B has occurred. In is possible to consider the conditional probability as the ratio of the probability P (A and B) of both A and B occurring to the probability P(B) of B occurring:

$$P ( A \vert B ) = P ( A and B ) / P ( B ) .$$

The value pᵢⱼ above determines the action with the maximum probability, the second maximum, or some other metric. The display system then displays those potential actions on the set of secondary virtual displays or display layers. In some embodiments, the method of predicting user actions uses exceedance forecasting, time series analysis, or other series analysis.

In some embodiments, as shown in FIG. 7B, a user 1 is interacting with a social media platform. Central display 9 shows a landing page. Based on the user's history, and multiple users' histories with the display system or the application itself, the probabilistic function determines that the user will most likely scroll through a series of updates. The most probable future action 91 is shown centrally and most prominently in the most prominent extended part of the display content. This content may consequently show an extended update or scroll feed. In the next windows, a medium-likely future action 92 is displayed with less prominence in the extended part of the display content of medium prominence Finally, least likely future action 93 is displayed least prominently most remotely. This content may involve clicking on a marketing campaign. As the user interacts with the social media platform, the probability distributions are updated, the display content is rearranged. Various sensors 13 may capture information about the user. The user may bring any suggested content into the window using any input means. In some embodiments, the predicted actions correspond to switching to a different application.

The predictive algorithm uses the data about various possible user actions and events includes metadata about the productivity, success/failure, user satisfaction. For example, it is most probable for a user who first starts navigating a social media site to click on advertisements and purchase items, and the second most probable event is to respond to messages. Let x₁ be the navigation to the social media site, let y₁ be the clicking of ads, and let y₂ be the event responding to messages, such that p₁₁=0.8 and p₂₁=0.5. In this scenario, the central secondary display would display content about ads, and the second secondary display would display content about responding to messages. However, the metadata about y₁₁ indicates that clicking on ads has led to overdraft fees in a budget monitoring app. So, the display system might reduce the value of p₁₁ to less than 0.5, for example, 0.4. Or the display system might include in the display content a warning message.

FIG. 7C describes an embodiment, a “Dynamic prioritizer,” in which the different options and possibilities are displayed in different layers based on a priority criterion P1, P2, P3 based on user focus, time of day, productivity style, metadata, or environments factors. Content deemed with the highest priority (P1) is displayed in a center main screen 9 for viewing by a user 1, whereas second priority content (P2) is automatically pulled up on a FoV 2D extension 25 as reminders. Some of the priorities may be organized in a multilayer display 11, with the highest priorities close to the user. A suggestion that a user normally does is shown as a third priority (P3) for example as an edge display 53. The distance of the content with respect to the center display is an indication of the priority and/or importance of the content. In some embodiments, this is time-dependent and depends on user history. In some embodiments, sensors 13 capture information about a user 1 or an environment and relay that information into the display system to assist in predictive capabilities. A user can ignore certain priorities, indicate reminders, or perform the recommended task by inputting information directly into a controlling function. A priority-based embodiment may be generated by identifying or comparing items that are listed on a calendar or digital list. Or, if the embodiment includes user input and time of day, the embodiment may keep track, for example, of the duration a task takes at different times of day under different user conditions and suggest a task at a time when it was historically completed the fastest.

In some embodiments, the display system content is configured for productivity. The user 1 is interacting with the display system at a certain time of day, and the main priority action, displayed on the central display 9, is answering emails. Based on the time of day, the software senses that a second action P2 is high priority because of the user's productivity levels with that second action at that time. In some embodiments, the next priority P2 is based on deadlines enumerated in a calendar and is displayed as an FoV 2D extension 25. A third priority P3 is to monitor personal finances such as bills, investment accounts, taxes, which all show up as a potential action on an edge display 53. In some embodiments a priority P3 is a secondary layer in a multilayer display 11, such that a user can be reminded of it without having to focus his eyes on it directly, i.e., to be able to keep it in a peripheral location.

In some embodiments, the different priorities may all be related to a single task. For example, the central priority my involving making important financial trades; the second priority might monitor cash flow for consequences of those trades, such that a software program suggests modifications or other trades; and a third priority might display a set of long-term financial goals, such as savings growth for a down payment to a home, retirement activities, or travel plans.

The display system may also arrange tangential activities in different dimensions. For example, the financial-related priorities may all be displayed in lateral extensions. A display image involving mortgage payments for a home might also have several depth layers with annotations about home renovations, repairs that are needed, or important weather warnings. The arrangement may change dynamically based on user input or sensory data.

In some embodiments the priorities P1, P2, . . . are recommendations based on a recommendation engine that takes as input the user profile and outputs various recommended activities. The recommended actions may be within a single software application (e.g., displaying all the possible digital library books that are related to a user's reading history), or they may span multiple apps (e.g., based on a user's history of using a chat feature in a specific social media app, the engine recommends multiple chat streams across different social media platforms).

FIG. 7D describes an embodiment, a “Parallel search recommender,” in which predictions and recommendations can be made within an application, or across multiple applications. In some embodiments, predictions and recommendations can be based on vertical search engines functions. A user 1 views a central display image 9, and based on the current actions, or based on user queries, a plurality of vertical search engines is produced in a plurality of display images. For example, a user inputs a query into a vertical search engine function 94. In some embodiments, the display images are arranged in a multilayer display 11 or as a column a vertically extended FoV. As a search progresses in one column, it dynamically updates based on the user's current actions or queries, but it also attends to other potential searches that may be of use and presents those results in another set of display images. The data retrieved in the first search is then input into a function 15 that attends to keywords, e.g., by using a self-attention mechanism, and then uses that information as new queries to a second search, which may be displayed in a second multilayer display 11. The functional relationship that one search engine uses to produce another search engine may be a transformer that attends to correlations in the various sections or the first search.

In some embodiments, a user is performing a literature search about a research topic. The primary search is initiated by the user with keywords A, B, and C. A vertical search appears in the first set of virtual display images. A software mechanism actively scans the search results and discovers a new keyword D. A second set of virtual display images then reports search results for only D, or for the combination of A through D. In some embodiments the user limited the search parameters to scientific sources and journals, but the software detects phrases that indicate a patent history of the initial keywords and displays prior art in a second search. After analysis of the figures of the first two vertical searches, a third search might display various downloadable executable files that can assist in numerical simulation or quantitative analysis of the desired research topic.

The vertical search engine may use a standard vertical search algorithm (e.g., crawling, indexing, and ranking), and an object identification algorithm may be used to identify key words or phrases to initiate the next search.

FIG. 7E describes an “Avatar-assisted predictor” embodiment in which a virtual assistant avatar 23 is shown in an FoV 2D extension 25 as it interacts with the user 1, who is viewing a central display image 9, and responds to user commands to accomplish different task functions 15, such as answering emails, drafting sketches or designs, chatting, taking notes, and the like. The different tasks available to the user, predictions and recommendations are shown as commands to be issued to the virtual assistant. In some embodiments, the virtual avatar is not always directly visible to the user or is called by the user from a voice command.

In an embodiment, the virtual avatar 23 is assisting in secondary tasks to assist the user in completing a primary goal. For example, the user is producing a document, which requires text, figures, and references. The user 1 is producing the main text content and has input into the avatar system basic parameters of the figures: figures size, resolution, format. The avatar proceeds to edit a set of image files accordingly and then has permission to incorporate the files into the image using an API. The avatar also analyzes the image content itself and extract words to describe the image, based on a transformer mechanism. These words become keywords in a web search that are presented to the user as alternative or improved figures, to assist in improving the final product.

In some embodiments, the permissions of the user are defined by an avatar-controlled subsection 23A of the display content, such that the avatar automatically monitors content within a certain window of the display, and the user interacts by dragging elements into or out of those subsections. This serves to give or withdraw the avatar permissions in real-time, and the specific content dynamically asserts which functions the avatar should be prioritizing. In an embodiment, the user may drag images into the subsection, and this indicates that the avatar should be engaging in image processing techniques, whereas if a folder of text documents is dragged into it, the avatar interprets this as performing a literature search to build a bibliography.

In an embodiment, a user is analyzing the results of a simulation, and the avatar function is assisting in the analysis by comparing the results to known results, to dynamic search results, or to the initial input parameters. For example, in a result of a simulation may include graphs or images that the avatar function processes for nonobvious correlations to the input data, and the avatar may suggest the results are physically valid, or that the simulation suffered a technical error.

In some embodiments, the avatar assistant may be a terminal for a user to input text or graphics, and the avatar assistant might continually prompt subsequent questions based on the input. For example, a user my input an image of a chair, and the avatar assistant may first produce a question, “What is this?” to display. Then, below this content, it may provide a set of possible answers: “It is a piece of furniture,” “It is brown,” “It is an object made of wood.” Then, below this set of answers is a tree of further questions that rely on the first responses. At any time, the user may interrupt, direct, or guide the avatar-generated question-and-answer. The question-and-answer development may depend on user history or user settings.

In an embodiment, a plurality of avatar assistants may be impacting derivative content in parallel. For example, they might be chat bots for a help center, and the user is monitoring the avatar assistant's messaging and can influence the results real-time.

FIG. 7F describes an “Event-triggered predictor” embodiment in which the different predictions and recommendations are shown in different event layers E1, E2, E3 based on user's event clicking or onstream clicking through a user input 12 like a mouse click, dynamically pulling up the different predictions and possibilities. The events can be automatically generated by a trigger in a video or in another software application, or the events may be triggered when certain combinations of software applications are used in a certain way. These are examples of an event-based action trigger that determines the various display content to be displayed on the extended display system.

For example, in some embodiments, a user 1 starts to perform image processing of a video in a while watching a video tutorial of a painting technique in a central display image 9. During the tutorial, a certain brush stroke is detected by a multi-output function 15 as the user replays that portion of the video, the user clicking being input into the function, and a similar tutorial about that brush stroke is found in another tutorial E1; the user may click on the image of the brush such that ads for similar graphics design products show shown in E2; and while the user pauses the video to view the end-result of the tutorial, upcoming venues for showing a finished product are shown with contact information or an online form for follow-up questions to the tutor are shown in E3. The events may be shown in a FoV 2D extension 25. Or the events may be displayed in multi-layer display. In some embodiments, a machine learning algorithm may show in other display images various alternative techniques or methods for achieving similar effects.

In another embodiment, the user is playing a video game. The user navigates the game and reaches certain milestones, and a first event E1 may be a choice of what task to complete in the next step of the game. A second event could be the user scrolling over a certain region in the video game environment, which triggers display event E2, hidden features of the game. Finally, the third event could be triggered as the user pauses the game or clicks on a link, and E3 display content is a marketing add for bonus features, game sequels, or other entertainment options. In any embodiment, the event-based display content can be influenced by the user history.

In the various embodiments, the display content can be arranged in an arbitrary way. In an embodiment, the display content can be arranged laterally, for example, to create a visual scroll or visual belt. A user may provide input via eye gaze or gesture, such that the visual scroll can be dynamically rotated: the user focuses on the display content of interest, and that display content is moved to a central viewing location; the other display contents are shifted sequentially. For example, an event-based predictive display may show three extended displays of events E1, E2, and E3, such that E1 is located to the left, E2 is in the center, and E3 is located on the right. If the user focuses his eye gaze on E1, then E1 is shifted rightward to the center, E2 is shifted rightward to the right, and E3 is moved to the left position. The visual scroll may be configured to display a single event or action at various past or future time instants. This is a “temporal scroll.” For example, the visual scroll may have a series of potential time-dependent actions. The visual scroll may be spatially separated, such that various aspects of an action or different actions for a given application are displayed separately. The visual scroll might be spatio-temporally separated, such that the possible content may be a combination of temporally scrolled actions or spatially separated content.

FIG. 7G describes a “Parametric visualizer” embodiment that considers a parametric visualization mechanism such that a virtual continuum of possibilities can be seen simultaneously or easily. An example of this embodiment is as follows. A user 1 watching a movie in a central display image 9. The content of the movie is fed into a neural network 77 and/or AI module 18 which generates annotations or alternative outcomes of the current scene and displays them in extended portions of an extended display system.

The user also inputs information using a generic input device 12 into a parametrizer function 15, which may also take as input a library 45. This parametrizer allows the user to input preferences, user history or profile, quantity, and scope of annotations, or other constraints, into the AI and ML functions. The output P is the set of parameters to tune the AI/ML functions.

In this embodiment, for example, one of the parametrizations results in Profile A, which generates sets of multilayer display content 11 of the movie, in which the first set describes annotations about the visual content, with detailed and larger annotations and visual content. The second set is more muted, smaller, and has only minor information about the associated soundtrack. A second format, Profile B, might have the relative importance of visual information to sound reversed. The soundtrack information is displayed prominently, with annotations as a hovering graphic 24, and some basic information about visual content is shown as an edge display 53.

In another example, a first user may be interested in the scientific details of the movie and have set a “light” setting parameter for the display content, such that the possible annotations all show the scientific or technical details of a few of the objects or motions in the movie. A second user may be an interior designer and sets the display parameters to “strong,” such that whenever the movie scenes are of a room in a house, annotations of all the furniture, housewares, and other goods in the scene include salability, prices, availability, or vendor locations. This may be described as a “display equalizer” function, where the output display is balanced according to various settings.

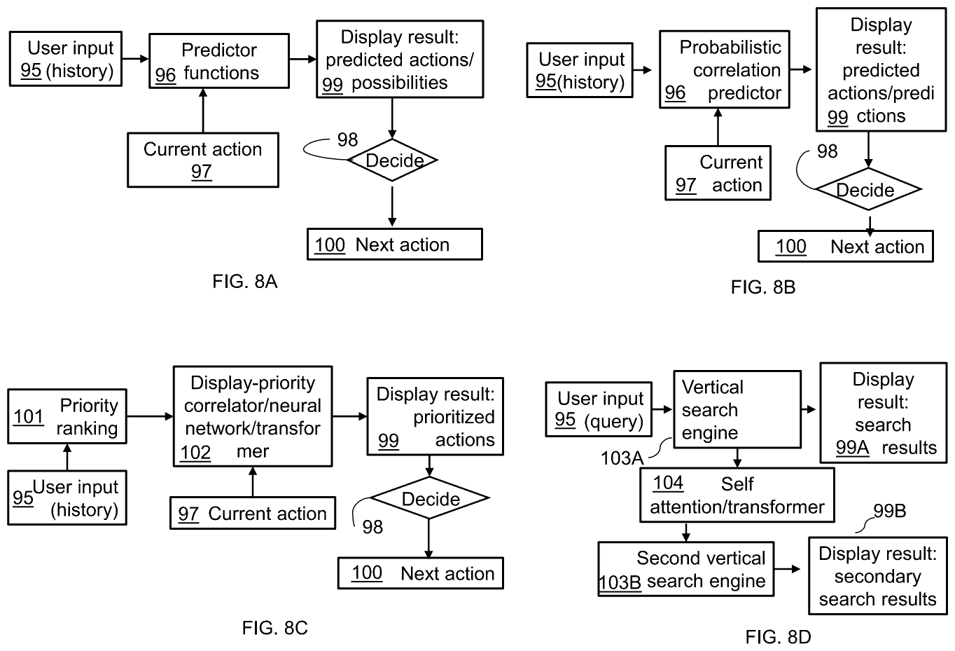

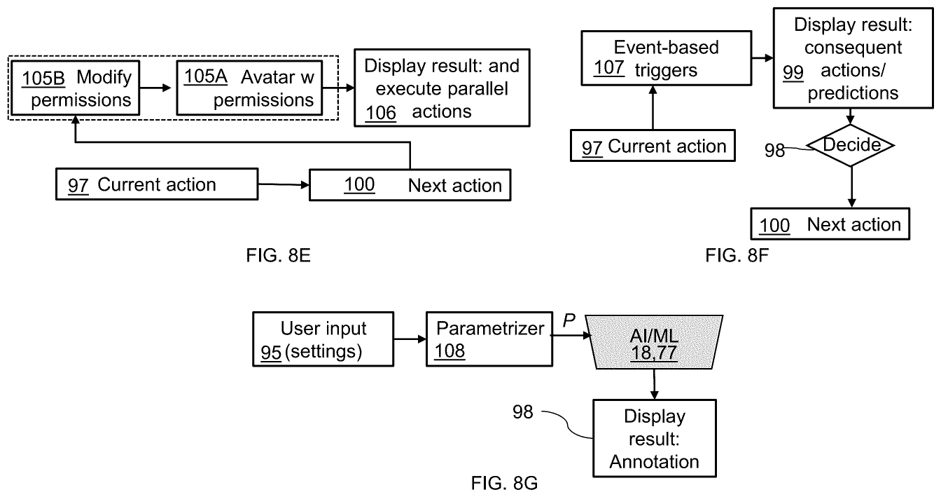

FIG. 8A through 8D describe different processes to predict future user actions in some of the embodiments described in FIG. 7A to FIG. 7G.

FIG. 8A describes a process related to the embodiment in FIG. 7A. A user input 95 comprising the user history and the user's current action 97 are input into a predictor function 96, which produces a display result 99 of predicted or possible actions. The user then decides 98 about what action to take, which results in a next action 100. The current action 97 then is incorporated into the user history for a next prediction.

FIG. 8B describes a process related to the embodiment in FIG. 7B. A user input 95, the user history, and the current action 97 are input into a probabilistic correlation predictor 96, which produces a display result 99 of possible or predicted actions. The user decides 98 to take a next action 100. The current action 97 then is incorporated into the user history for a next prediction.

FIG. 8C describes a process related to the embodiment in FIG. 7C. In it, a user input 95 is the user history, which is input into a priority ranking function 101, then is fed into the priority correlator 102. The possible actions are ranked based on priority and a display result 99 shows the prioritized actions. The user makes a decision 98 about what should be the next action 100 current action. In some embodiments, the priority correlator is a neural network of any kind, including a feedforward network, RNN, LSTM, attention-based transformer, of combinations thereof.

FIG. 8D describes a process related to the embodiment in FIG. 7D. A user input 95 is a search query that is fed into a first vertical search engine 103A. The results are displayed in a first display 99A. The data from the first search are also input into a transformer 104, which attends to and identifies key words to input into a second vertical search engine 103B. The output of this second search is displayed as a second display result 99B. In some embodiments, more than two vertical search engines are used. In some embodiments, the output of a later search may be used to modify an earlier search.

FIG. 8E describes a process of the embodiment in FIG. 7E, configured to have an avatar assistant. The avatar with permissions 105A generatively displays a display result 106 corresponding to possible or predicted actions. The given permissions allow the avatar to execute the actions as a user moves from a current action 97 to a next action 100. The next action may modify the permissions 105B of the avatar assistant and impact the next iteration of tasks completed by it.

FIG. 8F describes a process of the embodiment in FIG. 7F. A user's current action 97 is detected by an event-based trigger 107 which produces a display result 99 corresponding to various actions or other content. The user makes a decision 98 about what the next action should be 100.

Last, FIG. 8G shows a process of the embodiment in FIG. 7G. A user input 95, parameter settings, is input into a parametrizer 108 that produces parameters P that determines the strength and content of an AI module 18 or neural network 77. The generative output results in a display result 98 corresponding to annotation layers.

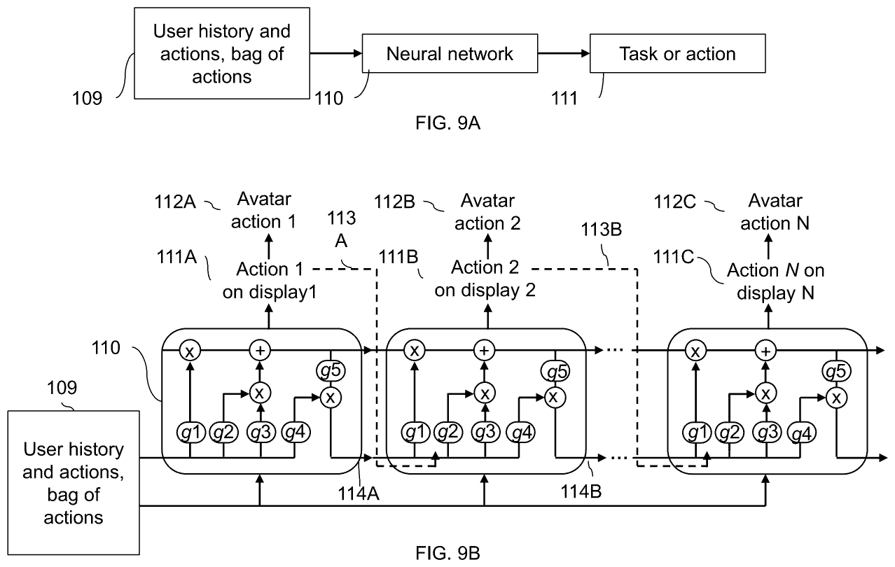

FIGS. 9A and 9B depict various machine-learning algorithms and methods for assisting in the predictive and generative software in this disclosure.

FIG. 9A shows a generic neural network pipeline: input 109 is the user history and input, plus a potential bag of actions serve as input into a machine learning architecture, like a neural network. The neural network 110 outputs a set of potential actions 111. The neural network can include training data that is derived from a single user's long-term history, multiple users on the display system, or combinations thereof.

In some embodiments, the neural network uses a dictionary that is learned on training data. The training data may come from the local display system and work environment and a unique set of users. In some embodiments, the dictionary and learning occur based on training data from distributed users.

FIG. 9B shows a more specific example of a recurrent neural network, configured as a long-term short-term memory (LSTM) neural network. In this figure, the user input, history, and a bag of actions are input 109 into the LSTM. This input is fed into an LSTM 110 with activation functions g1, g2, g3, g4, and g5. The input and output value from the previous cell are sent through neural network layers with activation functions g1, g2, g3. Then they are combined with the previous cell state through multiplication and addition operation. A potential action is produced 111A. The cell state is acted on with neural network and activation layer g5 and combined with current action and user input after neural network with activation function g4. The activation functions can be anything. In some embodiments, they are a sigmoid or tanh functions. The result is fed into the next cell iteration 113A of the LSTM, along with hidden layer information 114A, which produces a second potential action 111B output in the sequence and is fed into a next cell iteration 113B along with updated hidden layer information 114B. A third action 111C is produced, and so on. In some embodiments, a user avatar has permission for an execution 112A, 112B, 112C of the predicted actions or a subset of them. The activation functions can be standard sigmoid or tan functions. In some embodiments, they are user-defined.

In some embodiments, different neural networks are implemented, including a conventional neural network, simplified RNN, GRU, CNN, especially for image/object detection recommendations, which also use user input in various applications. In some embodiments, the architecture is one-to-one, one-to-many, many-to-one (such as in a classifier), or many-to-many.

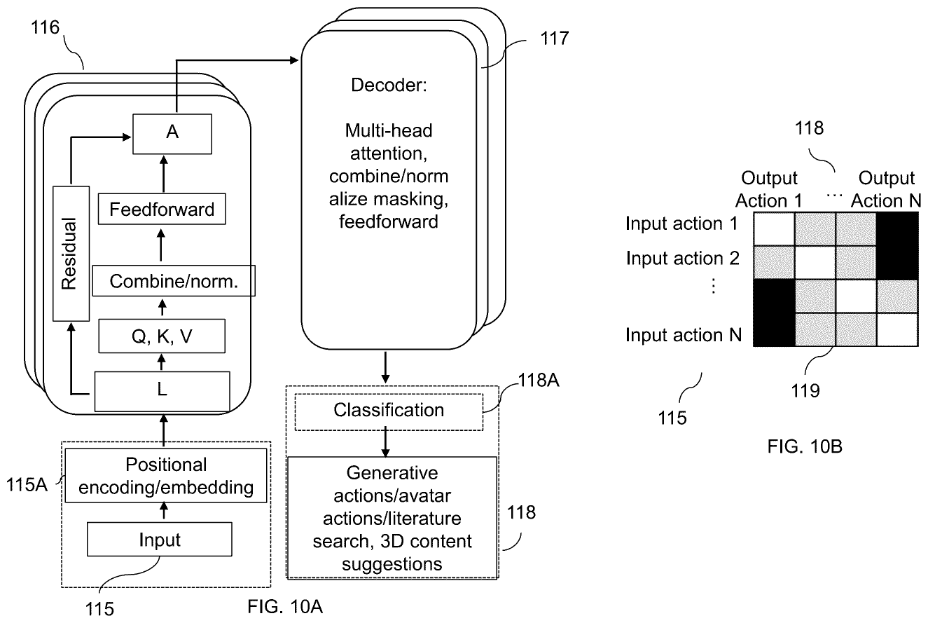

FIGS. 10A and 10B illustrate the use of attention in a transformer architecture to derive predicted actions, classify past actions, or transform a set of actions into a new set of actions, configured for other applications. In FIG. 10A, user actions and history are input 115 into the pipeline and are transformed through positional (sequential) embedding 115A and input into an encoder block 116. The input data are operated on by linear layers to produce query Q, key K, and value V. The encoding block combines Q, K, V and normalizes them, via, e.g., SoftMax. A feedforward layer acts on the data to produce attention matrix A. In some embodiments, residual data bypass elements in the encoding block. In some embodiments, multiple encoding blocks act in parallel. The data is then sent to a decoding block 117, which includes a multi-head attention block, combining and normalizing data matrices, and acting on the data with feedforward layers. In some embodiments, there are residual elements or masking blocks. The output 118 is a set of generative actions/avatar reactions/search results for potential actions. In some embodiments, a classification block 118A identifies the types of actions that are currently being used. In some embodiments, the actions are automatically executed by a user avatar.

In some embodiments, there are multiple transformer heads or multiple stages of attention, or multiple stacks of decoders and encoders. Feedback mechanisms, masks, and positional encoders can all be included in any embodiment.

An example of an attention matrix 119 is shown in FIG. 10B. Each row corresponds to an input (actions from the user history) 115, and each column corresponds to a potential output action 118. The grayscale value corresponds to the correlation between the input action and the output action. For example, Input action 1 correlates very strongly to output action 1 (white shading) of medium strength to output actions 2 and 3 (gray shading), and very weakly to output action N (black shading). In this way, the set of output actions is determined by both the set of input actions and the ordering in which those actions occurred.

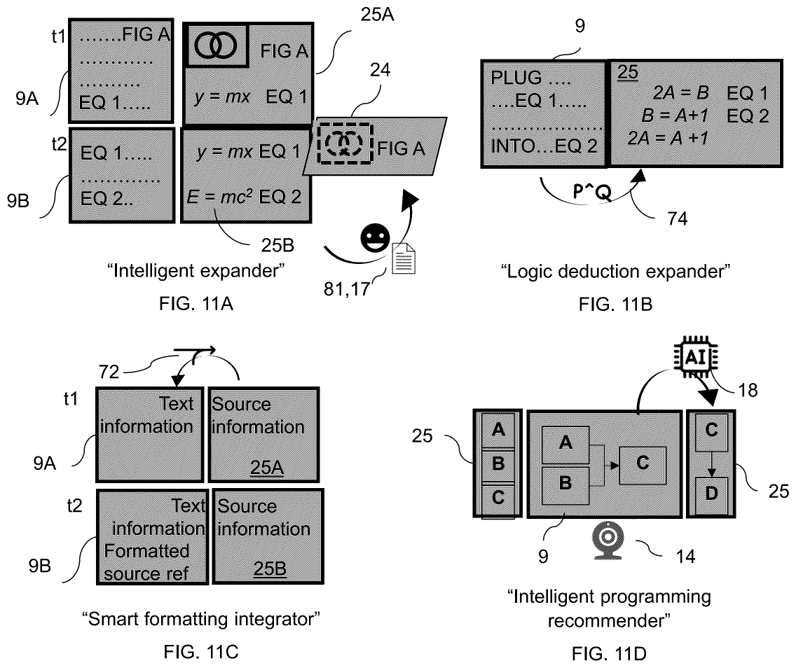

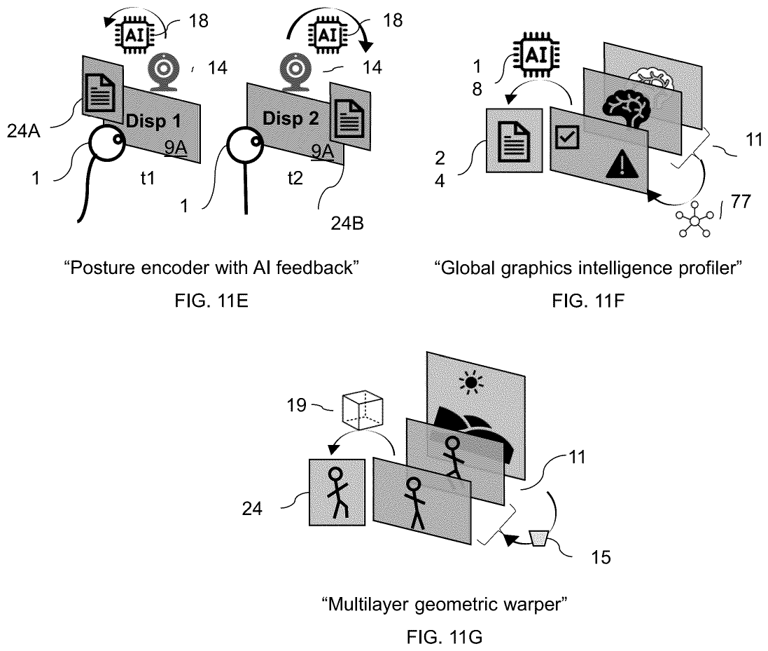

FIGS. 11A through 11G describe several embodiments of novel single user use cases.

FIG. 11A depicts an example display system, an “Intelligent expander,” that includes an extended FoV and hovering graphics, configured for use in active content generation. In this embodiment, the user experiences dynamic referencing of a text with predictive features. The central display 9A at time t1 shows a text. An object detector function 81 analyzer detects key words and phrases in the text to identify equations and figures and displays those in a separate display image in a 2D extension 25A. The separate display image may be part of a multilayer display, or it can be an extended field-of-view image. The separate display content is updated automatically, such that at time t2, when different content is shown in the primary display image 9B, different secondary content is identified in the secondary 2D extension 25B. In both cases, a hovering graphic 24 displays content from earlier times. For example, the primary display may include the text, “as shown in FIG. 1,” and the hovering graphics automatically display the portion of the primary text that involves the picture “FIG. 1.” A separate annotation function 17 may annotate or add more information about the content shown in the extended windows. For example, it may show related figures or mathematical deductions made from the shown figures and equations.

In an embodiment, the functions may highlight portions of the central display or annotate the extended display content to emphasize the relationships among those various contents.

FIG. 11B depicts a variant of the display of FIG. 11A, a “Logic deduction expander.” A primary display layer 9 shows primary content, such as text. In the text are various statements that are automatically detected by the software as logical statements. A secondary display image, which is an FoV 2D extension 25, or multilayer display in some embodiments, shows the logical consequence of the detected statements, as produced by a logic function 74. For example, if the primary text states “plug Eq 1 into Eq 2,” both equations 1 and 2 are displayed on the secondary image, and so is the generated result of the substitution of eq 1 into eq. 2. The logic function that controls the secondary display panel has preprogrammed mathematical logical structures to compute the results.

In some embodiments, the logical consequences are user directed. A user, for example, may query the text, using an audio input, various commands, or questions, including, “Can Equation 10 be proved?” or “Are Equations 11 and 12 simultaneously true, i.e., mutually consistent?” or “What are the differentiable properties of the expression on the left-hand side of Equation 9?” An AI program can answer the questions based on various mathematical libraries that are stored in the AI program. For example, the AI program may then parse an Equation 9 to identify the desired expression on its left-hand side, and analyze its connectedness, smoothness, differentiability, or other geometric or topological features, and output the result in a secondary hovering graphics or as an annotation overlay.

In FIG. 11C, the depicted embodiment is a “Smart formatting integrator,” and it acts as an application merger, configured for editing or creating content. The user is producing content, which is a text document in some embodiments. At time t1, the user has produced some text information in the primary display 9A, and some source information, used, for example, for reference, is displayed in a second display as an FoV 2D extension 25A. In some embodiments, it is a hovering graphic or part of a multilayer display image. At time t1, the user performs an action to merge the content from the two windows with a merge function 72. Based on learned understanding of the two contents, the software automatically formats the source information of the secondary image and produces a formatted bibliography in the primary display image. The user action may involve clicking and dragging a mouse, a keystroke, a voice command, or a gesture. In some embodiments, the merging is suggested by a predictive model, and the user confirms or rejects the suggestion. In some embodiments, the merging is done automatically based on user permissions of a predictive avatar. The result is that the main display image 9B at time t2 is modified with the source information integrated. The FoV 2D extension 25B at time t2 may be unchanged. Other suggestions for source material may be made based on a library and on analysis of what text is written. The suggestions may be a set of thesis statements, hypotheses, or outstanding questions based on the input texts.

FIG. 11D depicts an embodiment, an “Intelligent programming recommender,” which is user-context sensitive. A user is producing content, which is a computer program in some embodiments. In some embodiments the content is a multimedia product or an artistic or entertainment product. The central display 9 is the user's primary workspace, and the display system produces two virtual side images as FoV 2D extensions 54. In some embodiments, the side images are hovering graphics or an edge display image. The left display image displays user actions. The right image displays suggested actions based on user history and performed by an AI module. A camera 14 is optionally available to function as a gesture sensor. In some embodiments, the suggested display content are alternative methods of producing the same result as the user is attempting to produce. In some embodiments, the suggested content is an optimized version of the user-produced content. The user inputs information for desired results by gesture recognition through a camera. In some embodiments, the user uses a keyboard or mouse or voice commands. This software application may be used in a variety of ways, including programming, artistic, or a/v or multimedia generation, architecture, 3d design and engineering, game design.

An AI software mechanism may display other alternatives. E.g., in a game design module, a user creates a game character generated by speaking or typing text into a prompt. The AI software generates that character and suggests a narrative for that character, other features, or characteristics that character may need to fulfil the narrative, and side characters that may interact with it.

FIG. 11E illustrates a “Posture encoder with AI feedback” embodiment: a user uses the display system with a camera. The software application is a chatbot, natural language processing, predictive text, or chat prompts using a generative pre-trained transformer, in some embodiments. A user 1 inputs data into the workstation, and the virtual system displays the resulting content in a central display image 9A at time t1. A camera 9 captures gestures, micro gestures, facial expressions, and postures about the user and the resulting display 9A incorporates those physical features into the result. In some embodiments the results might show up as annotation information in a hovering graphic 24A. Even with the same requested dialogue, the software uses learned data about postures or facial expressions to produce different results at t2—hovering graphics 2B and main display image content 9B—compared to that at t1. The annotations can explain how the person's physical features were used and predict alternative results. Regarding teleconferencing software, the display may have other functions to automatically computationally remap poor posture, wandering eye contact, or highlight other adverse social cues for more positive display content.

FIG. 11F depicts an embodiment of the display system, a “Global graphics intelligence profiler,” configured as a multilayer display 11 with hovering graphics 25 purposes. In some embodiments, the use case involves medical imaging. A user observes on the multilayer display 11 a set of images of an object derived from different modalities. For example, in some embodiments involving medical imagining, the different layers are a CT scan, MRI, PET scan, X-ray, or photograph. These images are input into a neural network 77 (with dictionary data for all modalities) to produce a final layer. A final layer is an annotation layer that indicates areas of concern or confirmation of objective questions. A secondary hovering image 24 layer takes as input the annotation layer and produces via an AI module 18 a description of the annotations, a diagnosis or prognosis, or other features of the annotations that are not specifically in the annotation layer.

In some embodiments, the source data is AI generated, configured for training modules. In some embodiments, the display content is geometrically transformed using a neural radiance field, and the AI software suggests different views for interactive training and suggested teaching. In some embodiments, the AI mechanism is controlled by a second user, who serves as the trainer or educator and directs what images or annotations are emphasized based on the goals of the program.

In some embodiments, as in FIG. 11G, a “Multilayer geometric warper,” the different layers correspond to a sequence of pose assets of a character in a video game that share a common anchor or target point, and the hovering graphic is a warped version of the assets based on the common anchor. Here, the function is a geometric transformation function that may warp, for example, the pose or the stride of the character. One of the layers of multilayer image 11, say the back layer, may include a target graphic to which the character's figure must be warped. The target graphic may be a scene or environment with certain landmarks or anchor points, such that the warping is adjusted dynamically based on the anchor points. In some embodiments, a function 15 analyzes the scene and displays a subset of pose assets of a character. Those pose assets are then input into a geometric transformation function 19 to generate a warped pose in a hovering graphic 24. The type of warping is arbitrary. The warping and geometry transformations can be implemented with Generative-Adversarial-Networks (GANs) in which the anchors can play the role of “seeds” for the GANs.

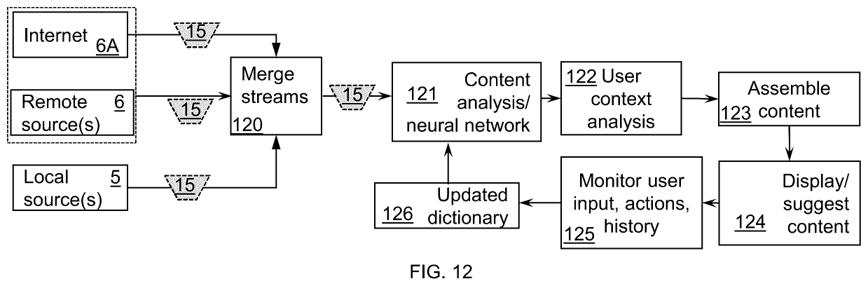

FIG. 12 shows a flowchart of a software mechanism of tandem computing. Multiple input streams include the internet 6A, local sources 5, and generic remote sources 6. Examples include cloud servers, local workstations, daisy-changed workstations, distributed networks, and edge devices. The data are optionally operated on by various functions 15 and then merged in a merge block 120. The resulting merged data may be operated on by another function 15 and analyzed by the display system, which can include neural networks, in content analysis block 121. A second content analysis block 122 understands the content in terms of the current context of the user actions or tasks/applications being used. The content is assembled in assemble block 123, and the content is then displayed on display system 124. In some embodiments, predictive actions, or suggestions are included in the content. The user input, actions, and history are monitored in a monitor block 125 and fed back into the analysis unit. The feedback may reside in an updated learning dictionary 126 for a machine learning algorithm before being directed into an analysis block. In some embodiments, merging is a nonlinear function or multidimensional function of the input streams.

User actions and feedback include time delays for making actions, decision making choices. Suggested content can be automatic depending on permissions given to the software. In some embodiments, the suggestions call a sub-application or autocomplete forms or online data entry requests. In some embodiments, the suggestions impact the health of the user, for example by suggesting taking a break, switch tasks, or maintaining focus, based on a user's health data.

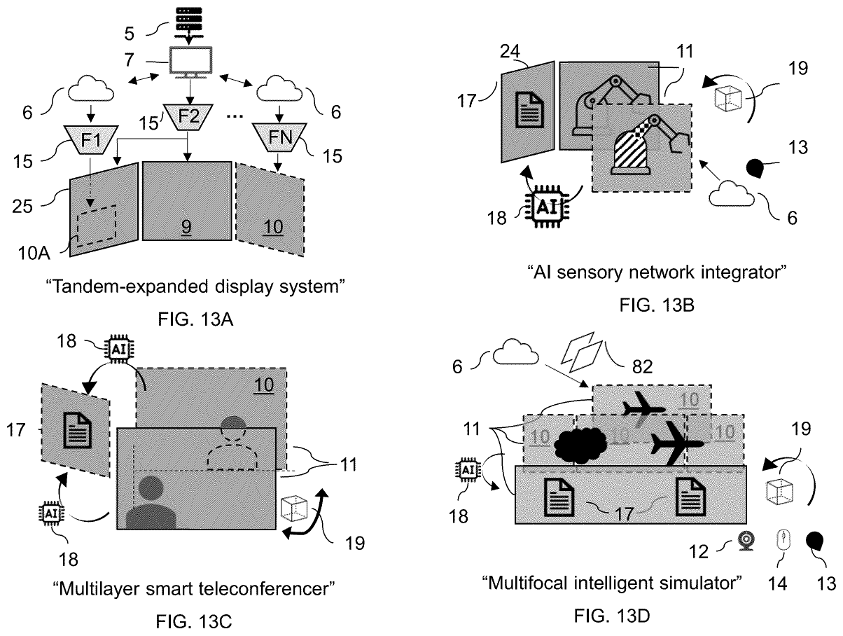

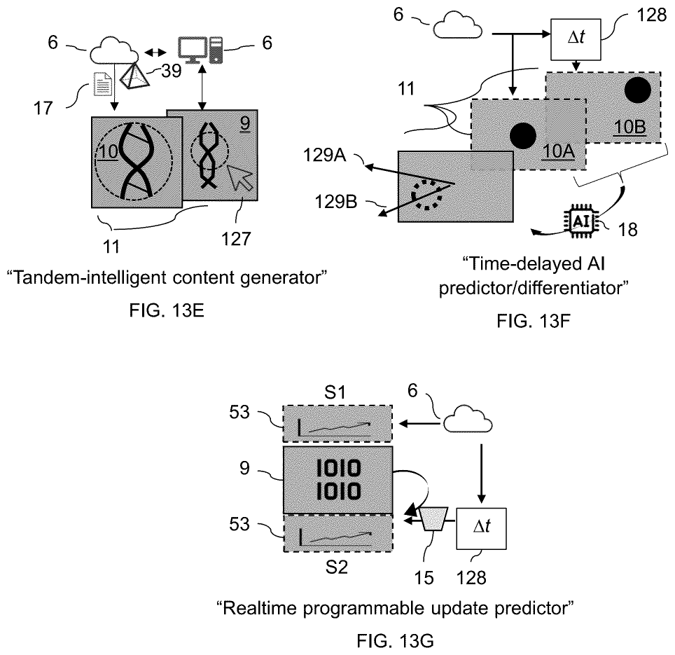

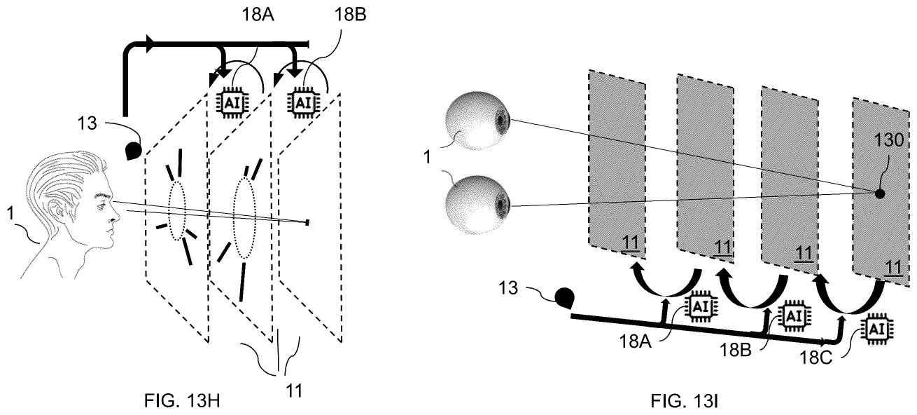

FIGS. 13A through 13I depict various embodiments using tandem computing methods, which include edge computing devices and distributed networks. FIG. 13A depicts a general tandem-computing environment, a “Tandem-expanded display system.” The display system produces N display images, including a generic central display 9 and an FoV 2D extension 25. In some embodiments, there are more than three panels or fewer than three. In some embodiments, the configuration is a multilayer display panel. In FIG. 13A, there are several sources of display content. One of the sources is a local source 5 connected to a display system 7 and produces the display content on the entire central display image 9. Other sources are remote sources 6 and generate content in the side windows. The right-side window is entirely a remotely sourced 10, that is, that entire display image is due to the remote source. In the left side window, a portion 10A is generated by the remote source, and the original local source produces the rest. In any embodiments, the display content can be operated on with functions 15, e.g., F1, F2, . . . , FN. All sources can communicate with each other, either directly or through various daisy chained configurations.

The embodiment in FIG. 13B illustrates an example tandem computer, an “AI sensory network integrator,” configured for use in teleoperations, robotic control, or quality control. One display area of a multilayer display 11 shows a video remote-controlled robot, for example, used in manufacturing, from a remote source 6. An array of distributed remote sensors 13 at the manufacturing site, vendor site, or any other location remotely produces the content for a front layer, which highlights the environment of the robot. In some embodiments, the remote sensors depict information about the robot, like the operating temperature or range limitations. In some embodiments, the remote sensors depict information about the product that the robot manipulates, such as quality-control sensing, random variations, stresses, and strains, or thermal or mechanical stability of the product or robot. The dual layer multilayer display images both are input into a geometric transformation function 19, which is used to overlay the sensory data on the video. For example, the sensory data may be a set of temperature sensors, and the geometric transformation functions uses a backpropagation algorithm to map the temperature profile of the device. A second function is an AI-module, which takes in the sensory data and the video as input and outputs an annotation 17 in a hovering graphic 24. The annotation provides descriptive content about the robot, or it predicts part failure, or it suggests modifications to the operation, or it suggests contacting vendors for support. For example, based on the temperature profile layered on the video, the AI module may generate content indicating that a robotic part is overheating, or that it may overheat soon unless an intervention is made.

FIG. 13C depicts a tandem computing embodiment, a “Multilayer smart teleconferencer,” for teleconferencing in virtual reality environments. A multilayer display 11 displays on each layer a given user in a shared virtual reality environment. One of the layers is a remotely sourced image 10 of a person. A geometric transformation function 19 acts on object and people in the scene are assigned to various depths and positions of the users. For example, an object detection subroutine detects the size of a person in one layer, which would be dependent on the person's position to a camera, and magnifies or minifies an image of a second person, such that the two are similar sizes.

In some embodiments, a secondary hovering-graphics layer 55 provides annotations and feedback to each user based on their facial expressions, eye gaze, tone, or head position, so that the user can modify his actions based on the suggested feedback. In some embodiments, AI module 19 assesses the conversation and the multiple users in the conversation to impact the conversation. For example, a facial expression analyzer function may assess the mood of a collaborative user and indicate whether the tone of the conversation should be serious, formal, informal, or lighthearted. Embodiments may be combined. For example, the “Multilayer smart teleconferencer” may include as part of its operation FIG. 11E, the “Posture encoder with AI feedback.”

The embodiment in FIG. 13D illustrates a use case of an extended virtual FoV display with multiple layers tandem computing, configured for use as a flight simulator, gaming experience, training experience, or weather/climate monitor. In this “Multifocal intelligent simulator,” several layers of a multilayer display 11 are remotely sourced images 11. These may be images of a flight simulator. The input stream passes through a multilayer optimizer to optimize the content for the display to maximize the depth perception. An AI-module 18 takes in the simulations images and provides annotations 17 on a front layer for a user-trainee to see. The annotations may be suggestions for next actions, dangers in the simulated environment, warnings, predicted alternatives, predicted motion or future dynamics of the environment. The annotation layer may also include images of instrumentation clusters and gauges. In some embodiments, the central viewing area may show the simulation, and the extended displays may show AI-generated predicted outcomes of the choices that a user can make based on the central content.

In some embodiments, the environment is a real-time image, for example, as produced by a camera located on an existing airplane, which is then used for flight simulation or observations. Or it may be a Realtime image of a remotely controlled vehicle, which the user controls in a teleoperations environment. In some embodiments, the annotation layer shows the predicted scene or the predicted motion at a future time, based on a delay that incorporates the latency. In some embodiments, the extended display of FIG. 13D is configured as a virtual tour of an environment, such as a museum, and an annotation layer provides annotations of the items in the environment.

In some embodiments, a sensor array in communication with the display system collects SLAM information about the user to influence or show distinct parts of the visual environment. For example, in a teleoperations center, SLAM information is input into a function to geometrically change the perspective of the virtual content for angle-accurate perspectives, which are true perspectives without any distortion that would occur from the sensors, cameras, or communication channel. Or, head tracking and eye gaze may be used, e.g., to detect where the user is looking and to modify that portion of the display content or zoom in on that area. In some embodiments, the AI-module is replaced by, or is impacted by, a trainer or instructor who may provide instructions as annotations. The instructor may be visible in the periphery of the user, such that the visual environment is immersive, and the instructor and user have a sense of being in the same place. This immersion allows a user to experience a visual environment with more realism. In some embodiments, the head tracking or eye gaze may be input into a geometric transformation function that modifies the simulation environment, to mimic shifts in viewing perspective.

FIG. 13E depicts an embodiment, a “Tandem-intelligent content generator,” in which the tandem display system is configured. A multilayer display 11 has main display image 9 that is produced by a local source and depicts, for example, scientific data or graphics. If the local source with display system 6 is a low-bandwidth source, the graphic or data is of low resolution or limited in some other way such as FoV, time resolution, feature depiction, or spatial resolution. The user provides an input, which includes a cursor input to move a cursor location 127 on the display image. The position of the cursor is detected, and the nearby portion of the display content is sent to a remote source 6, which relays more information about the nearby environment. The remote source may use an annotation function 17 to generate desired annotations in the remotely sourced image 10. In some embodiments, the cursor is not used and instead, the content of interested is determined by eye gaze location generated by an eye tracking input device. That extra information is displayed on a secondary display image in the multilayer display 11. It may be a FoV 2D extension display or a hovering graphic. The extra information could be a high-resolution or otherwise enhanced image of the environment. The extra information may be descriptive text, additional drawings or schematics, images of similar objects (as would be used in, e.g., an image web search). In some embodiments the extra information is a graph or simple text that shows up on an edge display image. In some embodiments, a graphics function 39 produces a dynamic image enhancement or upscaling, rendered from high-power computational sources. In some embodiments, different functional blocks allow a user to select different classes of modification, annotation, description, or suggestion. The annotation function and the graphics function may be parameterized by a user profile or history.

The embodiment in FIG. 13F depicts a use of the tandem computer, a “Time-delayed AI predictor/differentiator,” wherein a multilayer display 11 produces multiple frames of a video or a time lapse sequence of images of an object. In the embodiment, it produces a first remotely sourced image 10A and a second remotely sourced image 10B, where the second image is a time delayed version of the first image. The time delay 128 may be controlled by a user setting, or it may include latency of a video of the objects motion. The delay can be tuned to observe different time scales. For example, it may be tuned to be as small as possible, such that a user may consider very fast changes, or it may be tuned to be larger to consider slow changes.

In some embodiments, this application is used for weather prediction, and the object of interest is a storm or other localized weather effect. Both layers are then input into an AI module 18 that outputs onto a third layer the predicted evolution of the object. The time delay can be included, and the predicted image can show multiple possible trajectories, e.g., 135A and 135B, with different probabilities highlighted, or it can show various outcomes based on different time scales, e.g., local weather patterns for long-term trends in climate history. In some embodiments, the two images are almost identical, and the predicted image provides information about edges or differences between the two images or two frames of a video. In this way, this embodiment differentiates the visual content in time. In some embodiments, the different images come from different input streams, and the time difference is tunable, to contrast the content on different time scales. The AI module may incorporate any physical laws that describe the motion of the object under study.

In FIG. 13G, a tandem computer is configured for use in building automatic finance trading programs in a “Realtime programmable update predictor.” A user views a central display 9 that shows computer code for high-frequency trading operations. Multiple virtual edges 53 are displayed around the central image, all of which are generated by a remote source 6. The edge images include stock market values S1 and trends at various times, and the local workstation automatically compiles the code in real time. The code and the remote source data are input into a function 15 to generate predicted changes in stock prices for display along with the true values on the edge displays S2. In some embodiments, the latency is incorporated in a time delay 128 to assist the function in making predictive suggestions about how the market conditions change and what algorithms might be advantageous in future revisions. The function may be an AI-module, or it may be a statistical model in orthodox econometrics. The predictive measures may be used to mitigate latency for high-frequency trading located physically farther from the market floor. The function may rely on a dynamic time warping algorithm to compare time series data and optimize matches between them.

FIGS. 13H and 13I depict an embodiment in which a user is viewing a multilayer display. In FIG. 13H, a multilayer display 11 is viewed by a user 1. Different content is shown on each layer. Each layer corresponds to a different focal depth, to which the users' eyes individually accommodate. A sensor 13 may detect information about the user, such as eye gaze or geometry. The sensor may be a gesture camera that identifies specific gestures made by the viewer. The sensor may detect information about the environment. The data from the sensor and the content on each layer are input into a set of AI modules 18A and 18B, which may be configured differently, e.g., with different dictionaries, training mechanisms, or architectures. The outputs of the AI modules impact the display content. E.g., the user eye gaze may be in the center of the display, and the content of each layer moves radially inward or outward to change where the content is displayed. In this way, the set of AI modules create a network of feedback and communication between the viewer and the different focal planes. FIG. 13I shows a similar setup with four layers in a multilayer display 11 and three different AI modules 18A, 18B, and 18C. The user 1 focuses on a point 130 in the rear layer, such that both eye lenses accommodate that depth. If the user looked at content on a different layer, the accommodation of the lenses changes. In both cases, the layers may be locally sourced or remotely sourced.

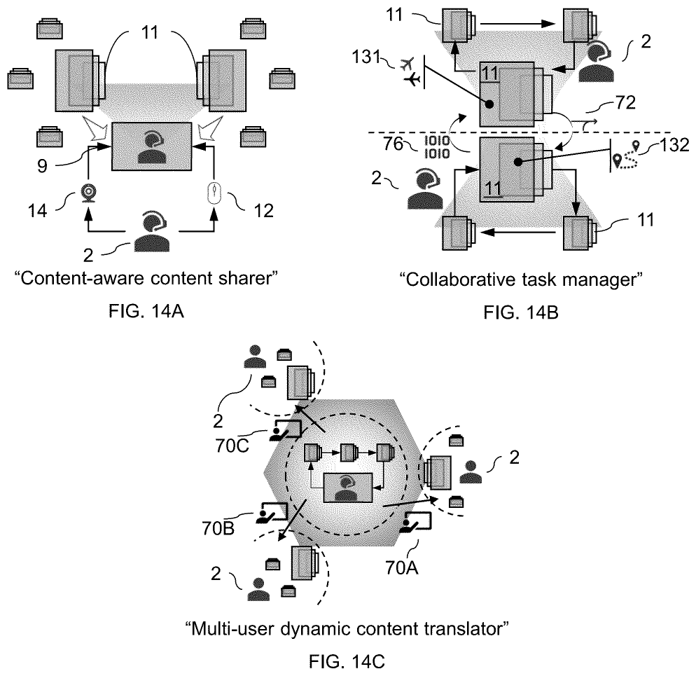

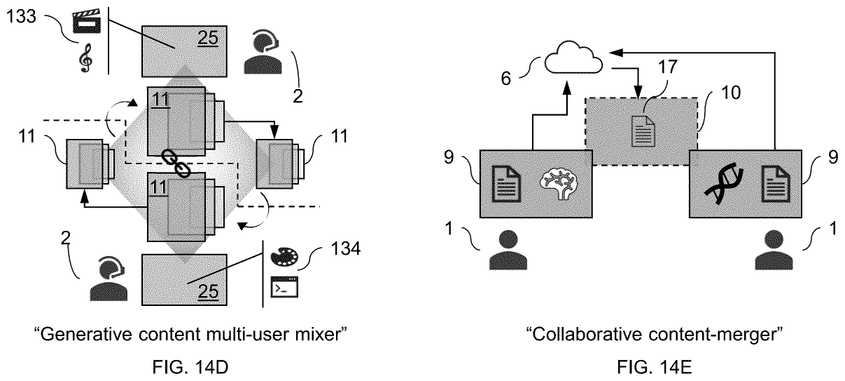

FIG. 14A through 14E shows different embodiments of novel muti-user and collaborative use cases. Collaborative use cases include, but are not limited to, content editing/creation/annotation of applications; exploring content/data; control-room applications; performing processes such as computations/simulations, rendering, mapping; and analyzing trends/patterns or visualizing multi-dimensional data. FIG. 14A depicts an embodiment, a “Content-aware content sharer,” in which two users 2 are engaged in a videoconference. One person, shown on a central display image 9, is transmitting information and explaining and pushing content to a receiving collaborative user 2. In this embodiment, the transmitting user controls some of the aspects of the receiving user's display system. For example, the transmitting user may choose the visual template for optimal presentation of, or interaction with, the content. The transmitting user may decide to push the content into multi-layer displays 11 for the receiving user, where the multilayer display is a set of images for a certain lesson with annotations created by a user. The transmitting user directs the content and the display system configuration through a variety of means, including gestures, keyboard or mouse input, or voice activation. The collaborative user 2 can interact with the display content using generic input devices 12, including a camera 14. In some embodiments, a sensor or sensor array is used to receive input from a user. The roles of explainer and receiver can be dynamically switched based on a configuration of the software, which decides who is the host and who is a guest.

FIG. 14B depicts an embodiment, a “Collaborative task manager,” in which two collaborative users 2 are collaborating in a scenario involving a complex task, such as air traffic control. Each user has his own display system and content showing various aspects of the scenario (e.g., air traffic control). In this embodiment, the displays systems both show sets of multilayer images 11. The information processed by each user can be passed back and forth between them and pushed to different streams of the other user using any input device or sensor. For example, in air traffic control, one user monitors the routes of the airplanes 131, while the other user computes different optimized routes or interacts with anticipated trajectories 132. The information of traffic monitored by the first user such as altitude, speed, and heading can be pushed numerically to the second user, which can generate optimized routes using a code function 76 and passed to the first user as alternative routes in a graphical mode. The function that the software uses is a merge function 72, which merges the information of one user into a form that is useable by the second user. Information display for the user monitoring the traffic may be more graphical whereas information display for the user running the calculations may be more numerical and tabulated in nature. The streams for each user can adjust to the nature of the information being processed. The software may automatically adjust the virtual display content or template, based on the information being sent.

FIG. 14C describes an embodiment, a “Multi-user dynamic content translator,” involving an online teaching scenario. A teacher pushes content to an audience (e.g., the students who are the collaborative users 2), which receives a customized version of the content. This is like the application of FIG. 14A, except that each student may receive the content differently based on his/her learning preferences and settings of the display. For example, a first student may be a visual learner—discovered through various calibration, testing, or interviews with that student—and so the content produced on the respective display system is more graphical. A second student may be better with quantitative reasoning, such that the respective display is more text-based, with mathematical equations. The software function then translates, though, e.g., a machine learning algorithm, the original content into a plurality of display contents. For example, the instructor may be reciting information about a physical principle. A voice-to-text program transcripts the statements, and an AI-generator produces visual content based on the text and on web searches that use the text as input. The information is all sent to a student's workstation, and a local analyzer then determines which of the modalities—voice, text, or imagery, or any combination—is optimal, based on student history and input. Each of the users receives content being shared by the teacher through a unique whiteboarding function 70A, 70B, 70C, which incorporates such translation functions.

In some embodiments, the dynamic translation uses data or metadata, and an AI module provides an annotation layer to assist in formulating questions for students. The annotation layer may be displayed for the instructor or for the students. FIG. 14D describes an embodiment of a collaborative scenario, such as generating movie production, or entertainment media, between two users that are in different locations. In this embodiment, a “Generative content multi-user mixer,” two users 2 share a multilayer display 11 which contains the common work in progress, shown on their respective display systems. Each user has an FoV 2D extension 25, or multilayer display 11, that can be pushed to the other while discussing different aspects of the work to be done back and forth. For example, the first user can be working on editing frames and soundtracks 133, whereas the second user can be working on improving and adding artificial effects 134 to the clips and soundtracks being edited by the first user. Each user can use their peripheral displays to show to the other user different suggestions to edit and improve the final product. In some embodiments, this configuration is used for web conferencing, multiplayer gaming, or collaborative teleoperations. In some embodiments, an annotation layer may be AI-generated. An annotation layer for one user might take as input the details of another user, and it may output various app suggestions—such as hyperlinks, advertisements, or chat interfaces—to assist in completing the collaborative task.

FIG. 14E describes an embodiment, a “Collaborative content merger,” of a collaborative scenario in which two users 1, which do not necessarily have to be in the same location, are generating multi-dimensional content, for example, in composing a research paper with text and graphics. The first user may be focused on analyzing and reporting medical imaging in a display image 9, while the second user may be focused on analyzing and reporting on the effects of some medications on a second display 9. The results of both reports are sent to a remote source 6, which then merges and live updates the collaborative result, which is then displayed by the display system as, e.g., a layer in a remotely sourced image 10. The images together may form a multilayer display, which may include various overlayed annotations 17. Both users see the same joint project as their work progresses. In some embodiments, the two users are in the same physical location, and the final result is displayed once for both users to view simultaneously in a common display. In some embodiments, various annotations can be made on any layer, by either user for viewing by the other user. In this embodiment, the users may be using different software applications. For example, if both are contributing to text, one user is using a what-you-see-is-what-you-get (WYSIWYG) software, whereas another user is using a plain-text software. As the individual content is generated, it is converted locally into a common format. Both sets of information are uploaded to a remote source 6, which analyzes and integrates or merges them together. The remote source can then send the merged document back to the users' display system for viewing.

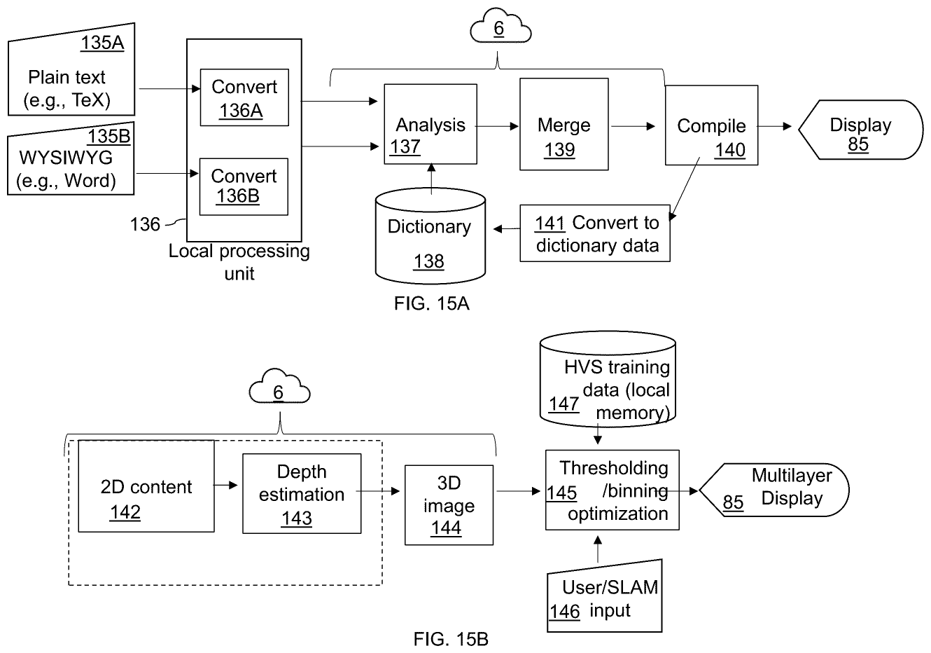

FIGS. 15A and 15B show different flowcharts describing different text and graphical editing modalities in tandem. FIG. 15A depicts a flowchart of a tandem text editing scenario in which two users are working on the same document. Each user is working with a different text editing tool. For example, one user can be working with a plain text editor 135A, such as TeX, and the other user can be working with WYSIWYG editor 135B, such as Microsoft Word. A local processing unit 136 contains a convert block 136A and a convert block 136B to convert the input data into a common format. The common format may be ASCII-type data. The information is sent to remote source 6, which analyzes the data in analysis block 137. This block also takes in a dictionary 138, configured for use in a neural network. The data is then combined in merge block 139 and compiled in a compile block 140. The remote source directs the result to the display system for display 85. The compiled data are fed into a convert to dictionary data block 141 to update the analysis dictionary.

FIG. 15B depicts a flowchart in which a 3D image is produced by a remote source 6. In some embodiments, the original data is a 2D image 142 or a set of 2D images. The remote software has an estimation block 143 to estimates depths in the images based on various cues—such as stereo information from multiple cameras, time-of-flight information, depth-from-shading or -shape, projective geometry, or monocular depth estimation—and merges them into a 3D image 144. The remote source 6 then sends the information to the local source, which has a threshold block 145 and thresholds or bins the depth information into a discrete set of depth planes that correspond to the layers of a multilayer display 85. The thresholding optimization may use a neural network that includes in an HVS dictionary 147 with information about the human visual system (HVS), as well as input 146 from a user or SLAM information. The HVS dictionary may include information about visual acuity or depth perception. The depth perception information may include data about the human horopter and Panum's Fusion Area; vergence or accommodation metrics for human populations varying by age; or information about the brain, eyes, and connecting nervous system. In some embodiments, the depth perception information is weighed highly against the other information, such that the algorithm optimizes the depth perception of the image content by a viewer. E.g., the image focal plane may be mapped to a shape related to Panum's Fusion Area.

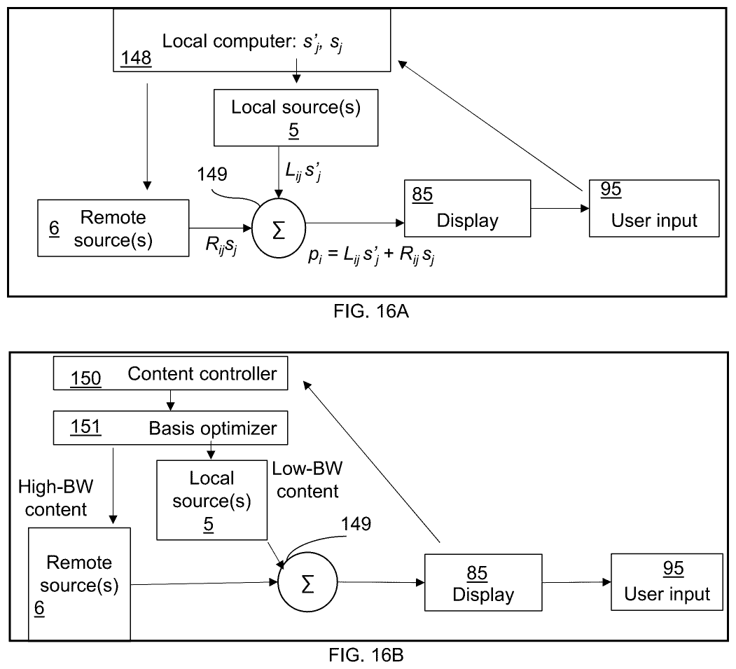

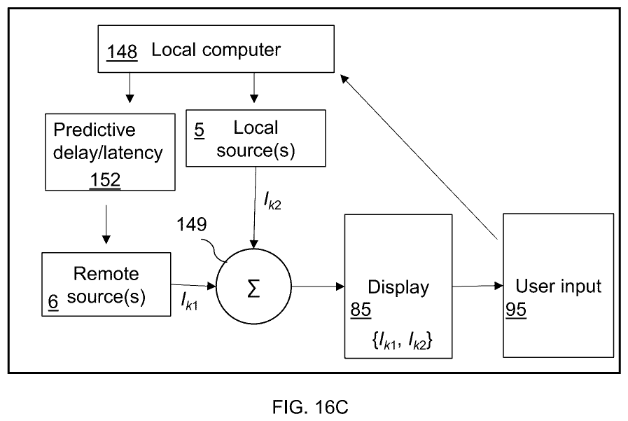

FIGS. 16A through 16C depict a set of pipelines in which both remote and local sources are used to produce display content. In some embodiments, the pipeline is application-independent and is set by the local workstation. In FIG. 16A, a local computer 148 divides the pixels into two sets sⱼ′ and sⱼ. Pixels sⱼ are sent to the remote source(s) 6 to be rendered by some operation Rᵢⱼ. Pixels sⱼ′ are sent to the local source 5 to be rendered by operation Lᵢⱼ. The resulting pixels are added together as a sum 149 to produce pixels pᵢ=Lᵢⱼ sⱼ+Rᵢⱼ sⱼ′. These pixels are then shown as a display 85. In some embodiments, user input 95, partly based on the current display content, is fed back to the local computer to change the sets of pixels sent remotely and locally. In some embodiments the sets sⱼ and sⱼ′ are disjoint. In some embodiments they overlap, such that the intersection represents a set of pixels that receive contributions from both remote and local sources as a weighted superposition.

FIG. 16B illustrates a similar pipeline, in which the content is divided by bandwidth. A content controller unit 150 analyzes the desired display content. The information is sent to a basis optimizer unit 151, which decomposes the content into an appropriate basis. For example, the basis can be a standard Fourier basis, or it can be a sparse basis, or a wavelet basis, or a content-adaptive basis. The basis modes where most of the energy lies (called here the high-bandwidth content) is sent to remote source 6, which then fetches or renders that content. The low-bandwidth content is then fetched or rendered by the local source 6. The two sets of content are then added together as a sum 149, and the sum is sent as display 85. In some embodiments, user input 95 can adjust the content type. For example, a user may wish to process an image, or may wish to use a certain functionality. The user can select the modality, which, in turn, corresponds to a particular image basis. The basis could be a standard Fourier basis, point-sparse basis, edge basis, or a higher-level basis for high-level object detection. An image I can be expressed as a superposition of bases modes Bₘ with weight wₘ:

$$I ( {r}_{m} ) = {\sum }_{{m}^{′}} {w}_{{m}^{′}} {B}_{{m}^{′}} ( {r}_{m} ) .$$

Next, threshold wₘ′ and find the ranges of m′ for which wₘ′ is above the threshold. This range corresponds to high-bandwidth portions of the display content. Send that range to the high-bandwidth processer to process and produce pixel values. Combine the rest with a low-bandwidth processer; add the result and send to the display system.

In some embodiments, the content is separated based on a feature type. For example, display content involving sharp edges is produced by the remote source, and display content involving broad features is produced by the local source. Or, in some embodiments, information about human subjects is produced by the remote source, and information about scenery is produced by the remote source. The basis chosen may depend on the specific software application, or it can be created dynamically. In this way, the separation is a form of foveated rendering.

In FIG. 16C, the content of a multilayer graphical display is analyzed by a local computer 148. Some of the layer information is sent to a local source 5 for display generation. The result is sent to remote source 6. The results of the local and remote display content generation are added together as a sum 149 and shown as display 85. User input 95 allows for changing the local computer analysis of the desired content. In some embodiments, information about the latency of the remote source is combined into a time delay block 152 with predictive modeling capabilities to impact the remote display content.

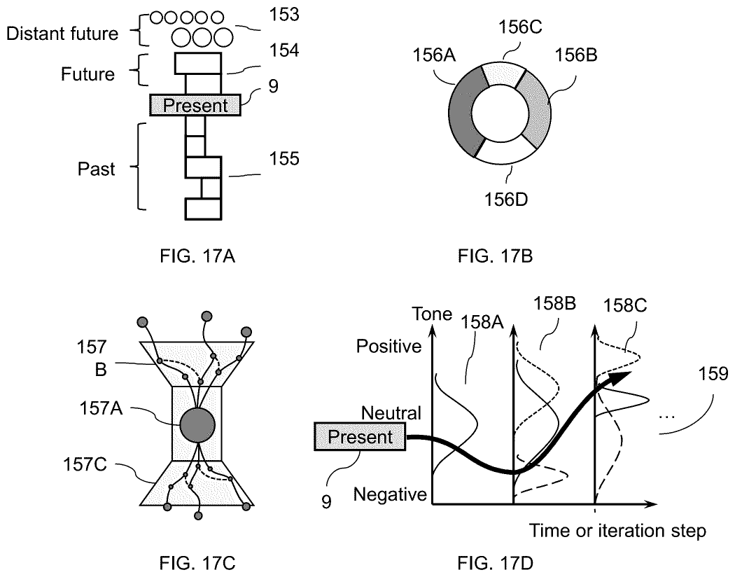

FIGS. 17A through 17D depict some auxiliary embodiments involving the infographic display of various events that span in time and space. FIG. 17A depicts a “timespan” embodiment in which a central display 9 shows information and events relevant to the present time, whereas a display below the central display a past-content graphic 155 as bars to show past events in a sequence that leads to the present. On the other hand, a screen on top of the central screen shows a future-content graphic 154 displays a stack of future possible options and events in a way that events/options more likely soon are highlighted than events/options likely compared to a distant-future graphic 153. In some embodiments, widths of bars indicate activity likelihood, and positions indicate recommendations based on other factors (like productivity or time of day). Bubbles indicate the least certainty in the distant future.

FIG. 17B depicts a “space-span” embodiment in which depicted events 156A, 156B, 156C, and 156D in the past are displayed in a way in which the size of the possible event in the near future is related to the likelihood that the user will activate such an event. In some embodiments, shading or color of the different pieces indicates future recommended actions.

FIG. 17C depicts a “tree-span” embodiment in which an event of interest 157A is connected to preceding events 157C being displayed by a screen below a central screen and possible event 157B derived from the event of interest are displayed by a screen above the central screen. Graph nodes correspond to past, present, or future actions. Connections are determined by correlations between actions. In some embodiments, there are multiple components, such that each component is a graph, the nodes of one component are not connected to the nodes of any other component.

FIG. 17D depicts an embodiment infographic in which the tone of suggested words in writing, for example, an email change dynamically as a function of the current input of the user. The tone can vary between positive, negative, or neutral tones. The present display 9 may show an image of an email environment for a user to compose an email. At the start, the user is presented with initial suggested words that are organized vertically based on the tone. The first distribution 158A is centered on neutral tones. As the user progresses through word choice 159, he chooses a slightly negative tone, and so the next distribution 158B shows different sets of words based on the tone chosen. A third distribution 158C follows the from a user change tone from negative to positive.

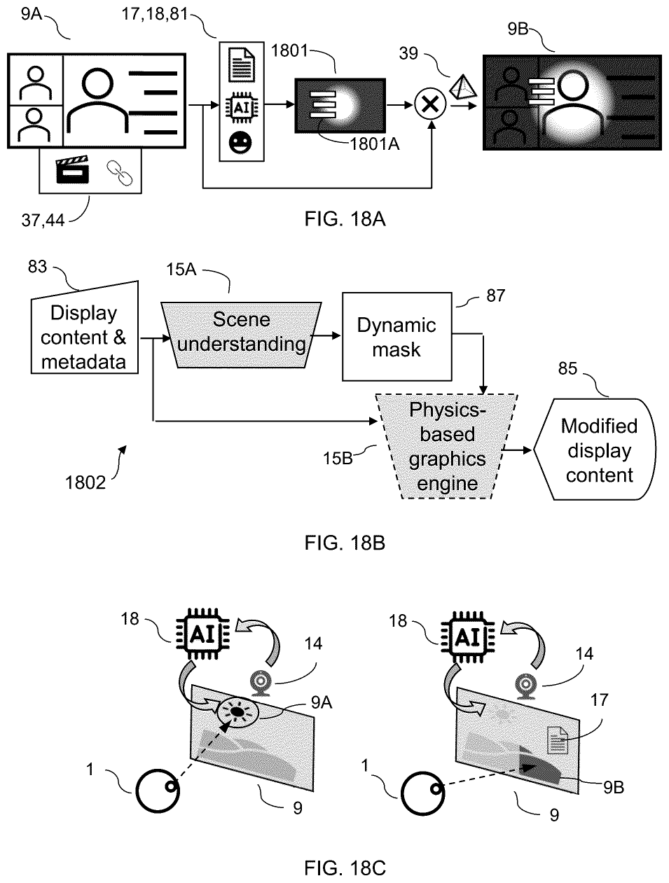

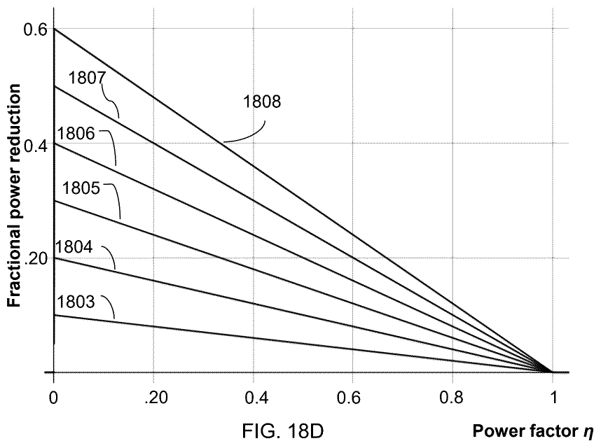

FIG. 18A shows a specific example of the type of annotation disclosed above. An input display content shows several types of display contents 9A. The input display content may be of a video clip 27. In some embodiments, the metadata 44 is included. The metadata includes information about the layout of certain windows, where the cursor is, and which windows are active, i.e., the metadata includes windows application programming interface information like coordinate locations of various graphics. The input display content and its meta data are input streams that pass through different functions. In some embodiments, one of the functions is an object detection function 81 or some other computer vision function, which may be used to detect high-, mid-, or low-level features about the input display content; or to detect changes in pixel values. For example, the function may identify a position of the cursor, or the position and area taken up by an active window. In some embodiments an AI module 18 operates on the input stream and its information. In some embodiments, an annotation function 17 operates on the input stream and its information, and the mask introduces annotations such as text or new graphics. In some embodiments, a machine learning algorithm or neural network is used to generate the mask. The output of one or more of these functions is a mask 1801, or overlay. An overlay, or mask, is a pattern to layer on top of the original content. In some embodiments, it is a pattern that multiplies the display content pixelwise. In some embodiments, it is a dynamic brightness mask such that the pixelwise multiplication changes the brightness of each pixel and serves to keep a certain portion of the display content bright and dim other portions. When the dynamic brightness mask multiplies the display content, the display system shows a modified display content 9B, in which a certain area is brighter. This serves to draw a viewer's attention or keep the focus of a viewer to a certain region. In some embodiments, the input stream is a sequence of frames of the display content (and metadata), and a time average of the sequence of frames is used to make the mask. For example, a computer vision function may compare the average of earlier frames of the original display content and compare it to the present frame. In some embodiments, the display system can be switched between two modes: either showing the input display content directly (without modification) or showing the modified display content.

In some embodiments, an optional graphics function 39 which is a physics-based engine that that further operates on the mask. For example, the physics-based engine may blur some of the display content that is subsequently shown on different focal planes of a multifocal display system. The physics-based graphics function may execute physics-based rendering to produce physically accurate shading or three-dimensional effects. Such effects may be produced using ray tracing models or Monte Carlo analysis.

The physics-based rendering function relies on physical laws to modify the display content to produce real-world physics effects. For example, in some embodiments the blurring of the display content produced by this function is determined by the monocular depth of the display content, i.e., by the position of the display content within a depth of field. In some embodiments, the function introduces shading of display content, the shading determined by the shape and orientation of objects within the display content or the reflectance or bidirectional reflectance distribution function of the objects.

In some embodiments, the mask is a brightness mask such that some pixels are dimmed or turned off. That is, the display system can show the input display content without a mask, and each pixel emits a certain amount of light. But if the display system shows the modified display content, then some of the pixels are dimmed or completely dark. In some embodiments, the pixels may be dimmed, and the brightness mask continuously decreases the brightness from a central position to the edges of the display. Because some pixels will be off or dim, the display panel will require less power consumption than if all the pixels were fully on to show the entire display content. Such would be the case in which each pixel is individually turned on or off, as in, for example, OLED, POLED, MOLED, micro-OLED, and LED displays, or similar active-matrix display where pixels emit light. In some embodiments, the displays use quantum-dot (QD) materials, e.g., as in QD-OLED displays. For example, if the power emitted by the display system from the (mn)-th pixel of an N×M display is Pₙₘ when showing the input display content directly, then the power P consumed by the display system is

$$P = {\sum }_{mn} {P}_{mn} ,$$

where the sum is over all pixels. Now, if a dynamic brightness mask is superimposed to dim or shut off certain pixels, this can be mathematically represented as a mask with values mₙₘ that multiply the power, where 0<mₙₘ<1, the new power P′ consumed by the display system when showing the modified display content is

$${P}^{′} = {\sum }_{mn} {m}_{mn} {P}_{mn} .$$

Because the mask values mₙₘ are all less than one, P′<P. The fractional change in power consumption is (P′-P)/P. The power ratio n is the ratio of power consumed by the display system when showing the modified display content to the power consumed by the display system when showing the input display content directly, i.e., is the absolute value of the quantity and quantifies the reduction in power consumption: η=P′/P. For example, if a dynamic brightness mask reduces the power to half its original value, the power ratio is 0.5, i.e., half as much power is used. The power ratio depends both on the mask and also on the display content itself. For example, if the mask is meant to highlight an active window that takes up a portion of the screen, the power ratio can range from 0.3 to 0.7. If the mask is meant to highlight a region of the cursor, the power ratio can range from 0.01 to 0.2. If the mask is meant to highlight a portion of an active window, the power ratio can range from 0.2 to 0.5. If the mask is meant to highlight a movie or some other large-scale content, the power ratio can range from 0.5 to 0.99.

For example, if the mask were binary and shut all pixels outside a certain region and all the pixels would otherwise be on, the power ratio is the ratio of the number of the illuminated pixels to the total number of pixels. In some embodiments, the mask is not binary, but smooth. The mask may obey a Gaussian function. If the number of pixels is large, the summations may be approximated as integrals, and the integrals would be over the area that includes the relevant pixels. In some embodiments, the display content that is bright corresponds to the angle subtended by the fovea of the human eye corresponding to in-focus regions of the visual field. At a viewing distance of 0.5 m, a 2-degree visual field angle corresponds to a linear dimension of the in-focus region of about 2 cm. If the mask keeps only this region bright, for an 80-cm display, the power ratio would be almost zero. If, instead, the mask keeps bright only an active window and dim or darken inactive windows and desktop or background images, the power ratio would be bigger. If the active window takes up half the display content area. The power ratio is 0.5. If the active window takes up one third of the display content area, the power ratio would be approximately one third. If only the cursor location is to be highlighted, corresponding to a region of the power ratio is bigger. If the cursor location is 1/100 of the display content size, the power ratio is 1/100. In an extreme case, the mask might be configured to follow a single pixel in the screen and darken everything else. The power ratio in this case is 1/(NM), where NM is the number of pixels (N rows of pixels and M columns of pixels). The power consumed by the display itself is virtually zero. For a 4K display, for example, NM≈8.9 million. At the other extreme, if all the pixels are on except for one, the power ratio is (1-1/MN). In this case the power consumed by the display is about the same as it is without the mask. A lower power ratio implies less power consumed by the display system.

The power ratio is a number that depends on only the (unmodified) display content and the modified display content. However, it directly influences the total power consumption and reflected power savings of computer systems that use the modified display content. The power ratio is directly related to the energy consumption of the display system and any driving computers. If the entire system is powered by a battery, e.g., a laptop, then a smaller power ratio implies a longer battery life. The energy consumption can be drastically reduced (battery life significantly extended) because the display's optical power is a large fraction of the total energy consumption of the system. If the power used by the non-display portions a system is P₀, and the display normally consumes power P, the total power P_{T} consumed is P_{T}=P₀+P, introducing a mask with a power η will cause the system to consume a reduced total P_{T}′=P₀+ηP, which is smaller than the original total power consumption. The overall fractional power reduction (1−η) f, where f is the ratio of the power consumed by the display itself to the total power: f=P/P_{T}. For example, if a display normally consumes about 20% to 40% of the total power, the fractional power reduction is between 0.2 (1−η) and 0.3 (1−η). A mask with a power ratio of 0.5 implies a fractional power reduction of 0.1 and 0.15. Because the power ratio can range as described above, so too can the fractional power ratio accordingly. In the limiting case of a mask that causes only one pixel to be on, the fractional power reduction is approximately f.

A graph of the fractional power reduction is shown in FIG. 18D. As the power ratio increases from 0 to 1, the fractional power reduction decreases from its maximum value (minimum power ratio, or maximum power savings) to its minimum value (maximum power ratio, or minimum power savings). In FIG. 18D, the different curves correspond to different values of f. A value f=0.1 corresponds to the lowest curve 1803; a value f=0.2 corresponds to the second lowest curve 1804; a value f=0.3 corresponds to the third lowest curve 1805; a value f=0.4 corresponds to the fourth lowest curve 1806; a value f=0.5 corresponds to the fifth lowest curve 1807; and a value f=0.6 corresponds to the highest curve 1808.

The power ratio similarly lengthens the battery life of a battery that is powering the system. If a battery operates at V volts and has a rating of Q amp-hours, can provide energy QV before it needs recharging or it dies. If the total power consumption is P_{T}, the battery will last a time QV/P_{T}. With a mask, the battery will last longer: QV/P_{T}′, which is (1+f)/(1+ηf) longer. For example, if the display itself consumes about 50% of the total power, and the mask produces a power ratio of 0.2-0.8, the battery can last between 1.1 and 1.3 times longer. If the mask has a smaller power ratio, say, 0.01 to 0.2, the battery can last 1.4 to 1.5 times longer. The improvement factor is limited by the non-display power consumption.

FIG. 18B shows a block diagram 1802 of the embodiment of FIG. 18A. The display content and metadata are input 83 into a set of functions that engage in scene understanding to calculate an overlay, such as a dynamic brightness mask. The scene understanding function 15A may be of any of the type described above, and results in a calculation block 87 that produces the overlay. The original display content and dynamic brightness mask may be input into a physics-based engine function 15B, which finally outputs the modified display content 85.

FIG. 18C shows a similar embodiment, in which user 1 provides input that is captured through a camera 14. In some embodiments, the camera is an eye tracking camera to detect an eye gaze of the viewer. The eye gaze is input into the set of functions that determine an overlay or the brightness mask for the display content 9 to highlight a first specific region 9A of the display content. When the eye gaze changes, a second specific region 9B is highlighted. In some embodiments the overlay includes an annotation 17. In some embodiments, an AI module 18 serves to generate annotations based on the eye gaze and the highlighted display content, but other functions, such as object detection or other computer vision functions, may be used. In some embodiments, the eye gaze data is combined with the original display content or its metadata. When the eye gaze shifts, a new display content is highlighted and annotated with an annotation. Eye gaze data includes fixations (steady gaze and duration at a display content), saccades (sudden eye movements, eye scanning, size, and timing of shifts in gaze), entropy (fluctuations or randomness in gaze), and pursuit (tracking display content as the content moves). In some embodiments, the specific eye gaze motion may be recognized by the AI module as a comment. For example, blinking, sweeping gaze across the screen, and the like, serve to select a region of the screen or execute a function on screen.

In some embodiments, the display content is of a virtual tour, a virtual lab, an architectural plan urban planning design, or some other engineering design or simulation. The highlighted content may be annotated by suggesting the next step on the virtual tour or the next procedural step in the virtual lab, or by annotating the highlighted region of a design with calculation details, material specifications, before-and-after generative images (e.g., in the case of an urban planning study), and the like.

The embodiments and block diagrams of FIGS. 18A through 18C are examples and variations of previously described embodiments, such as those in FIGS. 51 and 6I. In those embodiments, the functions operated on display content to produce modifications to the display content. In some of those embodiments, the modifications are shown on different layers. In other embodiments, they are shown on the same layer. In FIG. 6I, the input was a real-time video, but any graphical display content may be input instead.

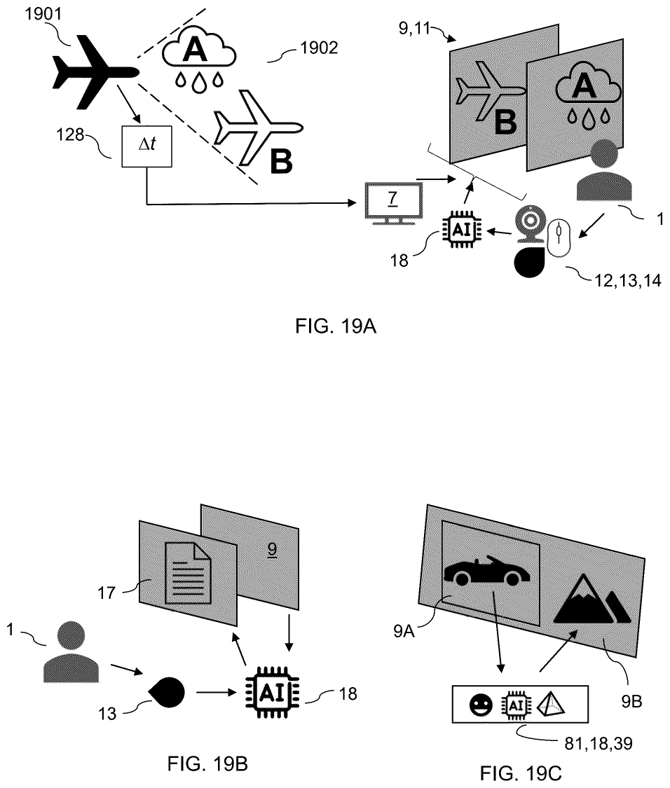

In FIG. 19A, a remote vehicle 1901 may be operated in the field with a camera feed to capture a live video of the scenery 1902 in its path. The content is time delayed 128 and sent to a display system 7 where it is displayed as display content 9 as part of a simulation training video corresponding to the vehicle usage. In some embodiments the display is a multilayer display 11. In some embodiments, the vehicle is an aircraft, and the simulation training video is a pilot simulation training experience. The user 1 of the display system, i.e., the trainee, has similar controls as in the real vehicle and has the goal of mimicking that actual field path. The trainee provides input into the system via user input 12 and sensor 13 devices. In some embodiments, a camera 14 is used for eye tracking. If the trainee succeeds, the display content continues to show the video feed. If the trainee deviates from the real-world path, a generative AI module 18, which is part of a simulation raining program, adjusts the content smoothly to simulated environments.

In FIG. 19B, a user 1 is viewing display content 9. An AI module 18 takes in the display content and calculates graphics properties, such as lag or latency from a user input. The AI then outputs as an annotation 17, for example as an annotation layer on a multilayer display system, to indicate the results and suggest methods to improve the graphics quality. The suggestions may be changes of the video quality itself—changing the resolution, the refresh rate, and the like—or by adjusting the global properties of the display system or computer itself, by shutting down other applications, replacing a batter, and the like. In some embodiments, the display is a multilayer display. The user provides input through a sensor 13. In some embodiments, the function is an object detection function or a computer vision function to execute image processing analysis on the graphics. In some embodiments, the AI module automatically changes graphics properties-such as refresh rate or resolution—in a display system based on a user input or a captured user property using, e.g., eye or head tracking to optimize the display system.

FIG. 19C shows a similar embodiment, in which a first display content 9A is shown on a display system. In some embodiments, the first display content is a video game. This first display content is then input into a set of functions. In some embodiments, the functions are an AI module 18, an object detection function 81, and a graphics function 39. In this embodiment, these functions detect graphics quality and produce a second display content 9B. In some embodiments, the second display content is like the mask of FIG. 18A. In some embodiments, the second display content is shown on an extended part of an extended display, such as an extended FoV or multilayer display. In some embodiments, the functions have preprogrammed instructions to modify or extend the first display content. For example, when the first display content shows a particular image, the object detection function detects that image and produces a secondary image to enhance the visual effect.

The embodiments of FIGS. 19A through 19C are examples of the types of embodiments shown in FIGS. 5A, 5I, and 13D. FIG. 13D shows a multifocal intelligent simulator with a remote source 6. In the present embodiment, the remote source is the video feed from the vehicle.

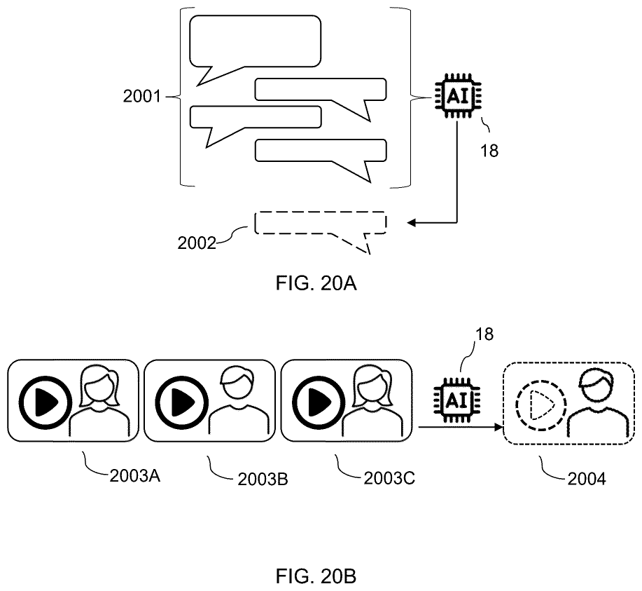

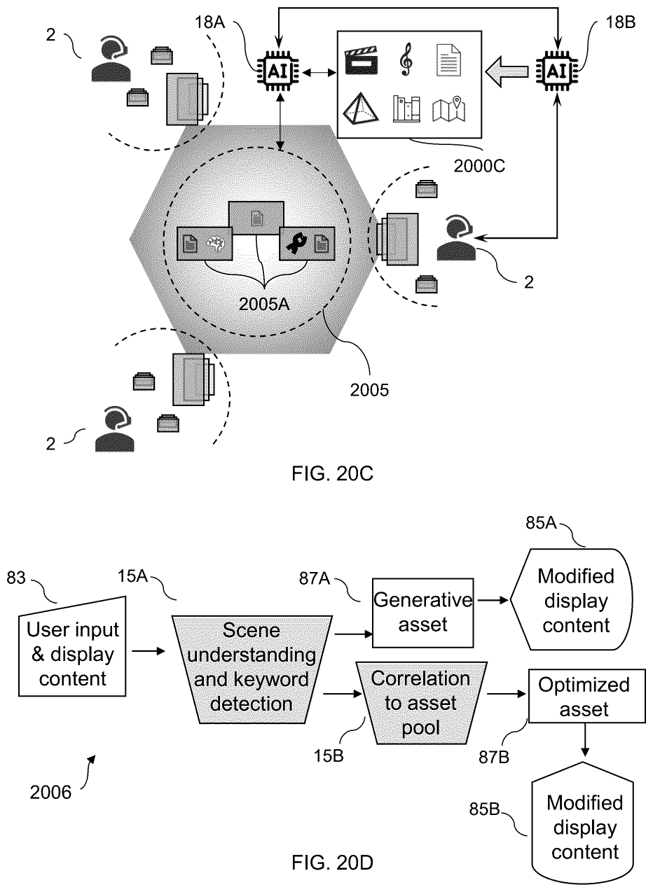

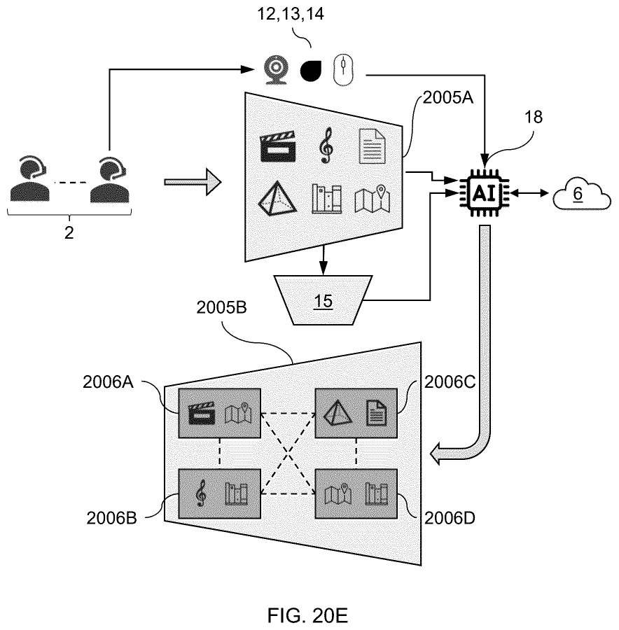

FIG. 20A shows a generalized version of an AI module predicting text. A text messages series 2001 is input into an AI module 18. The entire conversation history may be input into the module, which then outputs a suggested text based on, for example, a natural language processing algorithm. In some embodiments, a machine learning algorithm or neural network is used to generate text. In some embodiments, more recent texts are given more weight in the AI module. The suggested text 2002 incorporates information about tone, grammatical style, and the like. In some embodiments, a user-set permission allows the AI module to send the text to the recipient. The embodiment applies to video texts also, as shown in FIG. 20B. A first video chat 2003A, second video chat 2003B, and third video chat 2003C—or generally N past video chats—are input into an AI module 18, which generates a new video chat 2004. The new video chat incorporates past use backgrounds, user history, and the like to replicate the look and sound of the user. In some embodiments, the AI module is assisted by an object detection function to detect features about the background. The AI module may combine a natural language processing module with an image generation module. In some embodiments, the AI module uses a CNN, RNN, or GAN.

FIG. 20C depicts an embodiment in which multiple collaborative users 2 are sharing ideas and discussions in a shared visual environment 2005. An AI module 18A takes in the relevant assets 2005A and correlates them with other assets 2000C. Highly correlated assets from the library are then shown in the shared visual environment. In some embodiments, the assets include pictures, graphs, video, sounds, and text. A second AI module 18B implements may further assist in generating or selecting assets by communication with one of the collaborative users 2.

FIG. 20D shows a block diagram 2006 of the embodiment in FIG. 20C. User input and display content is input 83 into a set of functions that engages in scene understanding and keyword detection. In some embodiments, an AI module engages in a scene understanding and keyword detection function 15A and produces a new, generative asset in a calculation 87A and shows that asset on the display as modified display content 85A. In some embodiments, the AI module executes a correlation function 15B correlates the set of scenes understanding and keywords with an existing asset pool and executes another calculation 87B and chooses an optimized asset to show, which it does as a modified display content 85B.

FIG. 20E describes an embodiment in which collaborative users 2 lay out different ideas on a shared visual environment 2005A to identify emerging relationships or new combined ideas. In some embodiments, the shared visual environment is a digital whiteboard in a teleconferencing application. The AI module 18 captures the assets generated by the users either graphically through the shared visual environment, or voice or other user inputs via a user input 12, a generic sensor 13 or a webcam 14. The assets representing users' ideas in the shared visual environment 2005A can also be processed by a function 15, including object detection, segmentation, labelling. The output of function 15 is fed to AI module 18, which uses such information to further understand what users are trying to think about. The AI module 18 groups and generates further consolidated and substantiated ideas 2006A, 2006B, 2006C, 2006D, based on content in first shared visual environment 2005A and a remote source 6. The consolidated ideas and their emerging relations are shown to users 2 in a unified second shared visual environment 2005B for their revision and further iteration. In some embodiments, the second shared visual environment and the first shared visual environment are part of the same visual environment.

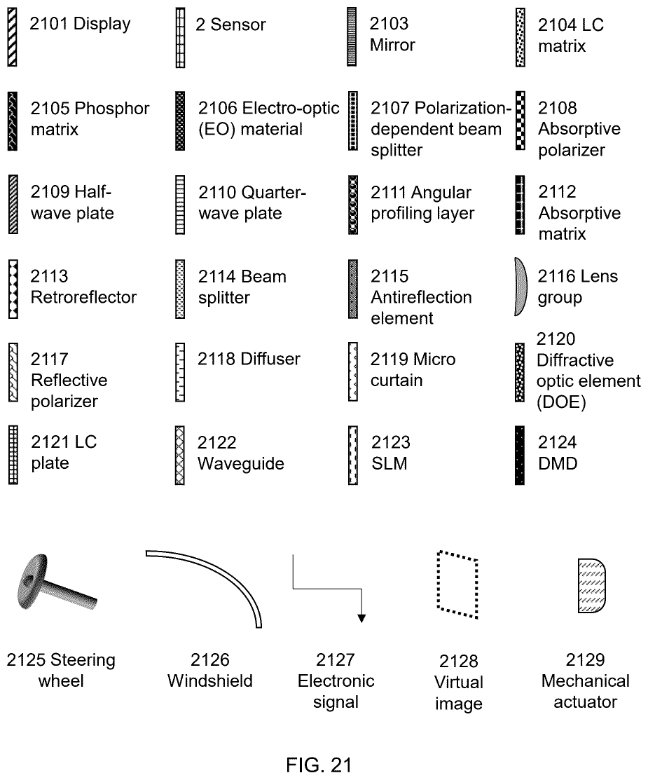

In some embodiments, an extended display system comprises a set of components. Further elements of the embodiments for this invention are shown in FIG. 21. The components can be engineered arbitrarily. These elements include hardware components used to produce extended display systems, main display subsystems, and extended display subsystems. A “main display part” or, equivalently, a “main display” or a “main display subsystem” is the physical embodiment of a main part of an extended display system. Similarly, an “extended display subsystem” or “extended display part” is the physical embodiment of the extended part. For example, a main display may be an LCD monitor, and the extended display subsystem/subsystem may be the display system described presently. In some embodiments, the main display part refers to a screen of a device, such as a laptop screen, cell phone screen, tablet screen, smart watch screen, any display screen or instrument cluster in a vehicle, a computer monitor screen, and the like.

Element 2101 is the schematic representation of a display. In some embodiments, the display is a volumetric display. In some embodiments the display is a backlight or broadband light source that is optically coupled to a modulation matrix.

Element 2 is the representation of a sensor, which can be an optical sensor, a camera sensor, an electronic sensor, or a motion sensor. In some embodiments, the sensor is an ambient-light sensor to measure the amount of ambient light present and output a corresponding electronic signal. An ambient light sensor may be a photodiode, a power meter, an imaging sensor, and the like. In some embodiments, user input or environmental input can be generated through a “sensor,” which receive information and produce a signal that can be input into a display system to impacts the display system's properties or content. Sensor includes those that use artificial intelligence (AI) mechanisms to interface with the display system directly or indirectly. Sensors include any type of camera, pressure or haptic sensors, sensors that detect health biological information about a person or the environments, clocks and other timing sensors, temperature sensors, audio sensors (including any type of microphone), chemical sensors, metrology sensors for scientific and engineering purposes, and the like.

Throughout this disclosure, the “imaging sensor” may use “arbitrary image sensing technologies” to capture light or a certain parameter of light that is exposed onto it. Examples of such arbitrary image sensing technologies include complementary-symmetry metal-oxide-semiconductor (CMOS), single photon avalanche diode (SPAD) array, charge-coupled Device (CCD), intensified charge-coupled device (ICCD), ultra-fast streak sensor, time-of-flight sensor (ToF), Schottky diodes, or any other light or electromagnetic sensing mechanism for shorter or longer wavelengths.

In any embodiment, any sensor can be used to provide information about a user, an environment, or other external conditions and scenarios to the display system. In some embodiments, for example, a camera is used to capture information about a user or a user's environment. Multiple cameras, or a camera array, or a camera system can be used. In some embodiments, depth cameras capture information about depth or sense gestures and poses, and they can be of any type. In this disclosure, a “depth camera,” “depth sensor,” or “RBGD camera” is an imaging device that records the distance between the camera and the distance to an object point. It can be actively illuminated or passively illuminated, and it can include multiple cameras. Light detection and ranging (LIDAR), and time-of-flight cameras are examples of active depth cameras. A depth camera can also use optical coherence tomography sensing (i.e., autocorrelation). It can use infrared (IR) illumination to extract depth from structure or shading. Depth cameras can incorporate gesture recognition or facial recognition features. Depth can also be estimated from conventional cameras or a plurality of conventional cameras through, for example, stereo imaging. The camera array or camera system can include any combination of these cameras.

A “gesture camera” is a camera that captures an image of a person and subsequently computationally infers gestures or poses that the person makes in the image. The gesture camera may comprise a conventional camera, a stereoscopic two-camera system or array of cameras, or a time-of-flight camera. In some embodiments machine learning is used to infer the gestures. In some embodiments, features are extracted from the image, such as object detection or image segmentation to assist in the gesture camera's function. In some embodiments, the physical gesture made by the person is compared to a library or a dictionary of gestures available to the computational module and software associated with the gesture camera. The library or dictionary is a dataset of labeled gestures that has been used to train the machine learning algorithm.

Element 2103 is a mirror, which can be a first-surface mirror, or second-surface mirror, or any reflective surface. Mirrors may be curved or flat. Generally, both mirrors and beam splitters, or semi-reflective elements, are used to direct light along a proscribed path in a display system. Both rely on specular reflection because their surfaces are smooth on the order of a wavelength. The term “specular reflector” therefore refers to both mirrors and beam splitters. The main difference is only the relative amount of light that is reflected. For example, with a perfect mirror, all the light is reflected, whereas in a standard beam splitter, about half the light is reflected. Though, a beam splitter may be designed to reflect other fractions of the light such as, for example, about 25% or 75%. The light that is reflected (reflectance) may vary by wavelength or polarization.

Element 2104 is a liquid-crystal (LC) matrix. This is an example of a modulation matrix and pixel. The pixels of the of the LC matrix modulate the polarization of the incident light, such that a polarizer converts the polarization changes to intensity changes to produce an image.

Element 2105 is a phosphor matrix, comprising at least one layer of phosphor material. In some embodiments, the phosphor materials are those used in current OLED devices. Some display devices are hybrid devices that combine fluorescent (dmac-dps, dmac-dmt for blue light) and phosphorescence (for red/yellow light). Some OLEDs use thermally active delated fluorescence.

Typically, phosphor materials are organometallic doped with iridium, platinum, or titanium. For example, Ir(ppy)3 contains iridium as the central metal atom and emits green light. Ir(piq)2(acac) is an iridium-based phosphorescent emitter, which emits deep blue light. Ir(MDQ)2(acac) is a blue-emitting phosphorescent material based on iridium. PtOEP: Platinum octaethylporphyrin is a phosphorescent material known for emitting red light. Ir(2-phq)3 is an iridium-based phosphorescent emitter that emits yellow light. FIrpic: is a blue-emitting phosphorescent material based on iridium and fluorine. PmIr is a phosphorescent material that emits blue light, composed of polymers with incorporated iridium complexes. PFO-DBTO2 is a blue-emitting phosphorescent material based on polyfluorene. Btp2Ir(acac) is a green-emitting phosphorescent material based on iridium. Ir(ppy)2(acac) is a green-emitting phosphorescent material containing iridium. DPVBi is an efficient blue phosphorescent emitter that is used to produce blue OLEDs. The yellow phosphorescent emitter is Ir(tptpy)2(acac).

Other phosphorescent materials use phosphorescent pigments that contain compounds like strontium aluminate, which is doped with rare earth elements like europium or dysprosium, for use in highlighters, emergency signs, and markings. Some glow-in-the-dark paints or dial indicators contain phosphorescent pigments based on zinc sulfide or strontium aluminate. Luminous elements on some watch and clock dials may consist of phosphorescent materials like tritium-based paints (though tritium is radioactive) or non-radioactive compounds like strontium aluminate.

Element 2106 is a generic electro-optic (EO) material. It can be an EO rotator such that by variation of a signal voltage, a linear polarization can be rotated to a desired angle.

Element 2107 is a polarization-dependent beam splitter (PBS). It reflects light of one polarization and transmits light of the orthogonal polarization. A PBS can be arbitrarily engineered and made using reflective polymer stacks, nanowire grids, or thin-film technologies. Other PBSs include PBS cubes.

Element 2108 is an absorptive polarizer such that one polarization of the light passes through, and the orthogonal polarization of light is absorbed. An “absorptive polarizer” is a polarizer that allows the light with polarization aligned with the pass angle of the polarizer to pass through and that absorbs the cross polarized light.

Element 2109 is a half-wave plate (HWP), which produces a relative phase shift of 180 degrees between perpendicular polarization components that propagate through it. For linearly polarized light, the effect is to rotate the polarization direction by an amount equal to twice the angle between the initial polarization direction and the axis of the waveplate. In some embodiments, horizontally polarized light is converted to vertically polarized light, and vice versa, after transmission through an HWP. Element 2110 is a quarter-wave plate (QWP), which produces a relative phase shift of 90 degrees between perpendicular polarization components that propagate through it. In some embodiments, it transforms linearly polarized light into circularly polarized light, and it transforms circularly polarized light into linearly polarized light.

Element 2111 is an angular profiling element. A directional film is an example of an angular profiling layer that allows the transmission of rays within a certain range of incident angles, whereas rays outside such a range of angles are blocked.

Element 2112 is an absorptive matrix, which is a modulation matrix that absorbs incident light with each portion of the absorptive matrix having a varying property of absorbance. In some embodiments, the portions of the absorptive matrix all have the same property of absorptance and therefore acts as an attenuator.

Element 2113 is a retroreflector, which is a mirror that reflects a light ray to reverse its direction. In some embodiments, a diverging spherical wave, or an expanding wavefront, is reflected by a retroreflector and forms a converging spherical wave. The retroreflector can be fabricated with microstructure such as microspheres or micro corner cubes or metasurfaces stacks, or it can be a nonlinear element. A phase conjugating mirror can act as a retroreflector.

Element 2114 is a beam splitter, which partially reflects and partially transmits light. The ratio of reflected light to transmitted light can be arbitrarily engineered. The transmission-to-reflection ratio may be 50:50. In some embodiments, the transmission-to-reflection ratio is 70:30. A “beam splitter” is a semi-reflective element that reflects a certain desired percentage of the intensity and transmits the rest of the intensity. The percentage can be dependent on the polarization. A simple example of a beam splitter is a glass slab with a semi-transparent silver coating or dielectric coating on it, such that it allows 50% of the light to pass through it and reflects the other 50%.

Element 2115 is an antireflection (AR) element that is designed to eliminate reflections of light incident on its surface. A microstructure such as a nano-cone layer may be an AR element. In some embodiments an AR element is a thin-film coating.

Element 2116 is a lens group, which consists of one or multiple lenses of arbitrary focal length, concavity, and orientation.

Element 2117 is a reflective polarizer, which reflects a specific polarization direction whereas allows the transmission of the perpendicular polarization respect the polarization direction being reflected. Throughout this disclosure, a “reflective polarizer” is a polarizer that allows the light that has its polarization aligned with the pass angle of the polarizer to transmit through the polarizer and that reflects the light that is cross polarized with its pass axis. A “wire grid polarizer” (a reflective polarizer made with nano wires aligned in parallel) is a non-limiting example of such a polarizer. Throughout this disclosure the “pass angle” of a polarizer is the angle at which the incident light normally incident to the surface of the polarizer can pass through the polarizer with maximum intensity. Two items that are “cross polarized,” are such that their polarization statuses or orientations are orthogonal to each other. For example, when two linear polarizers are cross polarized, their pass angles differ by 90 degrees.

Element 2118 is a diffuser, which serves to scatter light in a random or semi-random way. A diffuser can be a micro-beaded element/array or have another microstructure. Diffusers may reflect scattered light or transmit scattered light. The angular profile of the light may be arbitrarily engineered. In some embodiments, light scattered by a diffuser follows a Lambertian profile. In some embodiments, the light scattered forms a narrower profile.

Element 2119 is a micro-curtain that acts to redirect light into specified directions or to shield light from traveling in specified directions. A micro curtain can be made by embedding thin periodic absorptive layers in a polymer or glass substrate, or it can be made by fusing thin black coated glass and cutting cross-sectional slabs.

Element 2120 is a diffractive optical element (DOE), which has a structure to produce diffractive effects. The DOE can be of any material and may be arbitrary engineered. In some embodiments, a DOE is a Fresnel lens.

Element 2121 is a liquid crystal (LC) plate. In the “ON” state, the LC plate rotates the polarization of the light that passes through it. In the “OFF” state, the state of the light polarization is unchanged upon transmission through the layer. In some embodiments the LC is a nematic twisted crystal.

Element 2122 is a light waveguide. In some embodiments, a display is formed by optically coupling a light source, such as a backlight, to a waveguide. In some embodiments, the waveguide comprises multiple waveguides or is wavelength dependent.

Element 2123 is a spatial light modulator (SLM), which spatially modulates the amplitude or phase of light incident on it. An SLM may operate in reflection mode or transmission made, and it may be electrically addressable or optically addressable. In some embodiments, an SLM is used as a modulated matrix. Similarly, element 2124 is a digital micromirror device (DMD), which is an opto-electrical-mechanical mirror comprising mirror segments or pixels that each reflect light in a desired direction. Light incident on pixels corresponding to an image are directed in one direction, and unwanted light is directed into another direction. A DMD may be a modulation matrix.

Element 2125 is the steering wheel of a vehicle. The steering wheel may alternatively be a yoke and throttle, or other instrumentation to direct a vehicle. The vehicle may be of any type, including an automobile, an aircraft, a maritime vessel, a bus, and the like. Element 2126 is the windshield of a vehicle. In some aircraft vehicles, the aircraft canopy serves as the windshield. Element 2127 represents an electronic signal that is used in the electrical system that accompanies the display system to modulate the optical elements or provide feedback to a computer or computational module.

Element 2128 is a virtual image, which is the position at which a viewer will perceive an image created by the display systems disclosed herein.

Element 2129 is a mechanical actuator that can physically move the elements to which they are connected via an electrical or other types of signals.

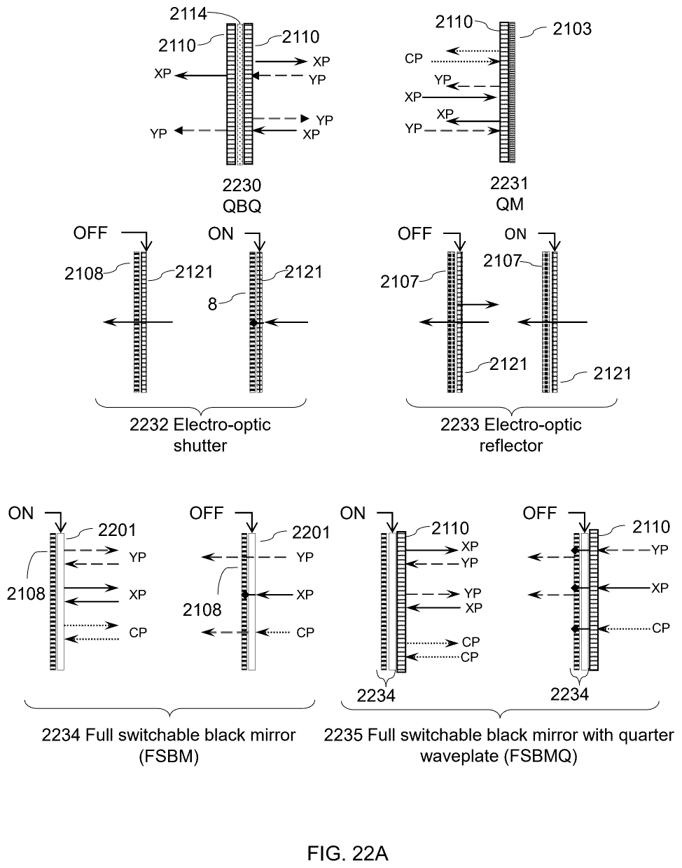

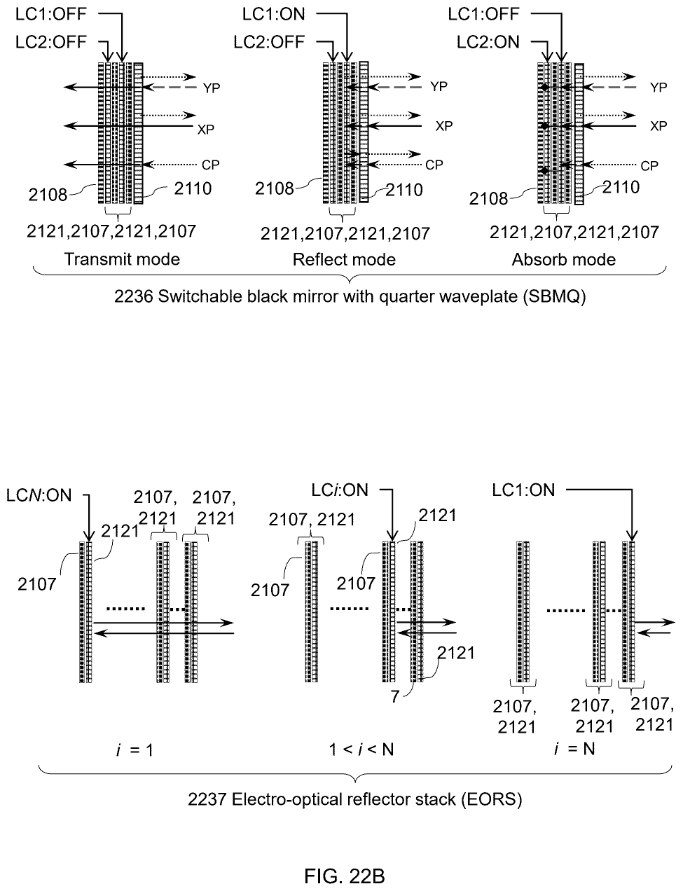

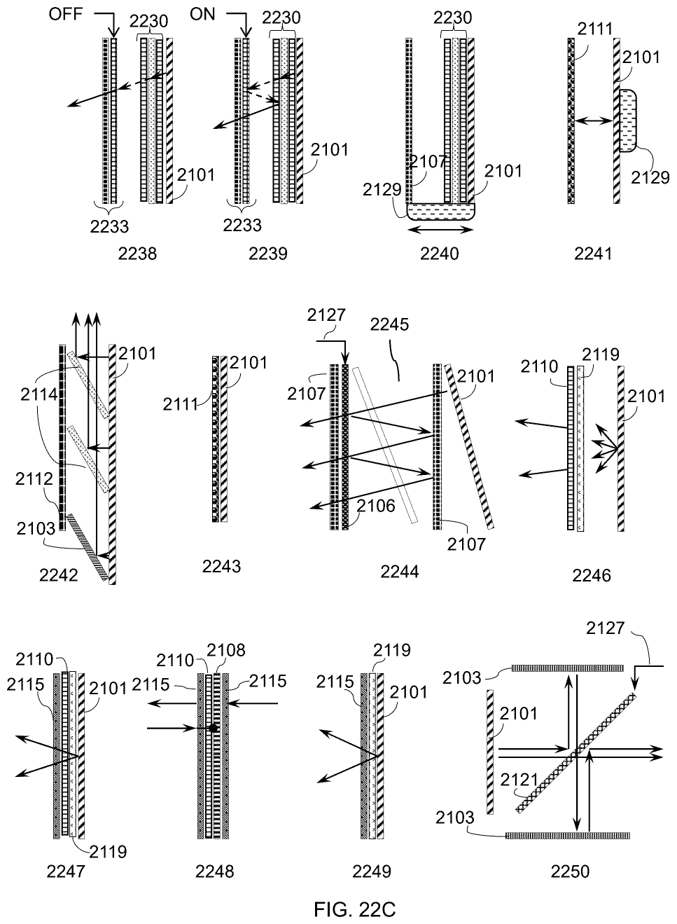

FIGS. 22A through 22C show how the basic elements in FIG. 21 can be combined to produce functional elements, architectures, subassemblies, or sub-systems. In some embodiments, these are integrated into a single, monolithic element, e.g., when a substrate is coated with various films or coatings. In some embodiments, they may be discrete components arranged with or without air gaps between them. In FIG. 22A, a QBQ 2230 comprises a QWP 2110, a beam splitter 2114, and another QWP 2110. Light incident on a QBQ is partially reflected and partially transmitted, and the QBQ acts as a HWP for both the reflected and transmitted portions, converting x-polarized light (XP) into y-polarized light and vice versa. In some embodiments the beam splitter is a PBS. A QM 2231 comprises a QWP 2110 and a mirror 2103. It reflects all light, and it converts x-polarized light into y-polarized light and vice versa (or, equivalently, horizontally polarized light into vertically polarized light). It does not change the polarization state of circularly polarized light.

An electro-optic shutter 2232 comprises an LC plate 2121 and an absorptive polarizer 2108. When the LC plate is ON, it rotates the polarized incident light such that it is aligned perpendicular to the absorptive polarizer and is absorbed by it. When the LC plate is OFF, it leaves the polarization unchanged and parallel to the absorptive polarizer which transmits it. An electro-optic reflector 2233 comprises an LC plate 2121 and a PBS 2107. When the LC plate is ON, it rotates the polarization such that it aligned along the transmit orientation of the PBS. When the LC layer is OFF, the light passing through it is aligned such that the PBS reflects it.

A fully switchable black mirror (FSBM) 2234 comprises an absorptive polarizer 2108 and a full switchable mirror 201, which may be an EO material. In the ON state, the full switchable mirror 201 is on and reflects light of all polarizations. In the OFF state, the switchable mirror transmits the light, and an absorptive polarizer 2108 extinguishes x-polarized light, transmits y-polarized light, and transmits only the y-component of circularly polarized light. A full switchable black mirror with quarter waveplate (FSMBQ) 2235 comprises an FSBM 2234 and a QWP 2110. In the ON state, it reflects all light and interchanges x-polarized with y-polarized light (and vice versa). It reflects circularly polarized light without changing the polarization. In the OFF state it extinguishes circularly polarized light, transmits y-polarized light, and coverts x-polarized light into y-polarized light and transmits the result.

FIG. 22B shows two switchable reflective stacks. A switchable black mirror with quarter waveplate (SBMQ) 2236 comprises a QWP 10, followed by two alternating layers of LC plates 2121 and PBSs 2107, and finally one absorptive polarizer 2108. The difference between the FSBMQ and the SBMQ is their corresponding polarization dependence. In the former the total reflectivity of the material is changing, agnostic to the polarization of the incident light, whereas the latter element produced a polarization-dependent reflectivity. For the SBMQ 2236, when both LC plates are OFF (“transmit mode”), all incident polarizations transmit an x-polarized component; incident linear polarization reflect circular polarization. Incident circular polarization reflects light that depends on whether it is right- or left-circularly polarized. When the first LC plate is ON and the second OFF (reflect mode), all light is reflected as circularly polarized. When the plate LC plate is OFF and the second LC is ON (absorb mode), incident light that strikes the absorptive layer and is extinguished, and no light is transmitted through the layers.

An electro-optical reflector stack (EORS) 2237 comprises a stack of N alternating PBS 2107 and LC plates 2121. All but one LC plate is in the OFF state, and the LC plate that is in the ON state reflects the incident x-polarized light. All other layers transmit light. By varying which LC layer is in the ON state, the EORS modulates the optical depth or optical path or the length that the light must travel through the stack before it is reflected by a cross-polarized PBS layer next to the ON LC layer. In some embodiments the LC plates and PBSs are configured to reflect y-polarized light.

Shown in FIG. 22C are further combinations of elements. In some embodiments, these form a variety of field evolving cavities (FEC) or layer stacks that can be used as subsystems for architectures explained throughout the disclosure. 2238 and 2239 are OFF and ON states, respectively, of a display 2101 and QBQ 2230 followed by an electro-optic reflector 2233. In the OFF state, the light directly exits the device to be viewed by an observer. In the ON state, the light is forced to travel one round trip in the cavity, and the displayed image appears to be deeper compared to the actual location of the display. In some embodiments, the monocular depth of the resulting image is approximately twice as far as that of the display itself. 2240 is a display 2101 followed by a QBQ 2230 and a PBS 2107 set on a mechanical actuator 2129. The actuator shifts the set of layers to create longer or shorter optical path lengths for the light and hence shorter or longer monocular depths. 2241 is a mechanical actuator 2129 fixed to display 2101. The actuator can shift the display relative to an angular profiling element 2111 to force the light to change directionality or to become collimated. In some embodiments, the angular profiling layer is a lenslet array such that the mechanical movement of the display changes the object distance and therefore impacts the collimation. In some embodiments, the display is “macro-formed,” meaning it may have mechanical waves or bends induced onto it by the mechanical actuators so that the directionality or collimation of the light that comes out of the angular lenslet array is impacted in a desired way. In some embodiments other elements, such as a beam splitter or mirror, are macro-formed.

In some embodiments, the display is mechanically shifting, because of the actuator's motion along a translational axis, again to impact the directionality of the exit light from the apertures. The mechanical actuation mechanism may be arbitrarily engineered. In some embodiments, the mechanical actuator is an array of ultrasonic transducers; in some embodiments, the mechanical translation is performed by a high rotation-per-minute brushless motor; in some embodiments, the mechanical movements are delivered via a piezo- or stepper motor-based mechanism.

An example of one type of FEC 2242 consists of display 2101 that is partitioned into segments, i.e., a segmented display. Light from the bottom segment is reflected by a mirror 2103, and light from the upper segments is reflected by subsequent beam splitters 2114. An absorptive matrix 12 absorbs unwanted stray light. In some embodiments the absorptive matrix is a uniform attenuator to substantially absorb all the light incident on it uniformly across its surface. This is an example of an off-axis FEC. In some embodiments, the FEC produces a multifocal image. The FEC can be arbitrarily engineered to represent the desired number of focal planes.

2243 consists of display 2101 layer followed immediately by an angular profiling element 2111, which may be a directional film here. The angular profiling layer might be a lenticular lens array to provide stereopsis to the viewer, or it might be a lenslet array or any other angular profiling layer to provide autostereoscopic 3D or provide different images to different angles.

An example of a tilted FEC 2244 is an angled display 2101, followed by a FEC comprising an “internal polarization clock” whose ends are composed of PBSs 2107. In between the PBSs 2107 is an EO material 2106 that acts as a polarization rotator and a birefringent element (which is a material whose refractive index depend on direction of travel and/or polarization, i.e., an anisotropic material) 2245, such that different angles of propagation result in different phase retardation of polarization. Another EO material 2106 acts as shutter element that uses an electronic signal 2127 that turns the light into a desired polarization so that only one of the round trips are allowed to exit the cavity, and the transmitted light has traveled a desired optical path or depth. This is a representation of a coaxial FEC with polarization clocks and segmented gated apertures with desired gating mechanisms. In some embodiments, each of these elements is segmented, such that light from different portions of a segmented display travel different distances.

2246 is a display 2101 followed by a micro-curtain 2119 and a QWP 2110 to function as pre-cavity optics. This allows desired profiling of the light of the display. The pre-cavity optics can adjust the polarization, angular distribution, or other properties of the light entering the cavity. 2247 shows a stack of elements: a display 2101, a QWP 2110, a micro-curtain layer 2119, and an antireflection element 2115. This subsystem is used in many disclosed systems and is categorized as a display. The micro curtain can be arbitrarily engineered, and it allows for control of the directionality of the light and the visibility of the display. The AR layer allows for reduction of ambient or internal reflections of the systems that use this subcomponent. In some embodiments, the AR element is a coating on substrate.

Subassembly 2248 is a sub-assembly consisting of an AR element 15 and an absorptive polarizer 2108 on one side facing a viewer and outside world, and a QWP 2110 another optional AR element 2115 or film on the side that faces the display from which light exits. In some embodiments, the AR element is a coating on substrate. In this disclosure, 2248 is an example of image aperture optic called an ambient light suppressor. In some embodiments, the ambient light suppressor is the final set of optical elements that the light experiences before exiting the display system. In some embodiments, the ambient light suppressor further comprises a directional film or angular profiling layer to produce angular profiling of the light exiting the system. Subassembly 2249 is a subassembly of a display with micro curtain layer and an AR element 2115 on top.

An example of an off-axis, or non-coaxial FEC 2250 is a sub-assembly consisting of two mirrors 2103 on the top and bottom, a display 2101 at the back, and an angled PBS 2107 with LC plate 2121 in the middle such that the electronic signal 2127 to the LC can change the length that the light must travel before it exits the cavity. In some embodiments, a stack of such angled PBS-on-LC splitters such that the length of the light travel can be programmed or controlled in multiple steps. In some embodiments, the mirror is a QM to rotate the polarization of the light.

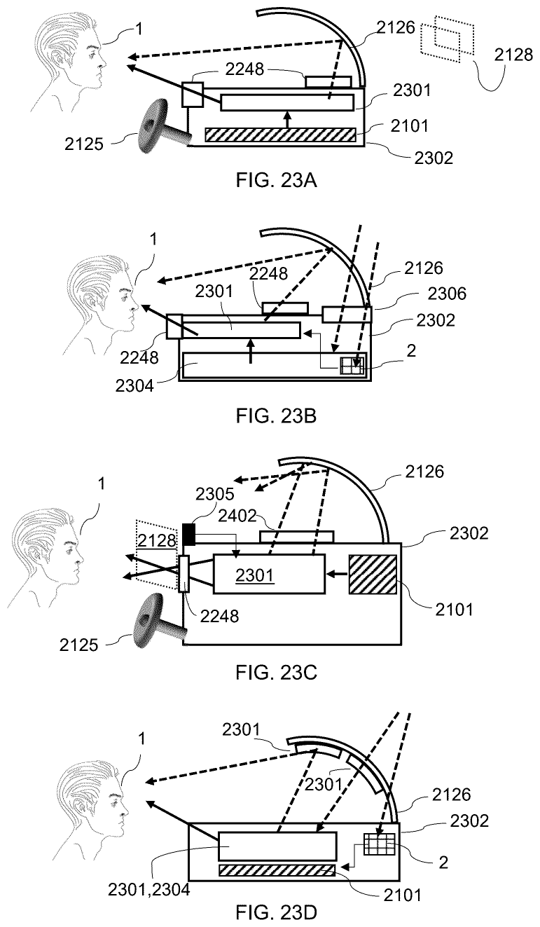

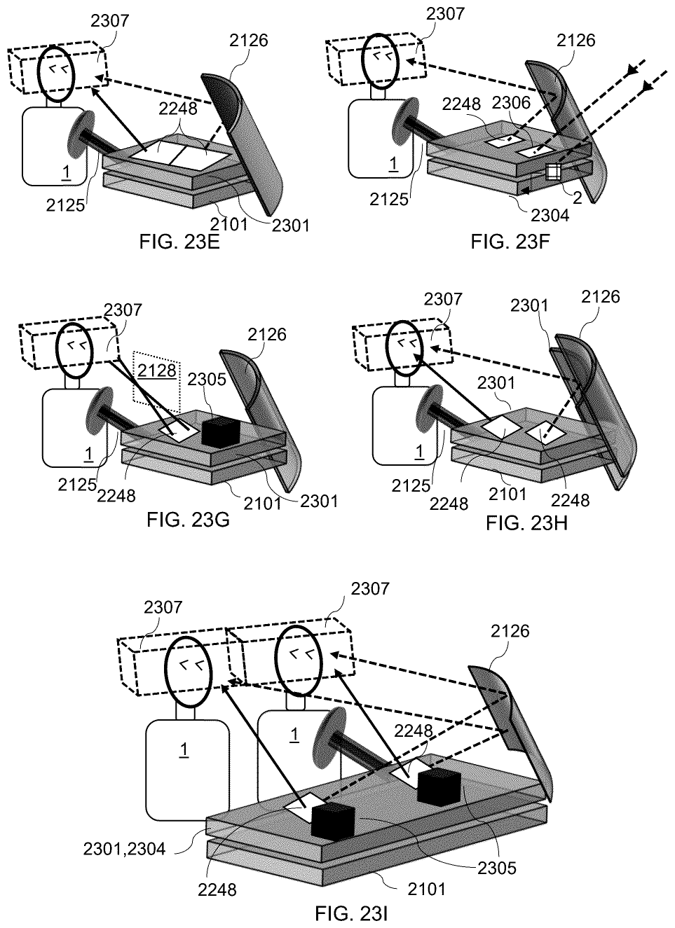

FIGS. 23A through 23D illustrate side views of the embodiments for multipurpose in-vehicle display systems that use either backlighting sources or ambient-light sources. In FIG. 23A is shown an example of a “dual-purpose in-vehicle display,” for which two sets of images are visible simultaneously by a viewer. A display 2101, which is a segmented display in some embodiments, emits light into an optical system 2301, both of which are contained in housing 2302. In some embodiments, the optical system comprises an FEC, and the FEC is of the architecture of those in FIG. 22C. The optical system modulates the light, including its optical path, and sends some of the light directly to a viewer 1 after passing through an ambient light suppressor 2248. Some of the light, before being sent to the viewer, exits the system through an image aperture or ambient light suppressor 2248, is reflected by the vehicle's windshield 2126, and then subsequently travels to the viewer to form a second virtual image for the viewer, who sees both the first and the second virtual images simultaneously. The viewer may be a driver behind a steering wheel 2125. In some embodiments, the viewer is another passenger or multiple passengers. In some embodiments either the first or the second virtual image are multifocal images. In some embodiments, the monocular depth of the first image differs from that of the second image.

FIG. 23B is an example of an “in-vehicle sunlight-activated display system,” for which ambient light external to the display system serves as the light source for producing images. In such a display, ambient light from outside the vehicle enters the vehicle. In some embodiments, the ambient light enters the vehicle through the windshield 2126 from the external environment. Some of the light may be sensed by a sensor 2, configured to produce an electrical signal based on the amount of light detected. The light then enters a sunlight modulating panel 2304 where it is prepared to enter an optical system 2301 to form an image that is directed to a viewer 1. In some embodiments the sunlight modulating panel and the optical system form a single display system. The sunlight modulating panel contains a modulation matrix to imprint image content onto the ambient light. In some embodiments the sunlight modulating pane comprises only the modulation matrix. In some embodiments some of the light forms an image corresponding to an instrument cluster. In some embodiments, the virtual images may form port of an entertainment system for a non-driving passenger of the vehicle. In some embodiments, at least a portion of the light exits the optical system 2301 past the housing 2302 and is reflected by a windshield to produce a HUD image for the viewer, i.e., some embodiments use the ambient light instead of the display in the embodiment of FIG. 23A. The light exiting the system passes through image apertures, liked ambient light suppressors 2248.

The ambient light sensor may control the optical system at least in part. In some embodiments, if the detected light is too low, or dim, the ambient light sensor controls and turns on a back-up display to produce the desired imagery instead of the ambient light. This occurs, for example, at night or in dark environmental settings. The ambient light may be sunlight entering the vehicle directly or indirectly. In some embodiments, the ambient light for the sunlight-activated display comes from other sources external to the vehicle.

FIG. 23C is an embodiment of a multipurpose display system that produces virtual images whose monocular depth is closer to a viewer than the physical components of the display system itself. Such images first must form a real image. Light from a display 2101 enters an optical system 2301 in a housing 2302. The optical system then prepares images and sends some of the light through an ambient light suppressor 2248 forming a real image after exiting. A viewer then perceives an image at the location of the real image, closer than the ambient light suppressor, i.e., the monocular depth of the image will be shorter than the viewer's distance to the display system. Because the virtual image is first formed as a real image and will appear to the viewer as floating, or hovering, in front of the display panel, such an image is called a “hovering real image.”

A gesture camera 2305 may be used to capture and recognize gestures made by the viewer. The information is then sent to the optical system to modify the image. In some embodiments, the camera can control other systems of the car, such as the electrical system, audio system, mechanical system, or sensor system. In some embodiments, the light is reflected from a windshield 2126 after exiting the system through an exit aperture 2402 to produce a virtual image that is perceived as being located inside the vehicle, rather than outside. The viewer is a driver behind a steering wheel 2125 in some embodiments—in which case the images may correspond to instrument cluster information.

FIG. 23D shows an embodiment in which parts of the optical system 2301 are embedded into or layered on top of the windshield 2126. In some embodiments, the optical systems integrated into the windshield comprise DOEs, anti-reflection coatings, or other directional or angular profiling layers, to collect more light for the ambient light displays of FIG. 23B. In some embodiments, the optical systems integrated in the windshield occur after light from a display 2101 enters a primary optical system 2301 in a housing 2302 and exits toward the optical system in the windshield. In this case, for example, the windshield-integrated optical system further impacts the resulting HUD image that a viewer 1 sees. In some embodiments, an ambient light sensor is used to signal to the display system whether to use a display, the ambient light source, or a combination thereof.

FIGS. 23E through 23H show perspective views of the display system embodiments described in FIGS. 23A through 23D. FIG. 23E shows a perspective view of FIG. 23A. Light from display 2101 enters an optical system 2301 and is prepared and formed into a virtual image. The light exits through an ambient light suppressor 2248. A portion of that light is then reflected by the windshield 2126 to the viewer 1, who sees a virtual image, like that formed by a HUD. Some light also passes directly to the viewer without interacting with the windshield at all to produce a second virtual image. The images are simultaneously visible to the viewer anywhere in a headbox space 2307. The viewer may be a driver behind a steering wheel 2125—in which case the images may include instrument-cluster information.

FIG. 23F shows a perspective view of FIG. 23B for a sunlight-activated display. External, or ambient light, for example sunlight, enters from the outside of the vehicle through the windshield 2126. In some embodiments this light is direct sunlight, and in some embodiments, it is diffused or reflected sunlight. The light enters through entrance aperture optics 2306. Some of the light may optionally be captured by a sensor 2 that measures the amount of light power entering the vehicle or the temporal or spatial variability of the light. Light also enters the sunlight modulating panel 2304 which prepares the light as it enters the optical system 2301. Inside either the sunlight-activated panel or the optical system is a modulation matrix to imprint a virtual image onto the light, which then exits the system through an ambient light suppressor 2248. Some light is visible directly by a viewer 1. In some embodiments, some of the light is first reflected by the windshield 2126 before being visible. The images are viewable in a headbox space 2307. The viewer may be a driver.

FIG. 23G is a perspective view of FIG. 23C. Light from display 2101 enters optical system 2301, where it is prepared as an image. The light exits through an ambient light suppressor 2248 and forms a real image. When the viewer 1 views the image within the headbox 2307, he sees a virtual image 2128 whose monocular depth is closer compared to the distance to the actual optical system, including the ambient light suppressor. The image is closer to the viewer than the display system; it is a hovering real image. A gesture camera 2305 captures information about the gestures of the person and uses that information to modify the image or impact a property of the vehicle.

FIG. 23H is a perspective view of FIG. 23D. A display 2101 emits light into an optical system 2301. Some of the light may exit an ambient light suppressor 2248 and be directly visible by a viewer 1 within a headbox space 307 as a first virtual image. Some of the light may exit a second ambient light suppressor 2248 and become incident on a second optical system 2301 that is integrated into the windshield itself 2126. This windshield-integrated system may consist of, for example, directional films, DOEs, waveguides, or polarization-dependent elements. The light is then viewed as a second virtual image by the viewer simultaneously with the first virtual image.

FIG. 23I depicts a perspective view of multiple passengers in the vehicle. The light from display 2101 enters an optical system or, if entering the vehicle from the environment, a sunlight modulating panel 2304 to create virtual images after exiting through ambient light suppressors 2248. The viewers 1 can see these images within headboxes. The headbox 2307 of each viewer may in fact be a single continuous volume, such that both viewers see all virtual images simultaneously. Some of the light may be reflected by the windshield before being visible. Gesture cameras 2305 may capture viewers' gestures to impact the vehicle or the images.

All embodiments in this disclosure may use computational methods for distortion compensation, e.g., they may have distortion-compensating elements or computational measures.

The embodiments described herein have utility for in-vehicle integration as display systems that do not require the viewer to wear a headset. Further, the virtual images formed by the display systems are visible by both eyes simultaneously, such that they are visible in a headbox that is wider than the average interpupillary distance, i.e., the distance between the two eyes. In some embodiments, the headbox spans a lateral dimension of 10 cm or more. Further, in some embodiments, the image apertures through which the light rays leave to form virtual images are also wider than the interpupillary distance. In some embodiments, the image apertures span a lateral dimension of 10 cm. In some embodiments they span a lateral dimension of 15 cm.

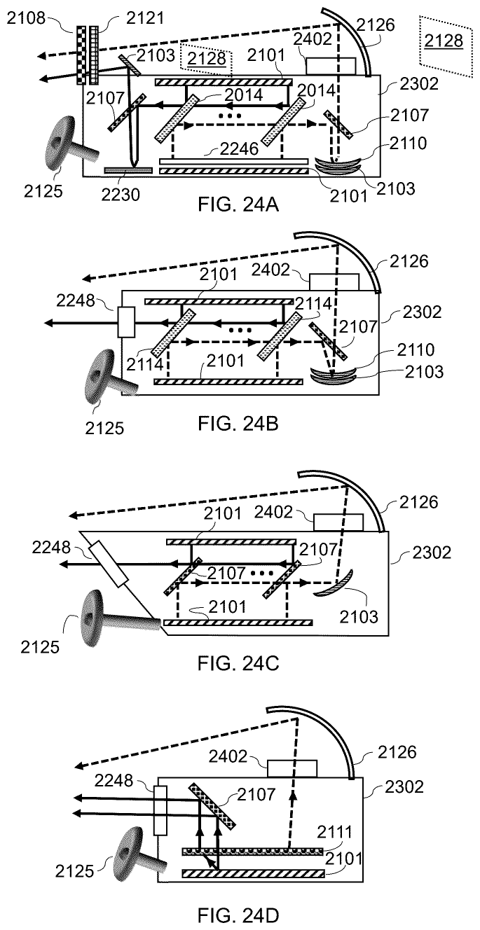

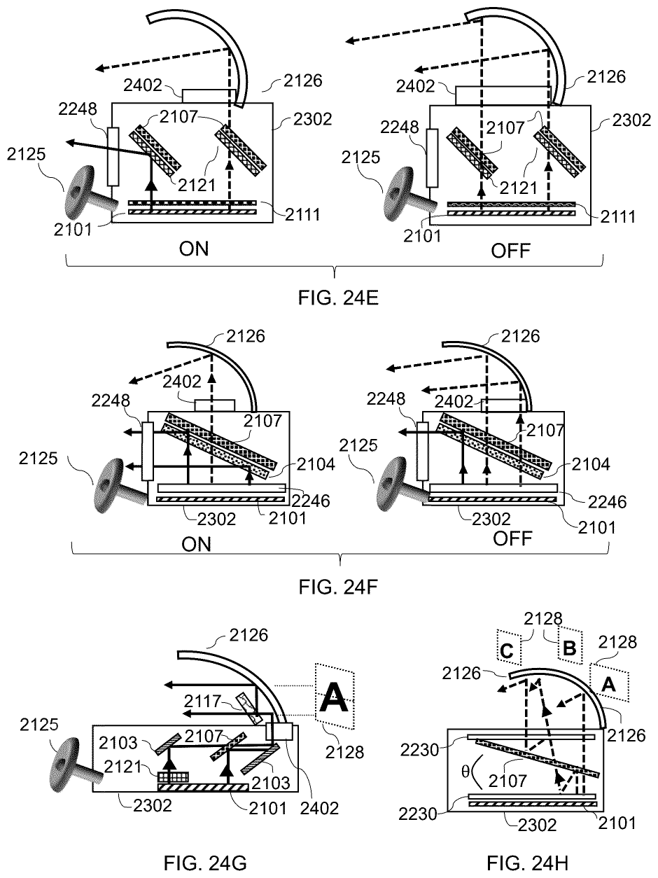

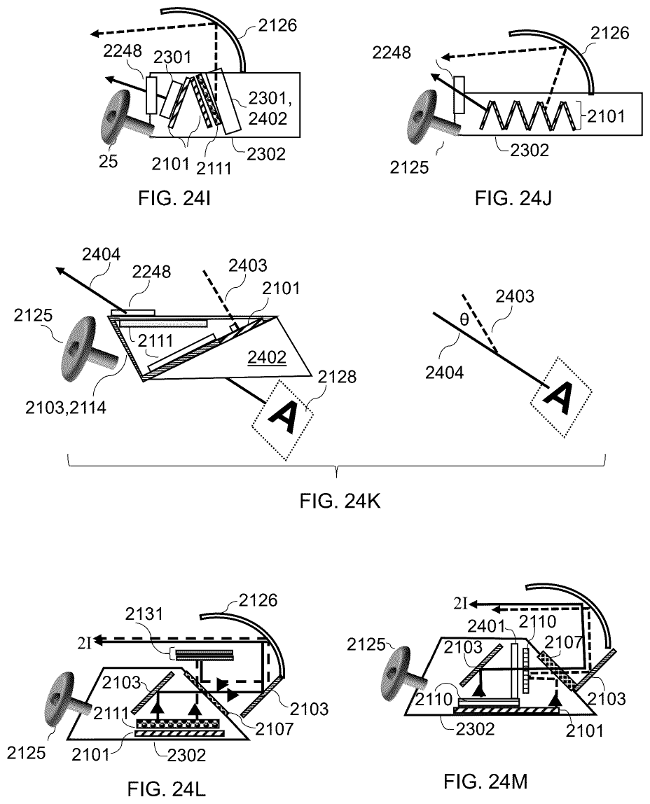

FIGS. 24A through 24M depict a set of embodiments for a multipurpose display system for a vehicle. In FIG. 24A a housing 2302 contains a display 2101 or a plurality of them. In some embodiments, the displays are segmented displays, for which each display shows a plurality of display content. In some embodiments the light from the display is impacted by pre-cavity optics 2246. The top display emits light that is reflected by a set of beam splitters 2114. The light travels to the left and is reflected by a PBS 2107, which directs the light downward to a QM 2230. The QM reflects the light and rotates the polarization such that it is transmitted by the PBS 2107 and then directed to a mirror 2103 to a viewer. A second display at the bottom of housing 2302 emits light vertically upward. The light is then reflected by each of the beam splitters 2114. The light is then reflected by another PBS 2107, through a QWP 2110, reflected by a mirror 2103, and back through the QWP 2110 (the QWP-mirror-QWP reflection is identical to a QM). In some embodiments, the mirror is curved whereas in some other embodiments, the mirror is flat. After doubly traveling through the QWP, the light polarization is rotated by ninety degrees, passes through the PBS 2107, through a generic image aperture 2402, and then is reflected by the windshield 2126 to produce a virtual image, such as a HUD image.

In some embodiments, the number of segments of the segmented display equals the number of focal planes at which virtual images are seen. In some embodiments, each display produces three virtual images at three different focal planes. In some embodiments, two such displays together produce a 3-focal-plane multifocal image for an instrument cluster and simultaneously a 3-focal-plane multifocal virtual image reflected from the windshield. In some embodiments, the mirror 2103 closest to the steering wheel is instead a transparent or dimmable liquid crystal layer. In some embodiments both sets of virtual images pass through both a dimmable LC layer 2121 and absorptive polarizer 2108 to produce a dimmable (semi-) transparent display. In some embodiments, the beam splitters inside the display system are polarization dependent beam splitters.

In the embodiment in FIG. 24B, a housing 2302 contains displays and optical components. A bottom display 2101 emits light upward toward a set of beam splitters 2114 that direct the light rightward, where it is reflected by a PBS through a QWP 2110, then reflected by a mirror 2103, and travels back through the QWP 2110, after which its polarization is rotated by ninety degrees. The light that passes through the PBS 2107, through a generic image aperture 2402, and is reflected by the windshield to create a virtual image, such as a HUD image. The image aperture may be an ambient light suppressor. A second display 2101 emits light downward to the beam splitters 2114, which reflect the light leftward. The light then exits the system through an ambient light suppressor 2248 to be viewed by, e.g., a driver behind a steering wheel 2125, simultaneously with the HUD image. Ambient light suppressor may contain AR elements, a polarizer, and a QWP, as in FIG. 22C.

In FIG. 24C, a first display panel 2101 in a housing 2302 emits light upward to a set of PBSs 2107 which direct the light rightward to a mirror. In some embodiments the mirror is curved; in some embodiments the mirror is flat. The light then passes through an exit aperture 2402 is reflected by the windshield and produces a HUD image for a viewer, e.g., a driver behind a steering wheel 2125. A second display 2101 emits light downward, and the set of PBS 2107 elements reflect the light leftward. Then it travels through an ambient light suppressor 2248, after which a viewer views it as a virtual image. In this embodiment, the ambient light suppressor is angled such that a line perpendicular to its surface is not along an optic axis of the system.

The embodiment in FIG. 24D has a housing 2302 that contains a display 2101 that emits light. The display light is segmented, such that one portion shows display content corresponding to a HUD image, and another portion is directly viewed without the light being reflected by the windshield after exiting the system through an exit aperture 2402. The light travels through an angular profiling element 2111, which may be a directional film, to reduce stray light or redirect light in a desired direction. One of the display contents is then reflected by the windshield 2126 to produce a virtual image, such as a HUD image. A second display content is reflected by a reflector, which is a PBS 2107 in some embodiments, and exits through an ambient light suppressor 2248 to form a virtual image. Both images are simultaneously viewable.

FIG. 24E is an embodiment in which the display system contains electrically switchable components to produce variable images. For example, a display 2101 emits light through an angular profiling element 2111, which may be a directional film. The display is a segmented display. One portion of light strikes an LC plate 2121 that is ON. The result is polarized light that is reflected by a PBS 2107, through an ambient light suppressor 2248 to produce an image, such as an instrument cluster behind a steering wheel 2125. A second part strikes a second LC plate 2121, which may be OFF, but the subsequent PBS 2107 is oriented such that it transmits the light, which is then reflected by a windshield 2126 to produce a second image. In the OFF state of the first LC layer 2121, the first portion of light has its polarization rotated such that both portions of light are incident on the windshield 2126 to produce two HUD images after traveling through an exit aperture 2402. In some embodiments, the HUD images are a single continuous image. The number of portions and switchable elements is arbitrary. For a display with N segments, there are 2^{N} possible image configurations. In some embodiments, there are multiple displays, each being a segmented display with one or more display contents.

FIG. 24F shows a similar embodiment as that in FIG. 4E. In this case, the switchable element is an LC matrix 2104. In some embodiments, the pixelation of this matrix corresponds to the segmented size of the display, i.e., to the number of display images shown on display 2101, which is a segmented display. In some embodiments, the light passes through pre-cavity optics 2246. As the light travels through the liquid crystal matrix, various portions may be ON to impact the polarization, such that two portions of the segmented display are reflected by the PBS 2107, travel through an ambient light suppressor 2248, to be visible as virtual image (which may be a multifocal image). One segment may be configured to travel through the PBS 2107, through an exit aperture 2402, be reflected by the windshield 2126 and create a HUD mage. In the OFF configuration, only one segment travels through the ambient light suppressor, and two segments travel through the PBS to be reflected by the windshield.

In FIG. 24G, a housing 2302 contains a display 2101, which may be a segmented display. The first portion travels through LC plate 2121. In some embodiments, this is replaced by a wave plate, such as a HWP. The light then is reflected by a mirror 2103, transmitted by a PBS 2107, and reflected by a second mirror 2103. The second portion of the display emits light that does not travel through an LC plate or wave plate, so its polarization differs from that of the first portion. Then, the light is reflected by the PBS 2107 and subsequently by the second mirror 2103. Then, both portions of light are reflected by the windshield for a first time, after which they are incident on a reflective polarizer 2117. This polarizer is oriented such that it passes the first portion of light and reflects the second portion, the second portion passing through an exit aperture 2402 then being reflected a second time by the windshield 2126 before heading to a viewer. The first portion and the second portion therefore travel the same optical distance, and their images have the same monocular depth, but they are now shifted transverse to their propagation direction. The reflections and geometry are arranged such that the two portions form one continuous virtual image at a single monocular depth, the size of the image larger than each portion individually. The result is that the virtual image 2128 image size (its transverse area) is larger than the size (transverse area) of the exit aperture 2402. In some embodiments at the exit aperture is located an ambient-light suppressor. In some embodiments, the two portions travel through an ambient light suppressor without interacting with a windshield, such that the resulting image is larger than the ambient light suppressor.

FIG. 24H shows an embodiment in which a display 2101 emits light through a QBQ 2230. The light that is transmitted through it is polarized perpendicular to the light that enters it. The QBQ is segmented and electrically addressable, such that the polarization change of different portions is modifiable independent of the others. This is produced, for example, but having two LC matrices sandwiching a beam splitter. The result is that different portions of the display light have different polarizations programmed into them. The light then subsequently strikes a PBS 2107, that is angled relative to the display, such that the surface of the PBS and the surface of the display form an angle θ. In some embodiments, 0 is an acute angle. Because different portions of light are polarized differently, some of the light is reflected by the PBS and some is transmitted. The light that is transmitted strikes a second QBQ 2230, which is also segmented and electrically addressable. Some of the light passes through it and is reflected by a windshield 2126. Light that is reflected, either by the PBS before passing through it or by the second QBQ, can experience further polarization changes and reflections, depending on how the QBQs are addressed. After multiple reflections, light that is transmitted to the windshield is shifted by an amount that depends on the number of reflections. Thus, multiple disjoint HUD images are visible, and the size and spacing of these images is programmable by the electrically addressable QBQs. Similarly, the angle at which light exits the display system also depends on how the QBQs are addressed. Light may exit in the same direction as that emitted by the display or at an angle different from the display light.

In any embodiment the monocular depth at which the image is perceived may be modified by inserting a slab of a refractive index n. In embodiments in which different virtual images are produced by different polarizations, the slab may be an anisotropic material, such as a uniaxial crystal or a biaxial crystal, to modify the polarizations differently. An anisotropic LC may be used to electrically modulate the index and consequently the monocular depth.

FIG. 24I shows an embodiment in which two displays 2101 are each angled and positioned within a housing 2302. One of them sends light through an optical system 2301, which impacts the profile and monocular depth, and then sends the light through an ambient light suppressor 2248, this first image visible by a viewer, for example, the driver behind a steering wheel 2125. The second display 2101 emits light through a directional filmi 2111 then through an optical system 2301, and an exit aperture 2402. Iin some embodiments the exit aperture comprises an ambient light suppressor. The light is subsequently reflected by a windshield 2126 to produce a virtual image, such as a HUD image, simultaneously visible with the first image. In some embodiments, the images are pre-compensated to account for the angular variation of the displays or the windshield.

FIG. 24J generalizes the embodiment of FIG. 24I Multiple displays 2101, or a single flexible display, are oriented so that one subset emits light through an ambient light suppressor 2248 for a first (set of) virtual image(s), and a second subset emits light toward the windshield 2126 to produce a second (set of) virtual image(s). In some embodiments, the displays are segmented displays. In some embodiments, the display shows content that is precomputed for distortion compensation. In some embodiments, either of the virtual images are multifocal images.

FIG. 24K shows an embodiment in which display 2101 is tilted such that a chief ray 2403 it emits points at an angle relative to the horizontal. In this embodiment this chief ray coincides with the line that is normal (perpendicular) to the display surface. The light enters a cavity comprising mirrors 2103 and/or beam splitters 2114 (i.e., semi-reflective) surfaces. Optional directional films 2111 and angular profiling layers may be used to impact the angular profile of the light. As the light is reflected within this cavity, its optical path increases and its direction changes. Upon exiting through an ambient light suppressor 2248, the chief ray of the virtual image 2404 is directed along a certain angle. This direction is perpendicular to the focal plane of the image. A viewer, for example, a driver behind a steering wheel 2125, sees a virtual image 2128. The optical path traveled by the image light equals the monocular depth of the image as perceived by the viewer. Because of the angular variation, the chief ray of the virtual image 2404 and the chief ray of the display 2403 from an angle θ, which is acute in some embodiments.

The embodiment of FIG. 24K may be integrated into other portions of a vehicle. For example, in some embodiments, it replaces a rearview mirror. In some embodiments, the display content is captured from a camera that is fixed to an external part of the vehicle, and the camera captures visual information about the environment behind the vehicle. The display panel subsequently shows the visual information. In some embodiments, the display system is integrated into the roof of a car and is configured for passenger entertainment.

FIG. 24L shows an embodiment that starts with housing 2302 containing display 2101, which may be a segmented display. The display emits light through a directional film. The display is segmented, and the first portion travels through a mirror 2103 and through a PBS 2107. The second segment travels upward through the PBS 2107, then is reflected and rotated in polarization by a QM 2231. The light, with its polarization rotated by 90 degrees, is reflected by the PBS 2107. Both portions of light subsequently overlap, are reflected by a second mirror 2103 and by the windshield 2126 to form a virtual image. If the two portions show identical content, then the intensity, or brightness, of the image is approximately doubled. It may increase by less than a factor of two based on any imperfections in the optical components. Further, both portions travel the same optical distance, so that the two portions also correspond to the same monocular depth or focal plane.

FIG. 24M shows an embodiment like that in FIG. 4L. Light from display 2101 is segmented. The first portion travels through a QWP 2110 to convert it to circular polarization. It is reflected by a mirror 2103 and passes through a circular polarizer (CP) 2401, then through a second QWP 2110 after which it is linearly polarized and passes through a PBS 2107. The PBS first reflects a second portion of light, passes through the QWP, is reflected by the CP 2401, passes again through the QWP 2110, and is then polarized to pass through the PBS, and be reflected by the mirror second mirror 2103. Here, both portions of light overlap and have traveled the same distance. They may show the same content, and so effective brightness is about a factor of 2 greater than either portion individually. The light is then reflected by the windshield and generates virtual images.

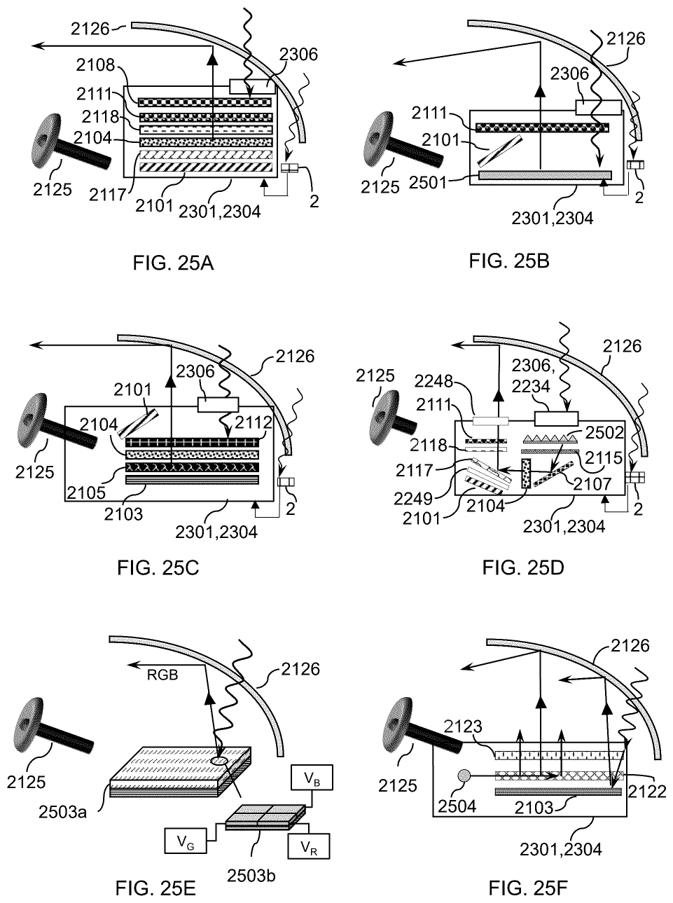

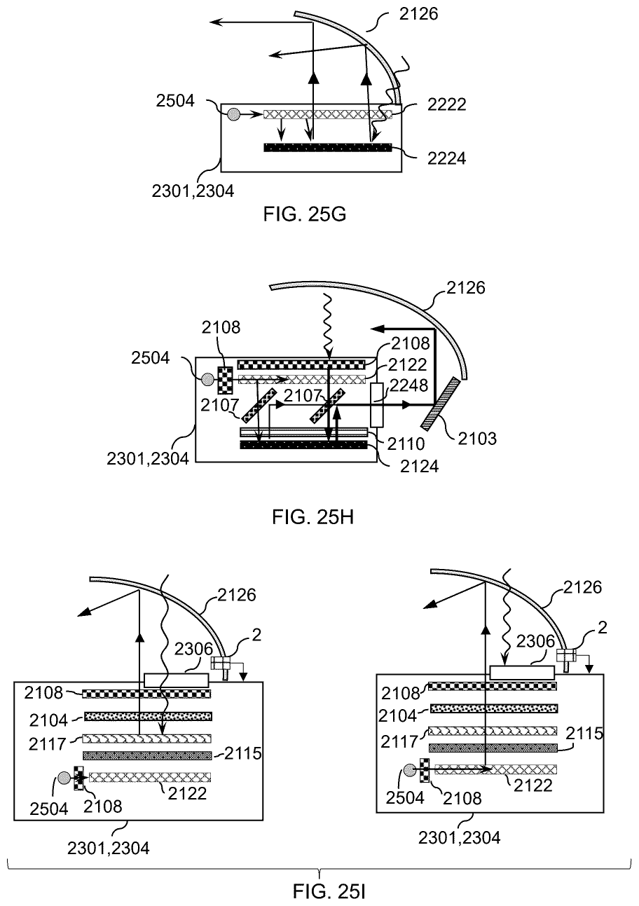

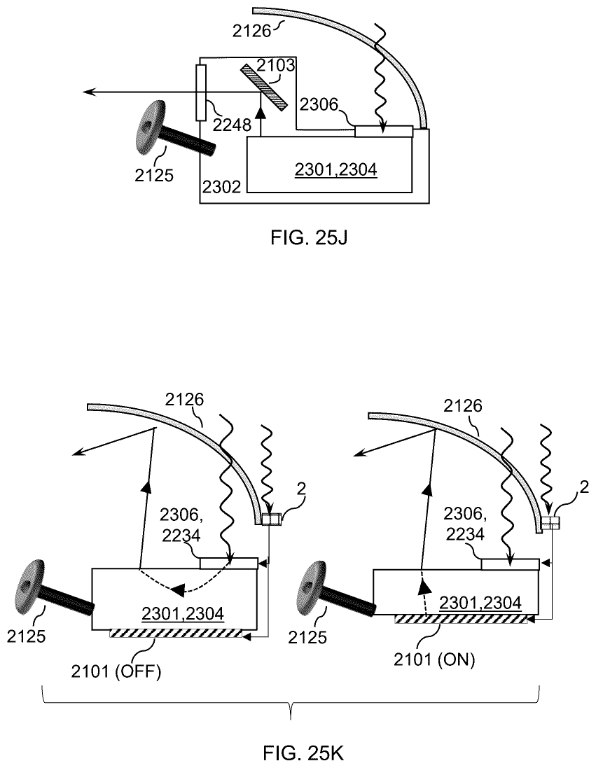

FIGS. 25A through 25I illustrate embodiments in which ambient light is collected and manipulated to generate a virtual image, which may be a HUD image, to be seen by the viewer, who may be a driver or other passenger. In some embodiments, the ambient light is too dim to be used as an image, an alternative backlight or display is used instead. In these embodiments, the optical components form a sunlight modulating panel 2304 and an optical system 2301.

FIG. 25A depicts an embodiment in which ambient light enters the vehicle through the windshield 2126 and enters the optical system 2301 and sunlight modulating panel 2304 through an entrance aperture or entrance aperture optics 2306. In some embodiments the entrance aperture optics is a transparent window. In some embodiments it comprises AR elements, directional films, or other angular profiling elements. And goes through an absorptive polarizer 2108 to polarizer the ambient light. In some embodiments, the polarizer is a coating on or integrated into the windshield itself. The polarized light then travels through an angular profiling element 2111, which is a directional film here, and a diffuser 2118 to make the light more spatially uniformly bright and to direct the light rays toward the other optical components. In some embodiments, the diffuser is only weakly diffusing such that the spatial variation of the intensity is not changed substantially. In some embodiments the order of the angular profiling element and diffuser are reversed. The light then travels through an LC matrix 4, which acts as a modulation matrix to manipulate the polarization state of the incoming ambient light. The manipulated light is reflected by a reflective polarizer 2117 and back through the polarizer diffuser and angular profiling element, to be subsequently reflected by the windshield 2126 and redirected to a viewer to produce a virtual image. A light sensor 2 measures the intensity of the ambient light. If the intensity of the ambient light is dim, the sensor and optical system activate a display 2101 to act as a source of light for producing the image. In this case, the display light travels through the polarizer and the LC matrix unchanged. (The LC matrix may be uniformly turned off so that the display light does not experience any change in polarization.) In any of embodiments in FIGS. 25A through 25L, a sensor may act to measure the ambient light, such that when the ambient light is too low to produce images, a backup light—such as a display, or backlight—may be turned on to provide the image content.

FIG. 25B depicts an embodiment in which ambient light enters the vehicle from the outside world through the windshield 2126, enters the system through the entrance aperture optics 2306, and through an angular profiling element 2111, such as a directional film. A pixelated electrophoretic matrix 2501 acts as the modulation matrix. Each pixel of an electrophoretic matrix has electrically charged pigment particles that can change the grayscale value of the pixel by applying a voltage. For grayscale electrophoretic elements, the pixel can become black or white. The electrophoretic pixels have display content programmed into the pigment values. The ambient light is then selectively reflected by the white pixels, travels back through the directional film and is reflected by the windshield to produce a virtual image for a viewer, who may be a driver behind a steering wheel 2125. A display 2101 acts as the source of for electrophoretic matrix in cases in which the intensity of ambient light is low—for example during nighttime—as detected by an ambient light sensor 2.

FIG. 25C depicts an embodiment in which ambient light going enters a vehicle through the windshield 2126, enters the system through the entrance aperture optics 2306, goes through an absorptive matrix 2112 that modulates the intensity of the incoming ambient light according to a desired image. The modulated ambient light goes through a LC matrix 2104. In some embodiments the LC matrix is OFF and does not contribute to the image formation. The light then strikes a phosphor matrix 2105, which is activated to emit light according to the pattern imprinted on the light. The phosphor material emits light that travels back upward through the previous elements and is reflected by the windshield to generate a virtual image. In some embodiments, the phosphor light that is emitted and that forms a virtual image reaches a viewer without being reflected by the windshield. A light sensor 2 measures the intensity of the ambient light. In some embodiments, it controls the absorptive matrix 2112 such that it smooths out fast-varying ambient light variations. For example, if the ambient light is rapidly varying between bright and dim, the electronic signal informs to absorptive matrix to be, respectively highly absorptive and less absorptive. In some embodiments, an optional mirror 2103 behind the phosphor matrix reflects light emitted downward to contribute to the ultimate virtual image. In some embodiments, when the ambient light is dim or dark, a display 2101 or other backlight is used as the light source for the image formation.

FIG. 25D depicts an embodiment in which ambient light going through the windshield 2126 is passes through a nanocone array 2502 to improve light collection. The collected ambient light goes through an antireflection element 2115 to avoid ghost images on the windshield. The light is reflected by a PBS 2107 that reflects polarized light, travels through an LC matrix 2104 to produce a polarization-modulated light beam. LC matrix 2104 manipulates the polarization state of the light pixelwise—it rotates some of the pixels' polarization by 90 degrees and leaves the others untouched, corresponding to an image. The light the strikes a reflective polarizer 2117, which reflects the pixels corresponding to the image and transmits the unwanted light. Reflected by a reflective polarizer 2117. An ambient light sensor 2 captures the brightness of the ambient light. If the conditions are such that ambient light will not produce a sufficiently bright or steady image, the entrance aperture optics 2306, engages an FSBM 2234 to prevent the ambient light from entering the system. Further, a display 2101 is turned on a polarized to pass through the reflective polarizer 2117 to serve as the image source. In either case (of display or ambient light source), the light travels through a diffuser 2118 and angular profiling element 2111 to impact the angular profile of the image. The light then reflects from the windshield 2126 and forms a virtual image. In some embodiments, an ambient light suppressor 2248 further mitigates stray light. In some embodiments, a display with pre-cavity optics 2249 is used to impact the profile of the light upon emission from the display.

FIG. 25E depicts an embodiment in which the colors of the ambient light going through the windshield 2126 are manipulated with an electro-wetting display matrix 2503a, which comprises individual pixels 2503b that modulate the color channels (e.g., RGB) of the ambient light. The modulation of the color channels is realized via different voltages applied to the individual sub-pixels, which are sensitive to one color channel. The manipulated color image is reflected upward, then reflected by the windshield 2126 to generate a virtual image, which may be HUD image. Electrowetting pixels rely on microfluidics between immiscible fluids, such as oil and water. In some embodiments, a pixel comprises an oil layer, a water layer, a transparent electrode, and a substrate. The oil is colored. For example, a red pixel corresponds to red oil, blue pixel to blue oil, etc. When there is no voltage applied, the oil covers the pixel surface and reflects the desired color, corresponding to its own. When a voltage is applied, the oil is shifted to one corner or edge of the pixel, letting light through. By addressing the electrodes such that the voltage pattern corresponds to a display content, the electrowetting imprints the display content onto the ambient light to reflect an image. The shape of the fluids depends on the surface tension and on the voltage applied and can be arbitrarily engineered. In some embodiments, the substrate is absorptive.

FIG. 25F depicts an embodiment in which ambient light going through the windshield 2126 is modulated by an SLM 2123. The SLM is a transmissive SLM that modulates the amplitude of the light. The light passes through a waveguide 2122, is reflected by a mirror, and retraces its path to be reflected by a windshield 2126 to form a virtual image for a viewer. In some embodiments, during low-ambient light scenarios, a backlight 2504 emits light into the waveguide 2122, which is designed to couple light only at the wavelengths emitted by the backlight. For example, in some embodiments, the backlight emits red, blue, and green light of a relatively narrow bandwidth compared to sunlight. This light couples to waveguide and spreads outward, emitted upward, where it is modulated by the SLM 2123 and produces a virtual image after reflection by the windshield. In some embodiments, the light exits directly to the viewer without interacting with the windshield.

FIG. 25G depicts a variant of embodiment in FIG. 5F in which ambient light going through the windshield 2126 is modulated by DMD 2124, which sends the light back to the windshield 2126 to generate a virtual image, which may be HUD image. Backlight source 2504 is coupled into a light waveguide 2122, which sends light to the DMD 24; the light is then reflected, and the zero-order diffracted light strikes the windshield to create a virtual image for a viewer. In some embodiments, both the backlight and the ambient light contribute to the image simultaneously. In some embodiments, only one or the other contributes.

FIG. 25H depicts an embodiment in which ambient light going through the windshield 2126 goes through absorptive polarizer 2108 that polarizes the transmitted light. The transmitted ambient light travels through a waveguide 2122, which is designed to be mostly transparent throughout the bandwidth of the ambient light, except possibly at some narrowband regions around predetermined colors. The transmitted light is polarized to be reflected by a PBS 2107. It then becomes circularly polarized by a QWP 2110 and is modulated by a DMD 2124, which acts as the modulation matrix. Upon a second pass through the QWP 2110, the light is polarized such that it is reflected by the PBS 2107 and directed out of the optical system 2301 through an ambient light suppressor 2248, reflected by a mirror 2103, reflected by a windshield 2126, and forms a virtual mirror. In low-ambient-light settings, a backlight source 2504 is polarized by an absorptive polarizer 2108 and is coupled into a light waveguide 2122, which outcouples the light downward to follow the same path as the ambient light transmitted through it.

FIG. 25I depicts an embodiment in which ambient light going through the windshield 2126 enters an optical system 2301 and sunlight modulating panel 2304 through entrance aperture optics 2306. The light goes through an absorptive polarizer 2108, which passes a certain polarization state. The light then is transmitted by an LC matrix 2104 that polarization modulates the light according to a desired image content. It manipulates the polarization state of the light, which is reflected by reflective polarizer 2117 back through the LC matrix 2104 and absorptive polarizer 2108. It is reflected by a windshield 2126 and forms a virtual image.

An ambient light sensor 2 measures the amount of ambient light. In some embodiments, it is integrated in the windshield of the vehicle or is mounted on an external surface. When the ambient light is low, the sensor indicates through an electronic signal to close the entrance aperture optics to prevent ambient light from entering the system. It also directs a backlight source 2504 to emit light, which passes through an absorptive polarizer 2108, is coupled to a waveguide 2122, is outcoupled through an AR element 2115, passes through the reflective polarizer 2117, is modulated by the LC matrix 4, and passes through the top absorptive polarizer 2108 to be reflected by the windshield an form an image. Note that in this embodiment, the polarized backlight is orthogonal to the polarizer ambient light, such that the former is transmitted by the reflective polarizer and the second dis reflected by it. Because of this, the LC matrix may have to switch which pixels are modulated to provide the appropriate content.

In FIG. 25J, ambient light enters through the windshield and enters a housing 2302 that contains an optical system 2301 and sunlight modulating panel 2304. This embodiment represents any of the embodiments of FIGS. 25A through 25I. The light exits the optical system and is reflected by a mirror 2103 through an ambient light suppressor 2248 to form a virtual image for a viewer, e.g., a driver behind a steering wheel 2125. In this case, the light is not reflected by the windshield before forming an image. In some embodiments, the virtual image is part of an instrument cluster.

FIG. 25K shows the general principle of switching between sunlight-driven, or ambient-light, image sources and integrated backlights or displays. When the ambient light is bright enough, as registered by a light sensor 2, light entering the vehicle through a windshield 2126 enters the optical system 2301 and sunlight modulating panel 2304 through the entrance aperture optics 2304, which may include a FSBM 2234, which is configured to let light pass. The light is imprinted with an image in the system and exits the display system to form a virtual image. In some embodiments, the light is reflected by the windshield before heading to the viewer. The display is OFF. When the sensor records a low ambient light reading, it switches the FSBM 2234 to prevent the ambient light from entering and turns the display 2101 ON. The display light then travels through the system to exit and form a virtual system. In some embodiments, the FSBM is a simple shutter or iris that can open or close to determine whether ambient light enters the system.

Some embodiments pertaining to FIGS. 25A through 25K use computational methods performing distortion compensation or a physical distortion compensation element before exiting the system. E.g., an affine transform may be computationally performed on image content to counter a resulting barrel or pincushion distortion after reflection by a curved reflector. In some embodiments, a physical partially transparent element produces the affine transform with a certain surface shape.

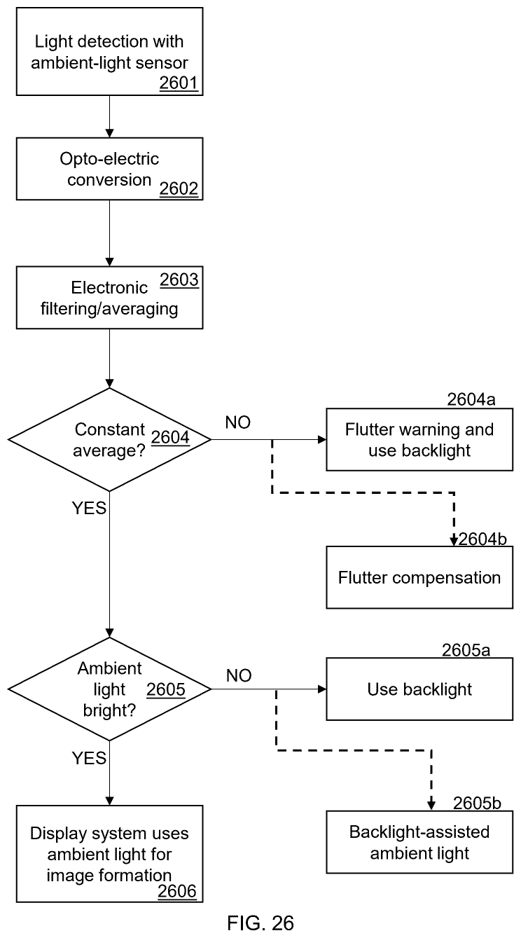

FIG. 26 shows a block diagram or flow chart describing different ambient light manipulation processes based on the desired output. The process starts with light detection 2601 with an ambient light sensor to capture the intensity and/or direction of the incoming ambient light. The collected ambient light goes through an opto-electric conversion step 2602. In some embodiments, the electronic signal produced is proportional to the incident intensity. This electronic signal output goes through an electronic filtering/averaging step 2603. This step produces a smoothed version of the raw electronic signal. In some embodiments, this is produced via windowed time average. In some embodiments, this is produced using a proportional-integral-derivative (PID) filter. The output from step 2603 is measured for constant intensity. In this step, the actual filtered electronic output is compared to a built-in threshold. For example, this comparison step, in some embodiments, compares the refresh rate of a standard display, such as 30 Hz, 60 Hz, 120 Hz, or 144 Hz. In some embodiments, it is compared to a time scale corresponding to the human vision system. If the average is constant compared to one or several of these thresholds, it is measured for intensity level in step 605. In this step, the average intensity may be computed over a large time window and compared to a standard threshold, such as a typical brightness of a display panel, or it may be a function of the human vision system sensitivity. In this step, the flowchart decides whether the ambient light is bright enough to form a virtual image in step 2606.

If an intensity average, as calculated in step 2603, is not constant, the system raises a flutter warning and uses a backlight 2604a. This may occur, e.g., in vehicle motion where there are canopy effects, such as driving along a round covered and surrounded by trees. In some embodiments, the ambient light sensor records spatial information about the distribution of light, and the backlight may be programmed to illuminate only those portions where flutter occurs, allowing the ambient light to produce images in the other regions of the optical system. In some embodiments, the flutter warning may trigger other electrically activated elements to help smooth out the light. After the brightness or intensity level is calculated, if the ambient light is not bright enough, the system uses backlight 2605a. This may be the case in low lighting conditions, such as nighttime driving. In some embodiments, the backlight simply assists, or adds to, the incoming ambient light 2605b.

The process of FIG. 26 allows the ambient light sensor to measure the ambient light and have a computer system decide whether the ambient light is sufficient to use as the light source for the display content, or whether it is insufficient and an integrated backlight or LCD display, or other display pane, is necessary. In some embodiments, the optical system or sunlight-activated system is modulated based on the signal from the ambient light sensor to compensate for spatial or temporal variations, e.g., by using diffusive time delays for smoothing out the lighting.

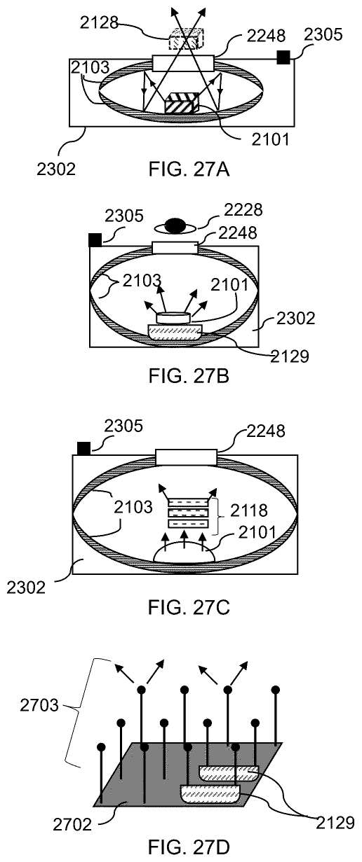

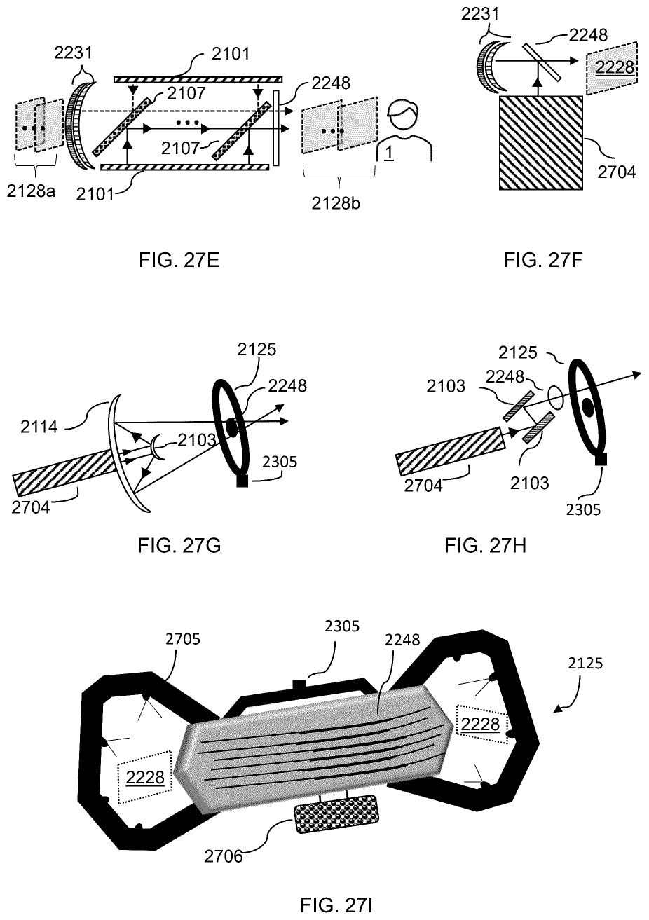

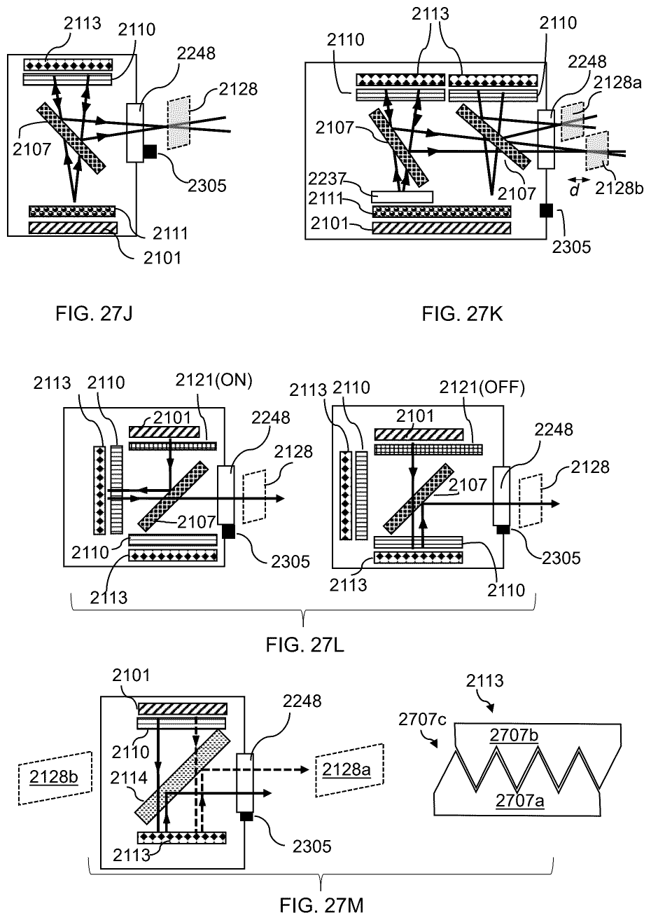

FIGS. 27A through 27M depict a set of embodiments that produce virtual images that are closer to a viewer than the physical components of the display system, i.e., hovering real images. All these embodiments may include a gesture camera, such that a viewer can interact with the virtual images. All these embodiments may have an ambient light suppressor to prevent external, ambient, or environmental light from entering the system. Therefore, whenever the display lights are off, the ambient light suppressor looks dark. In this way, the ambient light suppressor provides ambient light suppression for the hovering images. In FIG. 27A, a curved cavity with walls as mirrors 2103 contains a display, which may be a display 2101, which may be a volumetric display. The volumetric display, in some embodiments, is a moving light, such as an LED, or a plurality of moving LEDs. The motion is much faster than the response time of the eye so that the source is perceived as a continuous volume of light. The light fans out in all directions and bounces off various parts of the mirrors 2103. The mirrors are shaped such that a point at or just above where the light exits are where a real image is formed, i.e., where the light focuses to a secondary image. This is referred to as a “hovering real image” or a “hovering image” in this disclosure. A person who is looking at that spot will see a virtual image 2128. The cavity has an exit that is an ambient light suppressor 2248 which prevents unwanted ambient light from entering the cavity and producing ghost images or stray light artifacts for the viewer. With the ambient light suppressor in place, when the volumetric display is turned off, no light exits the system for the viewer to see, i.e., it will look dark when viewing the cavity through the ambient light suppressor. A gesture sensor 2305 captures gestures made by a viewer or passenger in a vehicle. That information may be used to change the volumetric display or the property of the vehicle itself.

FIG. 27B is another embodiment of a hovering image produced by cavity optics. Housing 2302 contains a curved cavity walled with mirrors 2103. The light source is display 2101, which is a volumetric display, in this case is a diffuser fiber that is bent or curved into a desired shape. Light that is coupled into the diffusive fiber is emitted at all points along it. In some embodiments there are multiple fibers. In some embodiments, there is a mechanical actuator 2129 to change the position or shape of the optical fiber(s), thus changing the configuration of the volumetric display light. The light proceeds as before: it bounces throughout the cavity forming a hovering image just above ambient light suppressor 2248, such that a viewer sees a virtual image 2128 in that location. A gesture sensor 2305 captures gestures made by a viewer or passenger in a vehicle. That information may be used to change the volumetric display or the property of the vehicle itself.

FIG. 27C shows another embodiment of the same time, where the display 2101 is a volumetric display, which is a collimated light source that passes through a set of diffusers 2118. The diffusers spread the light out, such that it bounces throughout the cavity and forms a hovering image just above the ambient light suppressor 2248. A gesture sensor 2305 captures gestures made by a viewer or passenger in a vehicle. That information may be used to change the volumetric display or the property of the vehicle itself. There are other types of volumetric display sources. For example, as shown in FIG. 27D, an array of optical fibers 2703 can be attached to a base 2702. The fibers may be cut to various lengths to create a volume of light. Optional mechanical actuators 2129 may be used to change the shape or position of some or all the fibers. In some embodiments, the volumetric display is a collimated display and a set of LC diffusers, a rotational multilevel display, a micro-projector and a set of LC diffusers, or an optical fiber or a plurality of optical fibers that are shaped into a certain fixed pattern. In some embodiments, the light sources are embedded in a polarization dependent slab to create different images based on polarization of light.

FIG. 27E shows an embodiment in which the cavity consists of a set of beam splitters and display panels. Like the embodiment in FIG. 4A, the displays are segmented displays. Light from a bottom display 2101 sends light upward through a set of semi reflectors, which is a set of PBSs 2107 in some embodiments. The light then travels through an ambient light suppressor 2248 to produce virtual images 28a that are deeper or farther from a viewer 1. A second display sends light downward to be reflected by the PBSs 2107. They strike a QM 2231 which is curved. The QM caused the polarization of the reflected light to be rotated by 90 degrees such that it passes through all the PBSs to be seen by the viewer 1. The curvature of the QM focuses the light to produce a real image just passed the ambient light suppressor 2248, such that the viewer sees virtual images 28b located there, closer to him than the distance to the ambient light suppressor itself. The ambient light suppressor prevents unwanted light from entering the embodiment and therefore, the system is dark when the displays are off.

FIG. 27F shows a generalized embodiment related to that in FIG. 27E. A display system 2704, which comprises light sources, optical systems and components, and/or FECs, generates image content. The light is reflected by an ambient light suppressor 2248, which may contain a polarization dependent beam splitter instead of an absorptive polarizer. The reflected light is reflected by a curved QM 2231, which focuses the light through the ambient light suppressor to produce hovering real images. The distance to the right of the ambient light suppressor 2248 where the image is formed depends on the curvature (i.e., on the focal length of the QM). A viewer looking toward the ambient light suppressor will see a virtual image 2128 at the position of the real image.

FIG. 27G shows an embodiment that produces hovering real images using a catadioptric system. Light from a display system 2705 passes through a curved beam splitter 2114 and is reflected by a curved mirror 2103 back toward the beam splitter. The beam splitter then reflects the light, e.g., nearby to, or through a gap in, steering wheel 2125. The light passes through an ambient light suppressor 2248 and produces a hovering real image, which a viewer may interact with through a gesture camera. In some embodiments, the gesture camera and/or the image can be impacted by the rotational of the wheel.

In FIG. 27H, a display system sends light through a first mirror 2103 and a second mirror 2103 through an ambient light suppressor 2248. The resulting image may be a hovering real image (if the mirrors are curved) or a deeper virtual image (if they are flat). The images may be near to a steering wheel 2125.

FIG. 27I is an example embodiment of when a steering wheel 2125 with display systems would look like in practice. Gesture camera 2305 is fixed to the steering wheel, and an ambient light suppressor 2248 is integrated in it. Virtual images 2128 appear at various positions around the wheel. Light/camera arrays 2705, and microphone array 2703, are fastened around the wheel. In some embodiments, the lights and cameras record the viewer's position or eye gaze and input that into the computational compensation of the display system to optimize the focal plane or perspective of the virtual images.

FIG. 27J shows an embodiment to produce hovering real images using retroreflective elements. A display 2101 emits light through an angular profiling element 2111, which may be a directional film. It is polarized to pass through a PBS 2107, and it is subsequently converted to circular polarization by a QWP 2110. The light is then reflected by a retroreflector 2113, which converts the diverging light rays into converging light rays, i.e., each ray is reflected along the path on which is struck the retroreflector. After a second pass through the QWP, the light is polarized to be reflected by the PBS 2107 and exits through an ambient light suppressor 2248. The converging light forms a hovering real image just beyond, such that a viewer will see a virtual image 2128 there. A gesture camera 2305 captures gestures of a viewer, and eh information is used to impact the image.

In FIG. 27K, multiple retroreflectors produce multifocal hovering real images. Light is emitted by display 2101 which is a segmented display. Each portion passes through a respective PBS 2107 through a QWP 2110 and reflected by a retroreflector 2113 to convert the diverging light into converging light. The double-pass through the QWP 2110 rotates the polarization of the light to be reflected by the PBSs and exits through the ambient light suppressor forming hovering real images. In some embodiments, the optical path of one segment of light is different than that of the other, such that two virtual images 28a, 28b are formed at two different focal planes for a multifocal image. The separation distance d can be further varied by inserting an EORS 2237 in either or both beam paths. In some embodiments, the PBSs are not parallel, such that the hovering images are shifted relative to each other.

FIG. 27L shows an embodiment that uses switchable elements with retroreflectors. A display emits light through an LC layer 2121 which is ON. The light is polarized to be reflected by a PBS 2107, passes through a QWP 2110, is reflected by a retroreflector 2113 on the left, passes through the same QWP 2110, and is polarized to pass through the PBS, through an ambient light suppressor to form a hovering real image. When the LC layer 2121 is OFF, the light is polarized to travel through the PBS 2107, through the bottom QWP10 and reflected by the bottom retroreflector 2114. The reflected light passes again through the bottom QWP and is reflected by the PBS, through the ambient light suppressor 2248. A gesture camera allows a viewer to interact with virtual image 2128. In some embodiments, the switching of the LC layer in synchronized with time-varying image content on the display. In some embodiments, the optical path length of the image differs depending on whether the LC layer is ON or OFF to produce a dynamically variable focal plane, or position of the image.

FIG. 27M shows an embodiment in which the retroreflector is birefringent, such that a first polarization experiences it as a retroreflector, and an orthogonal polarization experiences it as a normal (semi)-reflector or partial mirror. In some embodiments, this is produced by sandwiching an isotropic slab 2707a whose surface is retroreflector (e.g., a corner cube shape) against an anisotropic slab 2707b of complementary surface. For one polarization, the two indices are identical, and the corner-cube interface 2707c is invisible, such that the light experiences a conventional mirror, and produces a deeper virtual image 28b. For The orthogonal polarization, the two indices differ, and the corner-cube interface acts as a retroreflective surface to produce a hovering real image for a user to see a virtual image 28a close.

Light from display 2101, passes through a QWP 2110 to produce circularly polarized light. This light comprises equal amounts of vertically and horizontally polarized light or, equivalently, s- and p-polarized light. The light travels through a beam splitter 2114 and strikes the birefringent retroreflector 2113. One polarization experiences a normal reflection, is reflected by the beam splitter, and passes through the ambient light suppressor to produce a virtual image 2128 that is farther from a user. The orthogonal polarization, experiences the retroreflection action, produces converging light rays, and is reflected by the beam splitter 2114 and through the ambient light suppressor 2248 to produce a hovering real image, close to a viewer, who interacts with it through a gesture camera.

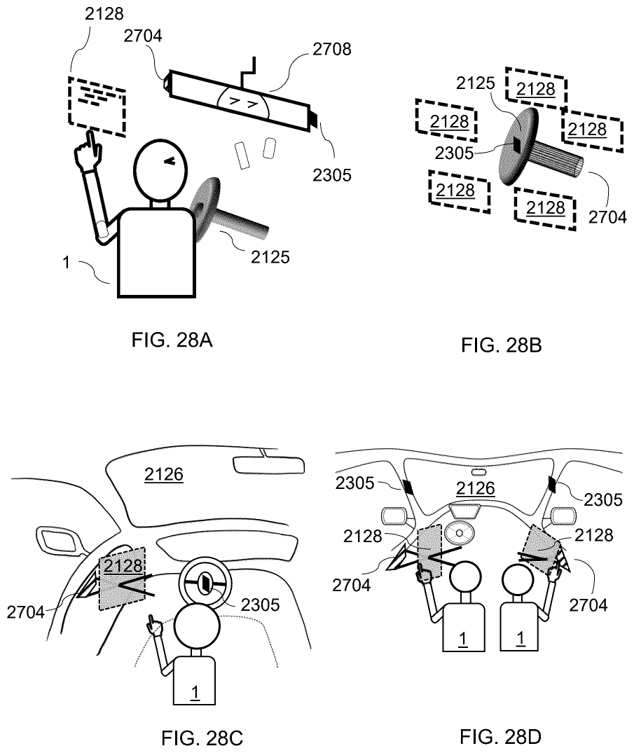

FIG. 28A through 28D depicts some applications using hovering buttons inside the cockpit or cabin of the vehicle. FIG. 28A depicts an embodiment in which a display system 2704 is placed near the rear mirror 2708. A hovering image 2128 offering different options to viewer 1 is shown around the rear mirror. Gesture camera 2305 interprets the gesture of viewer 1 and proceeds to activate the option selected by viewer 1 based on a specific acknowledgement gesture. Gesture camera 2305 can be, but not limited to, an eye tracking device.

FIG. 28B depicts an embodiment in which a display system 2704 shows several hovering buttons 2128 around the steering wheel offering different options to the user. A gesture camera 2305 interprets the gestures of the user and activates the option chosen by the user based on a specific acknowledgement gesture.

FIG. 28C depicts an embodiment in which a display system 2704 located on the side door of viewer and driver 1 shows a hovering button 2128. A gesture camera 2305 interprets the gesture of viewer and driver 2305 and activates the option selected by the viewer.

FIG. 28D depicts an extension of embodiment in FIG. 8C in which a set of twin display systems 2704 are placed at either door (driver and passenger), showing a set of hovering buttons, one for the driver 1 and another one for the side passenger 1. A pair of gesture cameras 2305 interpret the gestures of both the driver and passenger individual and activate the options selected by the driver and passenger independently.

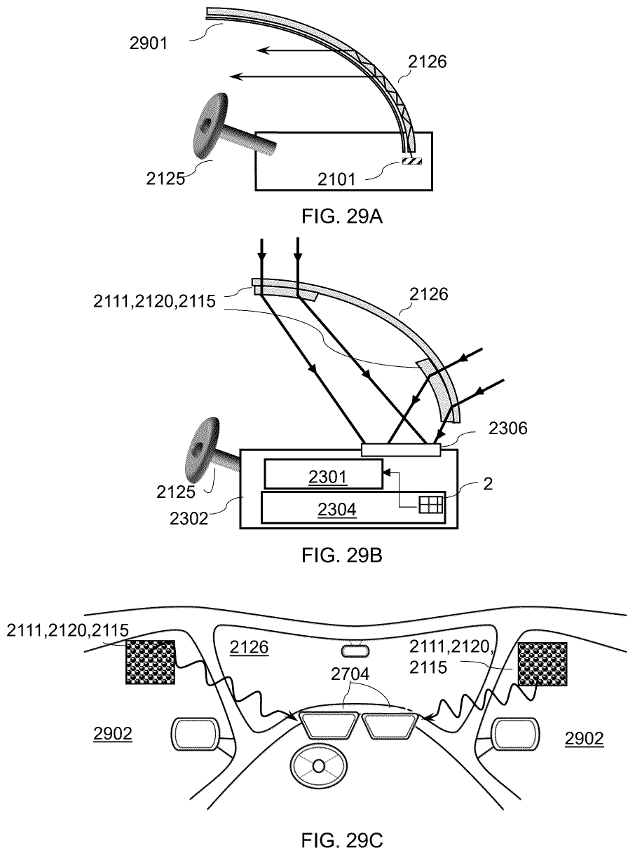

FIG. 29A through 29C show embodiments in which the windshield is an engineered component intrinsic to the optical system. FIG. 29A depicts an embodiment in which windshield 2126 acts as a waveguide. Display 2101 sends light into the edge of the windshield, which travels along the windshield 2126. Outcoupling layer 2901 allows light from within windshield to leak out by slightly modulating the index of refraction of such outcoupling layer 2901. In some embodiments, the outcoupling layer is a surface grating. FIG. 29B depicts an embodiment in which the windshield is integrated with optical elements to collect more light for a sunlight-activated display. The elements comprise an angular profiling element 2111, which may be a directional film, a diffractive optic element 2120, and an antireflection element 2115, and they each redirect ambient light to an aperture optics 2306 as the input window in housing 2302. In some embodiments, the DOE or directional film is a Fresnel lens to help concentrate the light into the entrance aperture optics. One ambient light collector set is placed toward the roof area whereas the other ambient light collector is placed on the bottom part of windshield 2126. Inside housing 2302, light sensor 2 measures the intensity and time variation of the ambient light and controls an optical system 2301 and sunlight modulating panel 2304. In some embodiments, the light collection layers are on different glass parts of the vehicle, such as other windows, sunroof apertures, or rear windows.

FIG. 29C depicts an embodiment in which twin ambient light collector sets comprising an angular profiling element 2111, a diffractive optic element 2120, and an antireflection element 2115 each redirect ambient light to display systems 2704, one for the driver and another for the passenger.

It is also possible to integrate this invention's embodiments with other optical elements, such as parallax barriers, polarization shutters, or lenticular arrays to send different images to different eyes. In some embodiments, this is aided with an eye tracking module, and in some embodiments, the other optical elements are worn as a headset. These systems may produce both monocular depth cues and stereoscopic depth cues to trigger accommodation and vergence binocular vision.

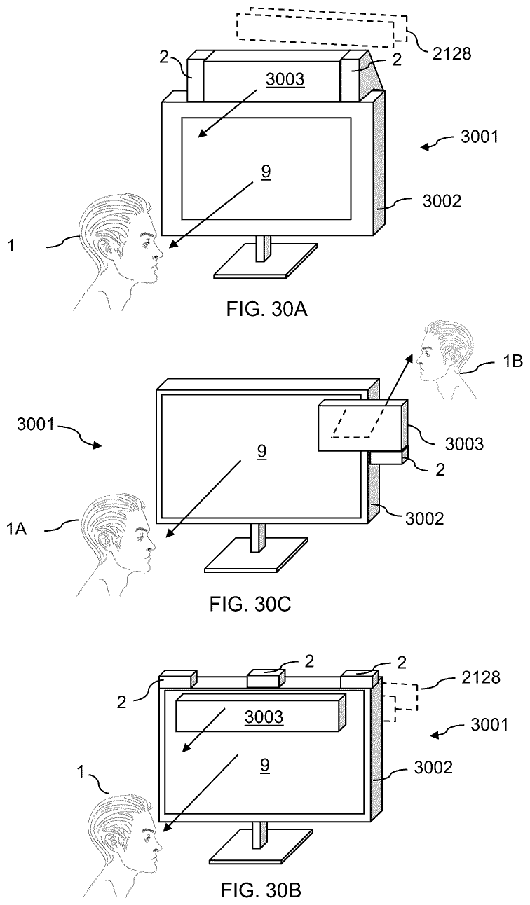

In some embodiments, the extended display subsystem of the extended display system is added on to an existing display, which is considered the main part. For example, in FIG. 30A, an extended display system 3001 includes a main display part 3002. This component may be an LCD or OLED display panel, a cathode ray tube (CRT) monitor, a television, any computer monitor, and the like. Operably coupled to the main display part 3002 is an extended display subsystem 3003 (or extended display part), which produces virtual images 2128 for a viewer 1. The virtual images may be of any type described above: a multilayer image, a hovering graphic, an extended FoV, etc. In some embodiments, sensors 2 collect information about a viewer or environment to impact the display content of the virtual images or of the main display content 9. The extended subsystem may have its own light/image source, e.g., a separate display panel within its housing. In some embodiments, the main display content and virtual images are simultaneously visible in a headbox.

In some embodiments, as in FIG. 30B, the extended display subsystem 3003 of the extended display system 3001 may direct light in a different direction than does the main display part 3002. In such a case, a viewer 1A of the main display content 9 differs from a viewer 1B of the content of the extended display subsystem 3003. This may be useful, for example, when a confidential part of a collaborative application is to be viewed by only one person. In some embodiments, a sensor 2 captures information about either viewers or the external environment.

FIG. 30C shows an extended display system 3001 in which the extended display subsystem 3003 is coupled to the main display part 3002 such that the image source for the former is a subregion of the display content 9 of the latter, seen by a viewer 1. A portion of the main display content 9 is fed into the extended display subsystem 3003, which is located on the front-facing side of the main display part 3001 and produces virtual images 2128 that have a monocular depth that is different from a distance between a viewer and the main display content 9. Multiple sensors 2 may include, for example, a gesture sensor or a camera to capture information about the external world.

The extended display subsystem may have an image aperture. The image aperture may have a smaller lateral size than that of the main display content, the lateral measured along a horizontal direction, a vertical direction, a diagonal, and the like. For example, the lateral size of the image aperture optic may be ½, ⅓, ¼, ⅕, or 1/10 a lateral size of the main display content. In some embodiments, the lateral size of the image aperture optic is between 10% and 50% a lateral size of the main display content. In some embodiments, the image aperture is slightly smaller than the main display content, e.g., between 80% and 95% of the main display content. Extended display subsystems may also be called an “accent display” or an “edge display.”

In some embodiments, light enters the extended display subsystem through an opening called an “aperture,” which is the geometric surface through which light enters or exits an optics subsystem. An entrance aperture optic may be placed at the location of the aperture. That is, if there is no entrance aperture optic at the location of the aperture, then the light need not pass through a physical element to enter the subsystem. An entrance aperture may add mechanical protection (e.g., protecting the specular reflectors from dust or physical manipulation), or it may optically profile the the polarization, spectrum, intensity, or angular profile of the incident light.

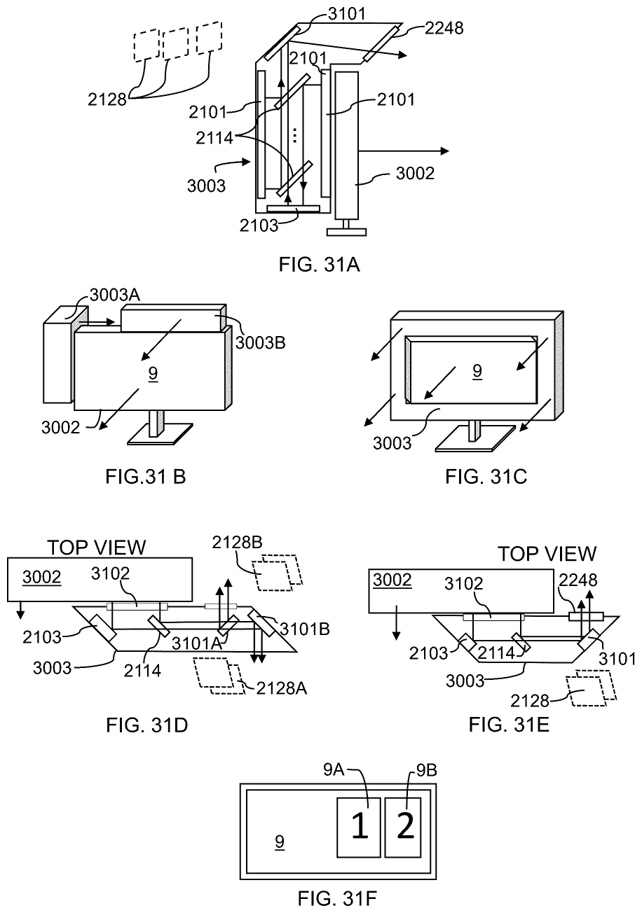

FIGS. 31A through 31F show further embodiments or related display content related to FIG. 30A. In FIG. 31A a viewer 1 is positioned in front of the main display part 3002 which directs light to him. The extended display subsystem 3003 is connected with components behind and on top of the main display part. In this embodiment, the extended display subsystem 3003 has as its light source two displays 2101, which act as segmented displays. The light is directed toward one or more beam splitters 2114. Some light is directed down to a mirror 2103, which reflects the light upward. Some light is directed upward upon initial incidence with the beam splitters 2114. All light is reflected by a relay 3101 and transmitted through an aperture optic 2248. In some embodiments, the relay is itself a mirror. In some embodiments, the relay has further angular profiling layers to impact the directionality of the light. The multiple directions of the light within the extended display subsystem 3003 result in virtual images 2128 that may have a plurality of monocular depths, i.e., may be a multilayer or multifocal image. In some embodiments, the bottom mirror or relay are curved. In some embodiments, virtual images are closer and a gesture camera captures the viewer's gestures to influence the virtual images, which act as real hovering buttons. In some embodiments, the curvature of an optical element serves to modify the volume of the headbox (by causing a tradeoff between image magnification and headbox size).

In some embodiments, as in FIG. 31B, the extended display subsystem comprises different, physically separated pieces. A first part of the extended display subsystem 3003A prepares and emits light into a second part of the extended display subsystem 3003B, which redirects light outward toward a viewer, as does the main display part 3002, which has a main display content 9. The two parts of the system may be separated by an air gap. In FIG. 31C, the extended display subsystem 3003 surrounds the entire frame of the main display part, which itself shows main display content 9. In this embodiment, virtual imagery may surround the main display content 9.

FIGS. 31D through 31F are similar embodiments to FIG. 30B, where the directionality of the virtual images is different than that of the main content. In FIG. 31D, light from the main display part 3002 enters the extended display subsystem 3003 through an aperture 3102 and interacts with a plurality of specular reflectors including beam splitters 2114 and mirrors 2103. The mirror may be a QM; the beam splitters may be polarization dependent. Two relays include a first and second relay 3101A, 3101B, wherein the first relay is semi-transparent. This lets extended content be visible as a first set of virtual images 2128A, viewable from behind the main display part 3002, and a second set of virtual images 2128B, viewable from in front, such that light corresponding to the second set travels in substantially the same direction as the light directly from the main display 3002.

FIG. 31E shows an embodiment in which light from the main display part 3002 enters the extended display subsystem 3003 through an aperture 3102, interacts with specular reflectors (mirror 2103, a beam splitter 2114, and a relay 3101), exits through an aperture optics 2248, and travels in substantially the opposite direction as light directly from the main display part 3002. Virtual image 2128 is thus visible to a viewer behind the main display part 3002. As shown in FIG. 31F, the main display content 9 may be segmented to include first and second subcontents 9A, 9B, each one corresponding to part of a multifocal image.

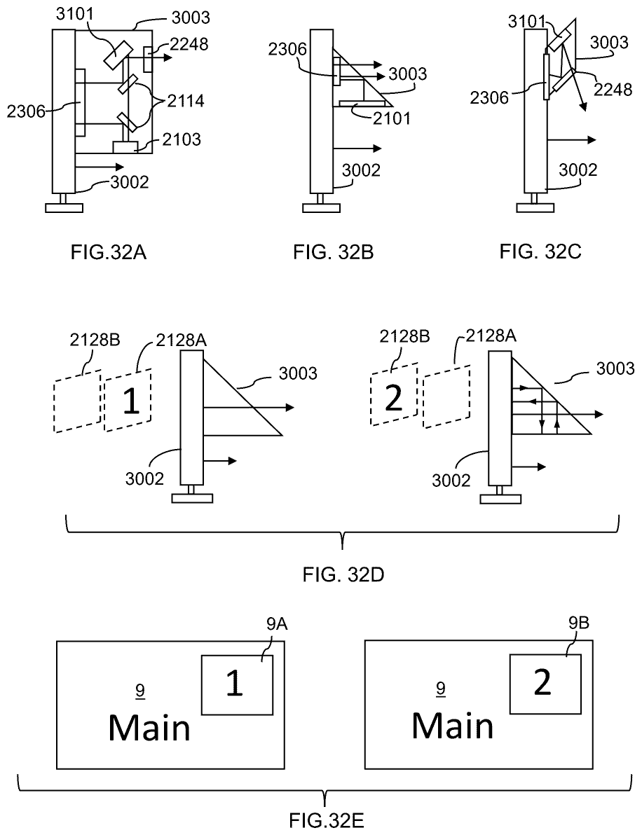

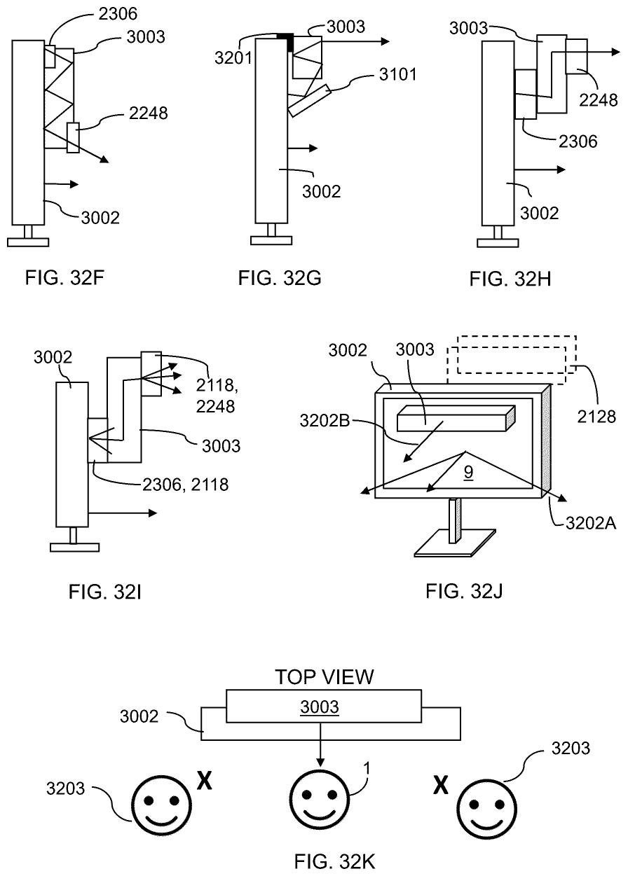

FIGS. 32A through 32K show examples of the embodiment of FIG. 30C, but features can be applied to FIGS. 30A and 30B. In FIG. 32A, the extended display subsystem 3003 is connected to the front of the main display part 3002; the former does not have its own light or image source. Instead, light from the main display part 3002 enters the extended display subsystem 3003 through an entrance aperture 2306. The light interacts with a plurality of specular reflectors (beam splitters 2114, mirror 2103, and relay 3101), and is then transmitted through an aperture optic 2248.

In FIG. 32B, the extended display subsystem 3003 has multiple light sources, including light from the main display part 3002, which enters the extended display subsystem 3003 through an entrance aperture 2306, as well as an internal display 2101. The light directly from the main display passes directly outward to a viewer, whereas the light from the internal display 2101 makes several bounces within the subsystem 3003 before exiting. The light from the main display part 3002 may bounce within the extended display subsystem 3003 multiple times. For example, FIG. 32C shows a main display part 3002 and an extended display subsystem 3003, where the light enters the latter through an entrance aperture 2306. The light is reflected by the aperture optic 2248, then by a relay 3101 (e.g., a mirror), and transmitted through the aperture optic. Here the light from the extended display subsystem 3003 exits in a different direction than that from the main display part 3002. The aperture optic may comprise a reflective polarizer, and the relay 3101 may be a QM.

In FIG. 32D, the extended display subsystem 3003 is electrically switchable and synchronized with the main display part 3002. At one instant, light from the main display part 3002 passes through the extended display subsystem 3003 without making any round trips to produce a near virtual image 2128A. At a second instant, the light bounces multiple times within the extended display subsystem 3003 to produce a far virtual image 2128B. FIG. 32E shows that the main display content 9 may include a first and second display subcontent 9A, 9B for the near and far virtual images, respectively, at different instants. Time varying extended display subsystems may be enabled by using switchable elements, e.g., an LC. In some embodiments, the switching occurs at a refresh rate of, or a fraction or multiple thereof, the main display part. In some embodiments, the refresh rate is 30 Hz, 60 Hz, 144 Hz, 24 Hz, 120 Hz, 165 Hz, 240 Hz, 360 Hz, 50 Hz, 100 Hz, 75 Hz, 85 Hz, or 480 Hz. In some embodiments, the refresh rate is variable.

FIG. 32F shows an embodiment in which light enters the extended display subsystem 3003, where the light source is the main display part 3002. The light enters through an entrance aperture 2306 and is guided along the extended display subsystem 3003, which in some embodiments, is a thin piece of glass, acrylic, or other transparent material. In such embodiments, the light is guided by being reflected multiple times along the faces before exiting. In some embodiments, the light exits through an aperture optic. In some embodiments, there is no aperture optic and the light simply exits through refraction at the slab/air interface. In some embodiments, as in FIG. 32G, a relay 3101 is positioned outside the slab that composes the extended display subsystem 3003. A mechanical spacer 3201 may assist with the positioning or alignment of the extended display subsystem 3003. Here, the plurality of specular reflectors corresponds to two or more surfaces or interfaces between, e.g., the acrylic or glass and the air.

In some embodiments, as in FIG. 32H, light from the main display part 3002 enters passes through the entrance aperture 2306 into the extended display subsystem 3003, which is a waveguide that guides the light along a transverse direction. In some embodiments, the waveguide has subwaveguides to collect different colors (red, blue, and green). In some embodiments, the entrance aperture 2306 is a surface grating that serves to in-couple the light. In some embodiments, the aperture optic 2248 is surface grating on the main waveguide to direct the light outward to a viewer.

In FIG. 32I, light enters the extended display subsystem 3003 through an aperture optic 2306 that includes a diffuser 2118. The aperture optics 2248 also includes a diffuser 2118. Diffusers may serve different purposes. In some embodiments, the diffusers spread the light out to create optical lighting effects, rather than to produce images. This could be, e.g., ambient lighting, mood lighting, lighting effects synchronized with an audio or other subsystem, and the like. In some embodiments, the diffusers modify the direction of the light to produce either lighting effects or images with angular properties. Such diffusers function as angular profiling layers or directional films. The diffusers may be arbitrarily engineered. Therefore the light's directionality may change relative to the light of the main display part 3002. The geometry, shape, and curvature of an extended display subsystem or its components may influence the directionality of the transmitted light.

For example, FIG. 32J shows an embodiment in which the main display part sends light in multiple directions, for example including in a first direction 3202A, whereas the extended display part 3003 produces virtual images 2128 that are directed in only a single direction 3202B. In this way, the viewability of the virtual images is different than that of the main display content 9. FIG. 32K shows the top view of the main display part 3002 and the extended display subsystem 3002 where a viewer 1 sees imagery from both parts, but other individuals 3203 do not see the light from the extended display subsystem. In this way, the headbox of the extended and main parts may differ. An application would be to show private or confidential content on the extended part only, such that only the intended viewer may see it, whereas nonconfidential information may be shown on the main part. This would be useful, for example, in an office space or other collaborative environment.

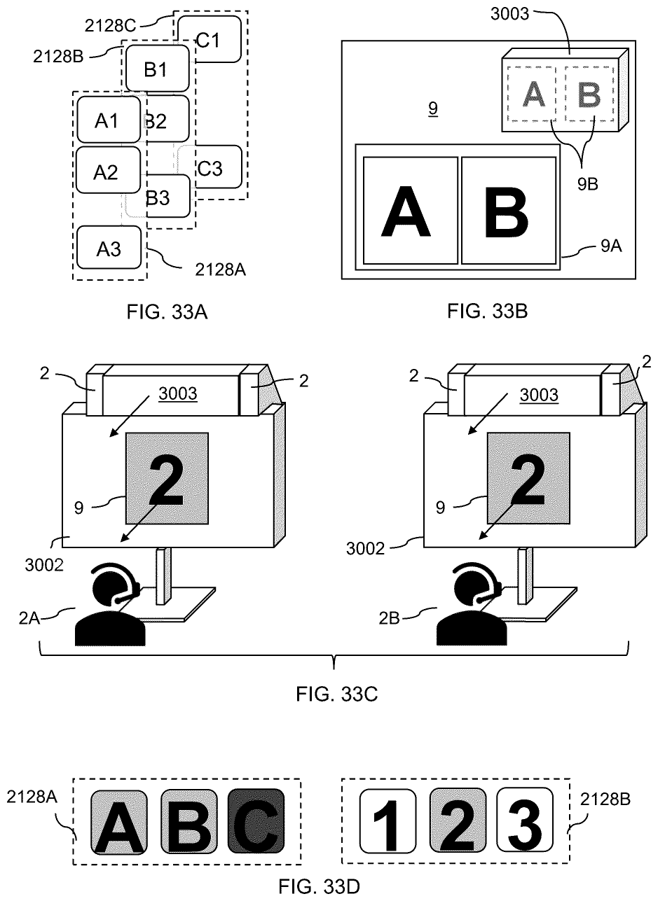

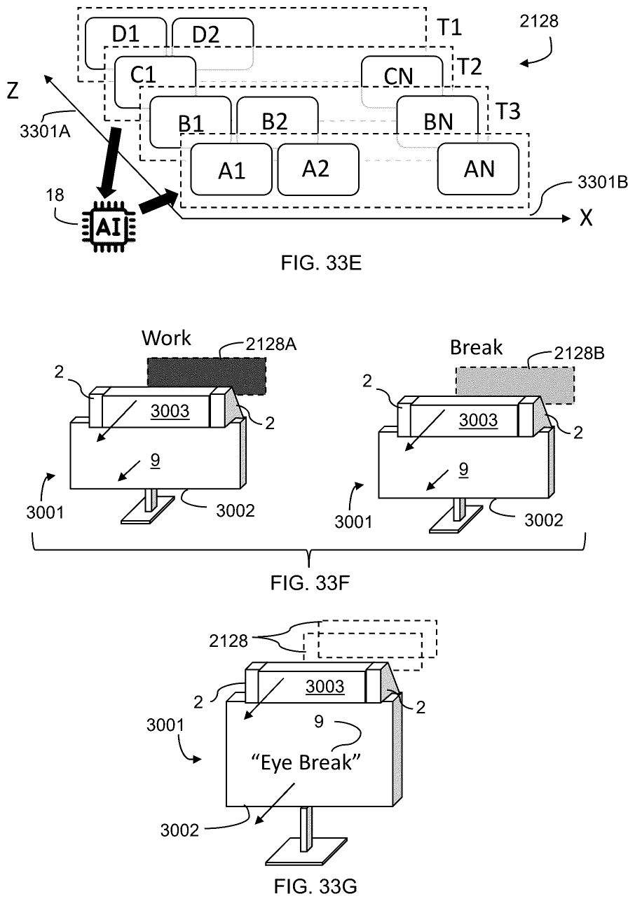

FIGS. 33A through 33G show further applications of extended displays. FIG. 33A shows a multifocal image which consists of a first, second, and third virtual image 2128A, 2128B, 2128C. In some embodiments, each focal plane that makes up the multifocal virtual image may show a sample calendar of a viewer's schedule in the future, e.g., for the following day, week, or month. Each focal plane may show a different set of options for each time slot. Some of the events may be suggested by an AI module that takes in the viewer's daily usage, a user's direct input, and the like. In some embodiments, a user input or a sensor, such as a gesture sensor, allows the user to select among the different options to choose the events for a given time slot. For example, a viewer may opt for event A1, event B2, and event C3, such that that calendar interval will keep and organize those events. In FIG. 33B, the extended display subsystem 3003 takes light input that comes from the main display 3002. In this example, the user could be developing content specifically for virtual imagery, such as multifocal image content. The main display part 3002 may show a display subcontent 9A, which corresponds to the different focal planes “A” and “B” of a multifocal image. As the viewer manipulates that content, through, e.g., video editing software, a copy of those images are shown as a second subcontent 9B, which is directed into the extended display part 3003 to produce a virtual image. The viewer can thus manipulate virtual imagery and view the results realtime.

FIG. 33C shows a collaborative application that may be used for work productivity in a shared visual environment. This can be called a corporate productivity tab. A first and second collaborative user 2A, 2B are each using an extended display system comprising a main display part 3002 showing main display content 9 and an extended display subsystem 3003. These systems may include sensors 2. Both users are collaborating on a mutual task “2.” The extended display content corresponds to a first and second virtual image 2128A, 2128B, as shown in FIG. 33D. The content includes information about the different users, “A,” “B,” “C” on one focal plane; and the tasks, “1,” “2,” and “3” on a second focal plane. Different shading of the tasks and users indicate who is working on what task at that moment. For example, the first virtual image 2128A and the second virtual image 2128B are visible by the first collaborative user 2A who sees that he (“A”) and collaborative user 2B (“B”) are shaded the same color as task “2.” The first collaborative user knows, therefore, that the second user is working on the same task, whereas a third collaborative user (“C”) is shaded differently indicating a different task. In some embodiments, the depth or positioning of the focal planes indicates other collaborations that may or may not be active at that instant, or how future tasks may be assigned based on current assignments. Further content includes video feeds from, e.g., a lab/factory floor, multimedia, email snippets, press/marketing/social media information, progress bars indicating task progress, and the like.

For example, FIG. 33E shows a multifocal virtual image 2128, where the different focal planes are positioned at different depths along a Z-axis 3301A and content with each focal plane along an X-axis 3301B. In some embodiments, content from some of the focal planes is input into an AI module 18 that generates content in another focal plane. Each focal plane may correspond to a different category, T1, T2, T3, . . . of tasks. Some of the tasks may be assigned to the user, and the generative content may suggest new tasks A1, A2, . . . , AN, based on the existing ones.

In some embodiments, the extended part of the display system shows something besides virtual images, e.g., ambient lighting effects. FIG. 33F shows such an embodiment in which an extended display system 3001 has a main display part 3002 that shows main display content 9. The viewer may have this system as his workstation. The extended display part 3003 may simply show colors or low-resolution imagery or “extended lighting” as a virtual image at a farther depth. In some embodiments, the system is used for “eye health and productivity application,” where the extended lighting is a first color 2128A indicating that the user should stay focused, and a second color 2128B when the user should take a break. A benefit of this is to promote eye health because the “break” portion may indicate to the user to look specifically at the farther images, requiring more relaxed accommodation (relaxed ciliary muscles). In some embodiments, sensors 2 capture eye gaze information to impact the intervals between work and break or in the type of lighting. In some embodiments, as shown in FIG. 33G, the main display content 9 indicates that an “eye break” be taken, causing the user to look at farther virtual images 2128 produced by the extended display part 3003. In some embodiments, the virtual image content is dynamic, varying in depth with time to aid in the eye relaxation techniques. The content of the virtual image can be immaterial imagery, further work tasks of a lower priority, calming ambient lighting, and the like. In some embodiments the eye health and productivity application exercises or relaxes a viewer's eyes by having him focus to a different depth than the distance to the main display. It may be used in a workplace to provide a work-content break. It may be used with a sensor that records viewer's eyes' properties or motions to infer health information.

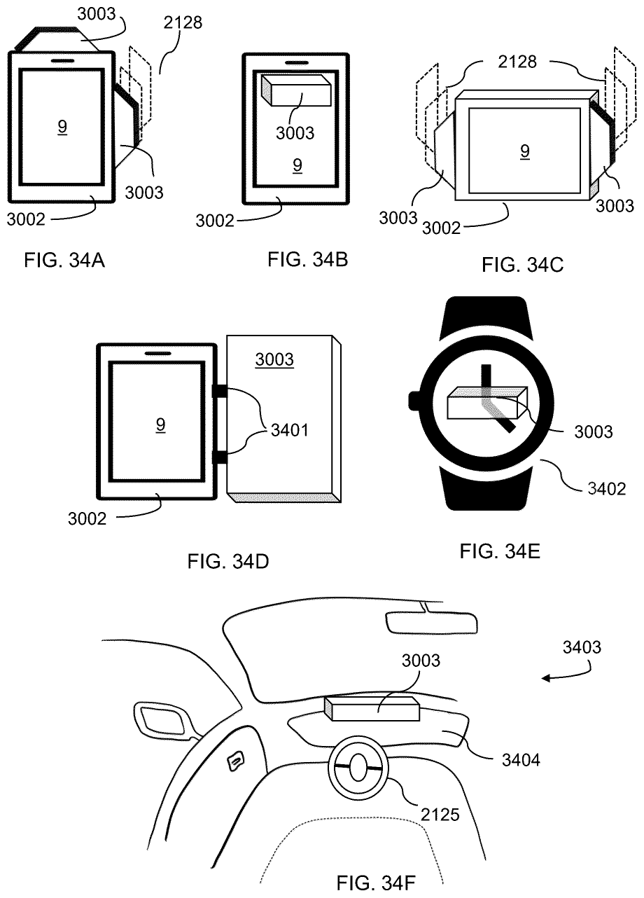

FIGS. 34A through 34F show examples of extended display systems for portable or in-vehicle scenarios. In FIG. 34A, the main display part 3002 is a mobile phone that shows main display content, and the extended display subsystems 3003 are attached to a part of the phone, such as a side, showing virtual images 2128. In some embodiments, the extended part has its own image source. In FIG. 34B, the extended display subsystem 3003 is fixed on top of the main display part 3002, such that a portion of the main display content 9 is used to create the virtual images (similar to FIG. 30C). FIG. 34C shows a similar embodiment as that in FIG. 34A. A tablet is the main display part 3002, which shows main display content 9, and extended display subsystems 3003 show virtual images 2128 on the edges. In any embodiment, the virtual images may be multifocal images. FIG. 34D also shows a portable device as the main display part 3002, which shows main display content 9. The extended display subsystem 3003 is fixed to the main part, but there is a gap, and the portions are connected by mechanical spacers 3401. In some embodiments, the spacers are mechanisms to change the orientation or position of the extended part relative to the main part. In FIG. 34E, the extended display part 3003 is affixed to the display portion of a smartwatch 3402.

FIG. 34F shows an embodiment in which the display system is integrated into a vehicle. 3403. The vehicle may have an in-built display system 3404, such as an instrument cluster, HUD, mirror replacement display, passenger infotainment system, and the like. In some embodiments, the display system 3404 is for a driver behind a steering wheel 2125. This display system may be any of the embodiments, for example in FIGS. 23A through 23D. The in-built display system 3404 serves as the main display part and an extended display subsystem 3003 is affixed to it producing further virtual content. In some embodiments, e.g., in these portable and in-vehicle systems, content may be collaborative. In some embodiments, the virtual images are tilted or curved relative to an aperture optic. In some embodiments, they are closer to the viewer than an aperture optic, and a gesture camera impacts the content. In some embodiments, the virtual images show information about a car's electrical, navigation, mechanical including kinematic information (speed, acceleration, direction), or computer subsystems. In some embodiments, a camera mounted on the outside captures information about nearby objects, cars, or points of interest, to be used as virtual imagery.

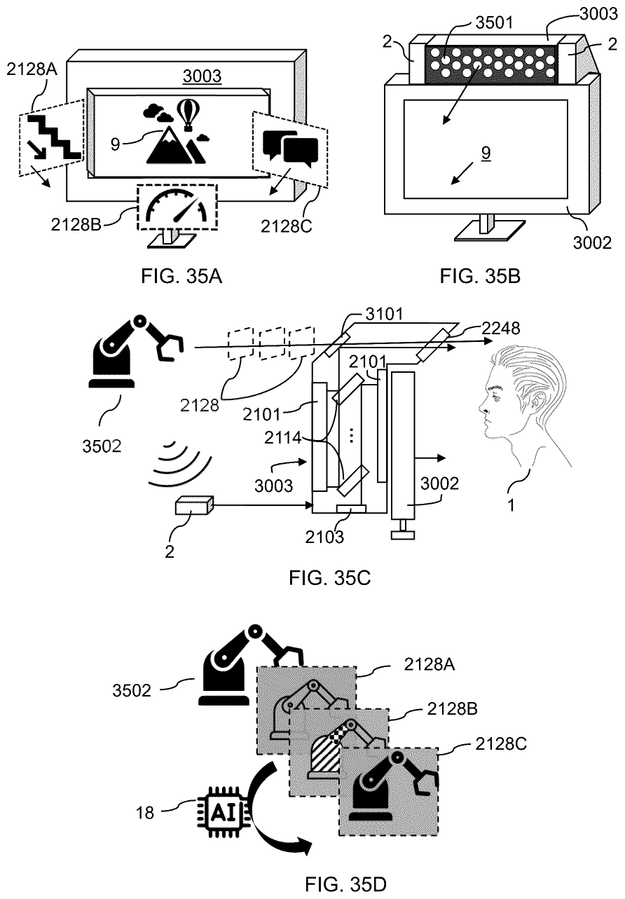

In some embodiments, the extended display system enhances applications originally intended for a main display. FIG. 35A shows an enhanced gaming application: the main display system shows a main display content 9, a gaming environment. The extended display subsystem 3003 converts imagery on the edges into virtual images 2128A, 2128B, and 2128C. In some embodiments, the images are closer to the viewer; tilted or curved to enhance immersion or approximate a human horopter; or modified by an AI module 18 within the extended display subsystem 3003.

In FIG. 35B, a gaming environment similar to FIG. 34G has the main display part 3002 showing main display content 9, and the extended display subsystem 3003 having an ambient-lighting component 3501 (or “ambient-lighting layer”) that may be an absorbing pattern or mask, an aperture array (a mask that has a pattern of small holes or perforations), a velvet or other absorbing layer, a low-resolution LCD matrix, a modulation matrix, and the like. An ambient-lighting layer is a component that changes or influences a property of the light but does not necessarily form a high-resolution virtual image. Rather, it is used to produce ambient or environmental effects. In some embodiments, this component serves as a component of the aperture optic. This type of extended display subsystem does not produce virtual images but rather different lighting effects, ambient lighting, mood lighting, lighting that may be synchronized with other subsystems or audio/music. An ambient-lighting layer may be used to produce the effects desired in FIGS. 33F and 33G.

FIG. 35C shows an embodiment like that in FIG. 31A, except that it enables AR-style display capabilities. A viewer 1 sees an image from the main display part 3002. Operably coupled to it is an extended display subsystem 3003, which has two displays 2101 that emit light toward a plurality of beam splitters 2114, which directs some light down to a mirror 2103. Light reflected from these specular reflectors is directed up to a semi-transparent relay 3101. This element reflects the light from the extended display subsystem 3101 and transmits light from an external scene 3502. All this light is then transmitted through an image aperture optic 2248 to be viewed by the viewer 1, who sees virtual images 2128 overlaid on top of the external scene 3502. In some embodiments, a sensor 2 records information about the external scene 3502 and transmits it to the display system to modify image content. In some embodiments, the beam splitters 2114 are polarization-dependent, and the mirror 2103 is a QM.

An example use case is in a manufacturing, design, hardware production, quality control, or prototyping environment. For example, as shown in FIG. 35D, the external scene 3502 is a machine or prototype, and the virtual images 2148A, 2148B, 2148C are images of designs of different subsystems (e.g., a mechanical, optical, electrical, or computational subsystems). In some embodiments, sensor information is to be shown on one of the virtual images, similar to the embodiment of FIG. 13B. Sensor data may feed an AI module 18 that generates modifications or textual notifications based on those data. For instance, the sensor may be a camera, and the AI module includes a computer-vision function to detect mechanical vibrations of a prototype during testing. The vibrations are recognized by the AI module as a deficiency, and a neural network outputs a possible reason why the mechanical design causes it and suggests mitigation measures.

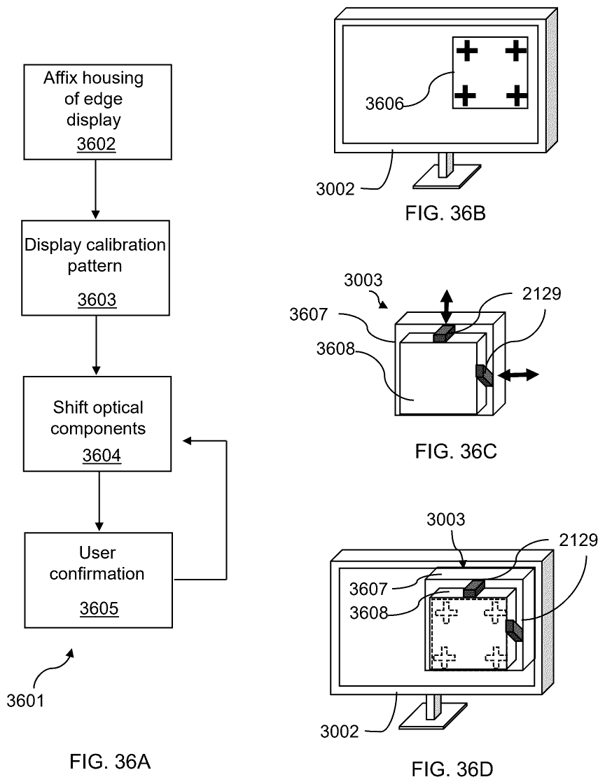

FIG. 36A shows a calibration block diagram 3601 to align an extended display subsystem over a main display part such that the image content shown on the main display correctly travels through the extended part to form the desired virtual image content. A “calibration mechanism” is a set of mechanical joints, actuators, etc., and the code or instructions to move subcomponents relative to the main display to optimize the imagery produced by the extended display subsystem. The calibration mechanism may be arbitrarily engineered. The first calibration step 3602 is to affix the housing of the edge display part to the main display part. In some embodiments, there are mechanical attachments or guides, such as clamps, tracks, grooves, and the like. The second calibration step 3603 is to display a calibration pattern in the area where the extended display subsystem is fixed. This pattern may be, for example, a sequence of lines, shapes, crosses, and the like, of various colors. In some embodiments, the calibration pattern is dynamic to calibrate a time-response, such as a refresh rate. The calibration may also be used to adjust brightness or local resolution. The third calibration step 3604 is to shift the optical components within the extended display relative to the mechanical housing that is fixed to the main display part. This relative motion may be enacted by a series of motors, gears, scissor mechanisms, and the like. The fourth calibration step 3605 is a user confirmation. This is a feedback step where a user who is viewing the resulting virtual image can continue to shift the optical components—directly or through electronic signaling via user input or other sensor—to optimize the image. Feedback may change the image's relative size or brightness, and it may be automated via an internal sensor (e.g., camera or photodetector) to detect light intensity and adjust the optical components accordingly.

Calibration steps are now described. In FIG. 36B, the main display part 3002 produces a calibration image 3606 where the extended display part resides. In FIG. 36C, the extended display subsystem 3003 has a housing 3607 and an optical subsystem 3608. Mechanical actuators 2129 move the optical subsystem relative to the housing. In FIG. 36D, the housing 3607 is affixed to the main display part 3002, and mechanical actuators 2129 move the optical subsystem 3608 to optimize the resulting virtual image. Mechanical actuators may be user adjustable.

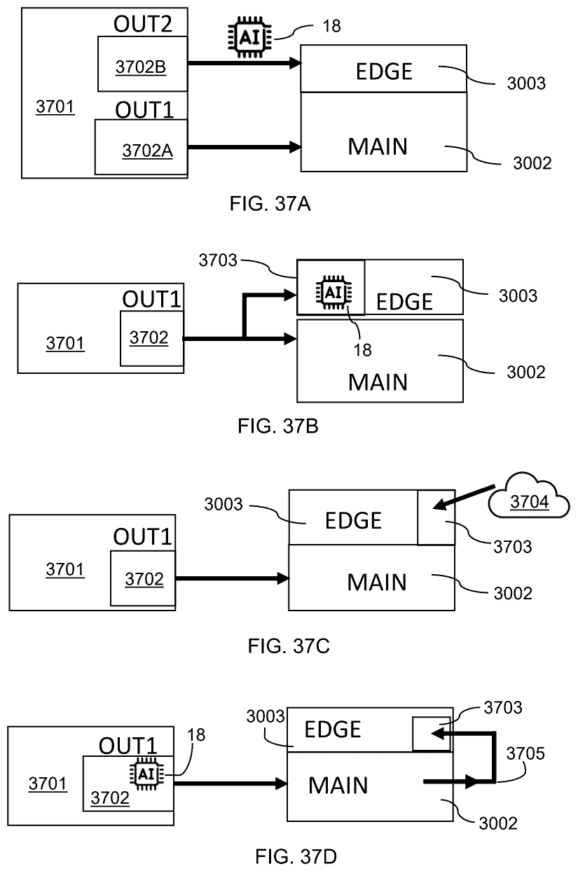

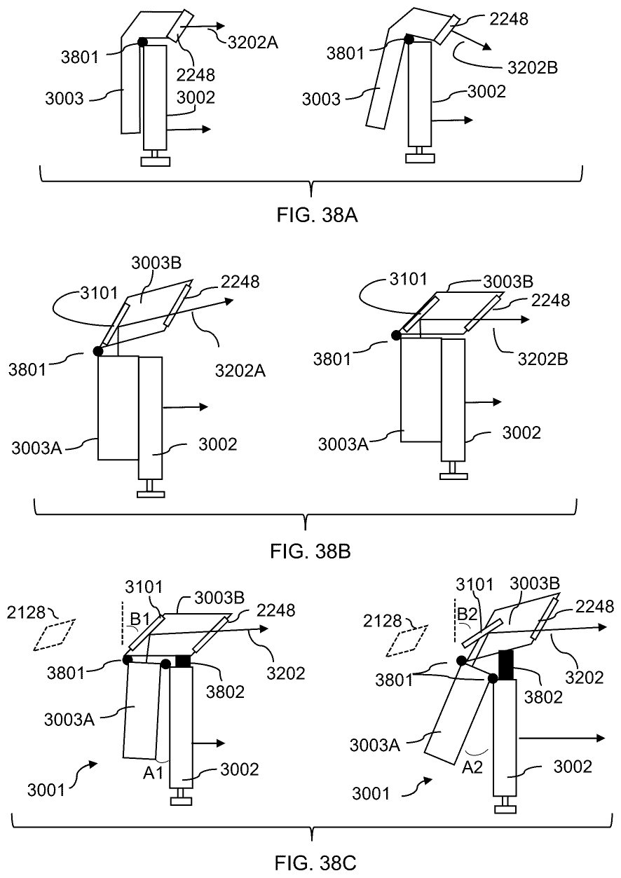

Main display and extended display subsystems are operably coupled, such that the content shown on them are coordinated. The extended content may show more features or extensions of the main content, may be synchronized with the main content, or may depend on the main content (e.g., as modified by an AI module). FIGS. 37A through 37D show some block diagrams to depict some of the various ways in which the display parts may be operably coupled. In FIG. 37A, a main computational unit 3701 has a first output 3702A to display content on the main display part 3003 and a second output 3702B to send display content to the extended display subsystem 3003. In some embodiments, an AI module 18 takes in the content from the second output 3202B to modify it before sending it to the display system. The output may be, for example, HDMI, USB, Bluetooth, etc. In FIG. 37B, a main computational unit 3701 has a single output 3702 that sends display content to the main display part 3002 and the extended display subsystem 3003. In this example, the content is the same, but the extended display subsystem has an in-built module 3703 that may include an AI module 18 to process the display content before being displayed on the extended display subsystem 3003. In FIG. 37C, the main computational unit 3701 sends display content via an output 3702 to the main display part 3002. The extended display part 3003 receives input via an in-built module 3703 from a wireless source 3704. In FIG. 38D, the main computational unit 3701 sends display information through an output 3702, including an AI module 18, before being shown on the main display part 3002, which has its own output that is sent via daisy chain 3705 to the extended display part 3003, where it is received and processed by an in-built module 3703.

FIGS. 38A through 38C show various embodiments of the mechanical coupling and how the mechanical coupling allows the extended part to be moved relative to the main part. For example, FIG. 38A shows an embodiment in which the extended display subsystem 3003 is connected to the main display part 3002 via a mechanical joint 3801, such as a hinge. When the mechanical joint is rotated such that the extended display subsystem 3003 is in a first position, light exits through an aperture optic 2248 and travels in a first direction 3202A. When the mechanical joint 3801 is rotated such that the extended display subsystem 3003 is in a second position, light exits and travels in a second direction 3202B. Such changes enable virtual images to change their positions or orientations while keeping light from the main display part 3002 fixed.

An extended display subsystem need not move monolithically. For example, FIG. 38B shows that the mechanical joint 3901 allows a first part of the extended display part 3003A to remain fixed while a second part of the extended display subsystem 3003B moves. Light exiting the first part enters the second, is reflected by a relay 3101 and is transmitted through an aperture optic 2248 to travel along a first direction 3202A or a second direction 3202B depending on the orientation of the second part. The main display part 3002 is fixed here. Although the image aperture optic is exemplified here with an ambient light suppressor, any optical component suffices. In any of the embodiments, the image aperture 2248 may instead be, e.g., a transparent layer of glass or plastic.

In some embodiments, mechanical joint comprise multiple gears, translational stages, scissor mechanisms, and the like. Internal optical elements may move in addition to the housing. E.g., in FIG. 38C, an extended display system 3001 includes a main display part 3002 and an extended display subsystem itself comprising a first part 3003A and a second part 3003B. A mechanical joint 3801 allows the first part 3003A and the second part 3003B to move differently from a first angle A1 to a second angle A2. The mechanical joint may include a series of gears, and a motorized or otherwise moveable mechanical spacer 3802. Further, an internal element, such as the optical relay 3101, rotates from a first angle B1 to a second angle B2. The result is that the direction 3202 and/or position of the light exiting through the aperture optics 2248 does not change, such that the virtual image 2128 is unchanged. This embodiment allows an extended display subsystem to adjust its shape or geometry to be able to accommodate different sizes or geometries of a main display part. In some embodiments, the difference between the angles B2 and B1 and the difference between the angles A2 and A1 satisfies |A2−A1|/|B2−B1|=2. Mechanical spacers may assist in eliminating lateral shifts of the virtual image. Hinges and spacers may move via user input, or mechanical or electronic means, or they may move automatically based on a sensor output.

A “mechanical joint,” is a mechanical coupling between a first part and a second part of a hardware (sub) system. The mechanical joint allows relative motion between the two parts. In some embodiments, it is a mechanical actuator, a hinge, a track, a ball joint, a gimbal joint, a telescoping joint, a mechanical linkage, or a combination thereof. The mechanical joint may be adjusted electronically or through a user's direct manipulations.

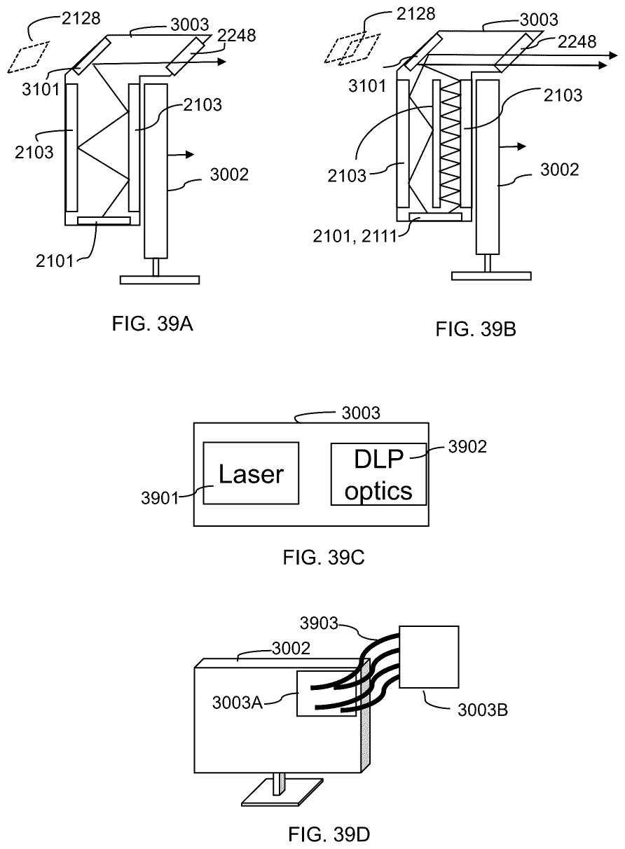

An FEC is part of a broader class of “light-guiding subsystems,” which are optical subsystems in which the light forms a virtual image by being guided along an optical path. An image guide or periscope-style guide are other examples of light-guiding subsystems. In some embodiments, the specular reflectors are different surfaces of, e.g., a slab of glass, acrylic, or other dielectric. FIGS. 39A through 39D show various light-guiding subsystems for extended display subsystems. FIG. 39A shows an embodiment of a main display part 3002 and extended display subsystem 3003, which generates light using a display 2101 and guides it via a plurality of mirrors 2103 to a relay 3101 and through an image aperture optic 2248 to generate a virtual image. In FIG. 39B, an extended display subsystem 3003 uses a display 2101, e.g., a segmented display that shows multiple display contents. An angular profiling layer 2111, e.g., a directional film, may alter the light direction. Shallow angles bounce many times between mirrors 2103, whereas more vertically oriented light bounces fewer times. The light is reflected by a relay 3101 through an aperture optic to produce a multifocal virtual image 2128. The bounce number maps to the monocular depth. FIG. 39C is a block diagram for an extended display subsystem 3003 where the light source is a laser 3901, which is out-coupled via digital light processing (DLP) optics 3902. In some embodiments, the DLP comprises an SLM or a DMD. In some embodiments, the DLP comprises refracting or reflecting optics, a diffuser, or an angular profiling layer. In some embodiments, the laser is replaced by one or more LEDs.

In FIG. 39D, the main display part 3002 is coupled to a first part 3003A of an extended display subsystem that receives light from the main part. The light is guided along a light guide comprising a bundle of optical fiber or elongated light guiding dielectrics 3903 to a second part of the extended display subsystem 3003B. Thus, the image light is guided by a set of elements, each carrying one or more pixels. The plurality of specular reflectors is the plurality of surfaces of each member of the bundle, which may take on certain cross sectional widths. In some embodiments, the cross-sectional with may be less than 100 microns, more than 100 microns, or more than 1 mm.

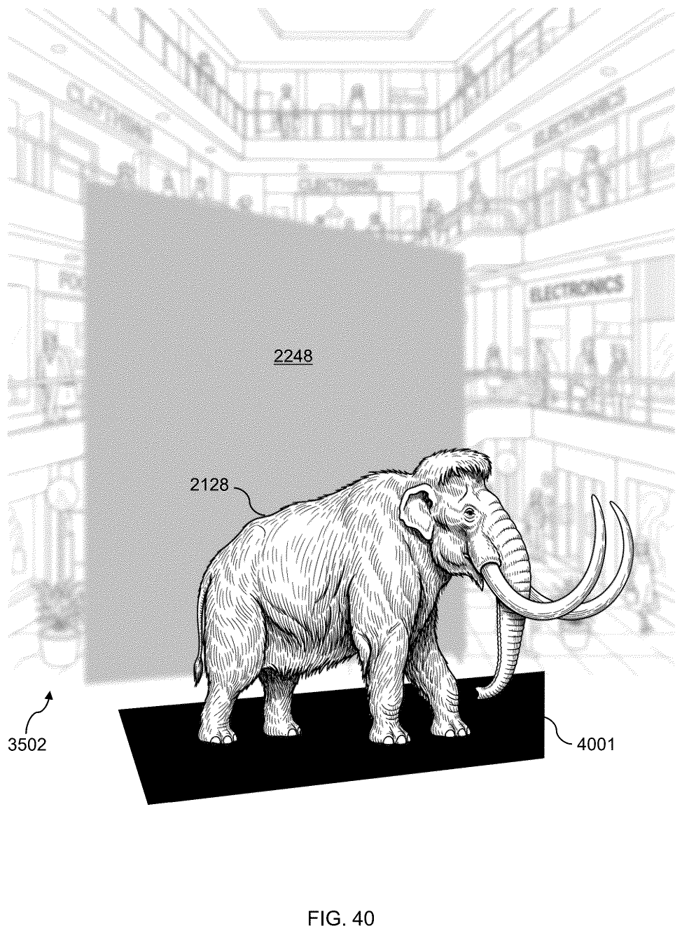

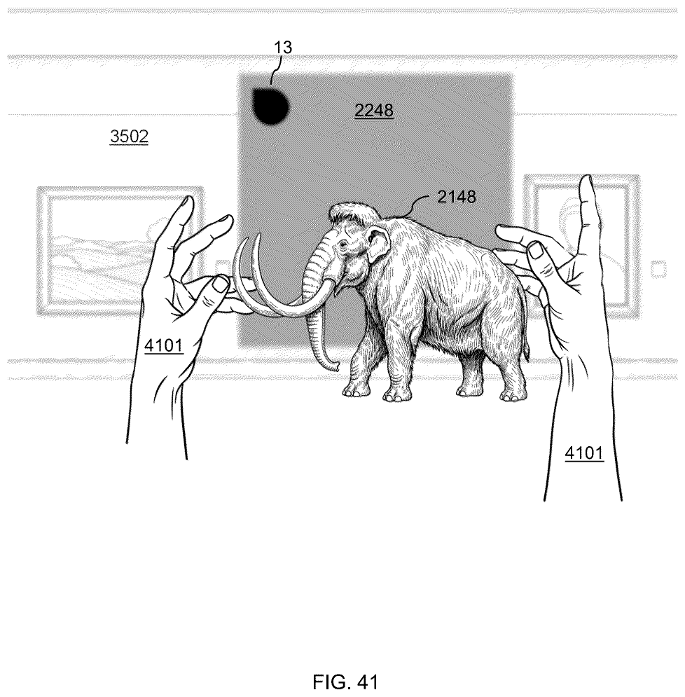

In some embodiments, instead of a size similar to that of a button, the size of a hovering (or, synonymously, “midair”) image is large, as shown in FIG. 40, which may be used for immersive entertainment, advertising, marketing, or decorative applications. The hovering image may have a lateral dimension greater than 20 cm, greater than 30 cm, greater than 50 cm, greater than 1 m, or greater than 2 m. The virtual image 2128 is hovering in front of the exit aperture optic 2248, such that focusing on the former will make the latter, as well as the environment 3502 behind the exit aperture optic 2248, appear blurry to the viewer. In some embodiments, a platform 4001 orients the position of the hovering image's monocular depth. In FIG. 41, the virtual image 2148 is floating near a viewer's body part 4101, such that the viewer can interact with it through sensors 13 that may be affixed to a component of the display system, such as the exit aperture optic 2248 or the housing. When the viewer is looking at the hovering image, the display system and the environment 3502 behind the hovering image will be blurred. In some embodiments, the blur is noticeable by the human viewer. In some embodiments, the blur is not noticeable, for example, if the distance between the aperture optic and hovering image corresponds to an optical power difference (diopters) that is not distinguishable by the human vision system.

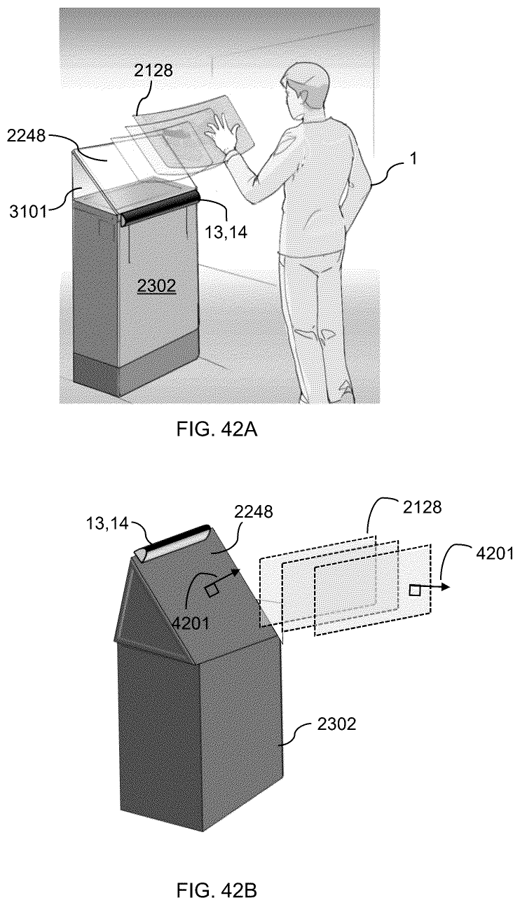

A hovering image may be generated by the embodiment shown in FIGS. 42A and 42B. A viewer 1 sees a virtual image 2128 which, in this embodiment, is a multilayer or multifocal virtual image that is hovering above or in front of the display systems exit aperture optic 2248. In some embodiments, the housing 2302 is extended to contain a plurality of specular reflectors. In embodiments like this one, the display system is a free-standing display system. The viewer 1 interacts with the image through sensors 13 and/or cameras 14. When sensors or cameras detection some feature of the viewer, it is said that the sensor or camera detects a property of the viewer. In some embodiments (FIG. 42A), at least one of the images is curved and/or has a surface parallel to the aperture optics. In some embodiments (FIG. 42B), the image planes are oriented in a different direction compared to the plane of the aperture optic, such that the angle formed by their respective normals 4201 is oblique. In some embodiments, the oblique angle is acute, for example, less than 90°, less than 80°, less than 70°, less than 60°, less than 50°, less than 45°, less than 30°, and the like.

Notably, a hovering image is closer to the viewer compared to the aperture optic, but other components or pieces of the entire display system may stand at a third, different, distance. For example, framing or bezels, or other mechanical or housing components may lie closer to the viewer than the hovering image. (This implies that the aperture optic itself may be recessed from the housing.)

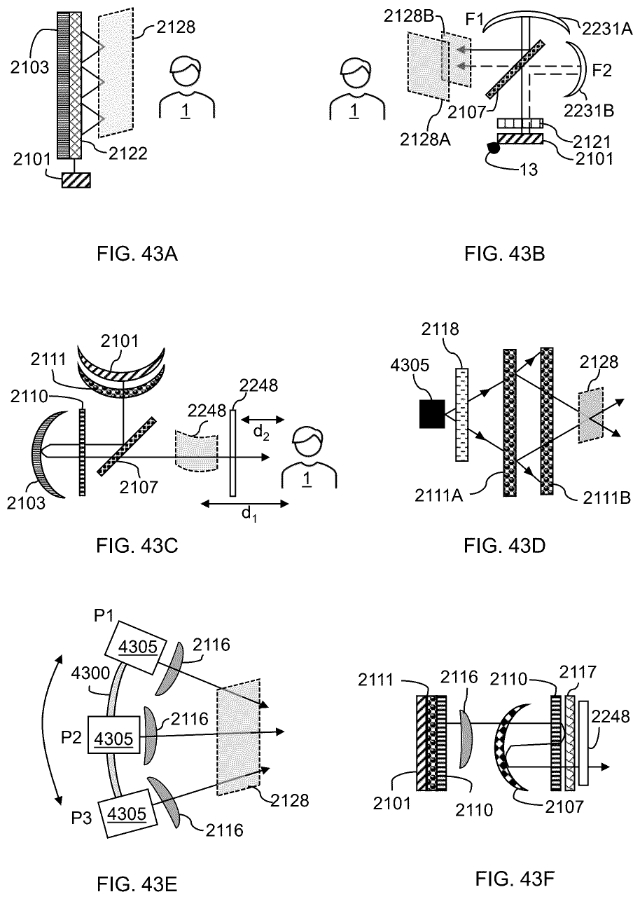

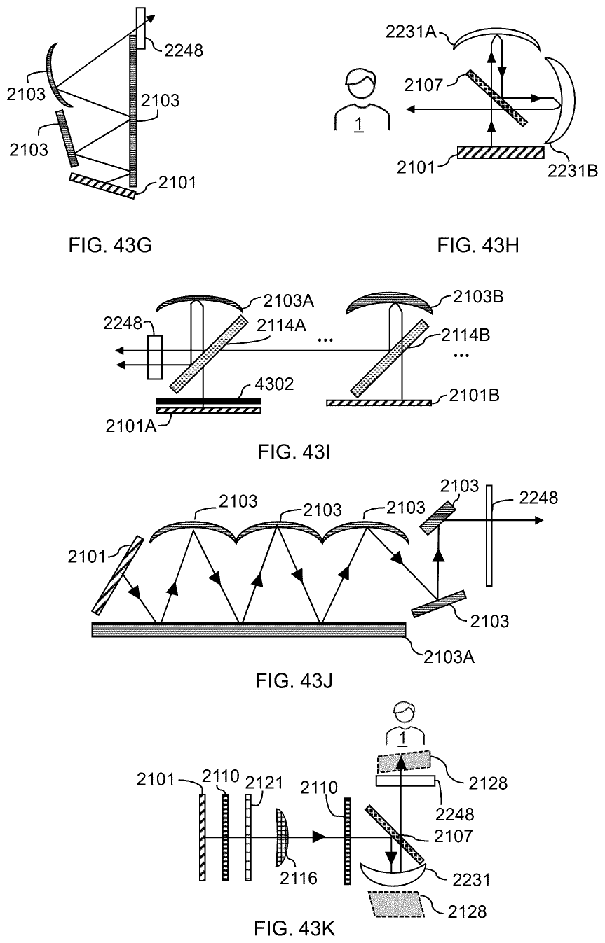

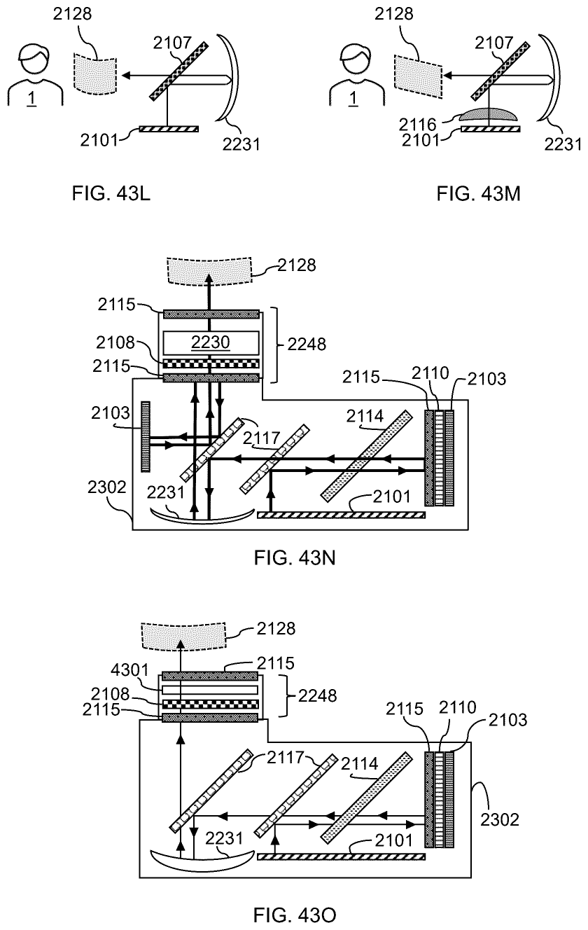

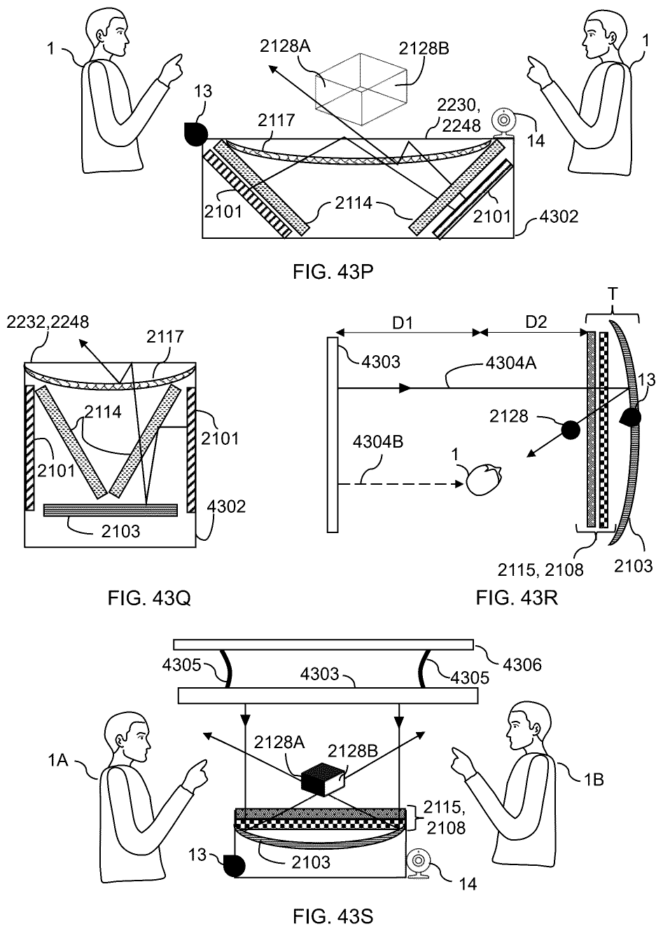

FIGS. 43A through 43S describe various display systems that generate hovering or floating images. In FIG. 43A, a display 2101 couples light into a waveguide 2122 that uses wave dispersion to shape the wavefront profile into converging points at the hovering image position. In some embodiments, the waveguide is a metamaterial or a photonic crystal. In some embodiments, a different light source is used, such one or more lasers or LEDs, which may be coupled to light shaping elements such as SLMs or DMDs. In some embodiments, a mirror 2103 is coated on one side of the waveguide to help reflect or channel light along the waveguide. In some embodiments, a grating is used to couple the light into and/or out of the waveguide. This may be a surface relief grating, for example, and each color channel may be directed by its own gratings/waveguides. The result is a virtual image 2128 that the viewer 1 perceives as closer to him than the optical components of the display system. In some embodiments throughout the disclosure, waveguides may be volume gratings, thin gratings, or polarization gratings.

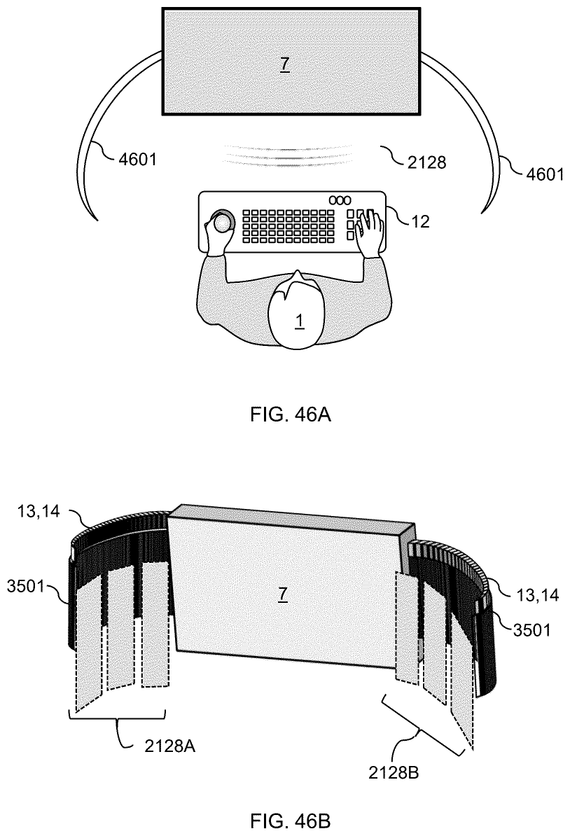

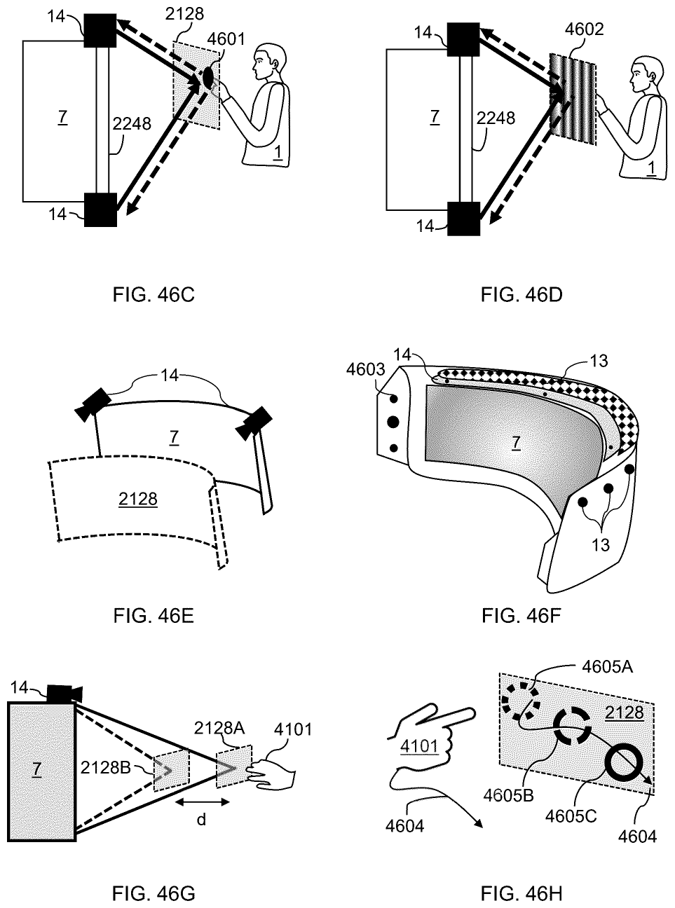

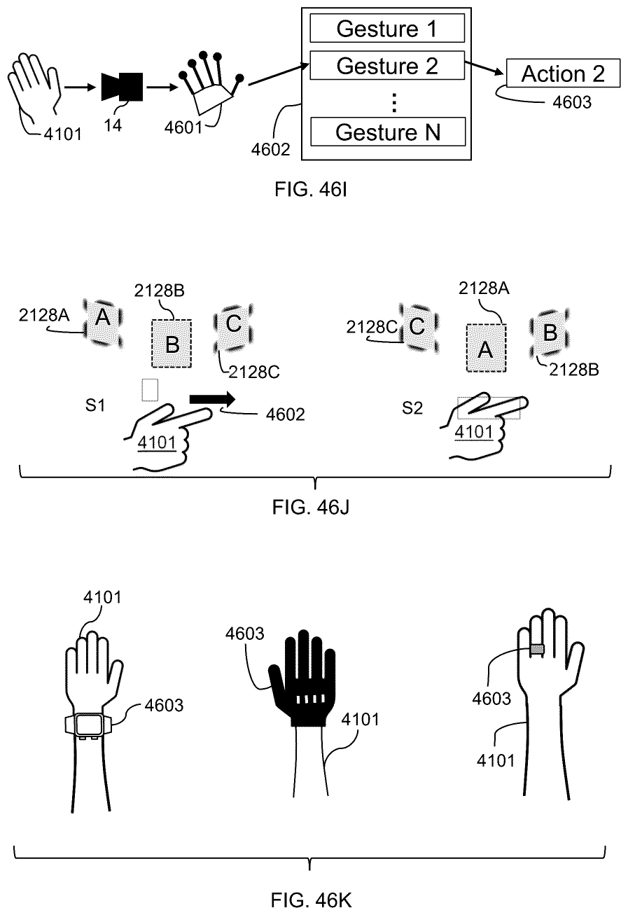

FIG. 43B shows an FEC-based system that is switchable: a display 2101 emits light through a LC plate 2121, which is in an ON state or an OFF state. In the ON state, the light is of a certain polarization, e.g., horizontally polarized, passes through a PBS 2107 (or reflective polarizer), is reflected by a first QM 2231A, which also rotates the polarization into vertical polarization, so that the light is reflected by the PBS 2107 and is seen by the viewer as a first virtual image 2128A. The focal length F1 of the specular reflector component of the first QM 2231A impacts the monocular depth or magnification of this virtual image. If the LC plate 2121 is changed to the OFF state, the light it transmits is polarized orthogonally to what transmits in the ON state, here, vertically polarized. It is then reflected by the PBS 2107, reflected and rotated in polarization by a second QM 2231B (which has a different focal length F2) transmitted by the PBS 2107, and forms a second virtual image 2128B, which has a different monocular depth. In this way, the depth, magnification, etc., of the hovering image can be modulated in time, by causing the LC plate to switch between states. In some embodiments, the switching is faster than the time response of the human eye, such that both virtual images are simultaneously visible. In some embodiments the LC plate is a LCVR and a specular reflector within a QM is a deformable mirror, such that a continuum of monocular depths or magnifications is achievable. In any embodiment wherein an LC plate, LCVR, LC matrix, or any electro-optic component is able to modulate or modify one or more monocular depths of a virtual image, said component “temporally modulates” the one or more monocular depths. The rate at which the monocular depth is monocular can be slower or faster than the human response, such that the viewer either can see the instants of modulation or can see only a time-averaged effect. This terminology is applicable at least to FIGS. 43B, 43K, and 46G, and to any other embodiment that includes such a component.

In some embodiments (see also FIGS. 43L and 43M), multiple elements are curved to impact the monocular depth of the hovering image, compensate distortions, or change the image magnification. The curvature of these elements may be concave, convex, freeform, spherical, cylindrical, parabolic, and the like. In some embodiments, the curvature in one direction (e.g., x) is different than that in the perpendicular direction (y), which may be useful especially, but not only, in high aspect-ratio images. For example, in FIG. 43C, the display 2101 is convex and emits light through a convex angular profiling layer 2111, which may be a directional film. The light is reflected by the PBS 2107, is transmitted through a QWP 2110, reflected by a concave mirror 2103, and transmitted back through the QWP 2110, such that its polarization is rotated 90° to be transmitted through the PBS 2017 and through the exit aperture optic 2248 to form a virtual image 2128 as viewed by a viewer 1. The image may be curved. Note that in this embodiment, the monocular depth is farther d₁ from the viewer 1 than the exit aperture optic 2248 at distance d₂. However, it is still considered a hovering image because it is first formed as a hovering real image at that location. Thus, in some embodiments, the hovering image has a monocular depth farther from the fewer than the exit aperture optic.

FIG. 43D shows a coherent-based embodiment, in which the generic light source 4303 is a laser 2111A and a second profiling layer 2111B. The first layer is an HOE or DOE that generates a real and virtual hologram. The second layer is a directional film to eliminate the highly diverging light rays of the virtual hologram, leaving behind the real hologram to generate a hovering virtual image 2128.

FIG. 43E shows a mechanically scanning embodiment, in which the generic light source 4303 (e.g., laser) and a collimating or focusing lens group 2116 are coupled to a mechanical track 4300 that can scan the optical components into different positions and orientations, e.g., positions P1, P2, and P3, which are swept through at a fast enough rate, for example, faster than 30 Hz, 60 Hz, or 120 Hz. Each position corresponds to a single point or small patch of the virtual image 2128. In this way, the aperture size is effectively increased compared to the optical components. This is a method of synthetic aperture enhancement for virtual displays.

FIG. 43F shows a coaxial FEC that forms hovering images. A display panel 2101 emits light, through an angular profiling layer 2111 that is a directional film then optionally through a lens group 2116 which is used to impact the curvature and monocular depth of the resulting image. In some embodiments, a wave plate, such as a QWP 2110 is disposed before a PBS 2107 to modify the polarization of the light. The light passes through the curved PBS 2107 and through another QWP 2110. It is then reflected by a reflective polarizer 2117 and through the QWP again, so that the light rotates its polarization and is reflected by the PBS 2107. The light then travels through the second QWP 2110, the reflective polarizer 2117, and through the exit aperture optic 2248.

In FIG. 43G, at least two of the specular reflectors, here, two flat mirrors 2103 form an acute angle relative to each other. As the display 2101 emits light into this embodiment, the reflected light changes its propagation direction. It then is reflected by a curved mirror 2103 and passes through the exit aperture optic 2248 to form a hovering image. The angle of the normal to this virtual image may be different than the angles of either of the normals of the two flat mirrors 2103. The acute angle between the at least two specular reflectors may be 45°, or smaller than 45°, 30°, 25°, 20°, or 15°. In some embodiments, it lies within a range, for example, between 45° and 5°, between 30° and 10°, and the like

FIG. 43H shows an embodiment in which a display 2101 emits light through a PBS 2107. The light is reflected by a first QM 2231A, reflected by the PBS 2107, then reflected by a second QM 2231B, such that it is transmitted by the PBS 2107 to be seen by the viewer 1. In this embodiment, the light is reflected by the PBS more than once, and it is transmitted by the PBS more than once. Either or both QMs may be curved. In this embodiment, the light path is folded such that the two mirrors are oriented at different angles relative to each other.

FIG. 43I shows an embodiment with multiple display panels, including a first display 2101A and a second display 2101B. In some embodiments, they emit light all in the same direction, upward in this figure. The upward traveling light passes through a semi-reflector such as a beam splitter, 2114A, 2114B, is reflected by a plurality of curved mirrors 2103A, 2103B, and is then reflected by the beam splitters to be transmitted by a single exit aperture optic 2248 to form a virtual image. In some embodiments, the spectrum of a first display 2101A differs from that of a second display 2101B. In order to modify the spectrums such that multifocal images are pleasing to the eye, reflect desired color characteristics, or are blended spectrally in an appropriate way, one or more color filters 4302 may be inserted in one of the beam paths. Color filters could comprise multilayer and/or dielectric thin films. In some embodiments, they have a finite rejection band, finite pass band, are high-pass filters, or low-pass filters.

In FIG. 43J a display 2101 emits light that propagates between one flat mirror 2103A and a plurality of curved mirrors 2103, each curved mirror contributing to the magnification, image depth, and image curvature. A final relay comprising two smaller flat mirrors 2103 redirects the light through an exit aperture optic 2248 to form a virtual image for a viewer.

It is important to note that multiple curved or focusing elements (e.g., a lens and a curved mirror, a plurality of curved mirrors, a plurality of curved lenses, a curved Fresnel lens, a lens with two curved surfaces, a plurality of Fresnel lenses, a Fresnel lens and a curved mirror, a Fresnel lens and a lens, and the like) distribute the required focusing power across them to enable further design freedoms in the system. In some embodiments, multiple such elements are used to mitigate an optical aberration (spherical aberration, coma, astigmatism, field curvature, distortion, chromatic aberration, and the like). In some embodiments, the Coddington shape factor is used to influence the image aberration. In some embodiments, aplanatic, freeform, achromatic, or aspheric curvatures are used. In some embodiments, the curvature of the focal plane(s) is (are) designed to match a Petzval surface.

In some embodiments, polarization is used to determine the light path. In FIG. 43K, light from a display 2101 passes through a QWP 2110 to create circularly polarized light from incident linear polarization, and then through an LC plate 2121, which can be ON or OFF. In the ON state, the light is RCP (LCP), and in the OFF state the transmitted light is LCP (RCP). The light then passes through a lens group 2116 which comprises a Pancharatnam-Berry (PB) lens. RCP and LCP light each experience a different curvature or focal length when passing through a PB lens. For example, RCP light my be focused as a convex lens would execute, and LCP would diverge as a concave lens would execute. In some embodiments, the sign of the curvature is the same but different in magnitude. The light then passes through a QWP 2110, is reflected by a PBS 2107, then reflected and rotated in polarization by a QM 2231, and exits through the exit aperture optic 2248 to a viewer 1, who sees two virtual images 2128 that are hovering images, corresponding to the LCP and RCP light.

FIGS. 43L and 43M each show an embodiment in which light from a display is reflected by a PBS 2107 (or reflective polarizer), then reflected and rotated in polarization by a QM 2231, such that the light is finally transmitted by the PBS to form a virtual image 2128 visible to a viewer. In some embodiments, the virtual image is curved, as in FIG. 43L. In some embodiments, an added lens group 2116 corrects that curvature to make the virtual image flat, as shown in FIG. 43M. In some embodiments, the curved specular reflector of the QM is external to the housing of the display system and is a windshield of a vehicle, such that the corrected curvature takes into account the curvature of the windshield. In some embodiments, the image content itself is modified with opposing curvature to that of the hardware components, such that the curvature is corrected by software.

FIG. 43N shows another embodiment of a hovering image display system. Light is emitted by a display system and encounters a plurality of semi-reflectors, including a reflective polarizer 2117, which directs light to an AR layer 2115, QWP 2110 and mirror 2103 (all through a beam splitter 2114, which may serve to direct other portions of light from the display to the same subassembly). The reflected light is rotated in polarization and passes through that reflective polarizer and is reflected by another reflective polarizer 2117 down to a curved QM 2231. The light then passes that second reflective polarizer is transmitted through an AR layer 2115, is reflected by a QBQ 2230, reflected by that second polarizer 2117 again, reflected and rotated in polarization by a flat mirror 2103, reflected again the by reflective polarizer 2117, and is transmitted through the AR layer 2115, QBQ 2230, and second AR layer 2115 (composing together the exit aperture optic 2248) to form a hovering virtual image 2128. In some embodiments, such as in FIG. 43O, the optical path can be shorter, so that after reflection by the curved QM 2231 and transmission by the second reflective polarizer 2117, the light passes through the exit aperture optic 2248 (comprising a first AR layer 2115, an absorptive polarizer 2108, and a second AR layer 2115 (any of which may be coated onto a substrate 4301 such as glass or plastic), the light exits and forms a virtual image 2128. In any embodiment, including FIGS. 43N and 43O, directional films may be disposed after one or more display panels. For a given display panel in some embodiments, multiple directional films are used at different orientations.

In some embodiments, multiple users can view the hovering image or interact with it simultaneously. FIG. 43P shows multiple viewers 1 interacting with a virtual image that may have a first virtual surface 2128A and a second virtual surface 2128B for each user to view respectively. In some embodiments, the first and second viewers are positioned in a first and second headbox, such that a virtual image is scene simultaneously while both viewers are in their respective headboxes. In some embodiments, the two headboxes are contiguous forming a single larger headbox, whereas in other embodiments, the two headboxes are not continuous. The embodiment may be integrated into a piece of furniture, such as a table, counter, chair, sofa, cabinet, shelf, and the like, or into a wall, ceiling, or floor. In some embodiments, it is integrated into a piece of furniture called a command station for command and control applications, a flight simulation rig, a teleoperations rig, and the like. The light-guiding subsystem is housed within the furniture 4302. A first and second display 2101 emit light respectively through a first and second specular reflector such as a beam splitter 2114. In some embodiments, an angular profiling layer such as a directional film is layered after the displays to change the directionality of the light rays or restrict the viewing angles. The light travels through a curved polarization-dependent semi-reflector such as a curved reflective polarizer 2117. It is reflected by a QBQ 2230, reflected by the reflective polarizer 2117, then transmitted through the QBQ 2230 and the exit aperture optic 2248 to form the imagery. In some embodiments, a viewer 1 can interact with the virtual objects using sensors 13 or one or more cameras 14 that detect gestures, motion, eye or head position/orientation, voice commands, and the like. These are nonlimiting examples of the types of properties that a camera/sensor can detect.

FIG. 43Q shows a cross section of an embodiment that is integrated into a piece of furniture 4302, such as a command station. Each of the vertical or substantially vertical walls have a display disposed 2101 onto them. In embodiments where the walls are contiguous, a single flexible or bent display (e.g., flexible OLED, AMOLED, or LED) is used, or a plurality of flexible or bent displays is used. The light is reflected downward by a semi-reflector such as a beam splitter 2114, is reflected back upward by a mirror 2103, transmitted through the beam splitter 2114, transmitted through a curved reflective polarizer 2117, reflected and rotated in polarization by a QBQ 2232, reflected by the reflective polarizer, and then transmitted through the QBQ 2232 and the exit aperture optic 2248. In some embodiments, the beam splitters are polarization dependent, and the mirror is a QM that changes the polarization. In some embodiments, there is a specular reflector for each vertical wall. In some embodiments, the vertical wall is curved, and the beam splitter is also curved into an inverted conical or partially conical shape, an inverted frustrum, and the like.

FIG. 43R shows an overhead view of an embodiment in which a viewer's intended position is between some of the optical components. A light source 4303, which may include a backlight, a modulation matrix that modulates the polarization of the backlight pixelwise, or collimating optics. The light travels a distance D1, passes a viewer 1, travels another distance D2 to the rest of the display system. It passes through an AR layer 2115 and absorptive polarizer 2108, which absorbs a certain polarization to convert the polarization modulation of the light into an intensity modulation, i.e, into a visible image. It is then reflected by a curved specular reflector such as a mirror 2103, travels back through the polarizer and AR coating to form a virtual image 2128. In some embodiments one or more sensors 13 allows the viewer 1 to interact with the image. In some embodiments, some light, for example a first light ray 4304A contributes to the image, while other light, such as a second light ray 4304B is blocked by the viewer 1 or another person or obstacle in the beam path. This affects the brightness and viewing zone(s) of the virtual image and depends on D1, D2, the thickness T of the optical subsystem and the focal length of the mirror. This embodiment allows the passive subassembly of the display system to be thinner by separating the light source.

In a similar embodiment, shown in FIG. 43S, the light source 4303 is supported by supports 4305 such as cables, and attached to a ceiling 4306, interior roof, high horizontal surface structure, ducts, joists, beams, and the like. The light travels downward through an AR layer 2115 and absorptive polarizer 2108 to generate an intensity modulation, is reflected by a curved mirror 2103, and forms a virtual image which may include a first virtual surface 2128A and a second virtual surface 2128B, each of which is viewed by a first viewer 1A and a second viewer 1B. Sensors 13 and/or cameras 14 allow for user interactivity. In some embodiments, a lateral dimension of the backlight is larger than that of the mirror or polarizer.

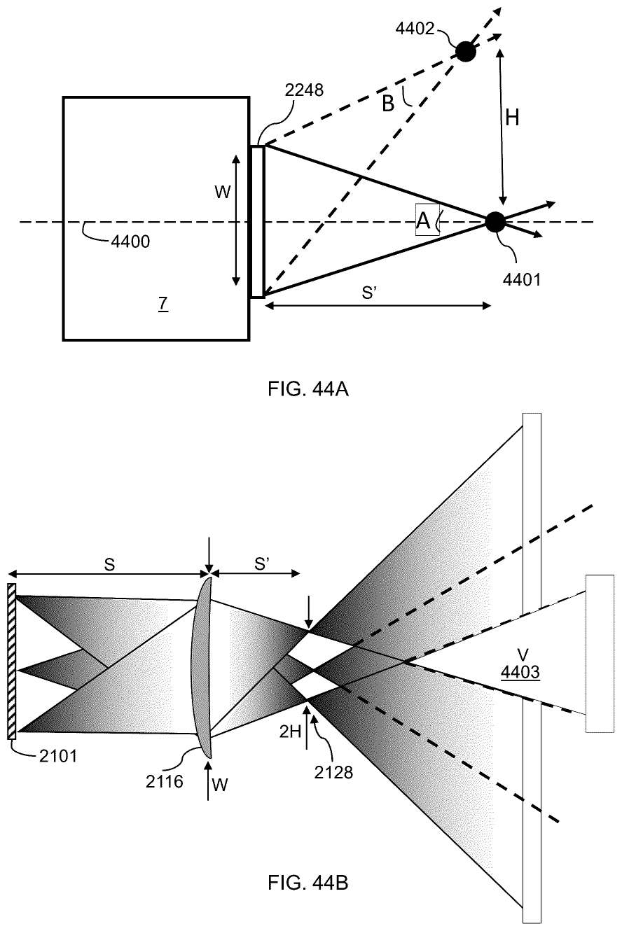

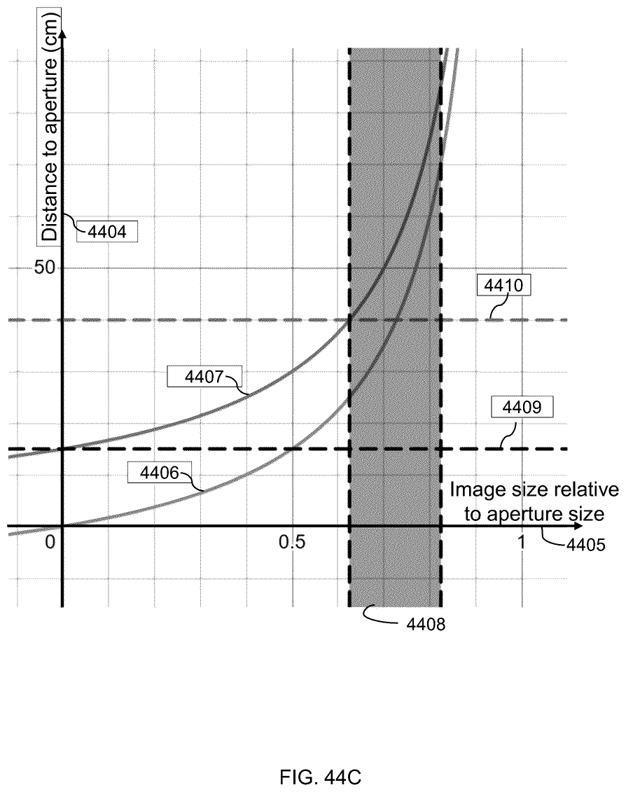

The size, shape, magnification, monocular depth(s), viewable zone, and field of view are determined by one or more properties of at least one optical component within the display system. FIG. 44A shows a display system 7 that is used to generate virtual hovering images. Such virtual images include a central image point 4401 located on the optic axis 4400, and a laterally separated image point 4402 that lies a perpendicular distance H from the optic axis. In some embodiments, the two points lie on the same flat plane whose surface is perpendicular to the optic axis, such that the focal plane is flat. In some embodiments, a focal plane of the virtual image is curved, such that the two points also have some longitudinal distance, along the optic axis, between them. The display system 7 has an exit aperture optic 2248 that has a lateral dimension W, and the central image point 4401 is a perpendicular distance S′ away, such that the angle A measured from that point subtends the aperture optic. The laterally separated image point 4402 subtends an angle B relative to the aperture optic, where B is calculated via

$$B = \frac{π}{2} + {tan}^{- 1} \frac{W / 2 - {S}^{′}}{D} - {tan}^{- 1} \frac{{S}^{′}}{W / 2 + H} ,$$

which monotonically decreases as H increases. In some embodiments, 2H is a lateral dimension of the virtual image.

FIG. 44B shows an example embodiment of an imaging system used as a display system to generate virtual floating or hovering images. A display 2101 disposed a distance S from a lens group 2116 directs light through the the lens group and forms a virtual image 2128 a distance S′ from the lens group. The diameter W of the lens serves as the lateral dimension of the aperture optic, and the image size is 2H. Note that when viewed as an imaging system, this location and image would be considered a real image. However, a viewer in the viewable zone 4403 V would perceive a floating image that is hovering in front of the lens by the distancer S′. V is defined as the region of space in which all points of the virtual image are visible by a human eye. It is synonymous with eyebox or, if both eyes of a human viewer can fit within it, the headbox as defined above. Therefore, the viewable zone/headbox may have a lateral dimension greater than or equal to the averager interpupillary distance, greater 7 cm, greater than [symbol] 10 cm [symbol] . In some cases, the lateral dimension may be greater than [symbol] 20 cm [symbol] , greater than [symbol] 30 cm [symbol] , greater than [symbol] 40 cm [symbol] , and greater than [symbol] 50 cm [symbol] . In some embodiments, the lateral dimension may be large enough to encompass both eyes of each of a plurality of viewers simultaneously.

Some of these elements are described in FIG. 44C, which plots various quantities on a graph of distance to the aperture (cm) (vertical axis 4404) and image size relative to aperture size (horizontal axis 4405). So, for example, if the image size is 2H and the aperture size is W, then the x-coordinate of a relevant observation point would be 2H/W (dimensionless). The position of the aperture optic itself corresponds to the horizontal axis. The distance between the aperture and the closest point of the viewable zone is shown by a first curve 4407, and the distance between the hovering image and the same point of the viewable zone is shown by a second curve 4406. In some embodiments, the distance of the virtual image from the aperture is greater than 15 cm, indicated by a first dashed line 4409. In some embodiments the closest distance between the viewable zone and the aperture is greater than 40 cm., indicated by a second dashed line 4410. The shaded region 4408 is the allowable image sizes corresponding to these two inequalities. The distance between the hovering image and the viewable zone must be greater than the smallest focusing distance of the human eye f₀. Further, the distance between the aperture and the hovering image may correspond to a diopter D₀ different than a human viewer can distinguish via accommodation. In some embodiments, this leads to an inequality for the image size x,

$$\frac{{f}_{0}}{{f}_{0} + {S}^{′}} < x < 1 + \frac{{D}_{0} {S}^{′}}{2} ( 1 - \sqrt{1 + \frac{4}{{D}_{0} {S}^{′}}} ) .$$

Because hovering images are produced by focusing light into a real image first, analysis of imaging systems can be applied here. For example, the aperture optic (the final physical optical component in the system) may not control the resulting image properties. In some embodiments, the viewable zone is determined by the field stop of the system, which is the component that controls the field of view by limiting the solid angle formed by chief rays. To determine the field stop, form the image of each component formed by all elements between it and the image space, and it will form the exit window, which is the component that limits the area of the image. Possible image sizes, magnifications, monocular depths, and headbox dimensions vary and depend on the numerical aperture (NA) of the display system. Some hovering virtual images may be smaller and act as virtual buttons that a viewer can interact with through sensors. Some hovering images the size of a person, or larger, for example, having an image size greater than 1 m, 2 m, 3 m, 5 m, or 10 m. For example, in some embodiments having a curved specular reflector or a plurality of such, the maximum image size is given as (Rₓ/R_{y}) Y, where Rₓ is distance from the viewer to the hovering image (the monocular depth), R_{y} is distance of the path from the viewer to (effective) curved specular reflector (if there are multiple such components), and Y is a lateral dimension of the effective curved specular reflector.

The optical properties and dimensions of the system components that determine the various monocular depths, viewing distances, accommodative changes, and the like. For example, in some embodiments that use a curved mirror, the distance between the location of the hovering image and the curved mirror is related to (a) the distance from the light source and the curved mirror and (b) the focal length of the curved mirror by the lens equation, thin lens equation, or variants thereof. In some embodiments, the distance between the location of the hovering image and the curved mirror is appropriately (to within 10% of) the value of the curved mirror's focal length.

As another example, for those embodiments which comprise a curved specular reflector, the viewable zone may be determined by the angle that the light source subtends relative to the curved specular reflector, or to the effective curved specular reflector if the system includes more than one individual curved element. In some embodiments, the viewable zone, therefore, is impacted by a lateral dimension of the light source or of a curved specular reflector.

As another example, in some embodiments, the difference between the monocular depth of the hovering image (the distance between the hovering image and the viewer/viewer's eyes), d₁, and the distance between the aperture optic and the viewer, d₂, is expressed through optical power or differences in optical power, measured in diopter (D). Diopter has dimensions of inverse length. In some embodiments, the magnitude of the difference between d₁ and d₂ corresponds to an accommodative change of 0.1 D. In some embodiments, it is greater than 0.05 D, greater than 0.1 D, greater than 0.2 D, greater than 0.25 D, greater than 0.3 D, greater than 0.5 D, greater than 0.75 D, or greater than 1 D. In some embodiments, the difference between d₁ and d₂ is measured in dimensions of length; the (absolute value) of the difference may be greater than 1 cm, greater than 5 cm, 10 cm, greater than 20 cm, greater than 30 cm, greater than 50 cm, or greater than 1 m. In some embodiments, a viewer may distinguish between the monocular depth and the distance to the exit aperture optic by spatial awareness, i.e., by moving a body part to the hovering image and noticing that the body part is in front of the exit aperture optic. Therefore, the difference may be on the order of the width of a human finger, for example, between at least 1-2 cm.

In some embodiments, the distance between the viewer and the hovering image (i.e., the monocular depth) is greater than 10 cm, greater than 20 cm, 25 cm, greater than 50 cm, greater than 75 cm, greater than 1 m, greater than 2 m, greater than 5 m, or greater than 10 m.

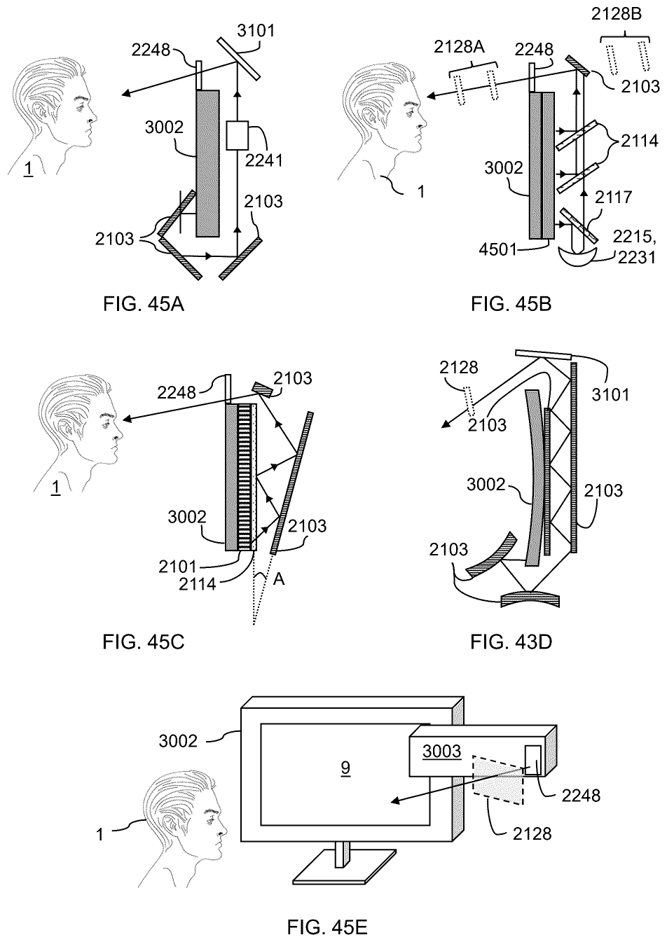

FIGS. 45A through 45E show embodiments of extended display subsystems that may produce hovering flowing images or farther virtual images. In FIG. 45A, a portion of light from main display 3002 is collected by one or more mirrors 2103 and directed behind the main display through an FEC 2241, which modulates at least one depth of the images formed by the portion of light. That light that is directed by a relay 3101, which may comprise one or more mirrors, through an exit aperture optic 2248, to be viewed by a viewer 1. In some embodiments, the FEC includes a curved specular reflector and generates hovering images. In some embodiments, the FEC includes an electrically switchable components, such as an LC plate or LC matrix, to modulate the depth of the image.

In FIG. 45B, the main display 3002 has a rear surface 4501 that emits light, such as would be the case if a display or other light source is adhered to the rear surface. A portion of that light is reflected downward by a reflective polarizer 2117, is reflected and rotated in polarization by combination AR layer 2115 and QM 2231, and is transmitted by the reflective polarizer, a plurality of beam splitters 2114, a mirror 2103 and through the exit aperture optic 2248 to the viewer, who sees virtual images 2128A closer than the aperture. Another portion of the light is directed by the beam splitters 2114, mirror 2103 and aperture optics 2248 to the viewer 1 to create a second set of virtual images 2128B that are farther away. In some embodiments, the light source lies outside the housing of the light-guiding subsystem.

FIG. 45C shows a main display 3002 with a secondary display 2101 adhered to its rear. It emits light through a beam splitter 2114, and the light is reflected back and forth between said beam splitter and a mirror, which are disposed at an oblique angle A relative to each other. The angle A may be acute, for example, less than 50°, less than 45°, less than 30°, less than 20°, or less than 10°. In some embodiments, the reflectivity of the beam splitter varies continuously or piecewise such that each round trip may experience a different reflectivity. For example, the reflectivity may decrease as the light travels upward such that light from the top of the display and from the bottom of the display 2101 have approximately equal brightness when viewed.

FIG. 43D shows a curved main display 3002 outcoupling a portion of light to a plurality of curved mirrors 2103 which direct light into an FEC comprising a plurality of flat mirrors 2103, which then direct the light to a relay 3101 forming a hovering virtual image 2128. In some embodiments, the curvature of the curved mirrors accounts for or is impacted by the curvature of the main display.

In FIG. 45E, a main display 3002 shows a display content 9, and some of the light is coupled to an extended display subsystem 3003, part of which lies outside the footprint of the main display. The components in this region direct the light through an aperture optic to form a virtual image 2128 for a viewer. In some embodiments, the aperture optic also lies outside the footprint. This effectively extends the viewing size of the display content and provides a larger image experience.

In some embodiments, shown in FIGS. 46A and 46B, the display system 7 has baffles 4601 extending from the edges and curving toward a viewer 1, who may be viewing virtual images 2128 and/or using a user input 12 device to interact with the images. That baffles have multiple functions. Depending on their shape, size, or orientation, they may block some of the virtual image light, including hovering virtual images, from being viewed from a certain position in the environment that is not the intended viewing position. In some embodiments, there are sensor 12 or camera 13 arrays on the baffles to detect properties of the user or of the environment. In some embodiments, the display includes an extended display system that is disposed along the baffles and that produces further virtual images 2128A, 2128B on the sides of the viewer. In some embodiments, the baffles provide ambient lighting effects near to the original virtual images 2128 to enhance, highlight, or otherwise impact them. In some embodiments, the ambient lighting from the baffles are synchronized with the virtual images, or it highlights the hovering buttons and, e.g., changes color when a viewer performs an action.

In any embodiment, sensors may be included to detect a property of a user, another person, or an environment to impact that screen. For example, in FIG. 46C, the display system 7 has IR cameras 14 disposed on it, so as the viewer 1 is looking at a virtual image 2128 from light traveling through the aperture 2248, his gestures can be detected. In some embodiments, the cameras are active cameras and direct a focused spot 4601 to an interactive feature in the image, such that when the viewer moves a body part, such as a finger, to that spot, the reflectivity changes, and those changes are detected by the cameras' sensors to signal to the associated electronics that the interactive feature is being manipulated. In some embodiments, such as in FIG. 46D, the IR cameras 14 use structured illumination to generate an IR pattern 4602, and the reflected pattern is observed by the system to understand how the viewer 1 is trying to interact with the imagery.

In some embodiments, such as that in FIG. 46E, the display system 7 shows a virtual image 2128 and a camera 14 or camera array are disposed on the system. These may be RGB or color cameras, grayscale, or monochrome. Their function is to observe the viewer and use computer vision algorithms for e.g., gesture detection, eye/head tracking, motion tracking, object detection, semantic segmentation, character recognition, and the like in order to understand how a viewer wishes to interact with the virtual image.

In some embodiments, feedback to the viewer is provided via a “feedback module,” which is any transducer, imagery, or electronic stimulus that provides information to the viewer about the viewer's properties. A feedback module can generate audio, ultrasonic, pressure, fluid, visual, temperature or other physical responses for the viewer to see, feel, or hear. In some embodiments, the feedback module generates the physical response when the viewer is interacting with a virtual image, by, for example, changing eye/head position, gaze, or gestures, or by giving audio commands. FIG. 46F shows the display system 7 with arrays of sensors 13 and cameras 14 mounted along the bezel in front of and behind. In some embodiments, an audio system 4603, such as a speaker or speaker array provides audio to the viewer. The audio may accompany the image content, or it may provide feedback to the user about how he is interacting with the images. For example, if the system detects a first gesture, a first sound may be emitted, and if the system detects a second gesture, a second sound is emitted.

In some embodiments, the feedback is visual. For example, in FIG. 46G, the display system 7 produces a first virtual image 2128A, and as a viewer's body part 4104 moves near that image, a camera 14 detects that gesture and sends an electronic signal to change an electrically switchable or modifiable component of the display system, such as the LC plate 2121 in FIG. 43B. The result is that the display system 7 now shows a second virtual image 2128B at a different monocular depth. This can mimic, for example, the notion of pushing or depressing a button.

Similarly, FIG. 46H shows a virtual image 2128. A viewer wishes to interact with an interactive region of that image. The viewer's body part 4101 starts at a position corresponding to an incorrect portion of the image. The virtual image may highlight that corresponding incorrect position 4605A and indicate a path 4604 to visually guide the viewer through a second incorrect position 4605B and ultimately to a correct position 4605C. At each position, the highlights may change, for example, becoming annotated differently, brighter, smaller, thicker, different styles, and the like, to cause the body part 4101 to travel the same path 4604. In some embodiments, as the finger or body part approaches in interactive region, the highlight may change line width or color (e.g., from red to blue), blurriness, and the like. Any continuous variation of size, shape, or color can indicate relative position between body part and interactive region.

FIG. 46I indicates how a computer vision task can provide interactivity. A user's body part 4101 is detected by a camera 14, and a computational module computes the structure of the gestures 4601. It classifies the gesture using a classification dictionary 4602 and then determines the associated action 4603. An example of gesture recognition is shown in FIG. 46J. Here, a first, second and third virtual image, 2128A, 2128B, and 2128C are visible in state S1. The central virtual image is closer in monocular depth to the viewer, and the others are set back some, such that they may be slightly blurry when viewing the central one. In some embodiments, the variation in depth follows a curved focal plane determined by the physical components. A body part 4101 of the viewer makes a gesture 4602, and that is detected by the system to change the virtual images into state S2. This has a scrolling or swiping effect on the virtual images, and the viewer can perform a second gesture, such as a pinch, to select the desired virtual image when it is centrally located. In some embodiments, the display is coupled to a wearable device 4603, as shown in FIG. 46K. This can be a watch, a glove, a jewelry piece such as ring, a wristband, a paddle, and the like. In some embodiments, there are haptic feedback modules on the wearable, to vibrate or direct ultrasonic vibrations into the user's body part 4101. In some embodiments, there is no wearable: the ultrasonic sensor or array is operably coupled to the display system, and it directs haptic feedback to the viewer without direct contact. In some embodiments, the user interacts with the display using standard inputs, such as a keyboard, mouse, scroll wheel, and the like.

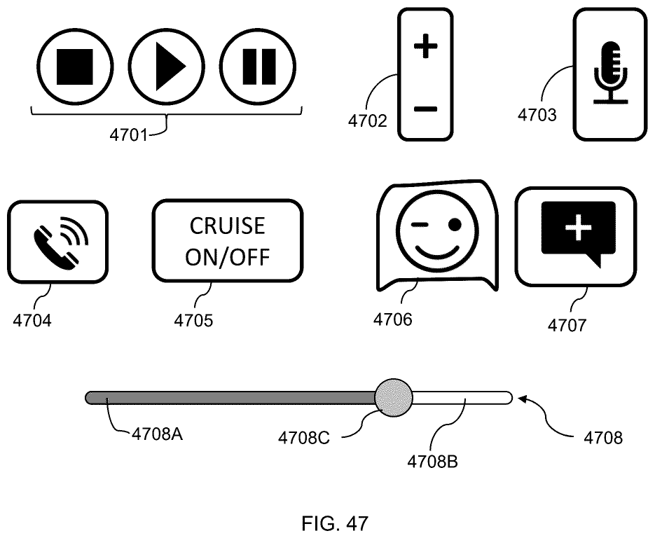

FIG. 47 shows a subset of some of the virtual images that can be shown as smaller hovering buttons that a viewer can interact with. Such buttons can include media control 4701, increase/decrease control 4702, voice control activation 4703, bluetooth calling activation 4704, vehicle control 4705, video call 4706, or app control 4707. In some embodiments, the interactive button has a long aspect ratio, such as a slide bar 4708, and the viewer can interact or move a first portion 4708C of the button, which separates the rest of the button into a first part 4708A and a second part 4708B.

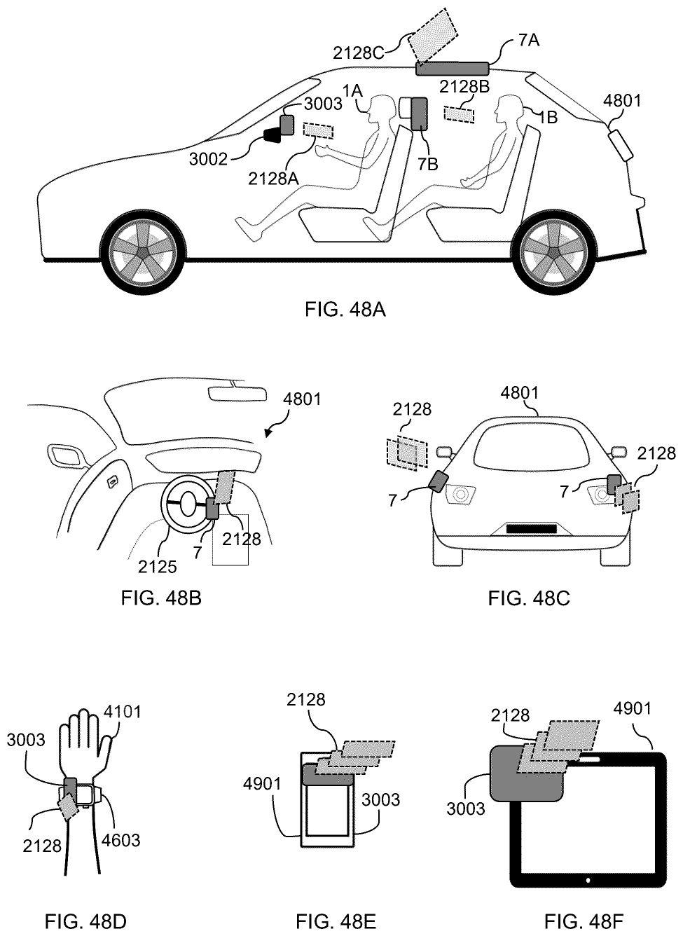

Such virtual images can be integrated into a variety of systems. In FIG. 48A, for example, virtual images are integrated into a vehicle 4801, viewable by a first viewer 1A or a second viewer 1B. Any already-integrated display system may be called an “in-vehicle” display, including a dashboard, central console, and passenger infotainment display. In some embodiments, a virtual image 2128 is formed by an extended display subsystem 3003 that is coupled to a main display 3002 within the cabin, such as a dashboard or instrument cluster. In some embodiments, a passenger viewer 1B may be viewing a first display 7A, which generates farther virtual images 2128C, and a second display 7B may be integrated into a part of the vehicle interior, such as seatback, to produce another virtual image 2128B that is closer. In some embodiments, such as in FIG. 48B, the display system 7 produces a hovering virtual image 2128 by being integrated into the steering wheel 2125 or other vehicle control instrumentation. In some embodiments, such as in FIG. 48C, the virtual images 2128 are visible outside the vehicle 4801, e.g., in front of, behind, or to the side of the vehicle. Such images are viewable by people external to the vehicle.

As shown in FIG. 48D through 48F, the virtual images 2128 may be produced by extended display subsystems 3003, that are integrated into devices such as wearables or portable devices, such as a watch 4603, phone 4901, laptop or tablet 4901, and the like.

The terms “machine readable medium,” “computer readable medium,” and similar terms here refer to non-transitory mediums, volatile or non-volatile, that store data and/or instructions that cause a machine to operate in a specific fashion. Common forms of machine-readable media include, e.g., a hard disk, solid state drive (SSD), magnetic tape, or any other magnetic data storage medium, an optical disc or any other optical data storage medium, any physical medium with patterns of holes, a random access memory (RAM), a programmable read-only memory (PROM), erasable programmable read-only memory (EPROM), a FLASH-EPROM, non-volatile random access memory (NVRAM), any other memory chip or cartridge, and networked versions of the same.

These and other various forms of computer readable media may be involved in carrying one or more sequences of one or more instructions to a processing device for execution. Such instructions embodied on the medium are called “instructions” or “code.” Instructions may be grouped as computer programs or other groupings. When executed, such instructions may enable a processing device to perform features or functions of the present application as discussed herein.

The various embodiments set forth herein are described in terms of exemplary block diagrams, flow charts, and other illustrations. As will become apparent to one of ordinary skill in the art, the illustrated embodiments and their various alternatives can be implemented without confinement to the illustrated examples. For example, block diagrams and their accompanying description should not be constructed as mandating a particular architecture or configuration. All illustrations, drawings, and examples in this disclosure describe selected versions of the techniques introduced here and they are not intended to limit the scope of the techniques introduced here.

Each of the processes, methods, and algorithms described in the preceding sections may be embodied in, and fully or partially automated by, code components executed by one or more computer systems or computer processors comprising computer hardware. The processes and algorithms may be implemented partially or wholly in application-specific circuitry. The various features and processes described above may be used independently of one another or may be combined in numerous ways. Different combinations and sub-combinations fall within the scope of this disclosure, and certain method or process blocks may be omitted in some implementations. Additionally, unless the context dictates otherwise, the methods and processes described herein are also not limited to any sequence, and the blocks or states relating thereto can be performed in other sequences that are appropriate, or may be performed in parallel, or in some other manner. Blocks or states may be added to or removed from the disclosed example embodiments. The performance of certain operations or processes may be distributed among computer systems or computer processors, not only residing within a single machine but deployed across several machines.

The term “or” may be constructed in either an inclusive or exclusive sense. Moreover, the description of resources, operations, or structures in the singular shall not be read to exclude the plural. Conditional language, including “can,” “could,” “might,” or “may,” unless specifically stated otherwise, or otherwise understood within the context as used, is intended to convey that certain embodiments include, while other embodiments do not include, certain features, elements, or steps.

Terms and phrases used in this document, and variations thereof, unless otherwise expressly stated, should be construed as open ended as opposed to limiting. Adjectives such as “conventional,” “traditional,” “normal,” “standard,” “known,” and similar should not be construed as limiting the item described to a given time period or to an item available as of a given time, but instead should be read to encompass conventional, traditional, normal, or standard technologies that may be available or known now or at any time in the future. Broadening words and phrases such as “one or more,” “at least,” “but not limited to” or similar phrases shall not be read to mean that the narrower case is intended or required in instances where such broadening phrases may be absent.

1. An interactive display system comprising:
a housing having an aperture and, within the housing,
a light source to emit light;
a plurality of specular reflectors to direct the light along an optical path forming a virtual image having a monocular depth; and
an exit aperture optic in the aperture to prevent stray light from impacting the virtual image, wherein
the monocular depth differs from a distance between the exit aperture optic and a viewer by a magnitude of at least 1 cm.

2. The interactive display of claim 1, wherein the monocular depth is closer to the viewer than the distance between the exit aperture optic and the viewer.

3. The interactive display system of claim 1, wherein the monocular depth is at least 10 cm.

4. The interactive display system of claim 1, wherein the virtual image is visible in a headbox that spans a lateral dimension of at least 7 cm.

5. The interactive display system of claim 4, wherein the viewer is a first viewer, the headbox is a first headbox, and wherein the virtual image is simultaneously visible by a second viewer located within a second headbox.

6. The interactive display system of claim 1, wherein the monocular depth is a first monocular depth, and the virtual image further comprises a second monocular depth, the first monocular depth and the second monocular depth forming a multifocal image.

7. The interactive display system of claim 1, wherein the virtual image is a first virtual image, the optical path is a first optical path, the monocular depth is a first monocular depth, and wherein the plurality of specular reflectors directs a portion of the light along a second optical path to create a second virtual image with a second monocular depth, the second monocular depth farther from the viewer than the distance between the exit aperture optic and the viewer.

8. The interactive display system of claim 1, wherein at least one of the plurality of specular reflectors is a curved specular reflector.

9. The interactive display system of claim 1, wherein at least one of the plurality of specular reflectors is polarization dependent.

10. The interactive display system of claim 1, further comprising a sensor or a camera to detect a property of the viewer, the property impacting the virtual image.

11. The interactive display system of claim 10, further comprising a feedback module to direct a physical response to the viewer when the viewer interacts with the virtual image.

12. The interactive display system of claim 1, wherein the interactive display is integrated into a vehicle.

13. The interactive display system of claim 1, wherein the interactive display is integrated into a device selected from a group consisting of a phone, a watch, a tablet, and a laptop.

14. A interactive display system comprising:
a housing having an aperture and, within the housing,
a light source to emit light;
a plurality of specular reflectors to direct the light along an optical path forming a virtual image possessing a monocular depth; and
an exit aperture optic in the aperture to transmit the light, wherein
at least one of the plurality of specular reflectors is a curved specular reflector, and the monocular depth is closer to a viewer than a distance between the exit aperture optic and the viewer.

15. The interactive display of claim 14, further comprising a sensor or a camera to detect a property of the viewer, the detected property impacting the virtual image.

16. The interactive display system of claim 14, wherein the virtual image is visible in at least one headbox that spans a lateral dimension of at least 7 cm.

17. The interactive display system of claim 14, further comprising an electro-optic element to temporally modulate the monocular depth.

18. An interactive display system, comprising:
a housing having an aperture;
a light-guiding subsystem secured within the housing and having a plurality of specular reflectors oriented to direct light from a light source forming a virtual image possessing a monocular depth; and
an exit aperture optic in aperture to transmit the light away from the housing, wherein the virtual image is visible in a headbox that spans at least 7 cm laterally, and the monocular depth is shorter than a distance between the exit aperture optic and a viewer in the headbox.

19. The interactive display system of 19, further comprising the light source.

20. The interactive display subsystem of claim 19, wherein at least one of the plurality of specular reflectors is retroreflective.

21. The interactive display subsystem of claim 19, further comprising:
a sensor or a camera to detect a property of the viewer, and
a feedback module to direct a physical response to the viewer, the physical response based on the property of the viewer.
